(19) United States
(12) Patent Application Publication
(10) Pub. No.: US 2023/0105414 A1
(43) Pub. Date: Apr. 6, 2023

(54) SILK COATED LEATHER AND PRODUCTS AND METHODS OF PREPARING THE SAME

(71) Applicant: EVOLVED BY NATURE, INC., Medford, MA (US)

(72) Inventors: Aaloka KOTWAL, Arlington, MA (US); Alexander WOLGE, Somerville, MA (US); Ilan E. GOLDBERG, Somerville, MA (US); Sara JOHNSON, Cambridge, MA (US); Maria UFRET, Grafton, MA (US); Gregory H. ALTMAN, Providence, RI (US); Carlos J. BOSQUES, Arlington, MA (US); Marius COSTACHE, Lexington, MA (US)

(21) Appl. No.: 17/793,342

(22) PCT Filed: Jan. 16, 2021
(86) PCT No.: PCT/US2021/013771

§ 371 Date: Jul. 15, 2022

Related U.S. Application Data
(60) Provisional application No. 62/981,263, filed on Feb. 25, 2020.
(60) Provisional application No. 62/966,296, filed on Jan. 27, 2020.
(60) Provisional application No. 62/962,655, filed on Jan. 17, 2020.

(51) Int. Cl. C14C 11/00; C14C 9/00; D06P 3/32; D06P 1/46

(52) U.S. Cl. CPC C14C 11/006; C14C 9/00; D06P 3/32; D06P 1/46

(57) ABSTRACT

Silk processed, coated, repaired, and/or infused leather or leather articles, and methods of preparing the same are disclosed herein.

### CROSS-REFERENCE TO RELATED APPLICATION

This application claims the benefit of U.S. Provisional Patent Applications Nos. 62/962,655, filed Jan. 17, 2020, 62/966,296, filed Jan. 27, 2020, and 62/981,263, filed Feb. 25, 2020, which are incorporated by reference herein in their entireties.

### REFERENCE TO A “SEQUENCE LISTING,” A TABLE, OR A COMPUTER PROGRAM LISTING APPENDIX SUBMITTED ON A COMPACT DISK

The sequence listing contained in the file named “032272-5012-WO50_ST25” and having a size of 15.6 kilobytes has been submitted electronically herewith via EFS-Web, and the contents of the .txt file are hereby incorporated by reference in their entirety.

### FIELD

In some embodiments, the disclosure relates to silk-coated leather apparel and products for use in home and automotive applications, such as leather coated with pure silk fibroin-based proteins or protein fragments thereof. In some embodiments, the disclosure relates to silk and silk protein fragments compositions, and methods of making and using thereof, for processing leather, for example coating leather, and/or repairing, hiding, or masking defects on or within leather, and/or as a mixing agent, additive, or replacement for leather processing chemicals.

### BACKGROUND

Silk is a natural polymer produced by a variety of insects and spiders, and comprises a filament core protein, silk fibroin, and a glue-like coating consisting of a non-filamentous protein, sericin. Silk fibers are lightweight, breathable, and hypoallergenic.

### SUMMARY

The disclosure provides an article comprising a leather substrate and silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5. In some embodiments, the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5. In some embodiments, the article further comprises about 0.001% (w/w) to about 10% (w/w) sericin relative to the silk fibroin proteins or fragments thereof. In some embodiments, the silk fibroin proteins or fragments thereof do not spontaneously or gradually gelate and do not visibly change in color or turbidity when in an aqueous solution for at least 10 days prior to being added to the leather substrate. In some embodiments, a portion of the silk fibroin proteins or fragments thereof is coated on a surface of the leather substrate. In some embodiments, a portion of the silk fibroin proteins or fragments thereof is infused into a layer of the leather substrate. In some embodiments, a portion of the silk fibroin proteins or fragments thereof is in a recessed portion of the leather substrate. In some embodiments, the article further comprises one or more polysaccharides selected from starch, cellulose, gum arabic, guar gum, xanthan gum, alginate, pectin, chitin, chitosan, carrageenan, inulin, and gellan gum. In some embodiments, the gellan gum comprises low-acyl content gellan gum. In some embodiments, the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5. In some embodiments, the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1. In some embodiments, the article further comprises one or more polyols, and/or one or more polyethers. In some embodiments, the polyols comprise one or more of glycol, glycerol, sorbitol, D-sorbitol, glucose, sucrose, mannitol, D-mannitol, and dextrose. In some embodiments, the polyethers comprise one or more polyethyleneglycols (PEGs). In some embodiments, the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5. In some embodiments, the article further comprises one or more of a silicone, a dye, a pigment, and a polyurethane. In some embodiments, the article further comprises one or more of a crosslinker, a crosslinker adduct, or a crosslinker reaction derivative. In some embodiments, the article further comprises one or more of: an isocyanate, isocyanate adduct, and/or isocyanate reaction derivative; a poly diisocyanate, poly diisocyanate adduct, and/or poly diisocyanate reaction derivative; an aziridine, aziridine adduct, and/or aziridine reaction derivative; a carbodiimide, carbodiimide adduct, and/or carbodiimide reaction derivative; an aldehyde, aldehyde adduct, and/or aldehyde reaction derivative; a polyisocyanate, polyisocyanate adduct, and/or polyisocyanate reaction derivative; a polyaziridine, polyaziridine adduct, and/or polyaziridine reaction derivative; a polycarbodiimide, polycarbodiimide adduct, and/or polycarbodiimide reaction derivative; a polyaldehyde, polyaldehyde adduct, and/or polyaldehyde reaction derivative; a polyurethane, polyurethane adduct, and/or polyurethane reaction derivative; a polyacrylate, polyacrylate adduct, and/or polyacrylate reaction derivative; a polyester, polyester adduct, and/or polyester reaction derivative; a wax, wax adduct, and/or wax reaction derivative; a protein, protein adduct, and/or protein reaction derivative; or an alcohol, alcohol adduct, and/or alcohol reaction derivative.

The disclosure also provides a method of treating a leather substrate with a silk formulation, the method comprising applying on a surface of the leather a silk formulation comprising silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5. In some embodiments, the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5. In some embodiments, the silk formulation further comprises about 0.001% (w/w) to about 10% (w/w) sericin relative to the silk fibroin proteins or fragments thereof. In some embodiments, the silk formulation further comprises about 0.001% (w/v) to about 10% (w/v) sericin. In some embodiments, the silk fibroin proteins or fragments thereof do not spontaneously or gradually gelate and do not visibly change in color or turbidity when in an aqueous solution for at least 10 days prior to being formulated and applied to the leather substrate. In some embodiments, a portion of the silk formulation is coated on a surface of the leather substrate, and/or a portion of the silk formulation is infused into a layer of the leather substrate, and/or a portion of the silk formulation enters a recessed portion of the leather substrate. In some embodiments, the silk formulation further comprises a rheology modifier. In some embodiments, the rheology modifier comprises one or more polysaccharides selected from starch, cellulose, gum arabic, guar gum, xanthan gum, alginate, pectin, chitin, chitosan, carrageenan gum, inulin, and gellan gum. In some embodiments, the gellan gum comprises low-acyl content gellan gum. In some embodiments, the w/w ratio between the silk fibroin proteins or fragments thereof and the rheology modifier in the silk formulation is selected from about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5. In some embodiments, the w/w ratio between the silk fibroin proteins or fragments thereof and the rheology modifier in the silk formulation is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1. In some embodiments, the w/v concentration of the rheology modifier in the silk formulation is between about 0.01% and about 5%, or between about 0.1% and about 1%. In some embodiments, the silk formulation further comprises a plasticizer. In some embodiments, the plasticizer comprises one or more polyols, and/or one or more polyethers. In some embodiments, the polyols are selected from one or more of glycol, glycerol, sorbitol, D-sorbitol, glucose, sucrose, mannitol, mannitol, D-mannitol, and dextrose. In some embodiments, the polyethers are one or more polyethyleneglycols (PEGs). In some embodiments, the w/w ratio between the silk fibroin proteins or fragments thereof and the plasticizer in the silk formulation is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5. In some embodiments, the w/v concentration of the plasticizer in the silk formulation is between about 0.01% and about 10%. In some embodiments, the silk formulation further comprises a defoaming agent at a concentration between about 0.001% and about 1%. In some embodiments, the defoaming agent comprises a silicone. In some embodiments, the silk formulation further comprises one or more of an isocyanate, a poly diisocyanate, an aziridine, a carbodiimide, an aldehyde, a polyisocyanate, a polyaziridine, a polycarbodiimide, a polyaldehyde, a polyurethane, a polyacrylate, a polyester, a wax, a protein, and/or an alcohol. In some embodiments, the silk formulation is a liquid, a gel, a paste, a wax, or a cream. In some embodiments, the silk formulation comprises one or more sub-formulations to be applied at the same time or at different times. In some embodiments, the concentration of silk fibroin proteins or fragments thereof in the silk formulation is between about 0.1% w/v and about 15% w/v. In some embodiments, the concentration of silk fibroin proteins or fragments thereof in the silk formulation is between about 0.5% w/v and about 12% w/v. In some embodiments, the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v. In some embodiments, the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 9.25% w/v, about 9.5% w/v, about 9.75% w/v, or about 10% w/v. In some embodiments, the concentration of silk fibroin proteins or fragments thereof in the silk formulation is between about 5 mg/mL and about 125 mg/mL. In some embodiments, the concentration of silk fibroin proteins or fragments thereof in the silk formulation is about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, or about 90 mg/mL. In some embodiments, the method further comprises one or more additional steps selected from dyeing, drying, water annealing, mechanical stretching, trimming, polishing, applying a pigment, applying a colorant, applying an acrylic formulation, applying an urethane formulation, chemical fixing, stamping, applying a silicone finish, providing a Uniflex treatment, and/or providing a Finiflex treatment, wherein the step of applying the silk formulation on a surface of the leather is performed before, during, or after the one or more additional steps. In some embodiments, treating the leather substrate with the silk formulation results in one or more of the following: increase in gloss, increase in color saturation, color enhancement, increase in color fixation, reduced dye use, and/or improved colorfastness. In some embodiments, the improvement is as to a leather substrate not similarly treated with a silk formulation.

Silk coated leather products and methods of preparing the same are disclosed herein. Silk and silk protein fragments, and silk and silk protein fragments (SPF) compositions as described herein, may be used to lock in color, as a surface treatment, in place or in addition to of any chemical used during any chemical processing step, to alter appearance, hand, texture, and/or quality of leather.

In some embodiments, silk and silk protein fragments, and silk and silk protein fragments compositions as described herein, may be used for finishing leather, for example to alter the sheen or luster of leather, and/or to achieve finishes such as matte, glossy, mirror, embossed, etc.

In some embodiments, silk and silk protein fragments, and silk and silk protein fragments compositions as described herein, may be used for repairing, masking, or hiding defects in leather or in hides, for example follicle defects, or other mechanical defects, whether superficial, or within the leather or hide.

In some embodiments, silk and silk protein fragments, and silk and silk protein fragments compositions as described herein, may be used to alter and/or improve the appearance of leather, hides, and/or leather products, or to change the grade of leather or hides, and thus to widen the array of applicable market areas for a given leather type.

In some embodiments, silk and silk protein fragments, and silk and silk protein fragments compositions as described herein may be used to improve the hand of leather, for example its feel, or description of softness.

In some embodiments, silk and silk protein fragments, and silk and silk protein fragments compositions as described herein, may be used as a pigment delivery system during the finishing phase, or at any other appropriate process step, to lock in color, adjust final coloration, or alter pigment chemistry or to improve colorant delivery.

In some embodiments, silk and silk protein fragments, and silk and silk protein fragments compositions as described herein, may be used before or after any mechanical processing step typical of leather processing, including, but not limited to, before or after Uniflex treatment, Finiflex treatment, heat stamping treatment, polishing treatment, skin trimming, or drying. In some embodiments, silk and silk protein fragments, and silk and silk protein fragments compositions as described herein, may be used prior to any mechanical process described herein. In some embodiments, silk and silk protein fragments, and silk and silk protein fragments compositions as described herein, may be used during a finishing or dyeing process. In some embodiments, silk and silk protein fragments, and silk and silk protein fragments compositions as described herein, may be used prior to any press treatment described herein

In some embodiments, silk and silk protein fragments, and silk and silk protein fragments compositions as described herein, may be used by spraying on leather.

In some embodiments, silk and silk protein fragments, and silk and silk protein fragments compositions as described herein, may be used by stamping on leather.

In some embodiments, silk and silk protein fragments, and silk and silk protein fragments compositions as described herein, may be integrated into and onto leather.

In some embodiments, silk and silk protein fragments, and silk and silk protein fragments compositions as described herein, may be used prior, during, or after a leather processing step, for example a finishing process, in lieu of any chemistry used for stabilizing, altering sheen, luster, color, darkness, tone, finish, hand, weight, etc.

In some embodiments, silk and silk protein fragments, and silk and silk protein fragments compositions as described herein, may be used prior, during, or after a leather processing step, for example a finishing process, in addition to any chemistry used for stabilizing, altering sheen, luster, color, darkness, tone, finish, hand, etc.

In some embodiments, silk and silk protein fragments, and silk and silk protein fragments compositions as described herein, may be used to serve one or more chemical function during the tanning stage up to and through the dyeing stage of leather processing.

In some embodiments, silk and silk protein fragments, and silk and silk protein fragments compositions as described herein, may be used to serve one or more or mechanical function during the tanning stage up to and through the dyeing stage of leather processing.

In some embodiments, silk and silk protein fragments, and silk and silk protein fragments compositions as described herein, may be used to serve one or more functions during the tanning stage up to and through the dyeing stage of leather processing.

In some embodiments, silk and silk protein fragments, and silk and silk protein fragments compositions as described herein, may be used prior, during, or after a leather processing step, for example a finishing process, to alter the contact angle of solvents applied to semi-finished or finished leathers.

In some embodiments, silk and silk protein fragments, and silk and silk protein fragments compositions as described herein, may be used prior, during, or after a leather processing step, for example a finishing process, as a defect filling agent of either pre- or post-dyed skins. In some embodiments, such use includes combination with a pigment, dye, blending agent, softening agent, rheology modifier etc.

In some embodiments, silk and silk protein fragments, and silk and silk protein fragments compositions as described herein, may be used prior to, during, or after any process described herein, and for any purpose described herein, and such use be augmented by the additional use of one or more physicochemical processing treatments, including but not limited to 02 plasma, use of a crosslinking agent, a photo-crosslinking agent, or an ultraviolet treatment.

In some embodiments, silk and silk protein fragments, and/or silk and silk protein fragments compositions as described herein, can be mixed with, or replace classes of materials including, but not limited to, aqueous lacquers, waxes, oils, protein or other binders, fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, dye dispersing agents, acidic dyes, basic dyes, chromium-based or other dyes, and/or colorants.

In some embodiments, the leather preparation process may include the treating of leather with a silk and/or SPF composition described herein. In some embodiments, the silk and/or SPF composition may include one or more chemical agents as described hereinbelow (e.g., silicone, polyurethane, etc.).

In an embodiment, the disclosure provides a method of treating leather with a silk and/or SPF composition described herein, wherein the method may include the steps of: dyeing the leather; mechanically stretching the leather; trimming the leather; polishing the leather; applying (optionally by spray application) a pigment, and/or an acrylic coating to the leather; chemically fixing the leather, stamping the leather, applying a silicone or other finish to the leather; providing a Uniflex treatment to the leather; and/or filling a defect on the surface or within the leather with a silk or SPF composition; wherein one or more of the foregoing steps includes applying the silk and/or SPF composition to the leather before, during, or after the recited steps.

In an embodiment, the disclosure provides a method of treating leather with a silk and/or SPF composition described herein, wherein the method may include the steps of: dyeing the leather, drying the leather; mechanically stretching the leather; trimming the leather; performing a first polish of the leather; applying (optionally by spray application) a colorant, and/or an acrylic to the leather; performing a second polish of the leather, providing a Finiflex treatment to the leather; and/or filling a defect on the surface or within the leather with a silk or SPF composition; wherein one or more of the foregoing steps includes applying the silk composition to the leather before, during, or after the recited steps.

In some embodiments, a silk and/or SPF composition described herein may be applied to leather or a leather article by any of the methods described herein, but also by hand-spraying, spraying using a mechanical spray setup, applying by brush, bath coating, rubbing, wet-mixing, washing, drumming, soaking, extruding, injecting, plastering, roller coating, and/or filling.

In some embodiments, a silk and/or SPF composition described herein may be applied alone, mixed with one or several chemicals (e.g., chemical agents), as one coat or multiple coats at multiple times using varied application methods, to leathers that have or have not been: dyed, chrome-treated, sprayed with: pigment, acrylic, fixation agents, finishing agents, and/or colorants. In some embodiments, a silk and/or SPF composition described herein may be applied to a finished leather or leather article, a mechanically treated leather or leather article, or a drummed leather or leather article. In some embodiments, a silk and/or SPF composition described herein may be applied into a defect of a finished leather or leather article, a mechanically treated leather or leather article, or a drummed leather or leather article.

In some embodiments, a silk and/or SPF composition described herein may be applied to leather or a leather article as a defect filler pre-dyeing and prior to finishing. In some embodiments, a silk and/or SPF composition described herein may be applied to leather or a leather article as a defect filler after dyeing and prior to finishing. In some embodiments, a silk and/or SPF composition described herein may be applied to leather or a leather article as a defect filler after dyeing and after finishing.

In some embodiments, a silk and/or SPF composition described herein may be applied to leather or a leather article as a defect filler, wherein application is by hand. In some embodiments, a silk and/or SPF composition described herein may be applied to leather or a leather article as a defect filler, wherein application is by finger. In some embodiments, a silk and/or SPF composition described herein may be applied to leather or a leather article as a defect filler, wherein application is by using a brush-type applicator. In some embodiments, a silk and/or SPF composition described herein may be applied to leather or a leather article as a defect filler, wherein application is by using a marker-type applicator. In some embodiments, a silk and/or SPF composition described herein may be applied to leather or a leather article as a defect filler, wherein application is by using a pen-type applicator. In some embodiments, a silk and/or SPF composition described herein may be applied to leather or a leather article as a defect filler, wherein application is by using a pipette-type applicator. In some embodiments, a silk and/or SPF composition described herein may be applied to leather or a leather article as a defect filler, wherein application is by using a syringe-type applicator. In some embodiments, a silk and/or SPF composition described herein may be applied to leather or a leather article as a defect filler, wherein application is by using an eyeliner brush-type applicator and any brush or brush-like applicator. In some embodiments, a silk and/or SPF composition described herein may be applied to leather or a leather article as a defect filler, wherein application is by using a heated stamp device applicator. In some embodiments, a silk and/or SPF composition described herein may be applied to leather or a leather article as a defect filler, wherein application is by using a sponge applicator. In some embodiments, a silk and/or SPF composition described herein may be applied to leather or a leather article as a defect filler, wherein application is by using a roller-coater In some embodiments, a silk and/or SPF composition described herein may be applied to leather or a leather article as a defect filler, wherein application is by “glue-gun”-like applicator.

In some embodiments, a silk and/or SPF composition described herein may be applied as a defect filler to bovine skin leather or leather article. In some embodiments, a silk and/or SPF composition described herein may be applied as a defect filler to sheep skin leather or leather article. In some embodiments, a silk and/or SPF composition described herein may be applied as a defect filler to lamb skin leather or leather article. In some embodiments, a silk and/or SPF composition described herein may be applied as a defect filler to horse skin leather or leather article. In some embodiments, a silk and/or SPF composition described herein may be applied as a defect filler to crocodile skin leather or leather article. In some embodiments, a silk and/or SPF composition described herein may be applied as a defect filler to alligator skin leather or leather article. In some embodiments, a silk and/or SPF composition described herein may be applied as a defect filler to avian skin leather or leather article. In some embodiments, a silk and/or SPF composition described herein may be applied as a defect filler to animal skin leather or leather article. In some embodiments, a silk and/or SPF composition described herein may be applied as a defect filler to split leather or leather article. In some embodiments, a silk and/or SPF composition described herein may be applied as a defect filler to suede leather or leather article. In some embodiments, a silk and/or SPF composition described herein may be applied as a defect filler to wet blue leather or leather article. In some embodiments, a silk and/or SPF composition described herein may be applied as a defect filler to altered leather or leather article. In some embodiments, a silk and/or SPF composition described herein may be applied as a defect filler to aniline leather or leather article. In some embodiments, a silk and/or SPF composition described herein may be applied as a defect filler to bonded leather or leather article. In some embodiments, a silk and/or SPF composition described herein may be applied as a defect filler to brushed leather or leather article. In some embodiments, a silk and/or SPF composition described herein may be applied as a defect filler to buffed leather or leather article. In some embodiments, a silk and/or SPF composition described herein may be applied as a defect filler to Bycast leather or leather article. In some embodiments, a silk and/or SPF composition described herein may be applied as a defect filler to chamois leather or leather article. In some embodiments, a silk and/or SPF composition described herein may be applied as a defect filler to plonge leather or leather article. In some embodiments, a silk and/or SPF composition described herein may be applied as a defect filler to chrome-tanned leather or leather article. In some embodiments, a silk and/or SPF composition described herein may be applied as a defect filler to combination tanned leather or leather article. In some embodiments, a silk and/or SPF composition described herein may be applied as a defect filler to Cordovan leather or leather article. In some embodiments, a silk and/or SPF composition described herein may be applied as a defect filler to corrected grain leather or leather article. In some embodiments, a silk and/or SPF composition described herein may be applied as a defect filler to crockproof leather or leather article. In some embodiments, a silk and/or SPF composition described herein may be applied as a defect filler to drummed leather or leather article. In some embodiments, a silk and/or SPF composition described herein may be applied as a defect filler to embossed leather or leather article. In some embodiments, a silk and/or SPF composition described herein may be applied as a defect filler to enhanced grain leather or leather article. In some embodiments, a silk and/or SPF composition described herein may be applied as a defect filler to grained leather or leather article. In some embodiments, a silk and/or SPF composition described herein may be applied as a defect filler to metallized leather or leather article. In some embodiments, a silk and/or SPF composition described herein may be applied as a defect filler to naked leather or leather article. In some embodiments, a silk and/or SPF composition described herein may be applied as a defect filler to natural grain leather or leather article. In some embodiments, a silk and/or SPF composition described herein may be applied as a defect filler to Nubuck leather or leather article. In some embodiments, a silk and/or SPF composition described herein may be applied as a defect filler to patent leather or leather article. In some embodiments, a silk and/or SPF composition described herein may be applied as a defect filler to pearlized leather or leather article. In some embodiments, a silk and/or SPF composition described herein may be applied as a defect filler to plated leather or leather article. In some embodiments, a silk and/or SPF composition described herein may be applied as a defect filler to printed leather or leather article. In some embodiments, a silk and/or SPF composition described herein may be applied as a defect filler to protected leather or leather article. In some embodiments, a silk and/or SPF composition described herein may be applied as a defect filler to pure aniline leather or leather article. In some embodiments, a silk and/or SPF composition described herein may be applied as a defect filler to tanned/retanned leather or leather article. In some embodiments, a silk and/or SPF composition described herein may be applied as a defect filler to round hand leather or leather article. In some embodiments, a silk and/or SPF composition described herein may be applied as a defect filler to saddle leather or leather article. In some embodiments, a silk and/or SPF composition described herein may be applied as a defect filler to semi-aniline leather or leather article. In some embodiments, a silk and/or SPF composition described herein may be applied as a defect filler to shrunken grain leather or leather article. In some embodiments, a silk and/or SPF composition described herein may be applied as a defect filler to side leather or leather article.

In some embodiments, a silk and/or SPF composition described herein (with or without one or more chemical agents) may be used to treat leather before or after the liming step. In some embodiments, a silk and/or SPF composition described herein (with or without one or more chemical agents) may be used to treat leather before or after the deliming and/or bateing steps. In some embodiments, a silk and/or SPF composition described herein (with or without one or more chemical agents) may be used to treat leather before or after the pickling step. In some embodiments, a silk and/or SPF composition described herein (with or without one or more chemical agents) may be used to treat leather before or after the tanning step. In some embodiments, a silk and/or SPF composition described herein (with or without one or more chemical agents) may be used to treat leather before or after the neutralizing, dyeing, and/or fat liquoring steps. In some embodiments, a silk and/or SPF composition described herein (with or without one or more chemical agents) may be used to treat leather before or after any drying step. In some embodiments, a silk and/or SPF composition described herein (with or without one or more chemical agents) may be used to treat leather before or after the finishing step. In some embodiments, a silk and/or SPF composition described herein (with or without one or more chemical agents) may be used during the finishing step or as part of the finishing step. In some embodiments, a silk and/or SPF composition described herein (with or without one or more chemical agents) may be used in a stand-alone silk and/or SPF treatment step.

In some embodiments, a silk and/or SPF composition described herein (with or without one or more chemical agents) may be used to treat leather during the liming step. In some embodiments, a silk and/or SPF composition described herein (with or without one or more chemical agents) may be used to treat leather during the deliming and/or bateing steps. In some embodiments, a silk and/or SPF composition described herein (with or without one or more chemical agents) may be used to treat leather during the pickling step. In some embodiments, a silk and/or SPF composition described herein (with or without one or more chemical agents) may be used to treat leather during the tanning step. In some embodiments, a silk and/or SPF composition described herein (with or without one or more chemical agents) may be used to treat leather during the neutralizing, dyeing, and/or fat liquoring steps. In some embodiments, a silk and/or SPF composition described herein (with or without one or more chemical agents) may be used to treat leather during the drying step. In some embodiments, a silk and/or SPF composition described herein (with or without one or more chemical agents) may be used to treat leather during the finishing step. In some embodiments, a silk and/or SPF composition described herein (with or without one or more chemical agents) may be used during the finishing step or as part of the finishing step.

In some embodiments, a silk and/or SPF composition described herein (with or without one or more chemical agents) may be used to treat leather during a process including one or more steps, for example one or more dyeing steps. In some embodiments, the silk and/or SPF composition can be used prior, during, or after a dyeing step. In some embodiments, a silk and/or SPF composition described herein (with or without one or more chemical agents) may be used to treat leather during a process including one or more steps, for example one or more mechanical processing steps. In some embodiments, the silk and/or SPF composition can be used prior, during, or after a mechanical processing step. Mechanical steps include, but are not limited to drying, polishing, stamping, Uniflex and/or Finiflex, stretching, and/or trimming. In some embodiments, a silk and/or SPF composition described herein (with or without one or more chemical agents) may be used to treat leather during a process including one or more steps, for example one or more polishing steps. In some embodiments, the silk and/or SPF composition can be used prior, during, or after a polishing step. In some embodiments, a silk and/or SPF composition described herein (with or without one or more chemical agents) may be used to treat leather during a process including one or more steps, for example one or more chemical treatment steps. In some embodiments, the silk and/or SPF composition can be used prior, during, or after a chemical treatment step. Chemical treatment steps include, but are not limited to one or more pigment treatment steps, one or more acrylic, silicone, and/or polyurethane treatment steps, and/or one or more chemical fixation treatment steps.

In an embodiment, a method is provided for processing leather with silk fibroin and/or SPF that may include silk-based proteins or fragments thereof to provide a silk fibroin processed leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, processing a surface of the leather material with a silk fibroin solution or composition before, during, or after any processing step. In some embodiments, the method may include, processing a surface of the leather material with a silk fibroin solution or composition before, during, or after pigment delivery. In some embodiments, the method may include, processing a surface of the leather material with a silk fibroin solution or composition before, during, or after color locking. In some embodiments, the method may include, processing a surface of the leather material with a silk fibroin solution or composition before, during, or after final coloration adjustment. In some embodiments, the method may include, processing a surface of the leather material with a silk fibroin solution or composition before, during, or after pigment chemistry alteration. In some embodiments, the method may include, processing a surface of the leather material with a silk fibroin solution or composition before, during, or after colorant delivery improvement. In some embodiments, the method may include, processing a surface of the leather material with a silk fibroin solution or composition before, during, or after Uniflex treatment. In some embodiments, the method may include, processing a surface of the leather material with a silk fibroin solution or composition before, during, or after Finiflex treatment. In some embodiments, the method may include, processing a surface of the leather material with a silk fibroin solution or composition before, during, or after heat stamping treatment. In some embodiments, the method may include, processing a surface of the leather material with a silk fibroin solution or composition before, during, or after polishing treatment. In some embodiments, the method may include, processing a surface of the leather material with a silk fibroin solution or composition before, during, or after skin trimming. In some embodiments, the method may include, processing a surface of the leather material with a silk fibroin solution or composition before, during, or after a finishing process. In some embodiments, the method may include, processing a surface of the leather material with a silk fibroin solution or composition before, during, or after tanning. In some embodiments, the method may include, processing a surface of the leather material with a silk fibroin solution or composition before, during, or after dyeing. In some embodiments, the method may include, processing a surface of the leather material with a silk fibroin solution or composition before, during, or after stretching. In some embodiments, the method may include, processing a surface of the leather material with a silk fibroin solution or composition before, during, or after drying. In some embodiments, the method may include, processing a surface of the leather material with a silk fibroin solution or composition before, during, or after trimming. In some embodiments, the method may include, processing a surface of the leather material with a silk fibroin solution or composition before, during, or after polishing.

In an embodiment, a method is provided for coating leather with silk fibroin and/or SPF that may include silk-based proteins or fragments thereof to provide a silk fibroin coated leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution before, during, or after any processing step. In some embodiments, the method may include, coating a surface of the leather material with the silk fibroin solution before, during, or after pigment delivery. In some embodiments, the method may include, coating a surface of the leather material with the silk fibroin solution before, during, or after color locking. In some embodiments, the method may include, coating a surface of the leather material with the silk fibroin solution before, during, or after final coloration adjustment. In some embodiments, the method may include, coating a surface of the leather material with the silk fibroin solution before, during, or after pigment chemistry alteration. In some embodiments, the method may include, coating a surface of the leather material with the silk fibroin solution before, during, or after colorant delivery improvement. In some embodiments, the method may include, coating a surface of the leather material with the silk fibroin solution before, during, or after Uniflex treatment. In some embodiments, the method may include, coating a surface of the leather material with the silk fibroin solution before, during, or after Finiflex treatment. In some embodiments, the method may include, coating a surface of the leather material with the silk fibroin solution before, during, or after heat stamping treatment. In some embodiments, the method may include, coating a surface of the leather material with the silk fibroin solution before, during, or after polishing treatment. In some embodiments, the method may include, coating a surface of the leather material with the silk fibroin solution before, during, or after skin trimming. In some embodiments, the method may include, coating a surface of the leather material with the silk fibroin solution before, during, or after a finishing process. In some embodiments, the method may include, coating a surface of the leather material with the silk fibroin solution before, during, or after tanning. In some embodiments, the method may include, coating a surface of the leather material with the silk fibroin solution before, during, or after dyeing. In some embodiments, the method may include, coating a surface of the leather material with the silk fibroin solution before, during, or after stretching. In some embodiments, the method may include, coating a surface of the leather material with the silk fibroin solution before, during, or after drying. In some embodiments, the method may include, coating a surface of the leather material with the silk fibroin solution before, during, or after trimming. In some embodiments, the method may include, coating a surface of the leather material with the silk fibroin solution before, during, or after polishing.

In some embodiments, the method may include, filing and/or repairing a defect on the surface of the leather material with a silk fibroin composition, for example silk fibroin glue, paste, gel, wax, putty, or the like. In an embodiment, a method is provided for repairing leather with silk fibroin and/or SPF that may include silk-based proteins or fragments thereof to provide a silk fibroin repaired leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, repairing a surface and/or defect of the leather material with the silk fibroin solution or composition before, during, or after any processing step. In some embodiments, the method may include, repairing a surface and/or defect of the leather material with the silk fibroin solution or composition before, during, or after pigment delivery. In some embodiments, the method may include, repairing a surface and/or defect of the leather material with the silk fibroin solution or composition before, during, or after color locking. In some embodiments, the method may include, repairing a surface and/or defect of the leather material with the silk fibroin solution or composition before, during, or after final coloration adjustment. In some embodiments, the method may include, repairing a surface and/or defect of the leather material with the silk fibroin solution or composition before, during, or after pigment chemistry alteration. In some embodiments, the method may include, repairing a surface and/or defect of the leather material with the silk fibroin solution or composition before, during, or after colorant delivery improvement. In some embodiments, the method may include, repairing a surface and/or defect of the leather material with the silk fibroin solution or composition before, during, or after Uniflex treatment. In some embodiments, the method may include, repairing a surface and/or defect of the leather material with the silk fibroin solution or composition before, during, or after Finiflex treatment. In some embodiments, the method may include, repairing a surface and/or defect of the leather material with the silk fibroin solution or composition before, during, or after heat stamping treatment. In some embodiments, the method may include, repairing a surface and/or defect of the leather material with the silk fibroin solution or composition before, during, or after polishing treatment. In some embodiments, the method may include, repairing a surface and/or defect of the leather material with the silk fibroin solution or composition before, during, or after skin trimming. In some embodiments, the method may include, repairing a surface and/or defect of the leather material with the silk fibroin solution or composition before, during, or after a finishing process. In some embodiments, the method may include, repairing a surface and/or defect of the leather material with the silk fibroin solution or composition before, during, or after tanning. In some embodiments, the method may include, repairing a surface and/or defect of the leather material with the silk fibroin solution or composition before, during, or after dyeing. In some embodiments, the method may include, repairing a surface and/or defect of the leather material with the silk fibroin solution or composition before, during, or after stretching. In some embodiments, the method may include, repairing a surface and/or defect of the leather material with the silk fibroin solution or composition before, during, or after drying. In some embodiments, the method may include, repairing a surface and/or defect of the leather material with the silk fibroin solution or composition before, during, or after trimming. In some embodiments, the method may include, repairing a surface and/or defect of the leather material with the silk fibroin solution or composition before, during, or after polishing.

In an embodiment, a method is provided for coating leather with silk fibroin and/or SPF that may include silk-based proteins or fragments thereof to provide a silk fibroin coated leather, wherein the silk fibroin coated upon the silk fibroin coated leather may be heat resistant to a selected temperature. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution. In some embodiments, the method may include drying the surface of the leather material that has been coated with the silk fibroin solution or composition to provide the silk fibroin coated leather material, wherein drying the surface of the leather material comprises heating the surface of the material without substantially decreasing silk fibroin coating performance. In some embodiments, the method may include, filing a defect on the surface of the leather material with a silk fibroin composition, for example silk fibroin glue, paste, gel, wax, putty, or the like.

In an embodiment, the silk fibroin processed leather materials of the disclosure may be processed with one or more of low molecular weight silk, medium molecular weight silk, and high molecular weight silk to provide resulting coated leather materials having enhanced hydrophobic or hydrophilic properties. In an embodiment, the silk fibroin coated leather materials of the disclosure may be coated with one or more of low molecular weight silk, medium molecular weight silk, and high molecular weight silk to provide resulting coated leather materials having enhanced hydrophobic or hydrophilic properties. In an embodiment, the silk fibroin repaired leather materials of the disclosure may have one or more defects repaired, masked, or hidden with one or more of low molecular weight silk, medium molecular weight silk, and high molecular weight silk to provide resulting leather materials having enhanced properties, including an enhanced quality grade.

In an embodiment, the silk fibroin processed leather materials of the disclosure may be processed with compositions including low molecular weight silk and medium molecular weight silk. In an embodiment, the silk fibroin coated leather materials of the disclosure may be coated with compositions including low molecular weight silk and medium molecular weight silk. In an embodiment, the silk fibroin defect-repaired leather materials of the disclosure may be repaired with compositions including low molecular weight silk and medium molecular weight silk. In some embodiments, the w/w ratio between low molecular weight silk and medium molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and medium molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and medium molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including low molecular weight silk and high molecular weight silk. In an embodiment, the silk fibroin coated leather materials of the disclosure may be coated with compositions including low molecular weight silk and high molecular weight silk. In an embodiment, the silk fibroin defect-repaired leather materials of the disclosure may be repaired with compositions including low molecular weight silk and high molecular weight silk. In some embodiments, the w/w ratio between low molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including medium molecular weight silk and high molecular weight silk. In an embodiment, the silk fibroin coated leather materials of the disclosure may be coated with compositions including medium molecular weight silk and high molecular weight silk. In an embodiment, the silk fibroin defect-repaired leather materials of the disclosure may be repaired with compositions including medium molecular weight silk and high molecular weight silk. In some embodiments, the w/w ratio between medium molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including low molecular weight silk, medium molecular weight silk, and high molecular weight silk. In an embodiment, the silk fibroin coated leather materials of the disclosure may be coated with compositions including low molecular weight silk, medium molecular weight silk, and high molecular weight silk. In an embodiment, the silk fibroin defect-repaired leather materials of the disclosure may be repaired with compositions including low molecular weight silk, medium molecular weight silk, and high molecular weight silk. In an embodiment, the w/w ratio between low molecular weight silk, medium molecular weight silk, and high molecular weight silk is about 1:1:8, 1:2:7, 1:3:6, 1:4:5, 1:5:4, 1:6:3, 1:7:2, 1:8:1, 2:1:7, 2:2:6, 2:3:5, 2:4:4, 2:5:3, 2:6:2, 2:7:1, 3:1:6, 3:2:5, 3:3:4, 3:4:3, 3:5:2, 3:6:1, 4:1:5, 4:2:4, 4:3:3, 4:4:2, 4:5:1, 5:1:4, 5:2:3, 5:3:2, 5:4:1, 6:1:3, 6:2:2, 6:3:1, 7:1:2, 7:2:1, or 8:1:1.

In an embodiment, the disclosure provides a silk and/or SPF processed leather article, wherein the processing comprises silk based proteins or fragments thereof having a weight average molecular weight range of about 5 kDa to about 144 kDa. In an embodiment, the disclosure provides a silk and/or SPF coated leather article, wherein the coating comprises silk based proteins or fragments thereof having a weight average molecular weight range of about 5 kDa to about 144 kDa. In an embodiment, the disclosure provides a silk and/or SPF defect-repaired leather article, wherein the defect filling comprises silk based proteins or fragments thereof having a weight average molecular weight range of about 5 kDa to about 144 kDa.

In an embodiment, the disclosure provides a silk and/or SPF processed leather article, wherein the processing comprises silk based proteins or fragments thereof having average weight average molecular weights of about 5 kDa to about 144 kDa. In an embodiment, the disclosure provides a silk and/or SPF coated leather article, wherein the coating comprises silk based proteins or fragments thereof having average weight average molecular weights of about 5 kDa to about 144 kDa. In an embodiment, the disclosure provides a silk and/or SPF defect-repaired leather article, wherein the defect filling comprises silk based proteins or fragments thereof having average weight average molecular weights of about 5 kDa to about 144 kDa.

In an embodiment, the disclosure provides a leather article processed with silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the disclosure provides a leather article having a coating wherein the coating comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the disclosure provides a leather article including a one or more leather defect-filling portions, wherein the composition comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues.

In an embodiment, the disclosure provides a leather article processed with silk based proteins or fragments thereof having a weight average molecular weight range of about 5 kDa to about 144 kDa. In an embodiment, the disclosure provides a leather article having a coating wherein the coating comprises silk based proteins or fragments thereof having a weight average molecular weight range of about 5 kDa to about 144 kDa. In an embodiment, the disclosure provides a leather article including a leather defect-filling composition, wherein the composition comprises silk based proteins or fragments thereof having a weight average molecular weight range of about 5 kDa to about 144 kDa.

In an embodiment, the disclosure provides a leather article processed with silk based proteins or fragments thereof having average weight average molecular weights of about 5 kDa to about 144 kDa. In an embodiment, the disclosure provides a leather article having a coating wherein the coating comprises silk based proteins or fragments thereof having average weight average molecular weights of about 5 kDa to about 144 kDa. In an embodiment, the disclosure provides a leather article including a leather defect-filling composition, wherein the composition comprises silk based proteins or fragments thereof having average weight average molecular weights of about 5 kDa to about 144 kDa.

In an embodiment, the disclosure provides a leather article processed with silk proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article including a leather defect-filling composition, coating wherein the composition comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin.

In an embodiment, the disclosure provides a leather article processed with silk proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article having a coating wherein the coating comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article including a leather defect-filling composition, coating wherein the composition comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article including a leather defect-filling compositions, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article including a leather defect-filling compositions, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article including a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article including a leather defect-filling composition, wherein the composition comprises silk based proteins or fragments thereof having average weight average molecular weight of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a leather defect-filling composition, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the disclosure provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the disclosure provides a leather article processed with a composition comprising silk based proteins or fragments thereof and a pigment and/or a colorant, the silk based proteins or fragments thereof having a weight average molecular weight range of about 5 kDa to about 144 kDa. In an embodiment, the disclosure provides a leather article having a coating comprising silk based proteins or fragments thereof and a pigment and/or a colorant, the silk based proteins or fragments thereof having a weight average molecular weight range of about 5 kDa to about 144 kDa. In an embodiment, the disclosure provides a leather article including a defect-filling composition comprising silk based proteins or fragments thereof and a pigment and/or a colorant, the silk based proteins or fragments thereof having a weight average molecular weight range of about 5 kDa to about 144 kDa. In an embodiment, the disclosure provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the disclosure provides a leather article processed with a composition comprising silk based proteins or fragments thereof and a pigment and/or a colorant, the silk based proteins or fragments thereof having average weight average molecular weights of about 5 kDa to about 144 kDa. In an embodiment, the disclosure provides a leather article having a coating comprising silk based proteins or fragments thereof and a pigment and/or a colorant, the silk based proteins or fragments thereof having average weight average molecular weights of about 5 kDa to about 144 kDa. In an embodiment, the disclosure provides a leather article including a defect-filling composition comprising silk based proteins or fragments thereof and a pigment and/or a colorant, the silk based proteins or fragments thereof having average weight average molecular weights of about 5 kDa to about 144 kDa.

In an embodiment, the disclosure provides a leather article processed with silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to processing the leather article, do not spontaneously or gradually gelate and do not visibly change in color or turbidity when in a solution for at least 10 days. In an embodiment, the disclosure provides a leather article having a coating wherein the coating comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to coating the leather article, do not spontaneously or gradually gelate and do not visibly change in color or turbidity when in a solution for at least 10 days. In an embodiment, the disclosure provides a leather article including a leather defect-filling composition, wherein the composition comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to repairing the leather article, do not spontaneously or gradually gelate and do not visibly change in color or turbidity when in a solution for at least 10 days.

In an embodiment, the disclosure provides a leather article processed with silk based proteins or fragments thereof having a weight average molecular weight range of about 5 kDa to about 144 kDa. In an embodiment, the disclosure provides a leather article having a coating wherein the coating comprises silk based proteins or fragments thereof having a weight average molecular weight range of about 5 kDa to about 144 kDa. In an embodiment, the disclosure provides a leather article including a leather defect-filling composition, wherein the composition comprises silk based proteins or fragments thereof having a weight average molecular weight range of about 5 kDa to about 144 kDa.

In an embodiment, the disclosure provides a leather article processed with silk based proteins or fragments thereof having average weight average molecular weights of about 5 kDa to about 144 kDa. In an embodiment, the disclosure provides a leather article having a coating wherein the coating comprises silk based proteins or fragments thereof having average weight average molecular weights of about 5 kDa to about 144 kDa. In an embodiment, the disclosure provides a leather article including a leather defect-filling composition, wherein the composition comprises silk based proteins or fragments thereof having average weight average molecular weights of about 5 kDa to about 144 kDa.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates general steps used in leather processing.

FIGS. 2A and 2B illustrate a process for repairing leather as described herein;

FIG. 2A: leather defect prior to repairing; and FIG. 2B: repaired defect filled with a composition as described herein.

FIGS. 3A to 3C illustrate a process for repairing leather as described herein;

FIG. 3A: leather defect prior to repairing; FIG. 3B: repaired defect filled with a composition as described herein; and FIG. 3C: repaired defect filled with a composition as described herein and then coated with Unithane 2132 NF.

FIGS. 4A to 4C illustrate a process for repairing leather as described herein;

FIG. 4A: leather defect prior to repairing; FIG. 4B: repaired defect filled with a composition as described herein; and FIG. 4C: repaired defect filled with a composition as described herein and then coated with Unithane 351 NF.

FIGS. 5A to 5C illustrate a process for repairing leather as described herein;

FIG. 5A: leather defect prior to repairing; FIG. 5B: repaired defect filled with a composition as described herein; and FIG. 5C: repaired defect filled with a composition as described herein and then coated with Silky Top 7425 NF.

FIGS. 6A to 6C illustrate a process for repairing leather as described herein;

FIG. 6A: leather defect prior to repairing; FIG. 6B: repaired defect filled with a composition as described herein; and FIG. 6C: repaired defect filled with a composition as described herein and then coated with Uniseal 9049.

FIGS. 7A to 7C illustrate a process for repairing leather as described herein;

FIG. 7A: leather defect prior to repairing; FIG. 7B: repaired defect filled with a composition as described herein; and FIG. 7C: repaired defect filled with a composition as described herein and then coated with a 6% low MW silk coating.

FIGS. 8A and 8B show an eyeliner brush—applicator for a defect filling process (FIG. 8A), and a brush pen/marker filled with silk as applicator for a defect filling process (FIG. 8B).

FIGS. 9A and 9B show a sample of undyed lambskin leather (left side—uncoated, right side—coated with 6% low MW silk, 4 seconds autospray; FIG. 9A), and a sample of dyed lambskin leather (left side—uncoated, right side—coated with 6% low MW silk, 4 seconds autospray; FIG. 9B).

FIGS. 10A and 10B show a sample of bovine leather coated with 6% low MW silk, 4 seconds autospray (FIG. 10A), and a sample of undyed lambskin leather coated with 6% low MW silk mixed with 1% Clariant Hostaperm Violet RL Spec Pigment (FIG. 10B).

FIGS. 11A and 11B show a sample of undyed lambskin leather defect filled with 21% med MW silk with brush pen, before (FIG. 11A), and after (FIG. 11B).

FIGS. 12A and 12B show a sample of undyed lambskin leather defect filled with 21% M silk with 1% Clariant Hostaperm Violet RL Spec Pigment applied with an eyeliner brush applicator, before (FIG. 12A), and after (FIG. 12B).

FIGS. 13A to 13C show application of a defect filler composition using an eyeliner-type applicator, resulting in enhanced control of the topography of silk deposition to more accurately match natural patters on leather surface; FIG. 13A: unfilled defect; FIG. 13B: one round of application using an eyeliner brush; and FIG. 13C: second round of application using an eyeliner brush (24% low MW silk).

FIGS. 14A and 14B show application of a defect filler composition using a brush pen applicator; FIG. 14A: unfilled defect; and FIG. 14B: filled defect.

FIGS. 15A and 15B show application of a defect filler composition using a pipette applicator; FIG. 15A: unfilled defect; and FIG. 15B: defect filled with 10 μL high concentration (˜21% w/v) silk composition.

FIGS. 16A and 16B show application of a defect filler composition using a pipette applicator; FIG. 16A: unfilled defect; and FIG. 16B: defect filled with 5 μL high concentration (˜21% w/v) silk composition.

FIGS. 17A and 17B show application of a defect filler composition using a pipette applicator; FIG. 17A: unfilled defect; and FIG. 17B: defect filled with 1 μL high concentration (˜21% w/v) silk composition.

FIGS. 18A and 18B show application of a defect filler composition using a pipette applicator; FIG. 18A: unfilled defect; and FIG. 18B: defect filled with 0.1 μL high concentration (˜21% w/v) silk composition.

FIGS. 19A and 19B illustrate before and after images of a leather sample coated with a GG-silk formulation variant; leather sample before (FIG. 19A) and after (FIG. 19B) coating with Silk+0.5% wt. GG pH 9.75; coating applied using wire bar coater 20 μm (TQC Industries); defect is in the center of the field of view of all images, magnification is approximately 3×.

FIGS. 20A and 20B illustrate before and after images of a leather sample coated with a GLY-silk formulation variant; leather sample before (FIG. 20A) and after (FIG. 20B) coating with Silk+10% vol. GLY pH 8; coating applied using wire bar coater 20 μm (TQC Industries); defect is in the center of the field of view of all images, magnification is approximately 3×.

FIGS. 21A and 21B illustrate before and after images (2D) of a leather sample coated with GG—silk before (FIG. 21A) and after (FIG. 21B) coating with Silk+0.5% wt. GG via point filling. Defect is in the center of the field of view of both images. Images were captured using a Taylor Hobson CCI HD optical profilometer.

FIGS. 22A and 22B illustrate before and after images (3D) of a leather sample coated with GG—silk before (FIG. 22A) and after (FIG. 22B) coating with Silk+0.5% wt. GG via point filling. Defect is in the center of the field of view of both images. Images were captured using a Taylor Hobson CCI HD optical profilometer.

FIGS. 23A and 23B illustrate before and after topography traces of a leather sample coated with GG—silk before (FIG. 23A) and after (FIG. 23B) coating with Silk+0.5% wt. GG via point filling. Traces were captured using a Taylor Hobson CCI HD optical profilometer.

FIG. 24 is a chart illustrating viscosity as a function of shear rate for two independent batches of silk-based coating formulations for leather (6% MID MW silk fibroin+0.5% w/v GG). Batch A (Triangle) and Batch B (Circle) refer to two separate manufacturing batches of purified silk fibroin solution—the curve illustrates the reproducibility of the silk formulations after the addition of Gellan gum in terms of their rheological properties.

FIG. 25 is a chart illustrating the fill score as a function of Gellan gum (GG) content. Higher GG concentration (higher viscosity) silk formulations demonstrated improved defect filling compared to lower GG concentration formulations. N=3 replicate coating samples per treatment group.

FIG. 26 is a chart illustrating viscosity as a function of shear rate for 6% Mid MW silk fibroin solutions containing different concentrations of GG.

FIGS. 27A to 27C are microscope images of lambskin leather sample coated with an SF-GG formulation variant. Leather sample before (FIG. 27A), after (FIG. 27B) coating with 6% MID MW Silk+0.5% w/v GG pH 9.75, and after finishing (FIG. 27C). The coating was applied using a wire bar coater (20 μm—TQC Industries). The defect site is in the center of the field of view all images, magnification is approximately 3×, scale bar approximately 1.0 mm.

FIG. 28 illustrates an example defect filling performance for one SF-GG formulation variant (6% MID MW silk fibroin+0.5% w/v GG) applied to lambskin leather containing 10 defect sites. The coating was applied over n=3 layers using a wire bar coater (10 μm TQC Industries). Data points shown are the average of N=20 sample coatings.

FIGS. 29A to 29D illustrate a Scoring System for Defect Fillings; FIG. 29A: score=0, uncoated defect site—coating has either not been applied or completely misses the defect area (score assigned after assessment of microscopy image); FIG. 29B: score=1, minor reduction of defect size around edges of cavity—no filling or aggregation of coating in defect cavity (score assigned after assessment of microscopy image); FIG. 29C: score=2, partial filling of defect cavity—noticeable build-up or partial build-up of coating material (score assigned after assessment of microscopy image); and FIG. 29D: score=3, defect appears filled, edges of coating formulation appear flush with grain surface around defect site (score assigned after assessment of microscopy image).

FIG. 30 illustrates an example Fill Score chart—Fill score as a function of applied wet coating thickness for various concentrations of silk fibroin-based formulations (3 applications at 10 μm using a wire bar coater—TQC Industries). Different silk concentrations for low MW (10-12.5% w/v) and mid MW (6% w/v) affect efficiency of filling as additional coating layers are applied. Higher silk concentrations and higher-GG content (12.5% w/v low mw+0.5% GG) formulations tend to demonstrate better filling characteristics than lower silk- and lower GG-content formulations.

FIGS. 31A and 31B are images of leather samples STI-18080701-T029 (not water annealed; FIG. 31A) and STI-18080701-T030 (water annealed; FIG. 31B). After the water drop has been wiped away, no water drop remains on STI-18080701-T030 (FIG. 31B).

FIGS. 32A to 32D are photographs leather samples T001-T004 (no spray coating); FIG. 32A: RSD-TXTL-287-T001, black bovine; FIG. 32B: RSD-TXTL-287-T002, brown lamb skin; FIG. 32C: RSD-TXTL-287-T003, magenta lamb skin; FIG. 32D: RSD-TXTL-287-T004, orange lamb skin.

FIGS. 33A to 33D are photographs of leather samples T005-T008 (6% Mid spray coating); FIG. 33A: RSD-TXTL-287-T005, black bovine, 6% Mid; FIG. 33B: RSD-TXTL-287-T006, brown lamb skin, 6% Mid; FIG. 33C: RSD-TXTL-287-T007, magenta lamb skin, 6% Mid; FIG. 33D: RSD-TXTL-287-T008, orange lamb skin, 6% Mid.

FIG. 34A to 34D are photographs of leather samples T009-T012 (6% Low spray coating); FIG. 34A: RSD-TXTL-287-T009, black bovine, 6% Low; FIG. 34B: RSD-TXTL-287-T010, brown lamb skin, 6% Low; FIG. 34C: RSD-TXTL-287-T011, magenta lamb skin, 6% Low; FIG. 34D: RSD-TXTL-287-T012, orange lamb skin 6% Low.

FIGS. 35A to 35E illustrate photographs of stenciled leather samples T013-T016 (6% Low with stencil coating), along with the stencil used to make the coatings;

FIG. 35A: sample RSD-TXTL-287-T013, black bovine, 6% Low with stencil; FIG. 35B: sample RSD-TXTL-287-T014, brown lambskin, 6% Low with stencil; FIG. 35C: sample RSD-TXTL-287-T015, magenta lambskin, 6% Low with stencil; FIG. 35D: sample RSD-TXTL-287-T016, orange lambskin, 6% Low with stencil; FIG. 35E: exemplary stencil.

FIGS. 36A to 36E illustrate exemplary embodiments of flexible films made from 6% Mid Silk with 3% plasticizers; the plasticizers used are, respectively, glycerol (FIG. 36A), PEG 200 (FIG. 36B), PEG 400 (FIG. 36C), D-sorbitol (FIG. 36D), and sucrose (FIG. 36E).

FIGS. 37A to 37F illustrate that plasticizers on their own are unable to form films, and thus that silk is integral to making a flexible film; the plasticizers used are, respectively, D-mannitol (FIG. 37A), sucrose (FIG. 37B), glycerol (FIG. 37C), PEG 400 (FIG. 37D), tartaric acid (FIG. 37E), and PEG 200 (FIG. 37F).

FIGS. 38A and 38B illustrate a visualization of break on leather coated using silk with and without plasticizer; and showing that the formulation of silk and plasticizer results in improved leather break compared to silk alone; FIG. 38A illustrates a leather sample coated with 6% MID MW silk and 0.5% (wt.) Gellan gum and 3% (volume) PEG 200, wherein no break areas visible after handling for 60 seconds; FIG. 38B illustrates a leather sample coated with 6% MID MW silk and 0.5% (wt.) Gellan gum, wherein the graphical arrows denote areas of excessive break remaining on the sample after handling for 60 seconds.

FIG. 39 is a chart illustrating that silk-PVA blends are also plasticized relative to silk alone, and can be used to fill leather defects as well as provide improved break. The fill ratio of various-MW polyvinyl alcohol (PVA)-silk blends is shown compared to silk-gellan gum control (far left) on 25 sq. in. leather samples. Samples are coated at 4.0 g/sq. ft. using an Automatic Film Application Table with a 20 μm wire bar coater (TQC Industries).

FIG. 40 illustrates the microscopic cross-section of silk and leather infusion with a microscope, showing two different silk molecules with varying penetration.

FIG. 41 illustrates the calculation of Delta E (ΔE) based on the change in 3 color values.

FIGS. 42A and 42B illustrate the color intensity change for silk treated and untreated Black and Brown Nubuck Crust leather samples.

FIG. 43 illustrates the diagram of ΔE value for silk treated Black and Brown Nubuck Crust leather samples.

FIGS. 44A-B illustrate the L₂, a₂ and b₂ values assigned for the calculation of ΔE value.

FIGS. 45A-B illustrate the color intensity change for silk treated and untreated Black and Blue Nubuck Finished leather samples.

FIG. 46 illustrates the diagram of ΔE value for silk treated Black and Blue Nubuck Finished leather samples.

FIGS. 47A-B illustrate the L₂, a₂ and b₂ values assigned for the calculation of ΔE value.

FIGS. 48A-B illustrate the color intensity change for silk treated and untreated Turquoise and Brown suede leather samples.

FIG. 49 illustrates the diagram of ΔE value for silk treated Turquoise and Brown suede leather samples.

FIGS. 50A-B illustrate the L₂, a₂ and b₂ values assigned for the calculation of ΔE value.

FIG. 51 illustrates the diagram of veslic score for silk treated Black and Brown Nubuck Crust leather samples, silk treated Black and Blue Nubuck Finished leather samples, untreated Black and Brown Nubuck Crust leather samples, untreated Black and Blue Nubuck Finished leather samples.

FIG. 52 illustrates the diagram of veslic score for silk treated Turquoise and Brown suede leather samples and untreated Turquoise and Brown suede leather samples.

FIGS. 53A and 53B illustrate the color of leather samples determined colorimetrically with color values plotted in the L*a*b* color space; FIG. 53A: a* and b* values for leather dyed with different concentrations of purple dye; FIG. 53B: L* values for leather dyed with different concentrations of purple dye.

FIGS. 54A and 54B illustrate the colorfastness to crocking performance for a Nubuck leather article; FIG. 54A: scores of control (N.T.) and experimental articles treated with Silk Formulation 1; FIG. 54B: crocking fabric pads for scores given in FIG. 54A (clockwise from top right: N.T. dry 50 cycles; treated dry 50 cycles; treated wet 5 cycles; N.T. wet 5 cycles); N=2 replicates per group.

FIGS. 55A and 55B illustrate colorfastness to crocking performance for a Full Grain leather article; FIG. 55A: scores of control (N.T.) and experimental articles treated with Silk Formulation 2; FIG. 55B: crocking fabric pads for scores given in FIG. 55A (clockwise from top right: N.T. dry 50 cycles; treated dry 50 cycles; treated wet 5 cycles; N.T. wet 5 cycles); N=2 replicates per group.

FIGS. 56A-56F: Blue Nubuck colorfastness to migration performance images of N.T. (FIGS. 56A and 56B) and treated (FIG. 56C: Formulation 3; FIG. 56D: Formulation 4; FIG. 56E: Formulation 5; FIG. 56F: Formulation 6) samples.

FIG. 57 is a flow chart showing various embodiments for producing silk fibroin protein fragments (SPFs) of the present disclosure.

FIG. 58 is a flow chart showing various parameters that can be modified during the process of producing a silk protein fragment solution of the present disclosure during the extraction and the dissolution steps.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Leather is a material manufactured by treating the skin peeled off from an animal body with a series of physical mechanic and chemical methods, followed by tanning. The leather materials are composed of weaved collagen fiber bundles and trace amount of elastic fibers and reticular fibers, of which the collagen fiber is between 95 and 98 percent. The natural weaving structure of collagen fiber in natural leather is that the thicker fiber bundles sometimes are divided into several strands of thinner fiber bundles and the resulting thinner fiber bundles sometimes incorporate other fiber bundles to form another larger fiber bundle.

Leather in its natural state is a nonwoven material where the fibrils of the fiber have grown together. The silk fibroin protein and collagen fibers in the leather are natural proteins composed of 22 proteinogenic amino acids. The silk protein has high affinity to the leather fibers (collagen fibers) resulted from the presence of hydrophilic amino acid residue in the silk fibroin protein (e.g., physical entanglement due to forming hydrogen bonding between silk protein fragments and leather fibers), for example, —OH group from serine, guanidine group from arginine, free amine group from lysine, —COOH group from aspartic acid and glutamic acid.

In some embodiments, herein described silk fibroin-based protein fragments and solutions may find application as color performance enhancer for leather or leather articles. In some embodiments, this disclosure provides silk treated leather or leather articles exhibiting good dyeability, excellent color fastness and enhanced color saturation.

The treatment on the leather and leather articles with silk fibroin-based protein fragments and solutions enhances the quality and aesthetic properties of the natural leather using non-toxic, sustainable and natural silk based composition. The silk treatment process disclosed herein advances leather products while respecting its heritage and craft without disruption to the leather tanning and creating process.

SPF Definitions and Properties

As used herein, “silk protein fragments” (SPF) include, without limitation, one or more of: “silk fibroin fragments” as defined herein; “recombinant silk fragments” as defined herein; “spider silk fragments” as defined herein; “silk fibroin-like protein fragments” as defined herein; “chemically modified silk fragments” as defined herein; and/or “sericin or sericin fragments” as defined herein. SPF may have any molecular weight values or ranges described herein, and any polydispersity values or ranges described herein. As used herein, in some embodiments the term “silk protein fragment” also refers to a silk protein that comprises or consists of at least two identical repetitive units which each independently selected from naturally-occurring silk polypeptides or of variations thereof, amino acid sequences of naturally-occurring silk polypeptides, or of combinations of both.

SPF Molecular Weight and Polydispersity

In an embodiment, a composition of the present disclosure includes SPF having an average weight average molecular weight selected from between about 1 to about 5 kDa. In an embodiment, a composition of the present disclosure includes SPF having an average weight average molecular weight selected from between about 5 to about 10 kDa. In an embodiment, a composition of the present disclosure includes SPF having an average weight average molecular weight selected from between about 10 to about 15 kDa. In an embodiment, a composition of the present disclosure includes SPF having an average weight average molecular weight selected from between about 15 to about 20 kDa. In an embodiment, a composition of the present disclosure includes SPF having an average weight average molecular weight selected from between about 14 to about 30 kDa. In an embodiment, a composition of the present disclosure includes SPF having an average weight average molecular weight selected from between about 20 to about 25 kDa. In an embodiment, a composition of the present disclosure includes SPF having an average weight average molecular weight selected from between about 25 to about 30 kDa. In an embodiment, a composition of the present disclosure includes SPF having an average weight average molecular weight selected from between about 30 to about 35 kDa. In an embodiment, a composition of the present disclosure includes SPF having an average weight average molecular weight selected from between about 35 to about 40 kDa. In an embodiment, a composition of the present disclosure includes SPF having an average weight average molecular weight selected from between about 39 to about 54 kDa. In an embodiment, a composition of the present disclosure includes SPF having an average weight average molecular weight selected from between about 40 to about 45 kDa. In an embodiment, a composition of the present disclosure includes SPF having an average weight average molecular weight selected from between about 45 to about 50 kDa. In an embodiment, a composition of the present disclosure includes SPF having an average weight average molecular weight selected from between about 50 to about 55 kDa. In an embodiment, a composition of the present disclosure includes SPF having an average weight average molecular weight selected from between about 55 to about 60 kDa. In an embodiment, a composition of the present disclosure includes SPF having an average weight average molecular weight selected from between about 60 to about 65 kDa. In an embodiment, a composition of the present disclosure includes SPF having an average weight average molecular weight selected from between about 65 to about 70 kDa. In an embodiment, a composition of the present disclosure includes SPF having an average weight average molecular weight selected from between about 70 to about 75 kDa. In an embodiment, a composition of the present disclosure includes SPF having an average weight average molecular weight selected from between about 75 to about 80 kDa. In an embodiment, a composition of the present disclosure includes SPF having an average weight average molecular weight selected from between about 80 to about 85 kDa. In an embodiment, a composition of the present disclosure includes SPF having an average weight average molecular weight selected from between about 85 to about 90 kDa. In an embodiment, a composition of the present disclosure includes SPF having an average weight average molecular weight selected from between about 90 to about 95 kDa. In an embodiment, a composition of the present disclosure includes SPF having an average weight average molecular weight selected from between about 95 to about 100 kDa. In an embodiment, a composition of the present disclosure includes SPF having an average weight average molecular weight selected from between about 100 to about 105 kDa. In an embodiment, a composition of the present disclosure includes SPF having an average weight average molecular weight selected from between about 105 to about 110 kDa. In an embodiment, a composition of the present disclosure includes SPF having an average weight average molecular weight selected from between about 110 to about 115 kDa. In an embodiment, a composition of the present disclosure includes SPF having an average weight average molecular weight selected from between about 115 to about 120 kDa. In an embodiment, a composition of the present disclosure includes SPF having an average weight average molecular weight selected from between about 120 to about 125 kDa. In an embodiment, a composition of the present disclosure includes SPF having an average weight average molecular weight selected from between about 125 to about 130 kDa. In an embodiment, a composition of the present disclosure includes SPF having an average weight average molecular weight selected from between about 130 to about 135 kDa. In an embodiment, a composition of the present disclosure includes SPF having an average weight average molecular weight selected from between about 135 to about 140 kDa. In an embodiment, a composition of the present disclosure includes SPF having an average weight average molecular weight selected from between about 140 to about 145 kDa. In an embodiment, a composition of the present disclosure includes SPF having an average weight average molecular weight selected from between about 145 to about 150 kDa. In an embodiment, a composition of the present disclosure includes SPF having an average weight average molecular weight selected from between about 150 to about 155 kDa. In an embodiment, a composition of the present disclosure includes SPF having an average weight average molecular weight selected from between about 155 to about 160 kDa. In an embodiment, a composition of the present disclosure includes SPF having an average weight average molecular weight selected from between about 160 to about 165 kDa. In an embodiment, a composition of the present disclosure includes SPF having an average weight average molecular weight selected from between about 165 to about 170 kDa. In an embodiment, a composition of the present disclosure includes SPF having an average weight average molecular weight selected from between about 170 to about 175 kDa. In an embodiment, a composition of the present disclosure includes SPF having an average weight average molecular weight selected from between about 175 to about 180 kDa. In an embodiment, a composition of the present disclosure includes SPF having an average weight average molecular weight selected from between about 180 to about 185 kDa. In an embodiment, a composition of the present disclosure includes SPF having an average weight average molecular weight selected from between about 185 to about 190 kDa. In an embodiment, a composition of the present disclosure includes SPF having an average weight average molecular weight selected from between about 190 to about 195 kDa. In an embodiment, a composition of the present disclosure includes SPF having an average weight average molecular weight selected from between about 195 to about 200 kDa. In an embodiment, a composition of the present disclosure includes SPF having an average weight average molecular weight selected from between about 200 to about 205 kDa. In an embodiment, a composition of the present disclosure includes SPF having an average weight average molecular weight selected from between about 205 to about 210 kDa. In an embodiment, a composition of the present disclosure includes SPF having an average weight average molecular weight selected from between about 210 to about 215 kDa. In an embodiment, a composition of the present disclosure includes SPF having an average weight average molecular weight selected from between about 215 to about 220 kDa. In an embodiment, a composition of the present disclosure includes SPF having an average weight average molecular weight selected from between about 220 to about 225 kDa. In an embodiment, a composition of the present disclosure includes SPF having an average weight average molecular weight selected from between about 225 to about 230 kDa. In an embodiment, a composition of the present disclosure includes SPF having an average weight average molecular weight selected from between about 230 to about 235 kDa. In an embodiment, a composition of the present disclosure includes SPF having an average weight average molecular weight selected from between about 235 to about 240 kDa. In an embodiment, a composition of the present disclosure includes SPF having an average weight average molecular weight selected from between about 240 to about 245 kDa. In an embodiment, a composition of the present disclosure includes SPF having an average weight average molecular weight selected from between about 245 to about 250 kDa. In an embodiment, a composition of the present disclosure includes SPF having an average weight average molecular weight selected from between about 250 to about 255 kDa. In an embodiment, a composition of the present disclosure includes SPF having an average weight average molecular weight selected from between about 255 to about 260 kDa. In an embodiment, a composition of the present disclosure includes SPF having an average weight average molecular weight selected from between about 260 to about 265 kDa. In an embodiment, a composition of the present disclosure includes SPF having an average weight average molecular weight selected from between about 265 to about 270 kDa. In an embodiment, a composition of the present disclosure includes SPF having an average weight average molecular weight selected from between about 270 to about 275 kDa. In an embodiment, a composition of the present disclosure includes SPF having an average weight average molecular weight selected from between about 275 to about 280 kDa. In an embodiment, a composition of the present disclosure includes SPF having an average weight average molecular weight selected from between about 280 to about 285 kDa. In an embodiment, a composition of the present disclosure includes SPF having an average weight average molecular weight selected from between about 285 to about 290 kDa. In an embodiment, a composition of the present disclosure includes SPF having an average weight average molecular weight selected from between about 290 to about 295 kDa. In an embodiment, a composition of the present disclosure includes SPF having an average weight average molecular weight selected from between about 295 to about 300 kDa. In an embodiment, a composition of the present disclosure includes SPF having an average weight average molecular weight selected from between about 300 to about 305 kDa. In an embodiment, a composition of the present disclosure includes SPF having an average weight average molecular weight selected from between about 305 to about 310 kDa. In an embodiment, a composition of the present disclosure includes SPF having an average weight average molecular weight selected from between about 310 to about 315 kDa. In an embodiment, a composition of the present disclosure includes SPF having an average weight average molecular weight selected from between about 315 to about 320 kDa. In an embodiment, a composition of the present disclosure includes SPF having an average weight average molecular weight selected from between about 320 to about 325 kDa. In an embodiment, a composition of the present disclosure includes SPF having an average weight average molecular weight selected from between about 325 to about 330 kDa. In an embodiment, a composition of the present disclosure includes SPF having an average weight average molecular weight selected from between about 330 to about 335 kDa. In an embodiment, a composition of the present disclosure includes SPF having an average weight average molecular weight selected from between about 335 to about 340 kDa. In an embodiment, a composition of the present disclosure includes SPF having an average weight average molecular weight selected from between about 340 to about 345 kDa. In an embodiment, a composition of the present disclosure includes SPF having an average weight average molecular weight selected from between about 345 to about 350 kDa.

In some embodiments, compositions of the present disclosure include SPF compositions selected from compositions #1001 to #2450, having weight average molecular weights selected from about 1 kDa to about 145 kDa, and a polydispersity selected from between 1 and about 5 (including, without limitation, a polydispersity of 1), between 1 and about 1.5 (including, without limitation, a polydispersity of 1), between about 1.5 and about 2, between about 1.5 and about 3, between about 2 and about 2.5, between about 2.5 and about 3, between about 3 and about 3.5, between about 3.5 and about 4, between about 4 and about 4.5, and between about 4.5 and about 5:

| MW | PDI (about) | | | | | | | | | |
|---|---|---|---|---|---|---|---|---|---|---|
| (about) | 1-5 | 1-1.5 | 1.5-2 | 1.5-3 | 2-2.5 | 2.5-3 | 3-3.5 | 3.5-4 | 4-4.5 | 4.5-5 |
| 1 kDa | 1001 | 1002 | 1003 | 1004 | 1005 | 1006 | 1007 | 1008 | 1009 | 1010 |
| 2 kDa | 1011 | 1012 | 1013 | 1014 | 1015 | 1016 | 1017 | 1018 | 1019 | 1020 |
| 3 kDa | 1021 | 1022 | 1023 | 1024 | 1025 | 1026 | 1027 | 1028 | 1029 | 1030 |
| 4 kDa | 1031 | 1032 | 1033 | 1034 | 1035 | 1036 | 1037 | 1038 | 1039 | 1040 |
| 5 kDa | 1041 | 1042 | 1043 | 1044 | 1045 | 1046 | 1047 | 1048 | 1049 | 1050 |
| 6 kDa | 1051 | 1052 | 1053 | 1054 | 1055 | 1056 | 1057 | 1058 | 1059 | 1060 |
| 7 kDa | 1061 | 1062 | 1063 | 1064 | 1065 | 1066 | 1067 | 1068 | 1069 | 1070 |
| 8 kDa | 1071 | 1072 | 1073 | 1074 | 1075 | 1076 | 1077 | 1078 | 1079 | 1080 |
| 9 kDa | 1081 | 1082 | 1083 | 1084 | 1085 | 1086 | 1087 | 1088 | 1089 | 1090 |
| 10 kDa | 1091 | 1092 | 1093 | 1094 | 1095 | 1096 | 1097 | 1098 | 1099 | 1100 |
| 11 kDa | 1101 | 1102 | 1103 | 1104 | 1105 | 1106 | 1107 | 1108 | 1109 | 1110 |
| 12 kDa | 1111 | 1112 | 1113 | 1114 | 1115 | 1116 | 1117 | 1118 | 1119 | 1120 |
| 13 kDa | 1121 | 1122 | 1123 | 1124 | 1125 | 1126 | 1127 | 1128 | 1129 | 1130 |
| 14 kDa | 1131 | 1132 | 1133 | 1134 | 1135 | 1136 | 1137 | 1138 | 1139 | 1140 |
| 15 kDa | 1141 | 1142 | 1143 | 1144 | 1145 | 1146 | 1147 | 1148 | 1149 | 1150 |
| 16 kDa | 1151 | 1152 | 1153 | 1154 | 1155 | 1156 | 1157 | 1158 | 1159 | 1160 |
| 17 kDa | 1161 | 1162 | 1163 | 1164 | 1165 | 1166 | 1167 | 1168 | 1169 | 1170 |
| 18 kDa | 1171 | 1172 | 1173 | 1174 | 1175 | 1176 | 1177 | 1178 | 1179 | 1180 |
| 19 kDa | 1181 | 1182 | 1183 | 1184 | 1185 | 1186 | 1187 | 1188 | 1189 | 1190 |
| 20 kDa | 1191 | 1192 | 1193 | 1194 | 1195 | 1196 | 1197 | 1198 | 1199 | 1200 |
| 21 kDa | 1201 | 1202 | 1203 | 1204 | 1205 | 1206 | 1207 | 1208 | 1209 | 1210 |
| 22 kDa | 1211 | 1212 | 1213 | 1214 | 1215 | 1216 | 1217 | 1218 | 1219 | 1220 |
| 23 kDa | 1221 | 1222 | 1223 | 1224 | 1225 | 1226 | 1227 | 1228 | 1229 | 1230 |
| 24 kDa | 1231 | 1232 | 1233 | 1234 | 1235 | 1236 | 1237 | 1238 | 1239 | 1240 |
| 25 kDa | 1241 | 1242 | 1243 | 1244 | 1245 | 1246 | 1247 | 1248 | 1249 | 1250 |
| 26 kDa | 1251 | 1252 | 1253 | 1254 | 1255 | 1256 | 1257 | 1258 | 1259 | 1260 |
| 27 kDa | 1261 | 1262 | 1263 | 1264 | 1265 | 1266 | 1267 | 1268 | 1269 | 1270 |
| 28 kDa | 1271 | 1272 | 1273 | 1274 | 1275 | 1276 | 1277 | 1278 | 1279 | 1280 |
| 29 kDa | 1281 | 1282 | 1283 | 1284 | 1285 | 1286 | 1287 | 1288 | 1289 | 1290 |
| 30 kDa | 1291 | 1292 | 1293 | 1294 | 1295 | 1296 | 1297 | 1298 | 1299 | 1300 |
| 31 kDa | 1301 | 1302 | 1303 | 1304 | 1305 | 1306 | 1307 | 1308 | 1309 | 1310 |
| 32 kDa | 1311 | 1312 | 1313 | 1314 | 1315 | 1316 | 1317 | 1318 | 1319 | 1320 |
| 33 kDa | 1321 | 1322 | 1323 | 1324 | 1325 | 1326 | 1327 | 1328 | 1329 | 1330 |
| 34 kDa | 1331 | 1332 | 1333 | 1334 | 1335 | 1336 | 1337 | 1338 | 1339 | 1340 |
| 35 kDa | 1341 | 1342 | 1343 | 1344 | 1345 | 1346 | 1347 | 1348 | 1349 | 1350 |
| 36 kDa | 1351 | 1352 | 1353 | 1354 | 1355 | 1356 | 1357 | 1358 | 1359 | 1360 |
| 37 kDa | 1361 | 1362 | 1363 | 1364 | 1365 | 1366 | 1367 | 1368 | 1369 | 1370 |
| 38 kDa | 1371 | 1372 | 1373 | 1374 | 1375 | 1376 | 1377 | 1378 | 1379 | 1380 |
| 39kDa | 1381 | 1382 | 1383 | 1384 | 1385 | 1386 | 1387 | 1388 | 1389 | 1390 |
| 40 kDa | 1391 | 1392 | 1393 | 1394 | 1395 | 1396 | 1397 | 1398 | 1399 | 1400 |
| 41 kDa | 1401 | 1402 | 1403 | 1404 | 1405 | 1406 | 1407 | 1408 | 1409 | 1410 |
| 42 kDa | 1411 | 1412 | 1413 | 1414 | 1415 | 1416 | 1417 | 1418 | 1419 | 1420 |
| 43 kDa | 1421 | 1422 | 1423 | 1424 | 1425 | 1426 | 1427 | 1428 | 1429 | 1430 |
| 44 kDa | 1431 | 1432 | 1433 | 1434 | 1435 | 1436 | 1437 | 1438 | 1439 | 1440 |
| 45 kDa | 1441 | 1442 | 1443 | 1444 | 1445 | 1446 | 1447 | 1448 | 1449 | 1450 |
| 46 kDa | 1451 | 1452 | 1453 | 1454 | 1455 | 1456 | 1457 | 1458 | 1459 | 1460 |
| 47 kDa | 1461 | 1462 | 1463 | 1464 | 1465 | 1466 | 1467 | 1468 | 1469 | 1470 |
| 48 kDa | 1471 | 1472 | 1473 | 1474 | 1475 | 1476 | 1477 | 1478 | 1479 | 1480 |
| 49 kDa | 1481 | 1482 | 1483 | 1484 | 1485 | 1486 | 1487 | 1488 | 1489 | 1490 |
| 50 kDa | 1491 | 1492 | 1493 | 1494 | 1495 | 1496 | 1497 | 1498 | 1499 | 1500 |
| 51 kDa | 1501 | 1502 | 1503 | 1504 | 1505 | 1506 | 1507 | 1508 | 1509 | 1510 |
| 52 kDa | 1511 | 1512 | 1513 | 1514 | 1515 | 1516 | 1517 | 1518 | 1519 | 1520 |
| 53 kDa | 1521 | 1522 | 1523 | 1524 | 1525 | 1526 | 1527 | 1528 | 1529 | 1530 |
| 54 kDa | 1531 | 1532 | 1533 | 1534 | 1535 | 1536 | 1537 | 1538 | 1539 | 1540 |
| 55 kDa | 1541 | 1542 | 1543 | 1544 | 1545 | 1546 | 1547 | 1548 | 1549 | 1550 |
| 56 kDa | 1551 | 1552 | 1553 | 1554 | 1555 | 1556 | 1557 | 1558 | 1559 | 1560 |
| 57 kDa | 1561 | 1562 | 1563 | 1564 | 1565 | 1566 | 1567 | 1568 | 1569 | 1570 |
| 58 kDa | 1571 | 1572 | 1573 | 1574 | 1575 | 1576 | 1577 | 1578 | 1579 | 1580 |
| 59 kDa | 1581 | 1582 | 1583 | 1584 | 1585 | 1586 | 1587 | 1588 | 1589 | 1590 |
| 60 kDa | 1591 | 1592 | 1593 | 1594 | 1595 | 1596 | 1597 | 1598 | 1599 | 1600 |
| 61 kDa | 1601 | 1602 | 1603 | 1604 | 1605 | 1606 | 1607 | 1608 | 1609 | 1610 |
| 62 kDa | 1611 | 1612 | 1613 | 1614 | 1615 | 1616 | 1617 | 1618 | 1619 | 1620 |
| 63 kDa | 1621 | 1622 | 1623 | 1624 | 1625 | 1626 | 1627 | 1628 | 1629 | 1630 |
| 64 kDa | 1631 | 1632 | 1633 | 1634 | 1635 | 1636 | 1637 | 1638 | 1639 | 1640 |
| 65 kDa | 1641 | 1642 | 1643 | 1644 | 1645 | 1646 | 1647 | 1648 | 1649 | 1650 |
| 66 kDa | 1651 | 1652 | 1653 | 1654 | 1655 | 1656 | 1657 | 1658 | 1659 | 1660 |
| 67 kDa | 1661 | 1662 | 1663 | 1664 | 1665 | 1666 | 1667 | 1668 | 1669 | 1670 |
| 68 kDa | 1671 | 1672 | 1673 | 1674 | 1675 | 1676 | 1677 | 1678 | 1679 | 1680 |
| 69 kDa | 1681 | 1682 | 1683 | 1684 | 1685 | 1686 | 1687 | 1688 | 1689 | 1690 |
| 70 kDa | 1691 | 1692 | 1693 | 1694 | 1695 | 1696 | 1697 | 1698 | 1699 | 1700 |
| 71 kDa | 1701 | 1702 | 1703 | 1704 | 1705 | 1706 | 1707 | 1708 | 1709 | 1710 |
| 72 kDa | 1711 | 1712 | 1713 | 1714 | 1715 | 1716 | 1717 | 1718 | 1719 | 1720 |
| 73 kDa | 1721 | 1722 | 1723 | 1724 | 1725 | 1726 | 1727 | 1728 | 1729 | 1730 |
| 74 kDa | 1731 | 1732 | 1733 | 1734 | 1735 | 1736 | 1737 | 1738 | 1739 | 1740 |
| 75 kDa | 1741 | 1742 | 1743 | 1744 | 1745 | 1746 | 1747 | 1748 | 1749 | 1750 |
| 76 kDa | 1751 | 1752 | 1753 | 1754 | 1755 | 1756 | 1757 | 1758 | 1759 | 1760 |
| 77 kDa | 1761 | 1762 | 1763 | 1764 | 1765 | 1766 | 1767 | 1768 | 1769 | 1770 |
| 78 kDa | 1771 | 1772 | 1773 | 1774 | 1775 | 1776 | 1777 | 1778 | 1779 | 1780 |
| 79 kDa | 1781 | 1782 | 1783 | 1784 | 1785 | 1786 | 1787 | 1788 | 1789 | 1790 |
| 80 kDa | 1791 | 1792 | 1793 | 1794 | 1795 | 1796 | 1797 | 1798 | 1799 | 1800 |
| 81 kDa | 1801 | 1802 | 1803 | 1804 | 1805 | 1806 | 1807 | 1808 | 1809 | 1810 |
| 82 kDa | 1811 | 1812 | 1813 | 1814 | 1815 | 1816 | 1817 | 1818 | 1819 | 1820 |
| 83 kDa | 1821 | 1822 | 1823 | 1824 | 1825 | 1826 | 1827 | 1828 | 1829 | 1830 |
| 84 kDa | 1831 | 1832 | 1833 | 1834 | 1835 | 1836 | 1837 | 1838 | 1839 | 1840 |
| 85 kDa | 1841 | 1842 | 1843 | 1844 | 1845 | 1846 | 1847 | 1848 | 1849 | 1850 |
| 86 kDa | 1851 | 1852 | 1853 | 1854 | 1855 | 1856 | 1857 | 1858 | 1859 | 1860 |
| 87 kDa | 1861 | 1862 | 1863 | 1864 | 1865 | 1866 | 1867 | 1868 | 1869 | 1870 |
| 88 kDa | 1871 | 1872 | 1873 | 1874 | 1875 | 1876 | 1877 | 1878 | 1879 | 1880 |
| 89 kDa | 1881 | 1882 | 1883 | 1884 | 1885 | 1886 | 1887 | 1888 | 1889 | 1890 |
| 90 kDa | 1891 | 1892 | 1893 | 1894 | 1895 | 1896 | 1897 | 1898 | 1899 | 1900 |
| 91 kDa | 1901 | 1902 | 1903 | 1904 | 1905 | 1906 | 1907 | 1908 | 1909 | 1910 |
| 92 kDa | 1911 | 1912 | 1913 | 1914 | 1915 | 1916 | 1917 | 1918 | 1919 | 1920 |
| 93 kDa | 1921 | 1922 | 1923 | 1924 | 1925 | 1926 | 1927 | 1928 | 1929 | 1930 |
| 94 kDa | 1931 | 1932 | 1933 | 1934 | 1935 | 1936 | 1937 | 1938 | 1939 | 1940 |
| 95 kDa | 1941 | 1942 | 1943 | 1944 | 1945 | 1946 | 1947 | 1948 | 1949 | 1950 |
| 96 kDa | 1951 | 1952 | 1953 | 1954 | 1955 | 1956 | 1957 | 1958 | 1959 | 1960 |
| 97 kDa | 1961 | 1962 | 1963 | 1964 | 1965 | 1966 | 1967 | 1968 | 1969 | 1970 |
| 98 kDa | 1971 | 1972 | 1973 | 1974 | 1975 | 1976 | 1977 | 1978 | 1979 | 1980 |
| 99 kDa | 1981 | 1982 | 1983 | 1984 | 1985 | 1986 | 1987 | 1988 | 1989 | 1990 |
| 100 kDa | 1991 | 1992 | 1993 | 1994 | 1995 | 1996 | 1997 | 1998 | 1999 | 2000 |
| 101 kDa | 2001 | 2002 | 2003 | 2004 | 2005 | 2006 | 2007 | 2008 | 2009 | 2010 |
| 102 kDa | 2011 | 2012 | 2013 | 2014 | 2015 | 2016 | 2017 | 2018 | 2019 | 2020 |
| 103 kDa | 2021 | 2022 | 2023 | 2024 | 2025 | 2026 | 2027 | 2028 | 2029 | 2030 |
| 104 kDa | 2031 | 2032 | 2033 | 2034 | 2035 | 2036 | 2037 | 2038 | 2039 | 2040 |
| 105 kDa | 2041 | 2042 | 2043 | 2044 | 2045 | 2046 | 2047 | 2048 | 2049 | 2050 |
| 106 kDa | 2051 | 2052 | 2053 | 2054 | 2055 | 2056 | 2057 | 2058 | 2059 | 2060 |
| 107 kDa | 2061 | 2062 | 2063 | 2064 | 2065 | 2066 | 2067 | 2068 | 2069 | 2070 |
| 108 kDa | 2071 | 2072 | 2073 | 2074 | 2075 | 2076 | 2077 | 2078 | 2079 | 2080 |
| 109 kDa | 2081 | 2082 | 2083 | 2084 | 2085 | 2086 | 2087 | 2088 | 2089 | 2090 |
| 110 kDa | 2091 | 2092 | 2093 | 2094 | 2095 | 2096 | 2097 | 2098 | 2099 | 2100 |
| 111 kDa | 2101 | 2102 | 2103 | 2104 | 2105 | 2106 | 2107 | 2108 | 2109 | 2110 |
| 112 kDa | 2111 | 2112 | 2113 | 2114 | 2115 | 2116 | 2117 | 2118 | 2119 | 2120 |
| 113 kDa | 2121 | 2122 | 2123 | 2124 | 2125 | 2126 | 2127 | 2128 | 2129 | 2130 |
| 114 kDa | 2131 | 2132 | 2133 | 2134 | 2135 | 2136 | 2137 | 2138 | 2139 | 2140 |
| 115 kDa | 2141 | 2142 | 2143 | 2144 | 2145 | 2146 | 2147 | 2148 | 2149 | 2150 |
| 116 kDa | 2151 | 2152 | 2153 | 2154 | 2155 | 2156 | 2157 | 2158 | 2159 | 2160 |
| 117 kDa | 2161 | 2162 | 2163 | 2164 | 2165 | 2166 | 2167 | 2168 | 2169 | 2170 |
| 118 kDa | 2171 | 2172 | 2173 | 2174 | 2175 | 2176 | 2177 | 2178 | 2179 | 2180 |
| 119 kDa | 2181 | 2182 | 2183 | 2184 | 2185 | 2186 | 2187 | 2188 | 2189 | 2190 |
| 120 kDa | 2191 | 2192 | 2193 | 2194 | 2195 | 2196 | 2197 | 2198 | 2199 | 2200 |
| 121 kDa | 2201 | 2202 | 2203 | 2204 | 2205 | 2206 | 2207 | 2208 | 2209 | 2210 |
| 122 kDa | 2211 | 2212 | 2213 | 2214 | 2215 | 2216 | 2217 | 2218 | 2219 | 2220 |
| 123 kDa | 2221 | 2222 | 2223 | 2224 | 2225 | 2226 | 2227 | 2228 | 2229 | 2230 |
| 124 kDa | 2231 | 2232 | 2233 | 2234 | 2235 | 2236 | 2237 | 2238 | 2239 | 2240 |
| 125 kDa | 2241 | 2242 | 2243 | 2244 | 2245 | 2246 | 2247 | 2248 | 2249 | 2250 |
| 126 kDa | 2251 | 2252 | 2253 | 2254 | 2255 | 2256 | 2257 | 2258 | 2259 | 2260 |
| 127 kDa | 2261 | 2262 | 2263 | 2264 | 2265 | 2266 | 2267 | 2268 | 2269 | 2270 |
| 128 kDa | 2271 | 2272 | 2273 | 2274 | 2275 | 2276 | 2277 | 2278 | 2279 | 2280 |
| 129 kDa | 2281 | 2282 | 2283 | 2284 | 2285 | 2286 | 2287 | 2288 | 2289 | 2290 |
| 130 kDa | 2291 | 2292 | 2293 | 2294 | 2295 | 2296 | 2297 | 2298 | 2299 | 2300 |
| 131 kDa | 2301 | 2302 | 2303 | 2304 | 2305 | 2306 | 2307 | 2308 | 2309 | 2310 |
| 132 kDa | 2311 | 2312 | 2313 | 2314 | 2315 | 2316 | 2317 | 2318 | 2319 | 2320 |
| 133 kDa | 2321 | 2322 | 2323 | 2324 | 2325 | 2326 | 2327 | 2328 | 2329 | 2330 |
| 134 kDa | 2331 | 2332 | 2333 | 2334 | 2335 | 2336 | 2337 | 2338 | 2339 | 2340 |
| 135 kDa | 2341 | 2342 | 2343 | 2344 | 2345 | 2346 | 2347 | 2348 | 2349 | 2350 |
| 136 kDa | 2351 | 2352 | 2353 | 2354 | 2355 | 2356 | 2357 | 2358 | 2359 | 2360 |
| 137 kDa | 2361 | 2362 | 2363 | 2364 | 2365 | 2366 | 2367 | 2368 | 2369 | 2370 |
| 138 kDa | 2371 | 2372 | 2373 | 2374 | 2375 | 2376 | 2377 | 2378 | 2379 | 2380 |
| 139 kDa | 2381 | 2382 | 2383 | 2384 | 2385 | 2386 | 2387 | 2388 | 2389 | 2390 |
| 140 kDa | 2391 | 2392 | 2393 | 2394 | 2395 | 2396 | 2397 | 2398 | 2399 | 2400 |
| 141 kDa | 2401 | 2402 | 2403 | 2404 | 2405 | 2406 | 2407 | 2408 | 2409 | 2410 |
| 142 kDa | 2411 | 2412 | 2413 | 2414 | 2415 | 2416 | 2417 | 2418 | 2419 | 2420 |
| 143 kDa | 2421 | 2422 | 2423 | 2424 | 2425 | 2426 | 2427 | 2428 | 2429 | 2430 |
| 144 kDa | 2431 | 2432 | 2433 | 2434 | 2435 | 2436 | 2437 | 2438 | 2439 | 2440 |
| 145 kDa | 2441 | 2442 | 2443 | 2444 | 2445 | 2446 | 2447 | 2448 | 2449 | 2450 |

As used herein, “low molecular weight,” “low MW,” or “low-MW” SPF may include SPF having a weight average molecular weight, or average weight average molecular weight selected from between about 5 kDa to about 38 kDa, about 14 kDa to about 30 kDa, or about 6 kDa to about 17 kDa. In some embodiments, a target low molecular weight for certain SPF may be weight average molecular weight of about 5 kDa, about 6 kDa, about 7 kDa, about 8 kDa, about 9 kDa, about 10 kDa, about 11 kDa, about 12 kDa, about 13 kDa, about 14 kDa, about 15 kDa, about 16 kDa, about 17 kDa, about 18 kDa, about 19 kDa, about 20 kDa, about 21 kDa, about 22 kDa, about 23 kDa, about 24 kDa, about 25 kDa, about 26 kDa, about 27 kDa, about 28 kDa, about 29 kDa, about 30 kDa, about 31 kDa, about 32 kDa, about 33 kDa, about 34 kDa, about 35 kDa, about 36 kDa, about 37 kDa, or about 38 kDa.

As used herein, “medium molecular weight,” “medium MW,” or “mid-MW” SPF may include SPF having a weight average molecular weight, or average weight average molecular weight selected from between about 31 kDa to about 55 kDa, or about 39 kDa to about 54 kDa. In some embodiments, a target medium molecular weight for certain SPF may be weight average molecular weight of about 31 kDa, about 32 kDa, about 33 kDa, about 34 kDa, about 35 kDa, about 36 kDa, about 37 kDa, about 38 kDa, about 39 kDa, about 40 kDa, about 41 kDa, about 42 kDa, about 43 kDa, about 44 kDa, about 45 kDa, about 46 kDa, about 47 kDa, about 48 kDa, about 49 kDa, about 50 kDa, about 51 kDa, about 52 kDa, about 53 kDa, about 54 kDa, or about 55 kDa.

As used herein, “high molecular weight,” “high MW,” or “high-MW” SPF may include SPF having a weight average molecular weight, or average weight average molecular weight selected from between about 55 kDa to about 150 kDa. In some embodiments, a target high molecular weight for certain SPF may be about 55 kDa, about 56 kDa, about 57 kDa, about 58 kDa, about 59 kDa, about 60 kDa, about 61 kDa, about 62 kDa, about 63 kDa, about 64 kDa, about 65 kDa, about 66 kDa, about 67 kDa, about 68 kDa, about 69 kDa, about 70 kDa, about 71 kDa, about 72 kDa, about 73 kDa, about 74 kDa, about 75 kDa, about 76 kDa, about 77 kDa, about 78 kDa, about 79 kDa, or about 80 kDa.

In some embodiments, the molecular weights described herein (e.g., low molecular weight silk, medium molecular weight silk, high molecular weight silk) may be converted to the approximate number of amino acids contained within the respective SPF, as would be understood by a person having ordinary skill in the art. For example, the average weight of an amino acid may be about 110 daltons (i.e., 110 g/mol). Therefore, in some embodiments, dividing the molecular weight of a linear protein by 110 daltons may be used to approximate the number of amino acid residues contained therein.

In an embodiment, SPF in a composition of the present disclosure have a polydispersity selected from between 1 to about 5.0, including, without limitation, a polydispersity of 1. In an embodiment, SPF in a composition of the present disclosure have a polydispersity selected from between about 1.5 to about 3.0. In an embodiment, SPF in a composition of the present disclosure have a polydispersity selected from between 1 to about 1.5, including, without limitation, a polydispersity of 1. In an embodiment, SPF in a composition of the present disclosure have a polydispersity selected from between about 1.5 to about 2.0. In an embodiment, SPF in a composition of the present disclosure have a polydispersity selected from between about 2.0 to about 2.5. In an embodiment, SPF in a composition of the present disclosure have a polydispersity selected from between about 2.5 to about 3.0. In an embodiment, SPF in a composition of the present disclosure have a polydispersity selected from between about 3.0 to about 3.5. In an embodiment, SPF in a composition of the present disclosure have a polydispersity selected from between about 3.5 to about 4.0. In an embodiment, SPF in a composition of the present disclosure have a polydispersity selected from between about 4.0 to about 4.5. In an embodiment, SPF in a composition of the present disclosure have a polydispersity selected from between about 4.5 to about 5.0.

In an embodiment, SPF in a composition of the present disclosure have a polydispersity of 1. In an embodiment, SPF in a composition of the present disclosure have a polydispersity of about 1.1. In an embodiment, SPF in a composition of the present disclosure have a polydispersity of about 1.2. In an embodiment, SPF in a composition of the present disclosure have a polydispersity of about 1.3. In an embodiment, SPF in a composition of the present disclosure have a polydispersity of about 1.4. In an embodiment, SPF in a composition of the present disclosure have a polydispersity of about 1.5. In an embodiment, SPF in a composition of the present disclosure have a polydispersity of about 1.6. In an embodiment, SPF in a composition of the present disclosure have a polydispersity of about 1.7. In an embodiment, SPF in a composition of the present disclosure have a polydispersity of about 1.8. In an embodiment, SPF in a composition of the present disclosure have a polydispersity of about 1.9. In an embodiment, SPF in a composition of the present disclosure have a polydispersity of about 2.0. In an embodiment, SPF in a composition of the present disclosure have a polydispersity of about 2.1. In an embodiment, SPF in a composition of the present disclosure have a polydispersity of about 2.2. In an embodiment, SPF in a composition of the present disclosure have a polydispersity of about 2.3. In an embodiment, SPF in a composition of the present disclosure have a polydispersity of about 2.4. In an embodiment, SPF in a composition of the present disclosure have a polydispersity of about 2.5. In an embodiment, SPF in a composition of the present disclosure have a polydispersity of about 2.6. In an embodiment, SPF in a composition of the present disclosure have a polydispersity of about 2.7. In an embodiment, SPF in a composition of the present disclosure have a polydispersity of about 2.8. In an embodiment, SPF in a composition of the present disclosure have a polydispersity of about 2.9. In an embodiment, SPF in a composition of the present disclosure have a polydispersity of about 3.0. In an embodiment, SPF in a composition of the present disclosure have a polydispersity of about 3.1. In an embodiment, SPF in a composition of the present disclosure have a polydispersity of about 3.2. In an embodiment, SPF in a composition of the present disclosure have a polydispersity of about 3.3. In an embodiment, SPF in a composition of the present disclosure have a polydispersity of about 3.4. In an embodiment, SPF in a composition of the present disclosure have a polydispersity of about 3.5. In an embodiment, SPF in a composition of the present disclosure have a polydispersity of about 3.6. In an embodiment, SPF in a composition of the present disclosure have a polydispersity of about 3.7. In an embodiment, SPF in a composition of the present disclosure have a polydispersity of about 3.8. In an embodiment, SPF in a composition of the present disclosure have a polydispersity of about 3.9. In an embodiment, SPF in a composition of the present disclosure have a polydispersity of about 4.0. In an embodiment, SPF in a composition of the present disclosure have a polydispersity of about 4.1. In an embodiment, SPF in a composition of the present disclosure have a polydispersity of about 4.2. In an embodiment, SPF in a composition of the present disclosure have a polydispersity of about 4.3. In an embodiment, SPF in a composition of the present disclosure have a polydispersity of about 4.4. In an embodiment, SPF in a composition of the present disclosure have a polydispersity of about 4.5. In an embodiment, SPF in a composition of the present disclosure have a polydispersity of about 4.6. In an embodiment, SPF in a composition of the present disclosure have a polydispersity of about 4.7. In an embodiment, SPF in a composition of the present disclosure have a polydispersity of about 4.8. In an embodiment, SPF in a composition of the present disclosure have a polydispersity of about 4.9. In an embodiment, SPF in a composition of the present disclosure have a polydispersity of about 5.0.

In some embodiments, in compositions described herein having combinations of low, medium, and/or high molecular weight SPF, such low, medium, and/or high molecular weight SPF may have the same or different polydispersities.

Silk Fibroin Fragments

Methods of making silk fibroin or silk fibroin protein fragments and their applications in various fields are known and are described for example in U.S. Pat. Nos. 9,187,538, 9,511,012, 9,517,191, 9,522,107, 9,522,108, 9,545,369, and 10,166,177, 10,287,728 and 10,301,768, all of which are incorporated herein in their entireties. Raw silk from silkworm Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. The crude silkworm fiber consists of a double thread of fibroin. The adhesive substance holding these double fibers together is sericin. The silk fibroin is composed of a heavy chain having a weight average molecular weight of about 350,000 Da (H chain), and a light chain having a weight average molecular weight about 25,000 Da (L chain). Silk fibroin is an amphiphilic polymer with large hydrophobic domains occupying the major component of the polymer, which has a high molecular weight. The hydrophobic regions are interrupted by small hydrophilic spacers, and the N- and C-termini of the chains are also highly hydrophilic. The hydrophobic domains of the H-chain contain a repetitive hexapeptide sequence of Gly-Ala-Gly-Ala-Gly-Ser and repeats of Gly-Ala/Ser/Tyr dipeptides, which can form stable anti-parallel-sheet crystallites. The amino acid sequence of the L-chain is non-repetitive, so the L-chain is more hydrophilic and relatively elastic. The hydrophilic (Tyr, Ser) and hydrophobic (Gly, Ala) chain segments in silk fibroin molecules are arranged alternatively such that allows self-assembling of silk fibroin molecules.

Provided herein are methods for producing pure and highly scalable silk fibroin-protein fragment mixture solutions that may be used across multiple industries for a variety of applications. Without wishing to be bound by any particular theory, it is believed that these methods are equally applicable to fragmentation of any SPF described herein, including without limitation recombinant silk proteins, and fragmentation of silk-like or fibroin-like proteins.

As used herein, the term “fibroin” includes silk worm fibroin and insect or spider silk protein. In an embodiment, fibroin is obtained from Bombyx mori. Raw silk from Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. Conversion of these insoluble silk fibroin fibrils into water-soluble silk fibroin protein fragments requires the addition of a concentrated neutral salt (e.g., 8-10 M lithium bromide), which interferes with inter- and intramolecular ionic and hydrogen bonding that would otherwise render the fibroin protein insoluble in water. Methods of making silk fibroin protein fragments, and/or compositions thereof, are known and are described for example in U.S. Pat. Nos. 9,187,538, 9,511,012, 9,517,191, 9,522,107, 9,522,108, 9,545,369, and 10,166,177.

The raw silk cocoons from the silkworm Bombyx mori was cut into pieces. The pieces silk cocoons were processed in an aqueous solution of Na₂CO₃ at about 100° C. for about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L×the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at about 100° C. for about 60 minutes to achieve complete dissolution of the native silk protein. The resulting silk fibroin solution was filtered and dialyzed using Tangential Flow Filtration (TFF) and a 10 kDa membrane against deionized water for 72 hours. The resulting silk fibroin aqueous solution has a concentration of about 8.5 wt. %. Then, 8.5% silk solution was diluted with water to result in a 1.0% w/v silk solution. TFF can then be used to further concentrate the pure silk solution to a concentration of 20.0% w/w silk to water.

Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

In some embodiments, the silk solutions are prepared under various preparation condition parameters such as: 90° C. 30 min, 90° C. 60 min, 100° C. 30 min, and 100° C. 60 min. Briefly, 9.3 M LiBr was prepared and allowed to sit at room temperature for at least 30 minutes. 5 mL of LiBr solution was added to 1.25 g of silk and placed in the 60° C. oven. Samples from each set were removed at 4, 6, 8, 12, 24, 168 and 192 hours.

In some embodiments, the silk solutions are prepared under various preparation condition parameters such as: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the 60° C. oven. Samples from each set were removed at 1, 4 and 6 hours.

In some embodiments, the silk solutions are prepared under various preparation condition parameters such as: Four different silk extraction combinations were used: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the oven at the same temperature of the LiBr. Samples from each set were removed at 1, 4 and 6 hours. 1 mL of each sample was added to 7.5 mL of 9.3 M LiBr and refrigerated for viscosity testing.

In some embodiments, SPF are obtained by dissolving raw unscoured, partially scoured, or scoured silkworm fibers with a neutral lithium bromide salt. The raw silkworm silks are processed under selected temperature and other conditions in order to remove any sericin and achieve the desired weight average molecular weight (Mw) and polydispersity (PD) of the fragment mixture. Selection of process parameters may be altered to achieve distinct final silk protein fragment characteristics depending upon the intended use. The resulting final fragment solution is silk fibroin protein fragments and water with parts per million (ppm) to non-detectable levels of process contaminants, levels acceptable in the pharmaceutical, medical and consumer eye care markets. The concentration, size and polydispersity of SPF may further be altered depending upon the desired use and performance requirements.

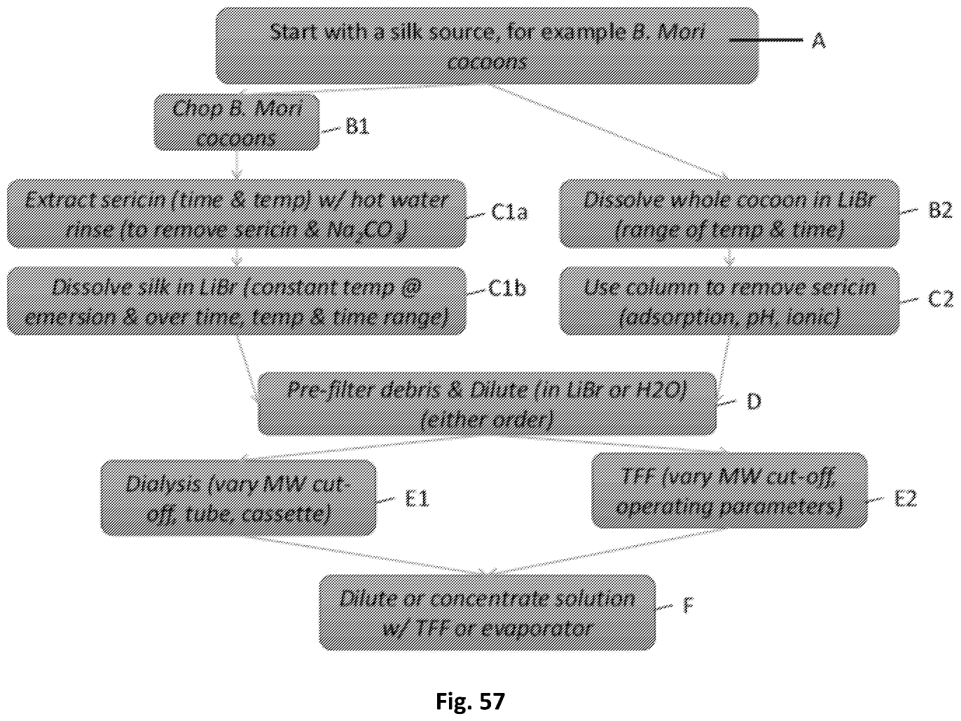

FIG. 57 is a flow chart showing various embodiments for producing pure silk fibroin protein fragments (SPFs) of the present disclosure. It should be understood that not all of the steps illustrated are necessarily required to fabricate all silk solutions of the present disclosure. As illustrated in FIG. 57, step A, cocoons (heat-treated or non-heat-treated), silk fibers, silk powder, spider silk or recombinant spider silk can be used as the silk source. If starting from raw silk cocoons from Bombyx mori, the cocoons can be cut into small pieces, for example pieces of approximately equal size, step B1. The raw silk is then extracted and rinsed to remove any sericin, step C1a. This results in substantially sericin free raw silk. In an embodiment, water is heated to a temperature between 84° C. and 100° C. (ideally boiling) and then Na₂CO₃ (sodium carbonate) is added to the boiling water until the Na₂CO₃ is completely dissolved. The raw silk is added to the boiling water/Na₂CO₃ (100° C.) and submerged for approximately 15-90 minutes, where boiling for a longer time results in smaller silk protein fragments. In an embodiment, the water volume equals about 0.4× raw silk weight and the Na₂CO₃ volume equals about 0.848× raw silk weight. In an embodiment, the water volume equals 0.1× raw silk weight and the Na₂CO₃ volume is maintained at 2.12 g/L.

Subsequently, the water dissolved Na₂CO₃ solution is drained and excess water/Na₂CO₃ is removed from the silk fibroin fibers (e.g., ring out the fibroin extract by hand, spin cycle using a machine, etc.). The resulting silk fibroin extract is rinsed with warm to hot water to remove any remaining adsorbed sericin or contaminate, typically at a temperature range of about 40° C. to about 80° C., changing the volume of water at least once (repeated for as many times as required). The resulting silk fibroin extract is a substantially sericin-depleted silk fibroin. In an embodiment, the resulting silk fibroin extract is rinsed with water at a temperature of about 60° C. In an embodiment, the volume of rinse water for each cycle equals 0.1 L to 0.2 L×raw silk weight. It may be advantageous to agitate, turn or circulate the rinse water to maximize the rinse effect. After rinsing, excess water is removed from the extracted silk fibroin fibers (e.g., ring out fibroin extract by hand or using a machine). Alternatively, methods known to one skilled in the art such as pressure, temperature, or other reagents or combinations thereof may be used for the purpose of sericin extraction. Alternatively, the silk gland (100% sericin free silk protein) can be removed directly from a worm. This would result in liquid silk protein, without any alteration of the protein structure, free of sericin.

The extracted fibroin fibers are then allowed to dry completely. Once dry, the extracted silk fibroin is dissolved using a solvent added to the silk fibroin at a temperature between ambient and boiling, step C1b. In an embodiment, the solvent is a solution of Lithium bromide (LiBr) (boiling for LiBr is 140° C.). Alternatively, the extracted fibroin fibers are not dried but wet and placed in the solvent; solvent concentration can then be varied to achieve similar concentrations as to when adding dried silk to the solvent. The final concentration of LiBr solvent can range from 0.1 M to 9.3 M. Complete dissolution of the extracted fibroin fibers can be achieved by varying the treatment time and temperature along with the concentration of dissolving solvent. Other solvents may be used including, but not limited to, phosphate phosphoric acid, calcium nitrate, calcium chloride solution or other concentrated aqueous solutions of inorganic salts. To ensure complete dissolution, the silk fibers should be fully immersed within the already heated solvent solution and then maintained at a temperature ranging from about 60° C. to about 140° C. for 1-168 hrs. In an embodiment, the silk fibers should be fully immersed within the solvent solution and then placed into a dry oven at a temperature of about 100° C. for about 1 hour.

The temperature at which the silk fibroin extract is added to the LiBr solution (or vice versa) has an effect on the time required to completely dissolve the fibroin and on the resulting molecular weight and polydispersity of the final SPF mixture solution. In an embodiment, silk solvent solution concentration is less than or equal to 20% w/v. In addition, agitation during introduction or dissolution may be used to facilitate dissolution at varying temperatures and concentrations. The temperature of the LiBr solution will provide control over the silk protein fragment mixture molecular weight and polydispersity created. In an embodiment, a higher temperature will more quickly dissolve the silk offering enhanced process scalability and mass production of silk solution. In an embodiment, using a LiBr solution heated to a temperature from 80° C. to 140° C. reduces the time required in an oven in order to achieve full dissolution. Varying time and temperature at or above 60° C. of the dissolution solvent will alter and control the MW and polydispersity of the SPF mixture solutions formed from the original molecular weight of the native silk fibroin protein.

Alternatively, whole cocoons may be placed directly into a solvent, such as LiBr, bypassing extraction, step B2. This requires subsequent filtration of silk worm particles from the silk and solvent solution and sericin removal using methods know in the art for separating hydrophobic and hydrophilic proteins such as a column separation and/or chromatography, ion exchange, chemical precipitation with salt and/or pH, and or enzymatic digestion and filtration or extraction, all methods are common examples and without limitation for standard protein separation methods, step C2. Non-heat treated cocoons with the silkworm removed, may alternatively be placed into a solvent such as LiBr, bypassing extraction. The methods described above may be used for sericin separation, with the advantage that non-heat treated cocoons will contain significantly less worm debris.

Dialysis may be used to remove the dissolution solvent from the resulting dissolved fibroin protein fragment solution by dialyzing the solution against a volume of water, step E1. Pre-filtration prior to dialysis is helpful to remove any debris (i.e., silk worm remnants) from the silk and LiBr solution, step D. In one example, a 3 μm or 5 μm filter is used with a flow-rate of 200-300 mL/min to filter a 0.1% to 1.0% silk-LiBr solution prior to dialysis and potential concentration if desired. A method disclosed herein, as described above, is to use time and/or temperature to decrease the concentration from 9.3 M LiBr to a range from 0.1 M to 9.3 M to facilitate filtration and downstream dialysis, particularly when considering creating a scalable process method. Alternatively, without the use of additional time or temperate, a 9.3 M LiBr-silk protein fragment solution may be diluted with water to facilitate debris filtration and dialysis. The result of dissolution at the desired time and temperate filtration is a translucent particle-free room temperature shelf-stable silk protein fragment-LiBr solution of a known MW and polydispersity. It is advantageous to change the dialysis water regularly until the solvent has been removed (e.g., change water after 1 hour, 4 hours, and then every 12 hours for a total of 6 water changes). The total number of water volume changes may be varied based on the resulting concentration of solvent used for silk protein dissolution and fragmentation. After dialysis, the final silk solution maybe further filtered to remove any remaining debris (i.e., silk worm remnants).

Alternatively, Tangential Flow Filtration (TFF), which is a rapid and efficient method for the separation and purification of biomolecules, may be used to remove the solvent from the resulting dissolved fibroin solution, step E2. TFF offers a highly pure aqueous silk protein fragment solution and enables scalability of the process in order to produce large volumes of the solution in a controlled and repeatable manner. The silk and LiBr solution may be diluted prior to TFF (20% down to 0.1% silk in either water or LiBr). Pre-filtration as described above prior to TFF processing may maintain filter efficiency and potentially avoids the creation of silk gel boundary layers on the filter's surface as the result of the presence of debris particles. Pre-filtration prior to TFF is also helpful to remove any remaining debris (i.e., silk worm remnants) from the silk and LiBr solution that may cause spontaneous or long-term gelation of the resulting water only solution, step D. TFF, recirculating or single pass, may be used for the creation of water-silk protein fragment solutions ranging from 0.1% silk to 30.0% silk (more preferably, 0.1%-6.0% silk). Different cutoff size TFF membranes may be required based upon the desired concentration, molecular weight and polydispersity of the silk protein fragment mixture in solution. Membranes ranging from 1-100 kDa may be necessary for varying molecular weight silk solutions created for example by varying the length of extraction boil time or the time and temperate in dissolution solvent (e.g., LiBr). In an embodiment, a TFF 5 or 10 kDa membrane is used to purify the silk protein fragment mixture solution and to create the final desired silk-to-water ratio. As well, TFF single pass, TFF, and other methods known in the art, such as a falling film evaporator, may be used to concentrate the solution following removal of the dissolution solvent (e.g., LiBr) (with resulting desired concentration ranging from 0.1% to 30% silk). This can be used as an alternative to standard HFIP concentration methods known in the art to create a water-based solution. A larger pore membrane could also be utilized to filter out small silk protein fragments and to create a solution of higher molecular weight silk with and/or without tighter polydispersity values.

An assay for LiBr and Na₂CO₃ detection can be performed using an HPLC system equipped with evaporative light scattering detector (ELSD). The calculation was performed by linear regression of the resulting peak areas for the analyte plotted against concentration. More than one sample of a number of formulations of the present disclosure was used for sample preparation and analysis. Generally, four samples of different formulations were weighed directly in a 10 mL volumetric flask. The samples were suspended in 5 mL of 20 mM ammonium formate (pH 3.0) and kept at 2-8° C. for 2 hours with occasional shaking to extract analytes from the film. After 2 hours the solution was diluted with 20 mM ammonium formate (pH 3.0). The sample solution from the volumetric flask was transferred into HPLC vials and injected into the HPLC-ELSD system for the estimation of sodium carbonate and lithium bromide.

The analytical method developed for the quantitation of Na₂CO₃ and LiBr in silk protein formulations was found to be linear in the range 10-165 μg/mL, with RSD for injection precision as 2% and 1% for area and 0.38% and 0.19% for retention time for sodium carbonate and lithium bromide respectively. The analytical method can be applied for the quantitative determination of sodium carbonate and lithium bromide in silk protein formulations.

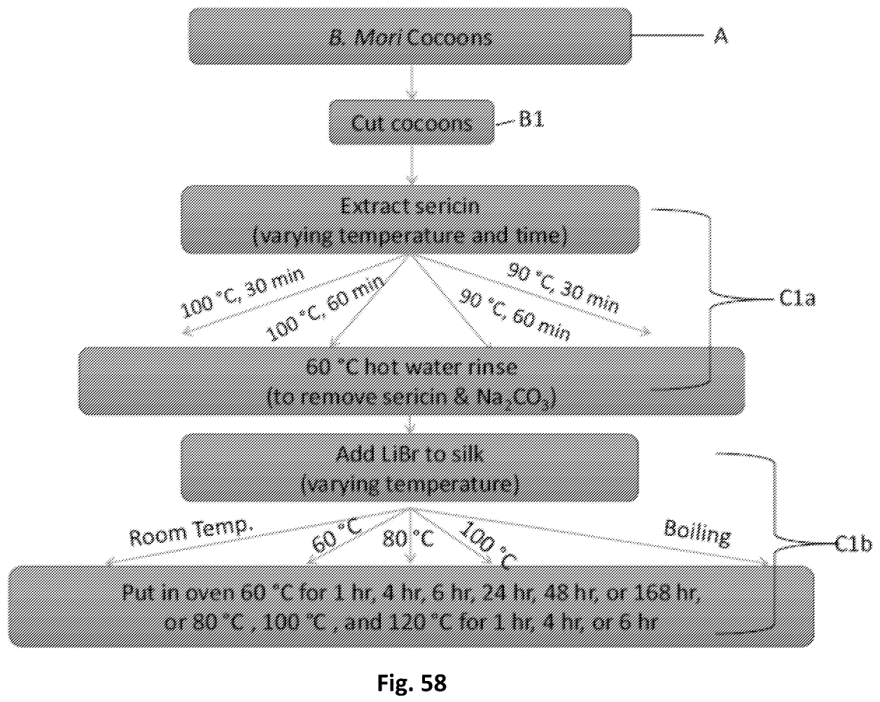

FIG. 58 is a flow chart showing various parameters that can be modified during the process of producing a silk protein fragment solution of the present disclosure during the extraction and the dissolution steps. Select method parameters may be altered to achieve distinct final solution characteristics depending upon the intended use, e.g., molecular weight and polydispersity. It should be understood that not all of the steps illustrated are necessarily required to fabricate all silk solutions of the present disclosure.

In an embodiment, silk protein fragment solutions useful for a wide variety of applications are prepared according to the following steps: forming pieces of silk cocoons from the Bombyx mori silkworm; extracting the pieces at about 100° C. in a Na₂CO₃ water solution for about 60 minutes, wherein a volume of the water equals about 0.4× raw silk weight and the amount of Na₂CO₃ is about 0.848× the weight of the pieces to form a silk fibroin extract; triple rinsing the silk fibroin extract at about 60° C. for about 20 minutes per rinse in a volume of rinse water, wherein the rinse water for each cycle equals about 0.2 L×the weight of the pieces; removing excess water from the silk fibroin extract; drying the silk fibroin extract; dissolving the dry silk fibroin extract in a LiBr solution, wherein the LiBr solution is first heated to about 100° C. to create a silk and LiBr solution and maintained; placing the silk and LiBr solution in a dry oven at about 100° C. for about 60 minutes to achieve complete dissolution and further fragmentation of the native silk protein structure into mixture with desired molecular weight and polydispersity; filtering the solution to remove any remaining debris from the silkworm; diluting the solution with water to result in a 1.0 wt. % silk solution; and removing solvent from the solution using Tangential Flow Filtration (TFF). In an embodiment, a 10 kDa membrane is utilized to purify the silk solution and create the final desired silk-to-water ratio. TFF can then be used to further concentrate the silk solution to a concentration of 2.0 wt. % silk in water.

Without wishing to be bound by any particular theory, varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Also without wishing to be bound by any particular theory, increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions.

The extraction step could be completed in a larger vessel, for example an industrial washing machine where temperatures at or in between 60° C. to 100° C. can be maintained. The rinsing step could also be completed in the industrial washing machine, eliminating the manual rinse cycles. Dissolution of the silk in LiBr solution could occur in a vessel other than a convection oven, for example a stirred tank reactor. Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

Varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions. While almost all parameters resulted in a viable silk solution, methods that allow complete dissolution to be achieved in fewer than 4 to 6 hours are preferred for process scalability.

In an embodiment, solutions of silk fibroin protein fragments having a weight average selected from between about 6 kDa to about 17 kDa are prepared according to following steps: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at most 1 hour; removing the lithium bromide from the silk fibroin extract; and producing an aqueous solution of silk protein fragments, the aqueous solution comprising: fragments having a weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. The aqueous solution of silk fibroin protein fragments may be lyophilized. In some embodiments, the silk fibroin protein fragment solution may be further processed into various forms including gel, powder, and nanofiber.

In an embodiment, solutions of silk fibroin protein fragments having a weight average molecular weight selected from between about 17 kDa to about 39 kDa are prepared according to the following steps: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of silk fibroin protein fragments comprises fragments having a weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay.

In some embodiments, a method for preparing an aqueous solution of silk fibroin protein fragments having an average weight average molecular weight selected from between about 6 kDa to about 17 kDa includes the steps of: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at least 1 hour; removing the lithium bromide from the silk fibroin extract; and producing an aqueous solution of silk protein fragments, the aqueous solution comprising: fragments having an average weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay. The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In some embodiments, a method for preparing an aqueous solution of silk fibroin protein fragments having an average weight average molecular weight selected from between about 17 kDa to about 39 kDa includes the steps of: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of pure silk fibroin protein fragments, wherein the aqueous solution of pure silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of pure silk fibroin protein fragments comprises fragments having an average weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay. The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In an embodiment, solutions of silk fibroin protein fragments having a weight average molecular weight selected from between about 39 kDa to about 80 kDa are prepared according to the following steps: adding a silk source to a boiling (100° C.) aqueous solution of sodium carbonate for a treatment time of about 30 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, sodium carbonate residuals of between about 10 ppm and about 100 ppm, fragments having a weight average molecular weight selected from between about 39 kDa to about 80 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. In some embodiments, the method may further comprise adding an active agent (e.g., therapeutic agent) to the aqueous solution of pure silk fibroin protein fragments. The method may further comprise adding an active agent selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha-hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2 wt. % and a vitamin content of at least 20 wt. %.

Molecular weight of the silk protein fragments may be controlled based upon the specific parameters utilized during the extraction step, including extraction time and temperature; specific parameters utilized during the dissolution step, including the LiBr temperature at the time of submersion of the silk in to the lithium bromide and time that the solution is maintained at specific temperatures; and specific parameters utilized during the filtration step. By controlling process parameters using the disclosed methods, it is possible to create silk fibroin protein fragment solutions with polydispersity equal to or lower than 2.5 at a variety of different molecular weight selected from between 5 kDa to 200 kDa, or between 10 kDa and 80 kDa. By altering process parameters to achieve silk solutions with different molecular weights, a range of fragment mixture end products, with desired polydispersity of equal to or less than 2.5 may be targeted based upon the desired performance requirements. For example, a higher molecular weight silk film containing an ophthalmic drug may have a controlled slow release rate compared to a lower molecular weight film making it ideal for a delivery vehicle in eye care products. Additionally, the silk fibroin protein fragment solutions with a polydispersity of greater than 2.5 can be achieved. Further, two solutions with different average molecular weights and polydispersity can be mixed to create combination solutions. Alternatively, a liquid silk gland (100% sericin free silk protein) that has been removed directly from a worm could be used in combination with any of the silk fibroin protein fragment solutions of the present disclosure. Molecular weight of the pure silk fibroin protein fragment composition was determined using High Pressure Liquid Chromatography (HPLC) with a Refractive Index Detector (RID). Polydispersity was calculated using Cirrus GPC Online GPC/SEC Software Version 3.3 (Agilent).

Differences in the processing parameters can result in regenerated silk fibroins that vary in molecular weight, and peptide chain size distribution (polydispersity, PD). This, in turn, influences the regenerated silk fibroin performance, including mechanical strength, water solubility etc.

Parameters were varied during the processing of raw silk cocoons into the silk solution. Varying these parameters affected the MW of the resulting silk solution. Parameters manipulated included (i) time and temperature of extraction, (ii) temperature of LiBr, (iii) temperature of dissolution oven, and (iv) dissolution time. Experiments were carried out to determine the effect of varying the extraction time. Tables A-G summarize the results. Below is a summary:
A sericin extraction time of 30 minutes resulted in larger molecular weight than a sericin extraction time of 60 minutes
Molecular weight decreases with time in the oven
140° C. LiBr and oven resulted in the low end of the confidence interval to be below a molecular weight of 9500 Da
30 min extraction at the 1 hour and 4 hour time points have undigested silk
30 min extraction at the 1 hour time point resulted in a significantly high molecular weight with the low end of the confidence interval being 35,000 Da
The range of molecular weight reached for the high end of the confidence interval was 18000 to 216000 Da (important for offering solutions with specified upper limit).

TABLE A
The effect of extraction time (30 min vs 60 min) on molecular weight of
silk processed under the conditions of 100 °C Extraction Temperature,
100° C. Lithium Bromide (LiBr) and 100° C. Oven Dissolution
(Oven/Dissolution Time was varied).

| Boil | Oven | Average | | Confidence | | |
|---|---|---|---|---|---|---|
| Time | Time | Mw | Std dev | Interval | | PD |
| 30 | 1 | 57247 | 12780 | 35093 | 93387 | 1.63 |
| 60 | 1 | 31520 | 1387 | 11633 | 85407 | 2.71 |
| 30 | 4 | 40973 | 2632 | 14268 | 117658 | 2.87 |
| 60 | 4 | 25082 | 1248 | 10520 | 59803 | 2.38 |
| 30 | 6 | 25604 | 1405 | 10252 | 63943 | 2.50 |
| 60 | 6 | 20980 | 1262 | 10073 | 43695 | 2.08 |

TABLE B
The effect of extraction time (30 min vs 60 min) on molecular weight of
silk processed under the conditions of 100° C. Extraction Temperature,
boiling Lithium Bromide (LiBr) and 60° C. Oven Dissolution for 4 hr.

| | | Average | Std | Confidence | | |
|---|---|---|---|---|---|---|
| Sample | Boil Time | Mw | dev | Interval | | PD |
| 30 min, 4 hr | 30 | 49656 | 4580 | 17306 | 142478 | 2.87 |
| 60 min, 4 hr | 60 | 30042 | 1536 | 11183 | 80705 | 2.69 |

TABLE C
The effect of extraction time (30 min vs 60 min) on molecular weight of
silk processed under the conditions of 100° C. Extraction Temperature,
60° C. Lithium Bromide (LiBr) and 60° C. Oven Dissolution (Oven/
Dissolution Time was varied).

| | | Oven | | | Confidence | | |
|---|---|---|---|---|---|---|---|
| Sample | Boil Time | Time | Average Mw | Std dev | Interval | | PD |
| 30 min, 1 hr | 30 | 1 | 58436 | | 22201 | 153809 | 2.63 |
| 60 min, 1 hr | 60 | 1 | 31700 | | 11931 | 84224 | 2.66 |
| 30 min, 4 hr | 30 | 4 | 61956.5 | 13337 | 21463 | 178847 | 2.89 |
| 60 min, 4 hr | 60 | 4 | 25578.5 | 2446 | 9979 | 65564 | 2.56 |

TABLE D
The effect of extraction time (30 min vs 60 min) on molecular weight of
silk processed under the conditions of 100° C. Extraction Temperature,
80° C. Lithium Bromide (LiBr) and 80° C. Oven Dissolution for 6 hr.

| | | | | Confidence | | |
|---|---|---|---|---|---|---|
| Sample | Boil Time | Average Mw | Std dev | Interval | | PD |
| 30 min, 6 hr | 30 | 63510 | | 18693 | 215775 | 3.40 |
| 60 min, 6 hr | 60 | 25164 | 238 | 9637 | 65706 | 2.61 |

TABLE E
The effect of extraction time (30 min vs 60 min) on molecular weight of
silk processed under the conditions of 100° C. Extraction Temperature,
80° C. Lithium Bromide (LiBr) and 60° C. Oven Dissolution (Oven/
Dissolution Time was varied).

| | | | Average | | Confidence | | |
|---|---|---|---|---|---|---|---|
| Sample | Boil Time | Oven Time | Mw | Std dev | Interval | | PD |
| 30 min, 4 hr | 30 | 4 | 59202 | 14028 | 19073 | 183760 | 3.10 |
| 60 min, 4 hr | 60 | 4 | 26312.5 | 637 | 10266 | 67442 | 2.56 |
| 30 min, 6 hr | 30 | 6 | 46824 | | 18076 | 121293 | 2.59 |
| 60 min, 6 hr | 60 | 6 | 26353 | | 10168 | 68302 | 2.59 |

TABLE F
The effect of extraction time (30 min vs 60 min) on molecular weight of
silk processed under the conditions of 100° C. Extraction Temperature,
140° C. Lithium Bromide (LiBr) and 140° C. Oven Dissolution (Oven/
Dissolution Time was varied).

| | | | | Std | Confidence | | |
|---|---|---|---|---|---|---|---|
| Sample | Boil Time | Oven Time | Average Mw | dev | Interval | | PD |
| 30 min, 4 hr | 30 | 4 | 9024.5 | 1102 | 4493 | 18127 | 2.00865 |
| 60 min, 4 hr | 60 | 4 | 15548 | | 6954 | 34762 | 2.2358 |
| 30 min, 6 hr | 30 | 6 | 13021 | | 5987 | 28319 | 2.1749 |
| 60 min, 6 hr | 60 | 6 | 10888 | | 5364 | 22100 | 2.0298 |

Experiments were carried out to determine the effect of varying the extraction temperature. Table G summarizes the results. Below is a summary:
Sericin extraction at 90° C. resulted in higher MW than sericin extraction at 100° C. extraction
Both 90° C. and 100° C. show decreasing MW over time in the oven.

TABLE G
The effect of extraction temperature (90° C. vs. 100° C.) on molecular
weight of silk processed under the conditions of 60 min. Extraction
Temperature, 100° C. Lithium Bromide (LiBr) and 100° C. Oven
Dissolution (Oven/Dissolution Time was varied).

| | | | Average | | Confidence | | |
|---|---|---|---|---|---|---|---|
| Sample | Boil Time | Oven Time | Mw | Std dev | Interval | | PD |
| 90° C., 4 hr | 60 | 4 | 37308 | 4204 | 13368 | 104119 | 2.79 |
| 100° C., 4 hr | 60 | 4 | 25082 | 1248 | 10520 | 59804 | 2.38 |
| 90° C., 6 hr | 60 | 6 | 34224 | 1135 | 12717 | 92100 | 2.69 |
| 100° C., 6 hr | 60 | 6 | 20980 | 1262 | 10073 | 43694 | 2.08 |

Experiments were carried out to determine the effect of varying the Lithium Bromide (LiBr) temperature when added to silk. Tables H-I summarize the results. Below is a summary:
No impact on molecular weight or confidence interval (all CI˜10500-6500 Da)
Studies illustrated that the temperature of LiBr-silk dissolution, as LiBr is added and begins dissolving, rapidly drops below the original LiBr temperature due to the majority of the mass being silk at room temperature

TABLE H
The effect of Lithium Bromide (LiBr) temperature on molecular weight
of silk processed under the conditions of 60 min. Extraction Time.,
100° C. Extraction Temperature and 60° C. Oven Dissolution (Oven/
Dissolution Time was varied).

| | LiBr | | | | | | |
|---|---|---|---|---|---|---|---|
| | Temp | | Average | | Confidence | | |
| Sample | (° C.) | Oven Time | Mw | Std dev | Interval | | PD |
| 60° C. LiBr, | 60 | 1 | 31700 | | 11931 | 84223 | 2.66 |
| 1 hr | | | | | | | |
| 100° C. LiBr, | 100 | 1 | 27907 | 200 | 10735 | 72552 | 2.60 |
| 1 hr | | | | | | | |
| RT LiBr, | RT | 4 | 29217 | 1082 | 10789 | 79119 | 2.71 |
| 4 hr | | | | | | | |
| 60° C. LiBr, | 60 | 4 | 25578 | 2445 | 9978 | 65564 | 2.56 |
| 4 hr | | | | | | | |
| 80° C. LiBr, | 80 | 4 | 26312 | 637 | 10265 | 67441 | 2.56 |
| 4 hr | | | | | | | |
| 100° C. LiBr, | 100 | 4 | 27681 | 1729 | 11279 | 67931 | 2.45 |
| 4 hr | | | | | | | |
| Boil LiBr, | Boil | 4 | 30042 | 1535 | 11183 | 80704 | 2.69 |
| 4 hr | | | | | | | |
| RT LiBr, | RT | 6 | 26543 | 1893 | 10783 | 65332 | 2.46 |
| 6 hr | | | | | | | |
| 80° C. LiBr, | 80 | 6 | 26353 | | 10167 | 68301 | 2.59 |
| 6 hr | | | | | | | |
| 100° C. LiBr, | 100 | 6 | 27150 | 916 | 11020 | 66889 | 2.46 |
| 6 hr | | | | | | | |

TABLE I
The effect of Lithium Bromide (LiBr) temperature on molecular weight
of silk processed under the conditions of 30 min. Extraction Time,
100° C. Extraction Temperature and 60° C. Oven Dissolution (Oven/
Dissolution Time was varied).

| | LiBr | | | | | | |
|---|---|---|---|---|---|---|---|
| | Temp | | Average | Std | Confidence | | |
| Sample | (° C.) | Oven Time | Mw | dev | Interval | | PD |
| 60° C. LiBr, | 60 | 4 | 61956 | 13336 | 21463 | 178847 | 2.89 |
| 4 hr | | | | | | | |
| 80° C. LiBr, | 80 | 4 | 59202 | 14027 | 19073 | 183760 | 3.10 |
| 4 hr | | | | | | | |
| 100° C. LiBr, | 100 | 4 | 47853 | | 19757 | 115899 | 2.42 |
| 4 hr | | | | | | | |
| 80° C. LiBr, | 80 | 6 | 46824 | | 18075 | 121292 | 2.59 |
| 6 hr | | | | | | | |
| 100° C. LiBr, | 100 | 6 | 55421 | 8991 | 19152 | 160366 | 2.89 |
| 6 hr | | | | | | | |

Experiments were carried out to determine the effect of v oven/dissolution temperature. Tables J-N summarize the results. Below is a summary:
Oven temperature has less of an effect on 60 min extracted silk than 30 min extracted silk. Without wishing to be bound by theory, it is believed that the 30 min silk is less degraded during extraction and therefore the oven temperature has more of an effect on the larger MW, less degraded portion of the silk.
For 60° C. vs. 140° C. oven the 30 min extracted silk showed a very significant effect of lower MW at higher oven temp, while 60 min extracted silk had an effect but much less
The 140° C. oven resulted in a low end in the confidence interval at ˜6000 Da.

TABLE J
The effect of oven/dissolution temperature on molecular weight of silk
processed under the conditions of 100° C. Extraction Temperature, 30 min.
Extraction Time, and 100° C. Lithium Bromide (LiBr) (Oven/Dissolution
Time was varied).

| Boil | Oven Temp | | | | Confidence | | |
|---|---|---|---|---|---|---|---|
| Time | (° C.) | Oven Time | Average Mw | Std dev | Interval | | PD |
| 30 | 60 | 4 | 47853 | | 19758 | 115900 | 2.42 |
| 30 | 100 | 4 | 40973 | 2632 | 14268 | 117658 | 2.87 |
| 30 | 60 | 6 | 55421 | 8992 | 19153 | 160366 | 2.89 |
| 30 | 100 | 6 | 25604 | 1405 | 10252 | 63943 | 2.50 |

TABLE K
The effect of oven/dissolution temperature on molecular weight of silk
processed under the conditions of 100° C. Extraction Temperature,
60 min. Extraction Time, and 100° C. Lithium Bromide (LiBr) (Oven/
Dissolution Time was varied).

| Boil Time | | | Average | | Confidence | | |
|---|---|---|---|---|---|---|---|
| minutes) | Oven Temp | Oven Time | Mw | Std dev | Interval | | PD |
| 60 | 60 | 1 | 27908 | 200 | 10735 | 72552 | 2.60 |
| 60 | 100 | 1 | 31520 | 1387 | 11633 | 85407 | 2.71 |
| 60 | 60 | 4 | 27681 | 1730 | 11279 | 72552 | 2.62 |
| 60 | 100 | 4 | 25082 | 1248 | 10520 | 59803 | 2.38 |
| 60 | 60 | 6 | 27150 | 916 | 11020 | 66889 | 2.46 |
| 60 | 100 | 6 | 20980 | 1262 | 10073 | 43695 | 2.08 |

TABLE L
The effect of oven/dissolution temperature on molecular weight of silk
processed under the conditions of 100° C. Extraction Temperature,
60 min. Extraction Time, and 140° C. Lithium Bromide (LiBr) (Oven/
Dissolution Time was varied).

| | Oven | | | | | | |
|---|---|---|---|---|---|---|---|
| Boil Time | Temp | Oven | | Std | Confidence | | |
| (minutes) | (° C.) | Time | Average | dev | Interval | | PD |
| 60 | 60 | 4 | 30042 | 1536 | 11183 | 80705 | 2.69 |
| 60 | 140 | 4 | 15548 | | 7255 | 33322 | 2.14 |

TABLE M
The effect of oven/dissoluticn temperature on molecular weight of silk
processed under the conditions of 100° C. Extraction Temperature,
30 min. Extraction Time, and 140° C. Lithium Bromide (LiBr) (Oven/
Dissolution Time was varied).

| Boil Time | Oven Temp | | Average | | Confidence | | |
|---|---|---|---|---|---|---|---|
| (minutes) | (° C.) | Oven Time | Mw | Std dev | Interval | | PD |
| 30 | 60 | 4 | 49656 | 4580 | 17306 | 142478 | 2.87 |
| 30 | 140 | 4 | 9025 | 1102 | 4493 | 18127 | 2.01 |
| 30 | 60 | 6 | 59383 | 11640 | 17641 | 199889 | 3.37 |
| 30 | 140 | 6 | 13021 | | 5987 | 28319 | 2.17 |

TABLE N
The effect of oven/dissolution temperature on molecular weight of silk
processed under the conditions of 100° C. Extraction Temperature,
60 min. Extraction Time, and 80° C. Lithium Bromide (LiBr) (Oven/
Dissolution Time was varied).

| | Oven | | | | | | |
|---|---|---|---|---|---|---|---|
| Boil Time | Temp | | | | Confidence | | |
| (minutes) | (° C.) | Oven Time | Average Mw | Std dev | Interval | | PD |
| 60 | 60 | 4 | 26313 | 637 | 10266 | 67442 | 2.56 |
| 60 | 80 | 4 | 30308 | 4293 | 12279 | 74806 | 2.47 |
| 60 | 60 | 6 | 26353 | | 10168 | 68302 | 2.59 |
| 60 | 80 | 6 | 25164 | 238 | 9637 | 65706 | 2.61 |

The raw silk cocoons from the silkworm Bombyx mori was cut into pieces. The pieces of raw silk cocoons were boiled in an aqueous solution of Na₂CO₃ (about 100° C.) for a period of time between about 30 minutes to about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L×the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at a temperature ranging from about 60° C. to about 140° C. for about 60 minutes to achieve complete dissolution of the native silk protein. The resulting solution was allowed to cool to room temperature and then was dialyzed to remove LiBr salts using a 3,500 Da MWCO membrane. Multiple exchanges were performed in Di water until Br ions were less than 1 ppm as determined in the hydrolyzed fibroin solution read on an Oakton Bromide (Br⁻) double-junction ion-selective electrode.

The resulting silk fibroin aqueous solution has a concentration of about 8.0% w/v containing pure silk fibroin protein fragments having an average weight average molecular weight selected from between about 6 kDa to about 16 kDa, about 17 kDa to about 39 kDa, and about 39 kDa to about 80 kDa and a polydispersity of between about 1.5 and about 3.0. The 8.0% w/v was diluted with DI water to provide a 1.0% w/v, 2.0% w/v, 3.0% w/v, 4.0% w/v, 5.0% w/v by the coating solution.

A variety of % silk concentrations have been produced through the use of Tangential Flow Filtration (TFF). In all cases a 1% silk solution was used as the input feed. A range of 750-18,000 mL of 1% silk solution was used as the starting volume. Solution is diafiltered in the TFF to remove lithium bromide. Once below a specified level of residual LiBr, solution undergoes ultrafiltration to increase the concentration through removal of water. See examples below.

Six (6) silk solutions were utilized in standard silk structures with the following results:

Solution #1 is a silk concentration of 5.9 wt. %, average MW of 19.8 kDa and 2.2 PDI (made with a 60 min boil extraction, 100° C. LiBr dissolution for 1 hour).

Solution #2 is a silk concentration of 6.4 wt. % (made with a 30 min boil extraction, 60° C. LiBr dissolution for 4 hrs).

Solution #3 is a silk concentration of 6.17 wt. % (made with a 30 min boil extraction 100° C. LiBr dissolution for 1 hour).

Solution #4 is a silk concentration of 7.30 wt. %: A 7.30% silk solution was produced beginning with 30 minute extraction batches of 100 g silk cocoons per batch. Extracted silk fibers were then dissolved using 100° C. 9.3 M LiBr in a 100° C. oven for 1 hour. 100 g of silk fibers were dissolved per batch to create 20% silk in LiBr. Dissolved silk in LiBr was then diluted to 1% silk and filtered through a 5 μm filter to remove large debris. 15,500 mL of 1%, filtered silk solution was used as the starting volume/diafiltration volume for TFF. Once LiBr was removed, the solution was ultrafiltered to a volume around 1300 mL. 1262 mL of 7.30% silk was then collected. Water was added to the feed to help remove the remaining solution and 547 mL of 3.91% silk was then collected.

Solution #5 is a silk concentration of 6.44 wt. %: A 6.44 wt. % silk solution was produced beginning with 60 minute extraction batches of a mix of 25, 33, 50, 75 and 100 g silk cocoons per batch. Extracted silk fibers were then dissolved using 100° C. 9.3 M LiBr in a 100° C. oven for 1 hour. 35, 42, 50 and 71 g per batch of silk fibers were dissolved to create 20% silk in LiBr and combined. Dissolved silk in LiBr was then diluted to 1% silk and filtered through a 5 μm filter to remove large debris. 17,000 mL of 1%, filtered silk solution was used as the starting volume/diafiltration volume for TFF. Once LiBr was removed, the solution was ultrafiltered to a volume around 3000 mL. 1490 mL of 6.44% silk was then collected. Water was added to the feed to help remove the remaining solution and 1454 mL of 4.88% silk was then collected.

Solution #6 is a silk concentration of 2.70 wt. %: A 2.70% silk solution was produced beginning with 60-minute extraction batches of 25 g silk cocoons per batch. Extracted silk fibers were then dissolved using 100° C. 9.3 M LiBr in a 100° C. oven for 1 hour. 35.48 g of silk fibers were dissolved per batch to create 20% silk in LiBr. Dissolved silk in LiBr was then diluted to 1% silk and filtered through a 5 μm filter to remove large debris. 1000 mL of 1%, filtered silk solution was used as the starting volume/diafiltration volume for TFF. Once LiBr was removed, the solution was ultrafiltered to a volume around 300 mL. 312 mL of 2.7% silk was then collected.

The preparation of silk fibroin solutions with higher molecular weights is given in Table O.

TABLE O
Preparation and properties of silk fibroin solutions.

| | | | | | Average | |
|---|---|---|---|---|---|---|
| | | | | | weight | |
| | | | | | average | |
| | Extraction | Extraction | LiBr | | molecular | |
| Sample | Time | Temp | Temp | Oven/Sol'n | weight | Average |
| Name | (mins) | (° C.) | (° C.) | Temp | (kDa) | polydispersity |
| Group | 60 | 100 | 100 | 100° C. | 34.7 | 2.94 |
| A TFF | | | | oven | | |
| Group | 60 | 100 | 100 | 100° C. | 44.7 | 3.17 |
| A DIS | | | | oven | | |
| Group | 60 | 100 | 100 | 100° C. | 41.6 | 3.07 |
| B TFF | | | | sol'n | | |
| Group | 60 | 100 | 100 | 100° C. | 44.0 | 3.12 |
| B DIS | | | | sol'n | | |
| Group | 30 | 90 | 60 | 60° C. sol'n | 129.7 | 2.56 |
| D DIS | | | | | | |
| Group | 30 | 90 | 60 | 60° C. sol'n | 144.2 | 2.73 |
| D FIL | | | | | | |
| Group | 15 | 100 | RT | 60° C. sol'n | 108.8 | 2.78 |
| E DIS | | | | | | |
| Group | 15 | 100 | RT | 60° C. sol'n | 94.8 | 2.62 |
| E FIL | | | | | | |

Silk aqueous coating composition for application to fabrics are given in Tables P and Q below.

TABLE P
Silk Solution Characteristics

| | | | | | |
|---|---|---|---|---|---|
| | Molecular Weight: | 57 kDa | | | |
| | Polydispersity: | 1.6 | | | |
| | % Silk | 5.0% | 3.0% | 1.0% | 0.5% |
| Process | Extraction | | | | |
| Parameters | Boil Time: | 30 minutes | | | |
| | Boil Temperature: | 100° C. | | | |
| | Rinse Temperature: | 60° C. | | | |
| | Dissolution | | | | |
| | LiBr Temperature: | 100 | | | |
| | Oven Temperature: | 100° C. | | | |
| | Oven Time: | 60 minutes | | | |

TABLE Q
Silk Solution Characteristics

| | | | | | |
|---|---|---|---|---|---|
| | Molecular Weight: | 25 kDa | | | |
| | Polydispersity: | 2.4 | | | |
| | % Silk | 5.0% | 3.0% | 1.0% | 0.5% |
| Process | Extraction | | | | |
| Parameters | Boil Time: | 60 minutes | | | |
| | Boil Temperature: | 100° C. | | | |
| | Rinse Temperature: | 60° C. | | | |
| | Dissolution | | | | |
| | LiBr Temperature: | 100° C. | | | |
| | Oven Temperature: | 100° C. | | | |
| | Oven Time: | 60 minutes | | | |

Three (3) silk solutions were utilized in film making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

Films were made in accordance with Rockwood et al. (Nature Protocols; Vol. 6; No. 10; published on-line Sep. 22, 2011; doi:10.1038/nprot.2011.379). 4 mL of 1% or 2% (wt/vol) aqueous silk solution was added into 100 mm Petri dish (Volume of silk can be varied for thicker or thinner films and is not critical) and allowed to dry overnight uncovered. The bottom of a vacuum desiccator was filled with water. Dry films were placed in the desiccator and vacuum applied, allowing the films to water anneal for 4 hours prior to removal from the dish. Films cast from solution #1 did not result in a structurally continuous film; the film was cracked in several pieces. These pieces of film dissolved in water in spite of the water annealing treatment.

Silk solutions of various molecular weights and/or combinations of molecular weights can be optimized for gel applications. The following provides an example of this process but it not intended to be limiting in application or formulation. Three (3) silk solutions were utilized in gel making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

“Egel” is an electrogelation process as described in Rockwood of al. Briefly, 10 ml of aqueous silk solution is added to a 50 ml conical tube and a pair of platinum wire electrodes immersed into the silk solution. A 20 volt potential was applied to the platinum electrodes for 5 minutes, the power supply turned off and the gel collected. Solution #1 did not form an EGEL over the 5 minutes of applied electric current.

Solutions #2 and #3 were gelled in accordance with the published horseradish peroxidase (HRP) protocol. Behavior seemed typical of published solutions.

Materials and Methods: the following equipment and material are used in determination of Silk Molecular weight: Agilent 1100 with chemstation software ver. 10.01; Refractive Index Detector (RID); analytical balance; volumetric flasks (1000 mL, 10 mL and 5 mL); HPLC grade water; ACS grade sodium chloride; ACS grade sodium phosphate dibasic heptahydrate; phosphoric acid; dextran MW Standards-Nominal Molecular Weights of 5 kDa, 11.6 kDa, 23.8 kDa, 48.6 kDa, and 148 kDa; 50 mL PET or polypropylene disposable centrifuge tubes; graduated pipettes; amber glass HPLC vials with Teflon caps; Phenomenex PolySep GFC P-4000 column (size: 7.8 mm×300 mm).

Procedural Steps:

### A) Preparation of 1 L Mobile Phase (0.1 M Sodium Chloride Solution in 0.0125 M Sodium Phosphate Buffer)

Take a 250 mL clean and dry beaker, place it on the balance and tare the weight. Add about 3.3509 g of sodium phosphate dibasic heptahydrate to the beaker. Note down the exact weight of sodium phosphate dibasic weighed. Dissolve the weighed sodium phosphate by adding 100 mL of HPLC water into the beaker. Take care not to spill any of the content of the beaker. Transfer the solution carefully into a clean and dry 1000 mL volumetric flask. Rinse the beaker and transfer the rinse into the volumetric flask. Repeat the rinse 4-5 times. In a separate clean and dry 250 mL beaker weigh exactly about 5.8440 g of sodium chloride. Dissolve the weighed sodium chloride in 50 mL of water and transfer the solution to the sodium phosphate solution in the volumetric flask. Rinse the beaker and transfer the rinse into the volumetric flask. Adjust the pH of the solution to 7.0±0.2 with phosphoric acid. Make up the volume in volumetric flask with HPLC water to 1000 mL and shake it vigorously to homogeneously mix the solution. Filter the solution through 0.45 μm polyamide membrane filter. Transfer the solution to a clean and dry solvent bottle and label the bottle. The volume of the solution can be varied to the requirement by correspondingly varying the amount of sodium phosphate dibasic heptahydrate and sodium chloride.

### B) Preparation of Dextran Molecular Weight Standard Solutions

At least five different molecular weight standards are used for each batch of samples that are run so that the expected value of the sample to be tested is bracketed by the value of the standard used. Label six 20 mL scintillation glass vials respective to the molecular weight standards. Weigh accurately about 5 mg of each of dextran molecular weight standards and record the weights. Dissolve the dextran molecular weight standards in 5 mL of mobile phase to make a 1 mg/mL standard solution.

### C) Preparation of Sample Solutions

When preparing sample solutions, if there are limitations on how much sample is available, the preparations may be scaled as long as the ratios are maintained. Depending on sample type and silk protein content in sample weigh enough sample in a 50 mL disposable centrifuge tube on an analytical balance to make a 1 mg/mL sample solution for analysis. Dissolve the sample in equivalent volume of mobile phase make a 1 mg/mL solution. Tightly cap the tubes and mix the samples (in solution). Leave the sample solution for 30 minutes at room temperature. Gently mix the sample solution again for 1 minute and centrifuge at 4000 RPM for 10 minutes.

### D) HPLC Analysis of the Samples

Transfer 1.0 mL of all the standards and sample solutions into individual HPLC vials. Inject the molecular weight standards (one injection each) and each sample in duplicate. Analyze all the standards and sample solutions using the following HPLC conditions:

| | |
|---|---|
| Column | Poly Sep GFC P-4000 (7.8 × 300 mm) |
| Column Temperature | 25° C. |
| Detector | Refractive Index Detector (Temperature @ |
| | 35° C.) |
| Injection Volume | 25.0 μL |
| Mobile Phase | 0.1M Sodium Chloride solution in 0.0125M |
| | sodium phosphate buffer |
| Flow Rate | 1.0 mL/min |
| Run Time | 20.0 min |

### E) Data Analysis and Calculations—Calculation of Average Molecular Weight Using Cirrus Software

Upload the chromatography data files of the standards and the analytical samples into Cirrus SEC data collection and molecular weight analysis software. Calculate the weight average molecular weight (M_{w}), number average molecular weight (Mₙ), peak average molecular weight (Mₚ), and polydispersity for each injection of the sample.

Spider Silk Fragments

Spider silks are natural polymers that consist of three domains: a repetitive middle core domain that dominates the protein chain, and non-repetitive N-terminal and C-terminal domains. The large core domain is organized in a block copolymer-like arrangement, in which two basic sequences, crystalline [poly(A) or poly(GA)] and less crystalline (GGX or GPGXX) polypeptides alternate. Dragline silk is the protein complex composed of major ampullate dragline silk protein 1 (MaSp1) and major ampullate dragline silk protein 2 (MaSp2). Both silks are approximately 3500 amino acid long. MaSp1 can be found in the fibre core and the periphery, whereas MaSp2 forms clusters in certain core areas. The large central domains of MaSp1 and MaSp2 are organized in block copolymer-like arrangements, in which two basic sequences, crystalline [poly(A) or poly(GA)] and less crystalline (GGX or GPGXX) polypeptides alternate in core domain. Specific secondary structures have been assigned to poly(A)/(GA), GGX and GPGXX motifs including β-sheet, α-helix and β-spiral respectively. The primary sequence, composition and secondary structural elements of the repetitive core domain are responsible for mechanical properties of spider silks; whereas, non-repetitive N- and C-terminal domains are essential for the storage of liquid silk dope in a lumen and fibre formation in a spinning duct.

The main difference between MaSp1 and MaSp2 is the presence of proline (P) residues accounting for 15% of the total amino acid content in MaSp2, whereas MaSp1 is proline-free. By calculating the number of proline residues in N. clavipes dragline silk, it is possible to estimate the presence of the two proteins in fibres; 81% MaSp1 and 19% MaSp2. Different spiders have different ratios of MaSp1 and MaSp2. For example, a dragline silk fibre from the orb weaver Argiope aurantia contains 41% MaSp1 and 59% MaSp2. Such changes in the ratios of major ampullate silks can dictate the performance of the silk fibre.

At least seven different types of silk proteins are known for one orb-weaver species of spider. Silks differ in primary sequence, physical properties and functions. For example, dragline silks used to build frames, radii and lifelines are known for outstanding mechanical properties including strength, toughness and elasticity. On an equal weight basis, spider silk has a higher toughness than steel and Kevlar. Flageliform silk found in capture spirals has extensibility of up to 500%. Minor ampullate silk, which is found in auxiliary spirals of the orb-web and in prey wrapping, possesses high toughness and strength almost similar to major ampullate silks, but does not supercontract in water.

Spider silks are known for their high tensile strength and toughness. The recombinant silk proteins also confer advantageous properties to cosmetic or dermatological compositions, in particular to be able to improve the hydrating or softening action, good film forming property and low surface density. Diverse and unique biomechanical properties together with biocompatibility and a slow rate of degradation make spider silks excellent candidates as biomaterials for tissue engineering, guided tissue repair and drug delivery, for cosmetic products (e.g. nail and hair strengthener, skin care products), and industrial materials (e.g. nanowires, nanofibers, surface coatings).

In an embodiment, a silk protein may include a polypeptide derived from natural spider silk proteins. The polypeptide is not limited particularly as long as it is derived from natural spider silk proteins, and examples of the polypeptide include natural spider silk proteins and recombinant spider silk proteins such as variants, analogs, derivatives or the like of the natural spider silk proteins. In terms of excellent tenacity, the polypeptide may be derived from major dragline silk proteins produced in major ampullate glands of spiders. Examples of the major dragline silk proteins include major ampullate spidroin MaSp1 and MaSp2 from Nephila clavipes, and ADF3 and ADF4 from Araneus diadematus, etc. Examples of the polypeptide derived from major dragline silk proteins include variants, analogs, derivatives or the like of the major dragline silk proteins. Further, the polypeptide may be derived from flagelliform silk proteins produced in flagelliform glands of spiders. Examples of the flagelliform silk proteins include flagelliform silk proteins derived from Nephila clavipes, etc.

Examples of the polypeptide derived from major dragline silk proteins include a polypeptide containing two or more units of an amino acid sequence represented by the formula 1: REP1-REP2 (1), preferably a polypeptide containing five or more units thereof, and more preferably a polypeptide containing ten or more units thereof. Alternatively, the polypeptide derived from major dragline silk proteins may be a polypeptide that contains units of the amino acid sequence represented by the formula 1: REP1-REP2 (1) and that has, at a C-terminal, an amino acid sequence represented by any of SEQ ID NOS: 1 to 3 of U.S. Pat. No. 9,051,453 or an amino acid sequence having a homology of 90% or more with the amino acid sequence represented by any of SEQ ID NOS: 1 to 3 of U.S. Pat. No. 9,051,453. In the polypeptide derived from major dragline silk proteins, units of the amino acid sequence represented by the formula 1: REP1-REP2 (1) may be the same or may be different from each other. In the case of producing a recombinant protein using a microbe such as Escherichia coli as a host, the molecular weight of the polypeptide derived from major dragline silk proteins is 500 kDa or less, or 300 kDa or less, or 200 kDa or less, in terms of productivity.

In the formula (1), the REP1 indicates polyalanine. In the REP1, the number of alanine residues arranged in succession is preferably 2 or more, more preferably 3 or more, further preferably 4 or more, and particularly preferably 5 or more. Further, in the REP1, the number of alanine residues arranged in succession is preferably 20 or less, more preferably 16 or less, further preferably 12 or less, and particularly preferably 10 or less. In the formula (1), the REP2 is an amino acid sequence composed of 10 to 200 amino acid residues. The total number of glycine, serine, glutamine and alanine residues contained in the amino acid sequence is 40% or more, preferably 60% or more, and more preferably 70% or more with respect to the total number of amino acid residues contained therein.

In the major dragline silk, the REP1 corresponds to a crystal region in a fiber where a crystal β sheet is formed, and the REP2 corresponds to an amorphous region in a fiber where most of the parts lack regular configurations and that has more flexibility. Further, the [REP1-REP2] corresponds to a repetitious region (repetitive sequence) composed of the crystal region and the amorphous region, which is a characteristic sequence of dragline silk proteins.

Recombinant Silk Fragments

In some embodiments, the recombinant silk protein refers to recombinant spider silk polypeptides, recombinant insect silk polypeptides, or recombinant mussel silk polypeptides. In some embodiments, the recombinant silk protein fragment disclosed herein include recombinant spider silk polypeptides of Araneidae or Araneoids, or recombinant insect silk polypeptides of Bombyx mori. In some embodiments, the recombinant silk protein fragment disclosed herein include recombinant spider silk polypeptides of Araneidae or Araneoids. In some embodiments, the recombinant silk protein fragment disclosed herein include block copolymer having repetitive units derived from natural spider silk polypeptides of Araneidae or Araneoids. In some embodiments, the recombinant silk protein fragment disclosed herein include block copolymer having synthetic repetitive units derived from spider silk polypeptides of Araneidae or Araneoids and non-repetitive units derived from natural repetitive units of spider silk polypeptides of Araneidae or Araneoids.

Recent advances in genetic engineering have provided a route to produce various types of recombinant silk proteins. Recombinant DNA technology has been used to provide a more practical source of silk proteins. As used herein “recombinant silk protein” refers to synthetic proteins produced heterologously in prokaryotic or eukaryotic expression systems using genetic engineering methods.

Various methods for synthesizing recombinant silk peptides are known and have been described by Ausubel et al., Current Protocols in Molecular Biology § 8 (John Wiley & Sons 1987, (1990)), incorporated herein by reference. A gram-negative, rod-shaped bacterium E. coli is a well-established host for industrial scale production of proteins. Therefore, the majority of recombinant silks have been produced in E. coli. E. coli which is easy to manipulate, has a short generation time, is relatively low cost and can be scaled up for larger amounts protein production.

The recombinant silk proteins can be produced by transformed prokaryotic or eukaryotic systems containing the cDNA coding for a silk protein, for a fragment of this protein or for an analog of such a protein. The recombinant DNA approach enables the production of recombinant silks with programmed sequences, secondary structures, architectures and precise molecular weight. There are four main steps in the process: (i) design and assembly of synthetic silk-like genes into genetic ‘cassettes’, (ii) insertion of this segment into a DNA recombinant vector, (iii) transformation of this recombinant DNA molecule into a host cell and (iv) expression and purification of the selected clones.

The term “recombinant vectors”, as used herein, includes any vectors known to the skilled person including plasmid vectors, cosmid vectors, phage vectors such as lambda phage, viral vectors such as adenoviral or baculoviral vectors, or artificial chromosome vectors such as bacterial artificial chromosomes (BAC), yeast artificial chromosomes (YAC), or P1 artificial chromosomes (PAC). Said vectors include expression as well as cloning vectors. Expression vectors comprise plasmids as well as viral vectors and generally contain a desired coding sequence and appropriate DNA sequences necessary for the expression of the operably linked coding sequence in a particular host organism (e.g., bacteria, yeast, or plant) or in in vitro expression systems. Cloning vectors are generally used to engineer and amplify a certain desired DNA fragment and may lack functional sequences needed for expression of the desired DNA fragments.

The prokaryotic systems include Gram-negative bacteria or Gram-positive bacteria. The prokaryotic expression vectors can include an origin of replication which can be recognized by the host organism, a homologous or heterologous promoter which is functional in the said host, the DNA sequence coding for the spider silk protein, for a fragment of this protein or for an analogous protein. Nonlimiting examples of prokaryotic expression organisms are Escherichia coli, Bacillus subtilis, Bacillus megaterium, Corynebacterium glutamicum, Anabaena, Caulobacter, Gluconobacter, Rhodobacter, Pseudomonas, Para coccus, Bacillus (e.g. Bacillus subtilis) Brevibacterium, Corynebacterium, Rhizobium (Sinorhizobium), Flavobacterium, Klebsiella, Enterobacter, Lactobacillus, Lactococcus, Methylobacterium, Propionibacterium, Staphylococcus or Streptomyces cells.

The eukaryotic systems include yeasts and insect, mammalian or plant cells. In this case, the expression vectors can include a yeast plasmid origin of replication or an autonomous replication sequence, a promoter, a DNA sequence coding for a spider silk protein, for a fragment or for an analogous protein, a polyadenylation sequence, a transcription termination site and, lastly, a selection gene. Nonlimiting examples of eukaryotic expression organisms include yeasts, such as Saccharomyces cerevisiae, Pichia pastoris, basidiosporogenous, ascosporogenous, filamentous fungi, such as Aspergillus niger, Aspergillus oryzae, Aspergillus nidulans, Trichoderma reesei, Acremonium chrysogenum, Candida, Hansenula, Kluyveromyces, Saccharomyces (e.g. Saccharomyces cerevisiae), Schizosaccharomyces, Pichia (e.g. Pichia pastoris) or Yarrowia cells etc., mammalian cells, such as HeLa cells, COS cells, CHO cells etc., insect cells, such as Sf9 cells, MEL cells, etc., “insect host cells” such as Spodoptera frugiperda or Trichoplusia ni cells. SF9 cells, SF-21 cells or High-Five cells, wherein SF-9 and SF-21 are ovarian cells from Spodoptera frugiperda, and High-Five cells are egg cells from Trichoplusia ni., “plant host cells”, such as tobacco, potato or pea cells.

A variety of heterologous host systems have been explored to produce different types of recombinant silks. Recombinant partial spidroins as well as engineered silks have been cloned and expressed in bacteria (Escherichia coli), yeast (Pichia pastoris), insects (silkworm larvae), plants (tobacco, soybean, potato, Arabidopsis), mammalian cell lines (BHT/hamster) and transgenic animals (mice, goats). Most of the silk proteins are produced with an N- or C-terminal His-tags to make purification simple and produce enough amounts of the protein.

In some embodiments, the host suitable for expressing the recombinant spider silk protein using heterogeneous system may include transgenic animals and plants. In some embodiments, the host suitable for expressing the recombinant spider silk protein using heterogeneous system comprises bacteria, yeasts, mammalian cell lines. In some embodiments, the host suitable for expressing the recombinant spider silk protein using heterogeneous system comprises E. coli. In some embodiments, the host suitable for expressing the recombinant spider silk protein using heterogeneous system comprises transgenic B. mori silkworm generated using genome editing technologies (e.g. CRISPR).

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences.

In some embodiments, “recombinant silk protein” refers to recombinant silkworm silk protein or fragments thereof. The recombinant production of silk fibroin and silk sericin has been reported. A variety of hosts are used for the production including E. coli, Saccharomyces cerevisiae, Pseudomonas sp., Rhodopseudomonas sp., Bacillus sp., and Strepomyces. See EP 0230702, which is incorporate by reference herein by its entirety.

Provided herein also include design and biological-synthesis of silk fibroin protein-like multiblock polymer comprising GAGAGX hexapeptide (X is A, Y, V or S) derived from the repetitive domain of B. mori silk heavy chain (H chain)

In some embodiments, this disclosure provides silk protein-like multiblock polymers derived from the repetitive domain of B. mori silk heavy chain (H chain) comprising the GAGAGS hexapeptide repeating units. The GAGAGS hexapeptide is the core unit of H-chain and plays an important role in the formation of crystalline domains. The silk protein-like multiblock polymers containing the GAGAGS hexapeptide repeating units spontaneously aggregate into β-sheet structures, similar to natural silk fibroin protein, where in the silk protein-like multiblock polymers having any weight average molecular weight described herein.

In some embodiments, this disclosure provides silk-peptide like multiblock copolymers composed of the GAGAGS hexapeptide repetitive fragment derived from H chain of B. mori silk heavy chain and mammalian elastin VPGVG motif produced by E. coli. In some embodiments, this disclosure provides fusion silk fibroin proteins composed of the GAGAGS hexapeptide repetitive fragment derived from H chain of B. mori silk heavy chain and GVGVP produced by E. coli, where in the silk protein-like multiblock polymers having any weight average molecular weight described herein.

In some embodiments, this disclosure provides B. mori silkworm recombinant proteins composed of the (GAGAGS)₁₆ repetitive fragment. In some embodiments, this disclosure provides recombinant proteins composed of the (GAGAGS)₁₆ repetitive fragment and the non-repetitive (GAGAGS)₁₆—F-COOH, (GAGAGS)₁₆—F-F-COOH, (GAGAGS)₁₆—F-F-F-COOH, (GAGAGS)₁₆—F-F-F-F-COOH, (GAGAGS)₁₆—F-F-F-F-F-F-F-F-COOH, (GAGAGS)₁₆—F-F-F-F-F-F-F-F-F-F-F-F-COOH produced by E. coli, where F has the following amino acid sequence SGFGPVANGGSGEASSESDFGSSGFGPVANASSGEASSESDFAG, and where in the silk protein-like multiblock polymers having any weight average molecular weight described herein.

In some embodiments, “recombinant silk protein” refers to recombinant spider silk protein or fragments thereof. The productions of recombinant spider silk proteins based on a partial cDNA clone have been reported. The recombinant spider silk proteins produced as such comprise a portion of the repetitive sequence derived from a dragline spider silk protein, Spidroin 1, from the spider Nephila clavipes. see Xu et al. (Proc. Natl. Acad. Sci. U.S.A., 87:7120-7124 (1990). cDNA clone encoding a portion of the repeating sequence of a second fibroin protein, Spidroin 2, from dragline silk of Nephila clavipes and the recombinant synthesis thereof is described in J. Biol. Chem., 1992, volume 267, pp. 19320-19324. The recombinant synthesis of spider silk proteins including protein fragments and variants of Nephila clavipes from transformed E. coli is described in U.S. Pat. Nos. 5,728,810 and 5,989,894. cDNA clones encoding minor ampullate spider silk proteins and the expression thereof is described in U.S. Pat. Nos. 5,733,771 and 5,756,677. cDNA clone encoding the flagelliform silk protein from an orb-web spinning spider is described in U.S. Pat. No. 5,994,099. U.S. Pat. No. 6,268,169 describes the recombinant synthesis of spider silk like proteins derived from the repeating peptide sequence found in the natural spider dragline of Nephila clavipes by E. coli, Bacillus subtilis, and Pichia pastoris recombinant expression systems. WO 03/020916 describes the cDNA clone encoding and recombinant production of spider spider silk proteins having repeative sequences derived from the major ampullate glands of Nephila madagascariensis, Nephila senegalensis, Tetragnatha kauaiensis, Tetragnatha versicolor, Argiope aurantia, Argiope trifasciata, Gasteracantha mammosa, and Latrodectus geometricus, the flagelliform glands of Argiope trifasciata, the ampullate glands of Dolomedes tenebrosus, two sets of silk glands from Plectreurys tristis, and the silk glands of the mygalomorph Euagrus chisoseus. Each of the above reference is incorporated herein by reference in its entirety.

In some embodiments, the recombinant spider silk protein is a hybrid protein of a spider silk protein and an insect silk protein, a spider silk protein and collagen, a spider silk protein and resilin, or a spider silk protein and keratin. The spider silk repetitive unit comprises or consists of an amino acid sequence of a region that comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide.

In some embodiments, the recombinant spider silk protein in this disclosure comprises synthetic spider silk proteins derived from repetitive units of natural spider silk proteins, consensus sequence, and optionally one or more natural non-repetitive spider silk protein sequences. The repeated units of natural spider silk polypeptide may include dragline spider silk polypeptides or flagelliform spider silk polypeptides of Araneidae or Araneoids.

As used herein, the spider silk “repetitive unit” comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide. A “repetitive unit” refers to a region which corresponds in amino acid sequence to a region that comprises or consists of at least one peptide motif (e.g. AAAAAA) or GPGQQ) that repetitively occurs within a naturally occurring silk polypeptide (e.g. MaSpI, ADF-3, ADF-4, or Flag) (i.e. identical amino acid sequence) or to an amino acid sequence substantially similar thereto (i.e. variational amino acid sequence). A “repetitive unit” having an amino acid sequence which is “substantially similar” to a corresponding amino acid sequence within a naturally occurring silk polypeptide (i.e. wild-type repetitive unit) is also similar with respect to its properties, e.g. a silk protein comprising the “substantially similar repetitive unit” is still insoluble and retains its insolubility. A “repetitive unit” having an amino acid sequence which is “identical” to the amino acid sequence of a naturally occurring silk polypeptide, for example, can be a portion of a silk polypeptide corresponding to one or more peptide motifs of MaSpI, MaSpII, ADF-3 and/or ADF-4. A “repetitive unit” having an amino acid sequence which is “substantially similar” to the amino acid sequence of a naturally occurring silk polypeptide, for example, can be a portion of a silk polypeptide corresponding to one or more peptide motifs of MaSpI, MaSpII, ADF-3 and/or ADF-4, but having one or more amino acid substitution at specific amino acid positions.

As used herein, the term “consensus peptide sequence” refers to an amino acid sequence which contains amino acids which frequently occur in a certain position (e.g. “G”) and wherein, other amino acids which are not further determined are replaced by the place holder “X”. In some embodiments, the consensus sequence is at least one of (i) GPGXX, wherein X is an amino acid selected from A, S, G, Y, P and Q; (ii) GGX, wherein X is an amino acid selected from Y, P, R, S, A, T, N and Q, preferably Y, P and Q; (iii) Aₓ, wherein x is an integer from 5 to 10.

The consensus peptide sequences GPGXX and GGX, i.e. glycine rich motifs, provide flexibility to the silk polypeptide and thus, to the thread formed from the silk protein containing said motifs. In detail, the iterated GPGXX motif forms turn spiral structures, which imparts elasticity to the silk polypeptide. Major ampullate and flagelliform silks both have a GPGXX motif. The iterated GGX motif is associated with a helical structure having three amino acids per turn and is found in most spider silks. The GGX motif may provide additional elastic properties to the silk. The iterated polyalanine Ax (peptide) motif forms a crystalline β-sheet structure that provides strength to the silk polypeptide, as described for example in WO 03/057727.

In some embodiments, the recombinant spider silk protein in this disclosure comprises two identical repetitive units each comprising at least one, preferably one, amino acid sequence selected from the group consisting of: GGRPSDTYG and GGRPSSSYG derived from Resilin. Resilin is an elastomeric protein found in most arthropods that provides low stiffness and high strength.

As used herein, “non-repetitive units” refers to an amino acid sequence which is “substantially similar” to a corresponding non-repetitive (carboxy terminal) amino acid sequence within a naturally occurring dragline polypeptide (i.e. wild-type non-repetitive (carboxy terminal) unit), preferably within ADF-3 (SEQ ID NO:1), ADF-4 (SEQ ID NO:2), NR3 (SEQ ID NO:41), NR4 (SEQ ID NO:42), ADF-4 of the spider Araneus diadematus as described in U.S. Pat. No. 8,367,803, C16 peptide (spider silk protein eADF4, molecular weight of 47.7 kDa, AMSilk) comprising the 16 repeats of the sequence GSSAAAAAAAASGPGGYGPENQGPSGPGGYGPGGP, an amino acid sequence adapted from the natural sequence of ADF4 from A. diadematus. Non-repetitive ADF-4 and variants thereof display efficient assembly behavior.

Among the synthetic spider silk proteins, the recombinant silk protein in this disclosure comprises in some embodiments the C16-protein having the polypeptide sequence SEQ ID NO: 1 as described in U.S. Pat. No. 8,288,512. Besides the polypeptide sequence shown in SEQ ID NO:1, particularly functional equivalents, functional derivatives and salts of this sequence are also included.

As used herein, “functional equivalents” refers to mutant which, in at least one sequence position of the abovementioned amino acid sequences, have an amino acid other than that specifically mentioned.

In some embodiments, the recombinant spider silk protein in this disclosure comprises, in an effective amount, at least one natural or recombinant silk protein including spider silk protein, corresponding to Spidroin major 1 described by Xu et al., PNAS, USA, 87, 7120, (1990), Spidroin major 2 described by Hinman and Lewis, J. Biol. Chem., 267, 19320, (1922), recombinant spider silk protein as described in U.S. Patent Application No. 2016/0222174 and U.S. Pat. Nos. 9,051,453, 9,617,315, 9,689,089, 8,173,772, 8,642,734, 8,367,803 8,097,583, 8,030,024, 7,754,851, 7,148,039, 7,060,260, or alternatively the minor Spidroins described in patent application WO 95/25165. Each of the above-cited references is incorporated herein by reference in its entirety. Additional recombinant spider silk proteins suitable for the recombinant RSPF of this disclosure include ADF3 and ADF4 from the “Major Ampullate” gland of Araneus diadematus.

Recombinant silk is also described in other patents and patent applications, incorporated by reference herein: US 2004590196, U.S. Pat. No. 7,754,851, US 2007654470, U.S. Pat. No. 7,951,908, US 2010785960, U.S. Pat. No. 8,034,897, US 20090263430, US 2008226854, US 20090123967, US 2005712095, US 2007991037, US 20090162896, US 200885266, U.S. Pat. No. 8,372,436, US 2007989907, US 2009267596, US 2010319542, US 2009265344, US 2012684607, US 2004583227, U.S. Pat. No. 8,030,024, US 2006643569, U.S. Pat. No. 7,868,146, US 2007991916, U.S. Pat. No. 8,097,583, US 2006643200, U.S. Pat. Nos. 8,729,238, 8,877,903, US 20190062557, US 20160280960, US 20110201783, US 2008991916, US 2011986662, US 2012697729, US 20150328363, U.S. Pat. No. 9,034,816, US 20130172478, U.S. Pat. No. 9,217,017, US 20170202995, U.S. Pat. No. 8,721,991, US 2008227498, U.S. Pat. Nos. 9,233,067, 8,288,512, US 2008161364, U.S. Pat. No. 7,148,039, U.S. Ser. No. 19/992,47806, US 2001861597, US 2004887100, U.S. Pat. Nos. 9,481,719, 8,765,688, US 200880705, US 2010809102, U.S. Pat. No. 8,367,803, US 2010664902, U.S. Pat. No. 7,569,660, U.S. Ser. No. 19/991,38833, US 2000591632, US 20120065126, US 20100278882, US 2008161352, US 20100015070, US 2009513709, US 20090194317, US 2004559286, US 200589551, US 2008187824, US 20050266242, US 20050227322, and US 20044418.

Recombinant silk is also described in other patents and patent applications, incorporated by reference herein: US 20190062557, US 20150284565, US 20130225476, US 20130172478, US 20130136779, US 20130109762, US 20120252294, US 20110230911, US 20110201783, US 20100298877, U.S. Pat. Nos. 10,478,520, 10,253,213, 10,072,152, 9,233,067, 9,217,017, 9,034,816, 8,877,903, 8,729,238, 8,721,991, 8,097,583, 8,034,897, 8,030,024, 7,951,908, 7,868,146, and 7,754,851.

In some embodiments, the recombinant spider silk protein in this disclosure comprises or consists of 2 to 80 repetitive units, each independently selected from GPGXX, GGX and Aₓ as defined herein.

In some embodiments, the recombinant spider silk protein in this disclosure comprises or consists of repetitive units each independently selected from selected from the group consisting of GPGAS, GPGSG, GPGGY, GPGGP, GPGGA, GPGQQ, GPGGG, GPGQG, GPGGS, GGY, GGP, GGA, GGR, GGS, GGT, GGN, GGQ, AAAAA, AAAAAA, AAAAAAA, AAAAAAAA, AAAAAAAAA, AAAAAAAAAA, GGRPSDTYG and GGRPSSSYG, (i) GPYGPGASAAAAAAGGYGPGSGQQ, (ii) GSSAAAAAAAASGPGGYGPENQGPSGPGGYGPGGP, (iii) GPGQQGPGQQGPGQQGPGQQ: (iv) GPGGAGGPYGPGGAGGPYGPGGAGGPY, (v) GGTTIIEDLDITIDGADGPITISEELTI, (vi) PGSSAAAAAAAASGPGQGQGQGQGQGGRPSDTYG, (vii) SAAAAAAAAGPGGGNGGRPSDTYGAPGGGNGGRPSSSYG, (viii) GGAGGAGGAGGSGGAGGS (SEQ ID NO: 27), (ix) GPGGAGPGGYGPGGSGPGGYGPGGSGPGGY, (x) GPYGPGASAAAAAAGGYGPGCGQQ, (xi) GPYGPGASAAAAAAGGYGPGKGQQ, (xii) GSSAAAAAAAASGPGGYGPENQGPCGPGGYGPGGP, (xiii) GSSAAAAAAAASGPGGYGPKNQGPSGPGGYGPGGP, (xiv) GSSAAAAAAAASGPGGYGPKNQGPSGPGGYGPGGP, or variants thereof as described in U.S. Pat. No. 8,877,903, for example, a synthetic spider peptide having sequential order of GPGAS, GGY, GPGSG in the peptide chain, or sequential order of AAAAAAAA, GPGGY, GPGGP in the peptide chain, sequential order of AAAAAAAA, GPGQG, GGR in the peptide chain.

In some embodiments, this disclosure provides silk protein-like multiblock peptides that imitate the repeating units of amino acids derived from natural spider silk proteins such as Spidroin major 1 domain, Spidroin major 2 domain or Spidroin minor 1 domain and the profile of variation between the repeating units without modifying their three-dimensional conformation, wherein these silk protein-like multiblock peptides comprise a repeating unit of amino acids corresponding to one of the sequences (I), (II), (III) and/or (IV) below.

[(XGG)_{w}(XGA)(GXG)ₓ(AGA)_{y}(G)_{z}AG]ₚ Formula (I) in which: X corresponds to tyrosine or to glutamine, w is an integer equal to 2 or 3, x is an integer from 1 to 3, y is an integer from 5 to 7, z is an integer equal to 1 or 2, and p is an integer and having any weight average molecular weight described herein, and/or

[(GPG₂YGPGQ₂)ₐ(X′)₂S(A)_{b}]ₚ Formula (II) in which: X′ corresponds to the amino acid sequence GPS or GPG, a is equal to 2 or 3, b is an integer from 7 to 10, and p is an integer and having any weight average molecular weight described herein, and/or

[(GR)(GA)ₗ(A)ₘ(GGX)ₙ(GA)ₗ(A)ₘ]ₚ Formula (III) and/or [(GGX)ₙ(GA)ₘ(A)₁]ₚ Formula (IV) in which: X″ corresponds to tyrosine, glutamine or alanine, 1 is an integer from 1 to 6, m is an integer from 0 to 4, n is an integer from 1 to 4, and p is an integer.

In some embodiments, the recombinant spider silk protein or an analog of a spider silk protein comprising an amino acid repeating unit of sequence (V):

[(Xaa Gly Gly)_{w}(Xaa Gly Ala)(Gly Xaa Gly)ₓ(Ala Gly Ala)_{y}(Gly)_{z}Ala Gly]ₚ Formula (V), wherein Xaa is tyrosine or glutamine, w is an integer equal to 2 or 3, x is an integer from 1 to 3, y is an integer from 5 to 7, z is an integer equal to 1 or 2, and p is an integer.

In some embodiments, the recombinant spider silk protein in this disclosure is selected from the group consisting of ADF-3 or variants thereof, ADF-4 or variants thereof, MaSpI (SEQ ID NO: 43) or variants thereof, MaSpII (SEQ ID NO: 44) or variants thereof as described in U.S. Pat. No. 8,367,803.

In some embodiments, this disclosure provides water soluble recombinant spider silk proteins produced in mammalian cells. The solubility of the spider silk proteins produced in mammalian cells was attributed to the presence of the COOH-terminus in these proteins, which makes them more hydrophilic. These COOH-terminal amino acids are absent in spider silk proteins expressed in microbial hosts.

In some embodiments, the recombinant spider silk protein in this disclosure comprises water soluble recombinant spider silk protein C16 modified with an amino or carboxyl terminal selected from the amino acid sequences consisting of: GCGGGGGG, GKGGGGGG, GCGGSGGGGSGGGG, GKGGGGGGSGGGG, and GCGGGGGGSGGGG. In some embodiments, the recombinant spider silk protein in this disclosure comprises C₁₆NR4, C₃₂NR4, C16, C32, NR4C₁₆NR4, NR4C₃₂NR4, NR3C₁₆NR3, or NR3C₃₂NR3 such that the molecular weight of the protein ranges as described herein.

In some embodiments, the recombinant spider silk protein in this disclosure comprises recombinant spider silk protein having a synthetic repetitive peptide segments and an amino acid sequence adapted from the natural sequence of ADF4 from A. diadematus as described in U.S. Pat. No. 8,877,903. In some embodiments, the RSPF in this disclosure comprises the recombinant spider silk proteins having repeating peptide units derived from natural spider silk proteins such as Spidroin major 1 domain, Spidroin major 2 domain or Spidroin minor 1 domain, wherein the repeating peptide sequence is GSSAAAAAAAASGPGQGQGQGQGQGGRPSDTYG or SAAAAAAAAGPGGGNGGRPSDTYGAPGGGNGGRPSSSYG, as described in U.S. Pat. No. 8,367,803.

In some embodiments, this disclosure provides recombinant spider proteins composed of the GPGGAGPGGYGPGGSGPGGYGPGGSGPGGY repetitive fragment and having a molecular weight as described herein.

As used herein, the term “recombinant silk” refers to recombinant spider and/or silkworm silk protein or fragments thereof. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk). For example, recombinant spider silk protein, as described herein, includes the proteins described in U.S. Patent Application No. 2016/0222174 and U.S. Pat. Nos. 9,051,453, 9,617,315, 9,689,089, 8,173,772, and 8,642,734.

Some organisms make multiple silk fibers with unique sequences, structural elements, and mechanical properties. For example, orb weaving spiders have six unique types of glands that produce different silk polypeptide sequences that are polymerized into fibers tailored to fit an environmental or lifecycle niche. The fibers are named for the gland they originate from and the polypeptides are labeled with the gland abbreviation (e.g. “Ma”) and “Sp” for spidroin (short for spider fibroin). In orb weavers, these types include Major Ampullate (MaSp, also called dragline), Minor Ampullate (MiSp), Flagelliform (Flag), Aciniform (AcSp), Tubuliform (TuSp), and Pyriform (PySp). This combination of polypeptide sequences across fiber types, domains, and variation amongst different genus and species of organisms leads to a vast array of potential properties that can be harnessed by commercial production of the recombinant fibers. To date, the vast majority of the work with recombinant silks has focused on the Major Ampullate Spidroins (MaSp).

Aciniform (AcSp) silks tend to have high toughness, a result of moderately high strength coupled with moderately high extensibility. AcSp silks are characterized by large block (“ensemble repeat”) sizes that often incorporate motifs of poly serine and GPX. Tubuliform (TuSp or Cylindrical) silks tend to have large diameters, with modest strength and high extensibility. TuSp silks are characterized by their poly serine and poly threonine content, and short tracts of poly alanine. Major Ampullate (MaSp) silks tend to have high strength and modest extensibility. MaSp silks can be one of two subtypes: MaSp1 and MaSp2. MaSp1 silks are generally less extensible than MaSp2 silks, and are characterized by poly alanine, GX, and GGX motifs. MaSp2 silks are characterized by poly alanine, GGX, and GPX motifs. Minor Ampullate (MiSp) silks tend to have modest strength and modest extensibility. MiSp silks are characterized by GGX, GA, and poly A motifs, and often contain spacer elements of approximately 100 amino acids. Flagelliform (Flag) silks tend to have very high extensibility and modest strength. Flag silks are usually characterized by GPG, GGX, and short spacer motifs.

Silk polypeptides are characteristically composed of a repeat domain (REP) flanked by non-repetitive regions (e.g., C-terminal and N-terminal domains). In an embodiment, both the C-terminal and N-terminal domains are between 75-350 amino acids in length. The repeat domain exhibits a hierarchical architecture. The repeat domain comprises a series of blocks (also called repeat units). The blocks are repeated, sometimes perfectly and sometimes imperfectly (making up a quasi-repeat domain), throughout the silk repeat domain. The length and composition of blocks varies among different silk types and across different species. Table 1 of U.S. Published Application No. 2016/0222174, the entirety of which is incorporated herein, lists examples of block sequences from selected species and silk types, with further examples presented in Rising, A. et al., Spider silk proteins: recent advances in recombinant production, structure-function relationships and biomedical applications, Cell Mol. Life Sci., 68:2, pg 169-184 (2011); and Gatesy, J. et al., Extreme diversity, conservation, and convergence of spider silk fibroin sequences, Science, 291:5513, pg. 2603-2605 (2001). In some cases, blocks may be arranged in a regular pattern, forming larger macro-repeats that appear multiple times (usually 2-8) in the repeat domain of the silk sequence. Repeated blocks inside a repeat domain or macro-repeat, and repeated macro-repeats within the repeat domain, may be separated by spacing elements.

The construction of certain spider silk block copolymer polypeptides from the blocks and/or macro-repeat domains, according to certain embodiments of the disclosure, is illustrated in U.S. Published Patent Application No. 2016/0222174.

The recombinant block copolymer polypeptides based on spider silk sequences produced by gene expression in a recombinant prokaryotic or eukaryotic system can be purified according to methods known in the art. In a preferred embodiment, a commercially available expression/secretion system can be used, whereby the recombinant polypeptide is expressed and thereafter secreted from the host cell, to be easily purified from the surrounding medium. If expression/secretion vectors are not used, an alternative approach involves purifying the recombinant block copolymer polypeptide from cell lysates (remains of cells following disruption of cellular integrity) derived from prokaryotic or eukaryotic cells in which a polypeptide was expressed. Methods for generation of such cell lysates are known to those of skill in the art. In some embodiments, recombinant block copolymer polypeptides are isolated from cell culture supernatant.

Recombinant block copolymer polypeptide may be purified by affinity separation, such as by immunological interaction with antibodies that bind specifically to the recombinant polypeptide or nickel columns for isolation of recombinant polypeptides tagged with 6-8 histidine residues at their N-terminus or C-terminus Alternative tags may comprise the FLAG epitope or the hemagglutinin epitope. Such methods are commonly used by skilled practitioners.

A solution of such polypeptides (i.e., recombinant silk protein) may then be prepared and used as described herein.

In another embodiment, recombinant silk protein may be prepared according to the methods described in U.S. Pat. No. 8,642,734, the entirety of which is incorporated herein, and used as described herein.

In an embodiment, a recombinant spider silk protein is provided. The spider silk protein typically consists of from 170 to 760 amino acid residues, such as from 170 to 600 amino acid residues, preferably from 280 to 600 amino acid residues, such as from 300 to 400 amino acid residues, more preferably from 340 to 380 amino acid residues. The small size is advantageous because longer spider silk proteins tend to form amorphous aggregates, which require use of harsh solvents for solubilization and polymerization. The recombinant spider silk protein may contain more than 760 residues, in particular in cases where the spider silk protein contains more than two fragments derived from the N-terminal part of a spider silk protein, The spider silk protein comprises an N-terminal fragment consisting of at least one fragment (NT) derived from the corresponding part of a spider silk protein, and a repetitive fragment (REP) derived from the corresponding internal fragment of a spider silk protein. Optionally, the spider silk protein comprises a C-terminal fragment (CT) derived from the corresponding fragment of a spider silk protein. The spider silk protein comprises typically a single fragment (NT) derived from the N-terminal part of a spider silk protein, but in preferred embodiments, the N-terminal fragment include at least two, such as two fragments (NT) derived from the N-terminal part of a spider silk protein. Thus, the spidroin can schematically be represented by the formula NTₘ-REP, and alternatively NTₘ-REP-CT, where m is an integer that is 1 or higher, such as 2 or higher, preferably in the ranges of 1-2, 1-4, 1-6, 2-4 or 2-6. Preferred spidroins can schematically be represented by the formulas NT₂-REP or NT-REP, and alternatively NT₂-REP-CT or NT-REP-CT. The protein fragments are covalently coupled, typically via a peptide bond. In one embodiment, the spider silk protein consists of the NT fragment(s) coupled to the REP fragment, which REP fragment is optionally coupled to the CT fragment.

In one embodiment, the first step of the method of producing polymers of an isolated spider silk protein involves expression of a polynucleic acid molecule which encodes the spider silk protein in a suitable host, such as Escherichia coli. The thus obtained protein is isolated using standard procedures. Optionally, lipopolysaccharides and other pyrogens are actively removed at this stage.

In the second step of the method of producing polymers of an isolated spider silk protein, a solution of the spider silk protein in a liquid medium is provided. By the terms “soluble” and “in solution” is meant that the protein is not visibly aggregated and does not precipitate from the solvent at 60,000×g. The liquid medium can be any suitable medium, such as an aqueous medium, preferably a physiological medium, typically a buffered aqueous medium, such as a 10-50 mM Tris-HCl buffer or phosphate buffer. The liquid medium has a pH of 6.4 or higher and/or an ion composition that prevents polymerization of the spider silk protein. That is, the liquid medium has either a pH of 6.4 or higher or an ion composition that prevents polymerization of the spider silk protein, or both.

Ion compositions that prevent polymerization of the spider silk protein can readily be prepared by the skilled person utilizing the methods disclosed herein. A preferred ion composition that prevents polymerization of the spider silk protein has an ionic strength of more than 300 mM. Specific examples of ion compositions that prevent polymerization of the spider silk protein include above 300 mM NaCl, 100 mM phosphate and combinations of these ions having desired preventive effect on the polymerization of the spider silk protein, e.g. a combination of 10 mM phosphate and 300 mM NaCl.

The presence of an NT fragment improves the stability of the solution and prevents polymer formation under these conditions. This can be advantageous when immediate polymerization may be undesirable, e.g. during protein purification, in preparation of large batches, or when other conditions need to be optimized. It is preferred that the pH of the liquid medium is adjusted to 6.7 or higher, such as 7.0 or higher, or even 8.0 or higher, such as up to 10.5, to achieve high solubility of the spider silk protein. It can also be advantageous that the pH of the liquid medium is adjusted to the range of 6.4-6.8, which provides sufficient solubility of the spider silk protein but facilitates subsequent pH adjustment to 6.3 or lower.

In the third step, the properties of the liquid medium are adjusted to a pH of 6.3 or lower and ion composition that allows polymerization. That is, if the liquid medium wherein the spider silk protein is dissolved has a pH of 6.4 or higher, the pH is decreased to 6.3 or lower. The skilled person is well aware of various ways of achieving this, typically involving addition of a strong or weak acid. If the liquid medium wherein the spider silk protein is dissolved has an ion composition that prevents polymerization, the ion composition is changed so as to allow polymerization. The skilled person is well aware of various ways of achieving this, e.g. dilution, dialysis or gel filtration. If required, this step involves both decreasing the pH of the liquid medium to 6.3 or lower and changing the ion composition so as to allow polymerization. It is preferred that the pH of the liquid medium is adjusted to 6.2 or lower, such as 6.0 or lower. In particular, it may be advantageous from a practical point of view to limit the pH drop from 6.4 or 6.4-6.8 in the preceding step to 6.3 or 6.0-6.3, e.g. 6.2 in this step. In a preferred embodiment, the pH of the liquid medium of this step is 3 or higher, such as 4.2 or higher. The resulting pH range, e.g. 4.2-6.3 promotes rapid polymerization,

In the fourth step, the spider silk protein is allowed to polymerize in the liquid medium having pH of 6.3 or lower and an ion composition that allows polymerization of the spider silk protein. Although the presence of the NT fragment improves solubility of the spider silk protein at a pH of 6.4 or higher and/or an ion composition that prevents polymerization of the spider silk protein, it accelerates polymer formation at a pH of 6.3 or lower when the ion composition allows polymerization of the spider silk protein. The resulting polymers are preferably solid and macroscopic, and they are formed in the liquid medium having a pH of 6.3 or lower and an ion composition that allows polymerization of the spider silk protein. In a preferred embodiment, the pH of the liquid medium of this step is 3 or higher, such as 4.2 or higher. The resulting pH range, e.g. 4.2-6.3 promotes rapid polymerization, Resulting polymer may be provided at the molecular weights described herein and prepared as a solution form that may be used as necessary for article coatings.

Ion compositions that allow polymerization of the spider silk protein can readily be prepared by the skilled person utilizing the methods disclosed herein. A preferred ion composition that allows polymerization of the spider silk protein has an ionic strength of less than 300 mM. Specific examples of ion compositions that allow polymerization of the spider silk protein include 150 mM NaCl, 10 mM phosphate, 20 mM phosphate and combinations of these ions lacking preventive effect on the polymerization of the spider silk protein, e.g. a combination of 10 mM phosphate or 20 mM phosphate and 150 mM NaCl. It is preferred that the ionic strength of this liquid medium is adjusted to the range of 1-250 mM.

Without desiring to be limited to any specific theory, it is envisaged that the NT fragments have oppositely charged poles, and that environmental changes in pH affects the charge balance on the surface of the protein followed by polymerization, whereas salt inhibits the same event.

At neutral pH, the energetic cost of burying the excess negative charge of the acidic pole may be expected to prevent polymerization. However, as the dimer approaches its isoelectric point at lower pH, attractive electrostatic forces will eventually become dominant, explaining the observed salt and pH-dependent polymerization behavior of NT and NT-containing minispidroins. It is proposed that, in some embodiments, pH-induced NT polymerization, and increased efficiency of fiber assembly of NT-minispidroins, are due to surface electrostatic potential changes, and that clustering of acidic residues at one pole of NT shifts its charge balance such that the polymerization transition occurs at pH values of 6.3 or lower.

In a fifth step, the resulting, preferably solid spider silk protein polymers are isolated from said liquid medium. Optionally, this step involves actively removing lipopolysaccharides and other pyrogens from the spidroin polymers.

Without desiring to be limited to any specific theory, it has been observed that formation of spidroin polymers progresses via formation of water-soluble spidroin dimers. The present disclosure thus also provides a method of producing dimers of an isolated spider silk protein, wherein the first two method steps are as described above. The spider silk proteins are present as dimers in a liquid medium at a pH of 6.4 or higher and/or an ion composition that prevents polymerization of said spider silk protein. The third step involves isolating the dimers obtained in the second step, and optionally removal of lipopolysaccharides and other pyrogens. In a preferred embodiment, the spider silk protein polymer of the disclosure consists of polymerized protein dimers. The present disclosure thus provides a novel use of a spider silk protein, preferably those disclosed herein, for producing dimers of the spider silk protein.

According to another aspect, the disclosure provides a polymer of a spider silk protein as disclosed herein. In an embodiment, the polymer of this protein is obtainable by any one of the methods therefor according to the disclosure. Thus, the disclosure provides various uses of recombinant spider silk protein, preferably those disclosed herein, for producing polymers of the spider silk protein as recombinant silk based coatings. According to one embodiment, the present disclosure provides a novel use of a dimer of a spider silk protein, preferably those disclosed herein, for producing polymers of the isolated spider silk protein as recombinant silk based coatings. In these uses, it is preferred that the polymers are produced in a liquid medium having a pH of 6.3 or lower and an ion composition that allows polymerization of said spider silk protein. In an embodiment, the pH of the liquid medium is 3 or higher, such as 4.2 or higher. The resulting pH range, e.g. 4.2-6.3 promotes rapid polymerization,

Using the method(s) of the present disclosure, it is possible to control the polymerization process, and this allows for optimization of parameters for obtaining silk polymers with desirable properties and shapes.

In an embodiment, the recombinant silk proteins described herein, include those described in U.S. Pat. No. 8,642,734, the entirety of which is incorporated by reference.

In another embodiment, the recombinant silk proteins described herein may be prepared according to the methods described in U.S. Pat. No. 9,051,453, the entirety of which is incorporated herein by reference.

An amino acid sequence represented by SEQ ID NO: 1 of U.S. Pat. No. 9,051,453 is identical to an amino acid sequence that is composed of 50 amino acid residues of an amino acid sequence of ADF3 at the C-terminal (NCBI Accession No.: AAC47010, GI: 1263287). An amino acid sequence represented by SEQ ID NO: 2 of U.S. Pat. No. 9,051,453 is identical to an amino acid sequence represented by SEQ ID NO: 1 of U.S. Pat. No. 9,051,453 from which 20 residues have been removed from the C-terminal. An amino acid sequence represented by SEQ ID NO: 3 of U.S. Pat. No. 9,051,453 is identical to an amino acid sequence represented by SEQ ID NO: 1 from which 29 residues have been removed from the C-terminal.

An example of the polypeptide that contains units of the amino acid sequence represented by the formula 1: REP1-REP2 (1) and that has, at a C-terminal, an amino acid sequence represented by any of SEQ ID NOS: 1 to 3 or an amino acid sequence having a homology of 90% or more with the amino acid sequence represented by any of SEQ ID NOS: 1 to 3 of U.S. Pat. No. 9,051,453 is a polypeptide having an amino acid sequence represented by SEQ ID NO: 8 of U.S. Pat. No. 9,051,453. The polypeptide having the amino acid sequence represented by SEQ ID NO: 8 of U.S. Pat. No. 9,051,453 is obtained by the following mutation: in an amino acid sequence of ADF3 (NCBI Accession No.: AAC47010, GI: 1263287) to the N-terminal of which has been added an amino acid sequence (SEQ ID NO: 5 of U.S. Pat. No. 9,051,453) composed of a start codon, His 10 tags and an HRV3C Protease (Human rhinovirus 3C Protease) recognition site, 1^{st} to 13^{th} repetitive regions are about doubled and the translation ends at the 1154th amino acid residue. In the polypeptide having the amino acid sequence represented by SEQ ID NO: 8 of U.S. Pat. No. 9,051,453, the C-terminal sequence is identical to the amino acid sequence represented by SEQ ID NO: 3.

Further, the polypeptide that contains units of the amino acid sequence represented by the formula 1: REP1-REP2 (1) and that has, at a C-terminal, an amino acid sequence represented by any of SEQ ID NOS: 1 to 3 of U.S. Pat. No. 9,051,453 or an amino acid sequence having a homology of 90% or more with the amino acid sequence represented by any of SEQ ID NOS: 1 to 3 of U.S. Pat. No. 9,051,453 may be a protein that has an amino acid sequence represented by SEQ ID NO: 8 of U.S. Pat. No. 9,051,453 in which one or a plurality of amino acids have been substituted, deleted, inserted and/or added and that has a repetitious region composed of a crystal region and an amorphous region.

Further, an example of the polypeptide containing two or more units of the amino acid sequence represented by the formula 1: REP1-REP2 (1) is a recombinant protein derived from ADF4 having an amino acid sequence represented by SEQ ID NO: 15 of U.S. Pat. No. 9,051,453. The amino acid sequence represented by SEQ ID NO: 15 of U.S. Pat. No. 9,051,453 is an amino acid sequence obtained by adding the amino acid sequence (SEQ ID NO: 5 of U.S. Pat. No. 9,051,453) composed of a start codon, His 10 tags and an HRV3C Protease (Human rhinovirus 3C Protease) recognition site, to the N-terminal of a partial amino acid sequence of ADF4 obtained from the NCBI database (NCBI Accession No.: AAC47011, GI: 1263289). Further, the polypeptide containing two or more units of the amino acid sequence represented by the formula 1: REP1-REP2 (1) may be a polypeptide that has an amino acid sequence represented by SEQ ID NO: 15 of U.S. Pat. No. 9,051,453 in which one or a plurality of amino acids have been substituted, deleted, inserted and/or added and that has a repetitious region composed of a crystal region and an amorphous region. Further, an example of the polypeptide containing two or more units of the amino acid sequence represented by the formula 1: REP1-REP2 (1) is a recombinant protein derived from MaSp2 that has an amino acid sequence represented by SEQ ID NO: 17 of U.S. Pat. No. 9,051,453. The amino acid sequence represented by SEQ ID NO: 17 of U.S. Pat. No. 9,051,453 is an amino acid sequence obtained by adding the amino acid sequence (SEQ ID NO: 5 of U.S. Pat. No. 9,051,453) composed of a start codon, His 10 tags and an HRV3C Protease (Human rhinovirus 3C Protease) recognition site, to the N-terminal of a partial sequence of MaSp2 obtained from the NCBI web database (NCBI Accession No.: AAT75313, GI: 50363147). Furthermore, the polypeptide containing two or more units of the amino acid sequence represented by the formula 1: REP1-REP2 (1) may be a polypeptide that has an amino acid sequence represented by SEQ ID NO: 17 of U.S. Pat. No. 9,051,453 in which one or a plurality of amino acids have been substituted, deleted, inserted and/or added and that has a repetitious region composed of a crystal region and an amorphous region.

Examples of the polypeptide derived from flagelliform silk proteins include a polypeptide containing 10 or more units of an amino acid sequence represented by the formula 2: REP3 (2), preferably a polypeptide containing 20 or more units thereof, and more preferably a polypeptide containing 30 or more units thereof. In the case of producing a recombinant protein using a microbe such as Escherichia coli as a host, the molecular weight of the polypeptide derived from flagelliform silk proteins is preferably 500 kDa or less, more preferably 300 kDa or less, and further preferably 200 kDa or less, in terms of productivity.

In the formula (2), the REP 3 indicates an amino acid sequence composed of Gly-Pro-Gly-Gly-X, where X indicates an amino acid selected from the group consisting of Ala, Ser, Tyr and Val.

A major characteristic of the spider silk is that the flagelliform silk does not have a crystal region, but has a repetitious region composed of an amorphous region. Since the major dragline silk and the like have a repetitious region composed of a crystal region and an amorphous region, they are expected to have both high stress and stretchability. Meanwhile, as to the flagelliform silk, although the stress is inferior to that of the major dragline silk, the stretchability is high. The reason for this is considered to be that most of the flagelliform silk is composed of amorphous regions.

An example of the polypeptide containing 10 or more units of the amino acid sequence represented by the formula 2: REP3 (2) is a recombinant protein derived from flagelliform silk proteins having an amino acid sequence represented by SEQ ID NO: 19 of U.S. Pat. No. 9,051,453. The amino acid sequence represented by SEQ ID NO: 19 of U.S. Pat. No. 9,051,453 is an amino acid sequence obtained by combining a partial sequence of flagelliform silk protein of Nephila clavipes obtained from the NCBI database (NCBI Accession No.: AAF36090, GI: 7106224), specifically, an amino acid sequence thereof from the 1220th residue to the 1659th residue from the N-terminal that corresponds to repetitive sections and motifs (referred to as a PR1 sequence), with a partial sequence of flagelliform silk protein of Nephila clavipes obtained from the NCBI database (NCBI Accession No.: AAC38847, GI: 2833649), specifically, a C-terminal amino acid sequence thereof from the 816th residue to the 907^{th} residue from the C-terminal, and thereafter adding the amino acid sequence (SEQ ID NO: 5 of U.S. Pat. No. 9,051,453) composed of a start codon, His 10 tags and an HRV3C Protease recognition site, to the N-terminal of the combined sequence. Further, the polypeptide containing 10 or more units of the amino acid sequence represented by the formula 2: REP3 (2) may be a polypeptide that has an amino acid sequence represented by SEQ ID NO: 19 of U.S. Pat. No. 9,051,453 in which one or a plurality of amino acids have been substituted, deleted, inserted and/or added and that has a repetitious region composed of an amorphous region.

The polypeptide can be produced using a host that has been transformed by an expression vector containing a gene encoding a polypeptide. A method for producing a gene is not limited particularly, and it may be produced by amplifying a gene encoding a natural spider silk protein from a cell derived from spiders by a polymerase chain reaction (PCR), etc., and cloning it, or may be synthesized chemically. Also, a method for chemically synthesizing a gene is not limited particularly, and it can be synthesized as follows, for example: based on information of amino acid sequences of natural spider silk proteins obtained from the NCBI web database, etc., oligonucleotides that have been synthesized automatically with AKTA oligopilot plus 10/100 (GE Healthcare Japan Corporation) are linked by PCR, etc. At this time, in order to facilitate the purification and observation of protein, it is possible to synthesize a gene that encodes a protein having an amino acid sequence of the above-described amino acid sequence to the N-terminal of which has been added an amino acid sequence composed of a start codon and His 10 tags.

Examples of the expression vector include a plasmid, a phage, a virus, and the like that can express protein based on a DNA sequence. The plasmid-type expression vector is not limited particularly as long as it allows a target gene to be expressed in a host cell and it can amplify itself. For example, in the case of using Escherichia coli Rosetta (DE3) as a host, a pET22b(+) plasmid vector, a pCold plasmid vector, and the like can be used. Among these, in terms of productivity of protein, it is preferable to use the pET22b(+) plasmid vector. Examples of the host include animal cells, plant cells, microbes, etc.

The polypeptide used in the present disclosure is preferably a polypeptide derived from ADF3, which is one of two principal dragline silk proteins of Araneus diadematus. This polypeptide has advantages of basically having high strength-elongation and toughness and of being synthesized easily.

Accordingly, the recombinant silk protein (e.g., the recombinant spider silk-based protein) used in accordance with the embodiments, articles, and/or methods described herein, may include one or more recombinant silk proteins described above or recited in U.S. Pat. Nos. 8,173,772, 8,278,416, 8,618,255, 8,642,734, 8,691,581, 8,729,235, 9,115,204, 9,157,070, 9,309,299, 9,644,012, 9,708,376, 9,051,453, 9,617,315, 9,968,682, 9,689,089, 9,732,125, 9,856,308, 9,926,348, 10,065,997, 10,316,069, and 10,329,332; and U.S. Patent Publication Nos. 2009/0226969, 2011/0281273, 2012/0041177, 2013/0065278, 2013/0115698, 2013/0316376, 2014/0058066, 2014/0079674, 2014/0245923, 2015/0087046, 2015/0119554, 2015/0141618, 2015/0291673, 2015/0291674, 2015/0239587, 2015/0344542, 2015/0361144, 2015/0374833, 2015/0376247, 2016/0024464, 2017/0066804, 2017/0066805, 2015/0293076, 2016/0222174, 2017/0283474, 2017/0088675, 2019/0135880, 2015/0329587, 2019/0040109, 2019/0135881, 2019/0177363, 2019/0225646, 2019/0233481, 2019/0031842, 2018/0355120, 2019/0186050, 2019/0002644, 2020/0031887, 2018/0273590, 20191/094403, 2019/0031843, 2018/0251501, 2017/0066805, 2018/0127553, 2019/0329526, 2020/0031886, 2018/0080147, 2019/0352349, 2020/0043085, 2019/0144819, 2019/0228449, 2019/0340666, 2020/0000091, 2019/0194710, 2019/0151505, 2018/0265555, 2019/0352330, 2019/0248847, and 2019/0378191, the entirety of which are incorporated herein by reference.

Silk Fibroin-Like Protein Fragments

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences. As used herein, “silk fibroin-like protein fragments” refer to protein fragments having a molecular weight and polydispersity as defined herein, and a certain degree of homology to a protein selected from native silk protein, fibroin heavy chain, fibroin light chain, or any protein comprising one or more GAGAGS hexa amino acid repeating units. In some embodiments, a degree of homology is selected from about 99%, about 98%, about 97%, about 96%, about 95%, about 94%, about 93%, about 92%, about 91%, about 90%, about 89%, about 88%, about 87%, about 86%, about 85%, about 84%, about 83%, about 82%, about 81%, about 80%, about 79%, about 78%, about 77%, about 76%, about 75%, or less than 75%.

As described herein, a protein such as native silk protein, fibroin heavy chain, fibroin light chain, or any protein comprising one or more GAGAGS hexa amino acid repeating units includes between about 9% and about 45% glycine, or about 9% glycine, or about 10% glycine, about 43% glycine, about 44% glycine, about 45% glycine, or about 46% glycine. As described herein, a protein such as native silk protein, fibroin heavy chain, fibroin light chain, or any protein comprising one or more GAGAGS hexa amino acid repeating units includes between about 13% and about 30% alanine, or about 13% alanine, or about 28% alanine, or about 29% alanine, or about 30% alanine, or about 31% alanine. As described herein, a protein such as native silk protein, fibroin heavy chain, fibroin light chain, or any protein comprising one or more GAGAGS hexa amino acid repeating units includes between 9% and about 12% serine, or about 9% serine, or about 10% serine, or about 11% serine, or about 12% serine.

In some embodiments, a silk fibroin-like protein described herein includes about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, or about 55% glycine. In some embodiments, a silk fibroin-like protein described herein includes about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, or about 39% alanine. In some embodiments, a silk fibroin-like protein described herein includes about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, or about 22% serine. In some embodiments, a silk fibroin-like protein described herein may include independently any amino acid known to be included in natural fibroin. In some embodiments, a silk fibroin-like protein described herein may exclude independently any amino acid known to be included in natural fibroin. In some embodiments, on average 2 out of 6 amino acids, 3 out of 6 amino acids, or 4 out of 6 amino acids in a silk fibroin-like protein described herein is glycine. In some embodiments, on average 1 out of 6 amino acids, 2 out of 6 amino acids, or 3 out of 6 amino acids in a silk fibroin-like protein described herein is alanine. In some embodiments, on average none out of 6 amino acids, 1 out of 6 amino acids, or 2 out of 6 amino acids in a silk fibroin-like protein described herein is serine.

Sericin or Sericin Fragments

The main body of the raw silk is silk fibroin fiber, and the silk fibroin fiber is coated with an adhesive substance silk sericin. Sericin is a colloidal silk protein that covers the surface of the silk thread and is composed of bulky amino acids rich in chemical reactivity such as serine, threonine, and aspartic acid, in addition to glycine and alanine. In the various processes of producing silk from raw silk, sericin is important in controlling the solubility of silk and producing high quality silk. Moreover, it plays an extremely important role as an adhesion functional protein. When silk fiber is used as a clothing material, most of the silk sericin covering the silk thread is removed and discarded, so sericin is a valuable unused resource.

In some embodiments, the silk protein fragments described herein include sericin or sericin fragments. Methods of preparing sericin or sericin fragments and their applications in various fields are known and are described herein, and are also described, for example, in U.S. Pat. Nos. 7,115,388, 7,157,273, and 9,187,538, all of which are incorporated by reference herein in their entireties.

In some embodiments, sericin removed from the raw silk cocoons, such as in a degumming step, can be collected and used in the methods described herein. Sericin can also be reconstituted from a powder, and used within the compositions and methods of the disclosure.

Other Properties of SPF

Compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In an embodiment, the stability of a composition of the present disclosure is about 1 day. In an embodiment, the stability of a composition of the present disclosure is about 2 days. In an embodiment, the stability of a composition of the present disclosure is about 3 days. In an embodiment, the stability of a composition of the present disclosure is about 4 days. In an embodiment, the stability of a composition of the present disclosure is about 5 days. In an embodiment, the stability of a composition of the present disclosure is about 6 days. In an embodiment, the stability of a composition of the present disclosure is about 7 days. In an embodiment, the stability of a composition of the present disclosure is about 8 days. In an embodiment, the stability of a composition of the present disclosure is about 9 days. In an embodiment, the stability of a composition of the present disclosure is about 10 days.

In an embodiment, the stability of a composition of the present disclosure is about 11 days, about 12 days, about 13 days, about 14 days, about 15 days, about 16 days, about 17 days, about 18 days, about 19 days, about 20 days, about 21 days, about 22 days, about 23 days, about 24 days, about 25 days, about 26 days, about 27 days, about 28 days, about 29 days, or about 30 days.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a SPF composition of the present disclosure is not soluble in an aqueous solution due to the crystallinity of the protein. In an embodiment, a SPF composition of the present disclosure is soluble in an aqueous solution. In an embodiment, the SPF of a composition of the present disclosure include a crystalline portion of about two-thirds and an amorphous region of about one-third. In an embodiment, the SPF of a composition of the present disclosure include a crystalline portion of about one-half and an amorphous region of about one-half. In an embodiment, the SPF of a composition of the present disclosure include a 99% crystalline portion and a 1% amorphous region. In an embodiment, the SPF of a composition of the present disclosure include a 95% crystalline portion and a 5% amorphous region. In an embodiment, the SPF of a composition of the present disclosure include a 90% crystalline portion and a 10% amorphous region. In an embodiment, the SPF of a composition of the present disclosure include a 85% crystalline portion and a 15% amorphous region. In an embodiment, the SPF of a composition of the present disclosure include a 80% crystalline portion and a 20% amorphous region. In an embodiment, the SPF of a composition of the present disclosure include a 75% crystalline portion and a 25% amorphous region. In an embodiment, the SPF of a composition of the present disclosure include a 70% crystalline portion and a 30% amorphous region. In an embodiment, the SPF of a composition of the present disclosure include a 65% crystalline portion and a 35% amorphous region. In an embodiment, the SPF of a composition of the present disclosure include a 60% crystalline portion and a 40% amorphous region. In an embodiment, the SPF of a composition of the present disclosure include a 50% crystalline portion and a 50% amorphous region. In an embodiment, the SPF of a composition of the present disclosure include a 40% crystalline portion and a 60% amorphous region. In an embodiment, the SPF of a composition of the present disclosure include a 35% crystalline portion and a 65% amorphous region. In an embodiment, the SPF of a composition of the present disclosure include a 30% crystalline portion and a 70% amorphous region. In an embodiment, the SPF of a composition of the present disclosure include a 25% crystalline portion and a 75% amorphous region. In an embodiment, the SPF of a composition of the present disclosure include a 20% crystalline portion and a 80% amorphous region. In an embodiment, the SPF of a composition of the present disclosure include a 15% crystalline portion and a 85% amorphous region. In an embodiment, the SPF of a composition of the present disclosure include a 10% crystalline portion and a 90% amorphous region. In an embodiment, the SPF of a composition of the present disclosure include a 5% crystalline portion and a 90% amorphous region. In an embodiment, the SPF of a composition of the present disclosure include a 1% crystalline portion and a 99% amorphous region.

As used herein, the term “substantially free of inorganic residuals” means that the composition exhibits residuals of 0.1% (w/w) or less. In an embodiment, substantially free of inorganic residuals refers to a composition that exhibits residuals of 0.05% (w/w) or less. In an embodiment, substantially free of inorganic residuals refers to a composition that exhibits residuals of 0.01% (w/w) or less. In an embodiment, the amount of inorganic residuals is between 0 ppm (“non-detectable” or “ND”) and 1000 ppm. In an embodiment, the amount of inorganic residuals is ND to about 500 ppm. In an embodiment, the amount of inorganic residuals is ND to about 400 ppm. In an embodiment, the amount of inorganic residuals is ND to about 300 ppm. In an embodiment, the amount of inorganic residuals is ND to about 200 ppm. In an embodiment, the amount of inorganic residuals is ND to about 100 ppm. In an embodiment, the amount of inorganic residuals is between 10 ppm and 1000 ppm.

As used herein, the term “substantially free of organic residuals” means that the composition exhibits residuals of 0.1% (w/w) or less, in an embodiment, substantially free of organic residuals refers to a composition that exhibits residuals of 0.05% (w/w) or less. In an embodiment, substantially free of organic residuals refers to a composition that exhibits residuals of 0.01% (w/w) or less. In an embodiment, the amount of organic residuals is between 0 ppm (“non-detectable” or “ND”) and 1000 ppm. In an embodiment, the amount of organic residuals is ND to about 500 ppm. In an embodiment, the amount of organic residuals is ND to about 400 ppm. In an embodiment, the amount of organic residuals is ND to about 300 ppm. In an embodiment, the amount of organic residuals is ND to about 200 ppm. In an embodiment, the amount of organic residuals is ND to about 100 ppm. In an embodiment, the amount of organic residuals is between 10 ppm and 1000 ppm.

Compositions of the present disclosure exhibit “biocompatibility” meaning that the compositions are compatible with living tissue or a living system by not being toxic, injurious, or physiologically reactive and not causing immunological rejection. Such biocompatibility can be evidenced by participants topically applying compositions of the present disclosure on their skin for an extended period of time. In an embodiment, the extended period of time is about 3 days. In an embodiment, the extended period of time is about 7 days, in an embodiment, the extended period of time is about 14 days, in an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

Following are non-limiting examples of suitable ranges for various parameters in and for preparation of the silk solutions of the present disclosure. The silk solutions of the present disclosure may include one or more, but not necessarily all, of these parameters and may be prepared using various combinations of ranges of such parameters.

In an embodiment, the percent SPF in the solution is less than 30.0 wt. %. In an embodiment, the percent SPF in the solution is less than 25.0 wt. %. In an embodiment, the percent SPF in the solution is less than 20.0 wt. %. In an embodiment, the percent SPF in the solution is less than 19.0 wt. %. In an embodiment, the percent SPF in the solution is less than 18.0 wt. %. In an embodiment, the percent SPF in the solution is less than 17.0 wt. %. In an embodiment, the percent SPF in the solution is less than 16.0 wt. %. In an embodiment, the percent SPF in the solution is less than 15.0 wt. %. In an embodiment, the percent SPF in the solution is less than 14.0 wt. %. In an embodiment, the percent SPF in the solution is less than 13.0 wt. %. In an embodiment, the percent SPF in the solution is less than 12.0 wt. %. In an embodiment, the percent SPF in the solution is less than 11.0 wt. %. In an embodiment, the percent SPF in the solution is less than 10.0 wt. %. In an embodiment, the percent SPF in the solution is less than 9.0 wt. %. In an embodiment, the percent SPF in the solution is less than 8.0 wt. %. In an embodiment, the percent SPF in the solution is less than 7.0 wt. %. In an embodiment, the percent SPF in the solution is less than 6.0 wt. %. In an embodiment, the percent SPF in the solution is less than 5.0 wt. %. In an embodiment, the percent SPF in the solution is less than 4.0 wt. %. In an embodiment, the percent SPF in the solution is less than 3.0 wt. %. In an embodiment, the percent SPF in the solution is less than 2.0 wt. %. In an embodiment, the percent SPF in the solution is less than 1.0 wt. %. In an embodiment, the percent SPF in the solution is less than 0.9 wt. %. In an embodiment, the percent SPF in the solution is less than 0.8 wt. %. In an embodiment, the percent SPF in the solution is less than 0.7 wt. %. In an embodiment, the percent SPF in the solution is less than 0.6 wt. %. In an embodiment, the percent SPF in the solution is less than 0.5 wt. %. In an embodiment, the percent SPF in the solution is less than 0.4 wt. %. In an embodiment, the percent SPF in the solution is less than 0.3 wt. %. In an embodiment, the percent SPF in the solution is less than 0.2 wt. %. In an embodiment, the percent SPF in the solution is less than 0.1 wt. %.

In an embodiment, the percent SPF in the solution is greater than 0.1 wt. %. In an embodiment, the percent SPF in the solution is greater than 0.2 wt. %. In an embodiment, the percent SPF in the solution is greater than 0.3 wt. %. In an embodiment, the percent SPF in the solution is greater than 0.4 wt. %. In an embodiment, the percent SPF in the solution is greater than 0.5 wt. %. In an embodiment, the percent SPF in the solution is greater than 0.6 wt. %. In an embodiment, the percent SPF in the solution is greater than 0.7 wt. %. In an embodiment, the percent SPF in the solution is greater than 0.8 wt. %. In an embodiment, the percent SPF in the solution is greater than 0.9 wt. %. In an embodiment, the percent SPF in the solution is greater than 1.0 wt. %. In an embodiment, the percent SPF in the solution is greater than 2.0 wt. %. In an embodiment, the percent SPF in the solution is greater than 3.0 wt. %. In an embodiment, the percent SPF in the solution is greater than 4.0 wt. %. In an embodiment, the percent SPF in the solution is greater than 5.0 wt. %. In an embodiment, the percent SPF in the solution is greater than 6.0 wt. %. In an embodiment, the percent SPF in the solution is greater than 7.0 wt. %. In an embodiment, the percent SPF in the solution is greater than 8.0 wt. %. In an embodiment, the percent SPF in the solution is greater than 9.0 wt. %. In an embodiment, the percent SPF in the solution is greater than 10.0 wt. %. In an embodiment, the percent SPF in the solution is greater than 11.0 wt. %. In an embodiment, the percent SPF in the solution is greater than 12.0 wt. %. In an embodiment, the percent SPF in the solution is greater than 13.0 wt. %. In an embodiment, the percent SPF in the solution is greater than 14.0 wt. %. In an embodiment, the percent SPF in the solution is greater than 15.0 wt. %. In an embodiment, the percent SPF in the solution is greater than 16.0 wt. %. In an embodiment, the percent SPF in the solution is greater than 17.0 wt. %. In an embodiment, the percent SPF in the solution is greater than 18.0 wt. %. In an embodiment, the percent SPF in the solution is greater than 19.0 wt. %. In an embodiment, the percent SPF in the solution is greater than 20.0 wt. %. In an embodiment, the percent SPF in the solution is greater than 25.0 wt. %.

In an embodiment, the percent SPF in the solution ranges from about 0.1 wt. % to about 30.0 wt. %. In an embodiment, the percent SPF in the solution ranges from about 0.1 wt. % to about 25.0 wt. %. In an embodiment, the percent SPF in the solution ranges from about 0.1 wt. % to about 20.0 wt. %. In an embodiment, the percent SPF in the solution ranges from about 0.1 wt. % to about 15.0 wt. %. In an embodiment, the percent SPF in the solution ranges from about 0.1 wt. % to about 10.0 wt. %. In an embodiment, the percent SPF in the solution ranges from about 0.1 wt. % to about 9.0 wt. %. In an embodiment, the percent SPF in the solution ranges from about 0.1 wt. % to about 8.0 wt. %. In an embodiment, the percent SPF in the solution ranges from about 0.1 wt. % to about 7.0 wt. %. In an embodiment, the percent SPF in the solution ranges from about 0.1 wt. % to about 6.5 wt. %. In an embodiment, the percent SPF in the solution ranges from about 0.1 wt. % to about 6.0 wt. %. In an embodiment, the percent SPF in the solution ranges from about 0.1 wt. % to about 5.5 wt. %. In an embodiment, the percent SPF in the solution ranges from about 0.1 wt. % to about 5.0 wt. %. In an embodiment, the percent SPF in the solution ranges from about 0.1 wt. % to about 4.5 wt. %. In an embodiment, the percent SPF in the solution ranges from about 0.1 wt. % to about 4.0 wt. %. In an embodiment, the percent SPF in the solution ranges from about 0.1 wt. % to about 3.5 wt. %. In an embodiment, the percent SPF in the solution ranges from about 0.1 wt. % to about 3.0 wt. %. In an embodiment, the percent SPF in the solution ranges from about 0.1 wt. % to about 2.5 wt. %. In an embodiment, the percent SPF in the solution ranges from about 0.1 wt. % to about 2.0 wt. %. In an embodiment, the percent SPF in the solution ranges from about 0.1 wt. % to about 2.4 wt. %. In an embodiment, the percent SPF in the solution ranges from about 0.5 wt. % to about 5.0 wt. %. In an embodiment, the percent SPF in the solution ranges from about 0.5 wt. % to about 4.5 wt. %. In an embodiment, the percent SPF in the solution ranges from about 0.5 wt. % to about 4.0 wt. %. In an embodiment, the percent SPF in the solution ranges from about 0.5 wt. % to about 3.5 wt. %. In an embodiment, the percent SPF in the solution ranges from about 0.5 wt. % to about 3.0 wt. %. In an embodiment, the percent SPF in the solution ranges from about 0.5 wt. % to about 2.5 wt. %. In an embodiment, the percent SPF in the solution ranges from about 1.0 wt. % to about 4.0 wt. %. In an embodiment, the percent SPF in the solution ranges from about 1.0 wt. % to about 3.5 wt. %. In an embodiment, the percent SPF in the solution ranges from about 1.0 wt. % to about 3.0 wt. %. In an embodiment, the percent SPF in the solution ranges from about 1.0 wt. % to about 2.5 wt. %. In an embodiment, the percent SPF in the solution ranges from about 1.0 wt. % to about 2.4 wt. %. In an embodiment, the percent SPF in the solution ranges from about 1.0 wt. % to about 2.0 wt. %.

In an embodiment, the percent SPF in the solution ranges from about 20.0 wt. % to about 30.0 wt. %. In an embodiment, the percent SPF in the solution ranges from about 0.1 wt. % to about 10.0 wt. %. In an embodiment, the percent SPF in the solution ranges from about 1.0 wt. % to about 10.0 wt. %. In an embodiment, the percent SPF in the solution ranges from about 2 wt. % to about 10.0 wt. %. In an embodiment, the percent SPF in the solution ranges from about 0.1 wt. % to about 6.0 wt. %. In an embodiment, the percent SPF in the solution ranges from about 6.0 wt. % to about 10.0 wt. %. In an embodiment, the percent SPF in the solution ranges from about 6.0 wt. % to about 8.0 wt. %. In an embodiment, the percent SPF in the solution ranges from about 6.0 wt. % to about 9.0 wt. %. In an embodiment, the percent SPF in the solution ranges from about 10.0 wt. % to about 20.0 wt. %. In an embodiment, the percent SPF in the solution ranges from about 11.0 wt. % to about 19.0 wt. %. In an embodiment, the percent SPF in the solution ranges from about 12.0 wt. % to about 18.0 wt. %. In an embodiment, the percent SPF in the solution ranges from about 13.0 wt. % to about 17.0 wt. %. In an embodiment, the percent SPF in the solution ranges from about 14.0 wt. % to about 16.0 wt. %. In an embodiment, the percent SPF in the solution is about 1.0 wt. %. In an embodiment, the percent SPF in the solution is about 1.5 wt. %. In an embodiment, the percent SPF in the solution is about 2.0 wt. %. In an embodiment, the percent SPF in the solution is about 2.4 wt. %. In an embodiment, the percent SPF in the solution is 3.0 wt. %. In an embodiment, the percent SPF in the solution is 3.5 wt. %. In an embodiment, the percent SPF in the solution is about 4.0 wt. %. In an embodiment, the percent SPF in the solution is about 4.5 wt. %. In an embodiment, the percent SPF in the solution is about 5.0 wt. %. In an embodiment, the percent SPF in the solution is about 5.5 wt. %. In an embodiment the percent SPF in the solution is about 6.0 wt. %. In an embodiment, the percent SPF in the solution is about 6.5 wt. %. In an embodiment, the percent SPF in the solution is about 7.0 wt. %. In an embodiment, the percent SPF in the solution is about 7.5 wt. %. In an embodiment, the percent SPF in the solution is about 8.0 wt. %. In an embodiment, the percent SPF in the solution is about 8.5 wt. %. In an embodiment, the percent SPF in the solution is about 9.0 wt. %. In an embodiment, the percent SPF in the solution is about 9.5 wt. %. In an embodiment, the percent SPF in the solution is about 10.0 wt. %.

In an embodiment, the percent sericin in the solution is non-detectable to 25.0 wt. %. In an embodiment, the percent sericin in the solution is non-detectable to 5.0 wt. %. In an embodiment, the percent sericin in the solution is 1.0 wt. %. In an embodiment, the percent sericin in the solution is 2.0 wt. %. In an embodiment, the percent sericin in the solution is 3.0 wt. %. In an embodiment, the percent sericin in the solution is 4.0 wt. %. In an embodiment, the percent sericin in the solution is 5.0 wt. %. In an embodiment, the percent sericin in the solution is 10.0 wt. %. In an embodiment, the percent sericin in the solution is 25.0 wt. %.

In some embodiments, the silk fibroin protein fragments of the present disclosure are shelf stable (they will not slowly or spontaneously gel when stored in an aqueous solution and there is no aggregation of fragments and therefore no increase in molecular weight over time), from 10 days to 3 years depending on storage conditions, percent SPF, and number of shipments and shipment conditions. Additionally, pH may be altered to extend shelf life and/or support shipping conditions by preventing premature folding and aggregation of the silk. In an embodiment, the stability of the LiBr-silk fragment solution is 0 to 1 year. In an embodiment, the stability of the LiBr-silk fragment solution is 0 to 2 years. In an embodiment, the stability of the LiBr-silk fragment solution is 0 to 3 years. In an embodiment, the stability of the LiBr-silk fragment solution is 0 to 4 years. In an embodiment, the stability of the LiBr-silk fragment solution is 0 to 5 years. In an embodiment, the stability of the LiBr-silk fragment solution is 1 to 2 years. In an embodiment, the stability of the LiBr-silk fragment solution is 1 to 3 years. In an embodiment, the stability of the LiBr-silk fragment solution is 1 to 4 years. In an embodiment, the stability of the LiBr-silk fragment solution is 1 to 5 years. In an embodiment, the stability of the LiBr-silk fragment solution is 2 to 3 years. In an embodiment, the stability of the LiBr-silk fragment solution is 2 to 4 years. In an embodiment, the stability of the LiBr-silk fragment solution is 2 to 5 years. In an embodiment, the stability of the LiBr-silk fragment solution is 3 to 4 years. In an embodiment, the stability of the LiBr-silk fragment solution is 3 to 5 years. In an embodiment, the stability of the LiBr-silk fragment solution is 4 to 5 years.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a composition of the present disclosure having SPF has non-detectable levels of LiBr residuals. In an embodiment, the amount of the LiBr residuals in a composition of the present disclosure is between 10 ppm and 1000 ppm. In an embodiment, the amount of the LiBr residuals in a composition of the present disclosure is between 10 ppm and 300 ppm. In an embodiment, the amount of the LiBr residuals in a composition of the present disclosure is less than 25 ppm. In an embodiment, the amount of the Li Br residuals in a composition of the present disclosure is less than 50 ppm. In an embodiment, the amount of the LiBr residuals in a composition of the present disclosure is less than 75 ppm. In an embodiment, the amount of the LiBr residuals in a composition of the present disclosure is less than 100 ppm. In an embodiment, the amount of the LiBr residuals in a composition of the present disclosure is less than 200 ppm. In an embodiment, the amount of the LiBr residuals in a composition of the present disclosure is less than 300 ppm. In an embodiment, the amount of the LiBr residuals in a composition of the present disclosure is less than 400 ppm. In an embodiment, the amount of the LiBr residuals in a composition of the present disclosure is less than 500 ppm. In an embodiment, the amount of the LiBr residuals in a composition of the present disclosure is less than 600 ppm. In an embodiment, the amount of the LiBr residuals in a composition of the present disclosure is less than 700 ppm. In an embodiment, the amount of the LiBr residuals in a composition of the present disclosure is less than 800 ppm. In an embodiment, the amount of the LiBr residuals in a composition of the present disclosure is less than 900 ppm. In an embodiment, the amount of the LiBr residuals in a composition of the present disclosure is less than 1000 ppm. In an embodiment, the amount of the LiBr residuals in a composition of the present disclosure is non-detectable to 500 ppm. In an embodiment, the amount of the LiBr residuals in a composition of the present disclosure is non-detectable to 450 ppm. In an embodiment, the amount of the LiBr residue in a composition of the present disclosure is non-detectable to 400 ppm. In an embodiment, the amount of the LiBr residuals in a composition of the present disclosure is non-detectable to 350 ppm. In an embodiment, the amount of the LiBr residuals in a composition of the present disclosure is non-detectable to 300 ppm. In an embodiment, the amount of the LiBr residuals in a composition of the present disclosure is non-detectable to 250 ppm. In an embodiment, the amount of the LiBr residuals in a composition of the present disclosure is non-detectable to 200 ppm. In an embodiment, the amount of the LiBr residuals in a composition of the present disclosure is non-detectable to 150 ppm. In an embodiment, the amount of the LiBr residuals in a composition of the present disclosure is non-detectable to 100 ppm. In an embodiment, the amount of the LiBr residuals in a composition of the present disclosure is 100 ppm to 200 ppm. In an embodiment, the amount of the LiBr residuals in a composition of the present disclosure is 200 ppm to 300 ppm. In an embodiment, the amount of the LiBr residuals in a composition of the present disclosure is 300 ppm to 400 ppm. In an embodiment, the amount of the LiBr residuals in a composition of the present disclosure is 400 ppm to 500 ppm.

In an embodiment, a composition of the present disclosure having SPF, has non-detectable levels of Na₂CO₃ residuals. In an embodiment, the amount of the Na₂CO₃ residuals in a composition of the present disclosure is less than 100 ppm. In an embodiment, the amount of the Na₂CO₃ residuals in a composition of the present disclosure is less than 200 ppm. In an embodiment, the amount of the Na₂CO₃ residuals in a composition of the present disclosure is less than 300 ppm. In an embodiment, the amount of the Na₂CO₃ residuals in a composition of the present disclosure is less than 400 ppm. In an embodiment, the amount of the Na₂CO₃ residuals in a composition of the present disclosure is less than 500 ppm. In an embodiment, the amount of the Na₂CO₃ residuals in a composition of the present disclosure is less than 600 ppm. In an embodiment, the amount of the Na₂CO₃ residuals in a composition of the present disclosure is less than 700 ppm. In an embodiment, the amount of the Na₂CO₃ residuals in a composition of the present disclosure is less than 800 ppm. In an embodiment, the amount of the Na₂CO₃ residuals in a composition of the present disclosure is less than 900 ppm. In an embodiment, the amount of the Na₂CO₃ residuals in a composition of the present disclosure is less than 1000 ppm. In an embodiment, the amount of the Na₂CO₃ residuals in a composition of the present disclosure is non-detectable to 500 ppm. In an embodiment, the amount of the Na₂CO₃ residuals in a composition of the present disclosure is non-detectable to 450 ppm. In an embodiment, the amount of the Na₂CO₃ residuals in a composition of the present disclosure is non-detectable to 400 ppm. In an embodiment, the amount of the Na₂CO₃ residuals in a composition of the present disclosure is non-detectable to 350 ppm. In an embodiment, the amount of the Na₂CO₃ residuals in a composition of the present disclosure is non-detectable to 300 ppm. In an embodiment, the amount of the Na₂CO₃ residuals in a composition of the present disclosure is non-detectable to 250 ppm. In an embodiment, the amount of the Na₂CO₃ residuals in a composition of the present disclosure is non-detectable to 200 ppm. In an embodiment, the amount of the Na₂CO₃ residuals in a composition of the present disclosure is non-detectable to 150 ppm. In an embodiment, the amount of the Na₂CO₃ residuals in a composition of the present disclosure is non-detectable to 100 ppm. In an embodiment, the amount of the Na₂CO₃ residuals in a composition of the present disclosure is 100 ppm to 200 ppm. In an embodiment, the amount of the Na₂CO₃ residuals in a composition of the present disclosure is 200 ppm to 300 ppm. In an embodiment, the amount of the Na₂CO₃ residuals in a composition of the present disclosure is 300 ppm to 400 ppm. In an embodiment, the amount of the Na₂CO₃ residuals in a composition of the present disclosure is 400 ppm to 500 ppm.

A unique feature of the SPF compositions of the present disclosure are shelf stability (they will not slowly or spontaneously gel when stored in an aqueous solution and there is no aggregation of fragments and therefore no increase in molecular weight over time), from 10 days to 3 years depending on storage conditions, percent silk, and number of shipments and shipment conditions. Additionally pH may be altered to extend shelf-life and/or support shipping conditions by preventing premature folding and aggregation of the silk. In an embodiment, a SPF solution composition of the present disclosure has a shelf stability for up to 2 weeks at room temperature (RT). In an embodiment, a SPF solution composition of the present disclosure has a shelf stability for up to 4 weeks at RT. In an embodiment, a SPF solution composition of the present disclosure has a shelf stability for up to 6 weeks at RT. In an embodiment, a SPF solution composition of the present disclosure has a shelf stability for up to 8 weeks at RT. In an embodiment, a SPF solution composition of the present disclosure has a shelf stability for up to 10 weeks at RT. In an embodiment, a SPF solution composition of the present disclosure has a shelf stability for up to 12 weeks at RT. In an embodiment, a SPF solution composition of the present disclosure has a shelf stability ranging from about 4 weeks to about 52 weeks at RT.

Table R below shows shelf stability test results for embodiments of SPF compositions of the present disclosure

TABLE R
Shelf Stability of SPF Compositions of the Present Disclosure

| % Silk | Temperature | Time to Gelation |
|---|---|---|
| 2 | RT | 4 weeks |
| 2 | 4° C. | >9 weeks |
| 4 | RT | 4 weeks |
| 4 | 4° C. | >9 weeks |
| 6 | RT | 2 weeks |
| 6 | 4° C. | >9 weeks |

In some embodiments, the water solubility of the silk film derived from silk fibroin protein fragments as described herein can be modified by solvent annealing (water annealing or methanol annealing), chemical crosslinking, enzyme crosslinking and heat treatment.

In some embodiments, the process of annealing may involve inducing beta-sheet formation in the silk fibroin protein fragment solutions used as a coating material. Techniques of annealing (e.g., increase crystallinity) or otherwise promoting “molecular packing” of silk fibroin-protein based fragments have been described. In some embodiments, the amorphous silk film is annealed to introduce beta-sheet in the presence of a solvent selected from the group of water or organic solvent. In some embodiments, the amorphous silk film is annealed to introduce beta-sheet in the presence of water (water annealing process). In some embodiments, the amorphous silk fibroin protein fragment film is annealed to introduce beta-sheet in the presence of methanol. In some embodiments, annealing (e.g., the beta sheet formation) is induced by addition of an organic solvent. Suitable organic solvents include, but are not limited to methanol, ethanol, acetone, isopropanol, or combination thereof.

In some embodiments, annealing is carried out by so-called “water-annealing” or “water vapor annealing” in which water vapor is used as an intermediate plasticizing agent or catalyst to promote the packing of beta-sheets. In some embodiments, the process of water annealing may be performed under vacuum. Suitable such methods have been described in Jin H-J et al. (2005), Water-stable Silk Films with Reduced Beta-Sheet Content, Advanced Functional Materials, 15: 1241-1247; Xiao H. et al. (2011), Regulation of Silk Material Structure by Temperature-Controlled Water Vapor Annealing, Biomacromolecules, 12(5): 1686-1696.

The important feature of the water annealing process is to drive the formation of crystalline beta-sheet in the silk fibroin protein fragment peptide chain to allow the silk fibroin self-assembling into a continuous film. In some embodiments, the crystallinity of the silk fibroin protein fragment film is controlled by controlling the temperature of water vapor and duration of the annealing. In some embodiments, the annealing is performed at a temperature ranging from about 65° C. to about 110° C. In some embodiments, the temperature of the water is maintained at about 80° C. In some embodiments, annealing is performed at a temperature selected from the group of about 65° C., about 70° C., about 75° C., about 80° C., about 85° C., about 90° C., about 95° C., about 100° C., about 105° C., and about 110° C.

In some embodiments, the annealing process lasts a period of time selected from the group of about 1 minute to about 40 minutes, about 1 minute to about 50 minutes, about 1 minute to about 60 minutes, about 1 minute to about 70 minutes, about 1 minute to about 80 minutes, about 1 minute to about 90 minutes, about 1 minute to about 100 minutes, about 1 minute to about 110 minutes, about 1 minute to about 120 minutes, about 1 minute to about 130 minutes, about 5 minutes to about 40 minutes, about 5 minutes to about 50 minutes, about 5 minutes to about 60 minutes, about 5 minutes to about 70 minutes, about 5 minutes to about 80 minutes, about 5 minutes to about 90 minutes, about 5 minutes to about 100 minutes, about 5 minutes to about 110 minutes, about 5 minutes to about 120 minutes, about 5 minutes to about 130 minutes, about 10 minutes to about 40 minutes, about 10 minutes to about 50 minutes, about 10 minutes to about 60 minutes, about 10 minutes to about 70 minutes, about 10 minutes to about 80 minutes, about 10 minutes to about 90 minutes, about 10 minutes to about 100 minutes, about 10 minutes to about 110 minutes, about 10 minutes to about 120 minutes, about 10 minutes to about 130 minutes, about 15 minutes to about 40 minutes, about 15 minutes to about 50 minutes, about 15 minutes to about 60 minutes, about 15 minutes to about 70 minutes, about 15 minutes to about 80 minutes, about 15 minutes to about 90 minutes, about 15 minutes to about 100 minutes, about 15 minutes to about 110 minutes, about 15 minutes to about 120 minutes, about 15 minutes to about 130 minutes, about 20 minutes to about 40 minutes, about 20 minutes to about 50 minutes, about 20 minutes to about 60 minutes, about 20 minutes to about 70 minutes, about 20 minutes to about 80 minutes, about 20 minutes to about 90 minutes, about 20 minutes to about 100 minutes, about 20 minutes to about 110 minutes, about 20 minutes to about 120 minutes, about 20 minutes to about 130 minutes, about 25 minutes to about 40 minutes, about 25 minutes to about 50 minutes, about 25 minutes to about 60 minutes, about 25 minutes to about 70 minutes, about 25 minutes to about 80 minutes, about 25 minutes to about 90 minutes, about 25 minutes to about 100 minutes, about 25 minutes to about 110 minutes, about 25 minutes to about 120 minutes, about 25 minutes to about 130 minutes, about 30 minutes to about 40 minutes, about 30 minutes to about 50 minutes, about 30 minutes to about 60 minutes, about 30 minutes to about 70 minutes, about 30 minutes to about 80 minutes, about 30 minutes to about 90 minutes, about 30 minutes to about 100 minutes, about 30 minutes to about 110 minutes, about 30 minutes to about 120 minutes, about 30 minutes to about 130 minutes, about 35 minutes to about 40 minutes, about 35 minutes to about 50 minutes, about 35 minutes to about 60 minutes, about 35 minutes to about 70 minutes, about 35 minutes to about 80 minutes, about 35 minutes to about 90 minutes, about 35 minutes to about 100 minutes, about 35 minutes to about 110 minutes, about 35 minutes to about 120 minutes, about 35 minutes to about 130 minutes, about 40 minutes to about 50 minutes, about 40 minutes to about 60 minutes, about 40 minutes to about 70 minutes, about 40 minutes to about 80 minutes, about 40 minutes to about 90 minutes, about 40 minutes to about 100 minutes, about 40 minutes to about 110 minutes, about 40 minutes to about 120 minutes, about 40 minutes to about 130 minutes, about 45 minutes to about 50 minutes, about 45 minutes to about 60 minutes, about 45 minutes to about 70 minutes, about 45 minutes to about 80 minutes, about 45 minutes to about 90 minutes, about 45 minutes to about 100 minutes, about 45 minutes to about 110 minutes, about 45 minutes to about 120 minutes, and about 45 minutes to about 130 minutes. In some embodiments, the annealing process lasts a period of time ranging from about 1 minute to about 60 minutes. In some embodiments, the annealing process lasts a period of time ranging from about 45 minutes to about 60 minutes. The longer water annealing post-processing corresponded an increased crystallinity of silk fibroin protein fragments.

In some embodiments, the annealed silk fibroin protein fragment film is immersing the wet silk fibroin protein fragment film in 100% methanol for 60 minutes at room temperature. The methanol annealing changed the composition of silk fibroin protein fragment film from predominantly amorphous random coil to crystalline antiparallel beta-sheet structure.

### Silk Fibroin-Based Protein Fragments and Solutions Thereof

Provided herein are methods for producing pure and highly scalable silk protein fragment (SPF) mixture solutions that may be used to process and/or coat at least a portion of leather and/or leather articles, or to repair at least one defect in a portion of leather and/or leather article. In some embodiments, SPF mixture solutions may also refer to silk fibroin solutions (SFS), and vice versa. The solutions are generated from raw pure intact silk protein material and processed in order to remove any sericin and achieve the desired average weight average molecular weight (MW) and polydispersity of the fragment mixture. Select method parameters may be altered to achieve distinct final silk protein fragment characteristics depending upon the intended use. The resulting final fragment solution is pure silk protein fragments and water with PPM to non-detectable levels of process contaminants. The concentration, size and polydispersity of silk protein fragments in the solution may further be altered depending upon the desired use and performance requirements. In an embodiment, the pure silk fibroin-based protein fragments in the solution are substantially devoid of sericin, have an average weight average molecular weight ranging from about 6 kDa to about 17 kDa, and have a polydispersity ranging from about 1.5 and about 3.0. In an embodiment, the pure silk fibroin-based protein fragments in the solution are substantially devoid of sericin, have an average weight average molecular weight ranging from about 17 kDa to about 39 kDa, and have a polydispersity ranging from about 1.5 and about 3.0. In an embodiment, the pure silk fibroin-based protein fragments in the solution are substantially devoid of sericin, have an average weight average molecular weight ranging from about 39 kDa to about 80 kDa, and have a polydispersity ranging from about 1.5 and about 3.0. As used herein, the term “silk solution” may refer to solutions of silk proteins, including solutions of silk fibroin-based protein fragments.

Without wishing to be bound by any particular theory, any and all solutions described herein can be further used or processed to obtain a variety of silk and/or SPF compositions, including, but not limited to, silk non-Newtonian fluids, silk materials that can sustain a shear stress network spanning the system, silk solutions containing water or another solvent trapped inside a loose silk polymer network, silk materials that transition from a liquid form via bond percolation transition such as gels, silk immobile network entrapping a mobile solvent, silk materials forming reversible or irreversible crosslinks, silk materials that exhibit a shear modulus, silk elastomers or silk materials exhibiting thermoplastic behavior, silk materials formed by the processes of either glass formation, gelation, or colloidal aggregation, silk crystals, and/or silk crystals polish, glues, gels, pastes, putties, and/or waxes.

As used herein when referring to a number or a numerical range, the term “about” means that the stated number or numerical range is included together with numbers or numerical ranges within experimental variability, or within statistical experimental error from the stated number or numerical range, wherein the variation or error is from 0% to 15%, or from 0% to 10%, or from 0% to 5% of the stated number or numerical range.

As used herein, “silk based proteins or fragments thereof” includes silk fibroin-based proteins or fragments thereof, natural silk based proteins or fragments thereof, recombinant silk based proteins or fragments thereof, and combinations thereof. Natural silk based proteins or fragments thereof include spider silk based proteins or fragments thereof, silkworm silk based proteins or fragments thereof, and combinations thereof. Silkworm based proteins or fragments thereof may include Bombyx mori silk based proteins or fragments thereof. The SPF mixture solutions described herein may include silk based proteins or fragments thereof. Moreover, SFS, as described herein, may be replaced with SPF mixture solutions. The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, and 9,545,369, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein.

As used herein, the terms “substantially sericin free” or “substantially devoid of sericin” refer to silk fibers in which a majority of the sericin protein has been removed. In an embodiment, silk fibroin that is substantially devoid of sericin refers to silk fibroin having between about 0.01% (w/w) and about 10.0% (w/w) sericin. In an embodiment, silk fibroin that is substantially devoid of sericin refers to silk fibroin having between about 0.01% (w/w) and about 9.0% (w/w) sericin. In an embodiment, silk fibroin that is substantially devoid of sericin refers to silk fibroin having between about 0.01% (w/w) and about 8.0% (w/w) sericin. In an embodiment, silk fibroin that is substantially devoid of sericin refers to silk fibroin having between about 0.01% (w/w) and about 7.0% (w/w) sericin. In an embodiment, silk fibroin that is substantially devoid of sericin refers to silk fibroin having between about 0.01% (w/w) and about 6.0% (w/w) sericin. In an embodiment, silk fibroin that is substantially devoid of sericin refers to silk fibroin having between about 0.01% (w/w) and about 5.0% (w/w) sericin. In an embodiment, silk fibroin that is substantially devoid of sericin refers to silk fibroin having between about 0% (w/w) and about 4.0% (w/w) sericin. In an embodiment, silk fibroin that is substantially devoid of sericin refers to silk fibroin having between about 0.05% (w/w) and about 4.0% (w/w) sericin. In an embodiment, silk fibroin that is substantially devoid of sericin refers to silk fibroin having between about 0.1% (w/w) and about 4.0% (w/w) sericin. In an embodiment, silk fibroin that is substantially devoid of sericin refers to silk fibroin having between about 0.5% (w/w) and about 4.0% (w/w) sericin. In an embodiment, silk fibroin that is substantially devoid of sericin refers to silk fibroin having between about 1.0% (w/w) and about 4.0% (w/w) sericin. In an embodiment, silk fibroin that is substantially devoid of sericin refers to silk fibroin having between about 1.5% (w/w) and about 4.0% (w/w) sericin. In an embodiment, silk fibroin that is substantially devoid of sericin refers to silk fibroin having between about 2.0% (w/w) and about 4.0% (w/w) sericin. In an embodiment, silk fibroin that is substantially devoid of sericin refers to silk fibroin having between about 2.5% (w/w) and about 4.0% (w/w) sericin. In an embodiment, silk fibroin that is substantially devoid of sericin refers to silk fibroin having a sericin content between about 0.01% (w/w) and about 0.1% (w/w). In an embodiment, silk fibroin that is substantially devoid of sericin refers to silk fibroin having a sericin content below about 0.1% (w/w). In an embodiment, silk fibroin that is substantially devoid of sericin refers to silk fibroin having a sericin content below about 0.05% (w/w). In an embodiment, when a silk source is added to a boiling (100° C.) aqueous solution of sodium carbonate for a treatment time of between about 30 minutes to about 60 minutes, a degumming loss of about 26 wt. % to about 31 wt. % is obtained.

As used herein, the term “substantially homogeneous” may refer to pure silk fibroin-based protein fragments that are distributed in a normal distribution about an identified molecular weight. As used herein, the term “substantially homogeneous” may refer to an even distribution of an additive, for example a pigment, throughout a composition of the present disclosure.

As used herein, “residuals” refer to materials related to one or more process steps in the manufacturing of silk fibroin solutions, silk fibroin fragments solutions, or concentrates thereof.

In some embodiments, compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which in some embodiments may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

In some embodiments, compositions and articles described herein, and methods of preparing the same, include silk coated leather or leather article. The leather or leather article may be a polymeric material such as those described elsewhere herein. The terms “infused” and/or “partially dissolved” includes mixing to form a dispersion of, e.g., a portion of leather or leather article with a portion of the silk based coating. In some embodiments, the dispersion may be a solid suspension (i.e., a dispersion comprising domains on the order of 10 nm) or a solid solution (i.e., a molecular dispersion) of silk. In some embodiments, the dispersion may be localized at the surface interface between the silk coating and the leather or leather article, and may have a depth of 1 nm, 2 nm, 5 nm, 10 nm, 25 nm, 50 nm, 75 nm, 100 nm, or greater than 100 nm, depending on the method of preparation. In some embodiments, the dispersion may be a layer sandwiched between the leather or leather article and the silk coating. In some embodiments, the dispersion may be prepared by coating silk, including silk fibroin with the characteristics described herein, onto the leather or leather article, and then performing an additional process to form the dispersion, including heating at a temperature of 100° C., 125° C., 150° C., 175° C., 200° C., 225° C., or 250° C. for a time period selected from the group consisting of 1 minute, 2 minutes, 5 minutes, 10 minutes, 15 minutes, 20 minutes, 30 minutes, 1 hour, 2 hours, 4 hours, 8 hours, 16 hours, or 24 hours. In some embodiments, heating may be performed at or above the glass transition temperature (T_{g}) of silk and/or the polymeric fabric or textile, which may be assessed by methods known in the art. In some embodiments, the dispersion may be formed by coating silk, including silk fibroin with the characteristics described herein, onto the leather or leather article, and then performing an additional process to impregnate the silk coating into the leather or leather article, including treatment with an organic solvent. Methods for characterizing the properties of polymers dissolved in one another are well known in the art and include differential scanning calorimetry and surface analysis methods capable of depth profiling, including spectroscopic methods.

In some embodiments, compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In some embodiments, where aqueous solutions are used to prepare SPF compositions or SPF containing coatings, the aqueous solutions are prepared using any type of water. In some embodiments, water may be DI water, tap water, or naturally available water. As used herein, “tap water” refers to potable water provided by public utilities and water of comparable quality, regardless of the source, without further refinement such as by reverse osmosis, distillation, and/or deionization. Therefore, the use of “DI water,” “RODI water,” or “water,” as set forth herein, may be understood to be interchangeable with “tap water” according to the processes described herein without deleterious effects to such processes.

Leather and Leather Articles Processed, Coated, and/or Repaired with Silk Fibroin-Based Protein Fragments

The disclosure provides an article including a leather substrate and silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, the silk fibroin proteins or fragments thereof have any average weight average molecular weight described herein. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, of claim 1, wherein the silk fibroin proteins or fragments thereof have a polydispersity between about 4 and about 4.5. In some embodiments, the silk fibroin proteins or fragments thereof have a polydispersity between about 4.5 and about 5. Some methods for adding a protein to a substrate, including a leather substrate, are described in U.S. Pat. No. 8,993,065, incorporated herein by reference in its entirety.

The disclosure also provides an article including a leather substrate and silk fibroin proteins or fragments thereof having any average weight average molecular weight and polydispersity described herein, and optionally any other limitations described herein, and about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%.

The disclosure also provides an article including a leather substrate and silk fibroin proteins or fragments thereof having any average weight average molecular weight and polydispersity described herein, and optionally any other limitations described herein, wherein the silk fibroin proteins or fragments thereof do not spontaneously or gradually gelate and do not visibly change in color or turbidity when in an aqueous solution for at least 10 days prior to being added to the leather substrate. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month prior to being added to the leather substrate.

The disclosure also provides an article including a leather substrate and silk fibroin proteins or fragments thereof having any average weight average molecular weight and polydispersity described herein, and optionally any other limitations described herein, wherein: 1) a portion of the silk fibroin proteins or fragments thereof is coated on a surface of the leather substrate; or 2) a portion of the silk fibroin proteins or fragments thereof is infused into a layer of the leather substrate, in some embodiments, such layers having a thickness as described herein; or 3) a portion of the silk fibroin proteins or fragments thereof is in a recessed portion of the leather substrate selected from an opening, a crevice, and a defect in the leather substrate; or 4) any combination of the above.

In some embodiments, a portion of the silk fibroin proteins or fragments thereof, which is coated on a surface of the leather substrate can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm. In some embodiments, a coating including silk fibroin proteins or fragments thereof, and optionally rheology modifiers and/or plasticizer, which is coated on a surface of the leather substrate, can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm. In some embodiments, a coating including silk fibroin proteins or fragments thereof, and optionally rheology modifiers and/or plasticizer, which is coated on a surface of the leather substrate, can have a thickness of less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, or less than about 30 μm. In some embodiments, a coating including silk fibroin proteins or fragments thereof, and optionally rheology modifiers and/or plasticizer, which is coated on a surface of the leather substrate, can have a thickness of greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, or greater than about 30 μm.

As described herein, silk fibroin proteins or fragments thereof can be coated on any surface of the leather substrate, or included in a recessed portion of the leather substrate. A recessed portion of the leather substrate can have various depths, including, without limitation, between about 1 μm and about 15 μm, between about 5 μm and about 25 μm, between about 10 μm and about 50 μm, between about 25 μm and about 75 μm, between about 50 μm and about 150 μm, between about 75 μm and about 500 μm, and between about 100 μm and about 1000 μm. In some embodiments, a recessed portion of the leather substrate can have a depth of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, about 100 μm, about 101 μm, about 102 μm, about 103 μm, about 104 μm, about 105 μm, about 106 μm, about 107 μm, about 108 μm, about 109 μm, about 110 μm, about 111 μm, about 112 μm, about 113 μm, about 114 μm, about 115 μm, about 116 μm, about 117 μm, about 118 μm, about 119 μm, about 120 μm, about 121 μm, about 122 μm, about 123 μm, about 124 μm, about 125 μm, about 126 μm, about 127 μm, about 128 μm, about 129 μm, about 130 μm, about 131 μm, about 132 μm, about 133 μm, about 134 μm, about 135 μm, about 136 μm, about 137 μm, about 138 μm, about 139 μm, about 140 μm, about 141 μm, about 142 μm, about 143 μm, about 144 μm, about 145 μm, about 146 μm, about 147 μm, about 148 μm, about 149 μm, about 150 μm, about 151 μm, about 152 μm, about 153 μm, about 154 μm, about 155 μm, about 156 μm, about 157 μm, about 158 μm, about 159 μm, about 160 μm, about 161 μm, about 162 μm, about 163 μm, about 164 μm, about 165 μm, about 166 μm, about 167 μm, about 168 μm, about 169 μm, about 170 μm, about 171 μm, about 172 μm, about 173 μm, about 174 μm, about 175 μm, about 176 μm, about 177 μm, about 178 μm, about 179 μm, about 180 μm, about 181 μm, about 182 μm, about 183 μm, about 184 μm, about 185 μm, about 186 μm, about 187 μm, about 188 μm, about 189 μm, about 190 μm, about 191 μm, about 192 μm, about 193 μm, about 194 μm, about 195 μm, about 196 μm, about 197 μm, about 198 μm, about 199 μm, or about 200 μm. In some embodiments, a recessed portion of the leather substrate can have a depth of about 132 μm, about 151 μm, about 126 μm, about 132 μm, and/or about 63 μm.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 50% and about 75% of the depth of the recessed portion, at least between about 45% and about 80% of the depth of the recessed portion, at least between about 65% and about 85% of the depth of the recessed portion, at least between about 75% and about 95% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 53%, 52%, 51%, or 50% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 5% and about 25% of the depth of the recessed portion, at least between about 10% and about 35% of the depth of the recessed portion, at least between about 15% and about 50% of the depth of the recessed portion, at least between about 25% and about 75% of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, less than about 30 μm, less than about 31 μm, less than about 32 μm, less than about 33 μm, less than about 34 μm, less than about 35 μm, less than about 36 μm, less than about 37 μm, less than about 38 μm, less than about 39 μm, less than about 40 μm, less than about 41 μm, less than about 42 μm, less than about 43 μm, less than about 44 μm, less than about 45 μm, less than about 46 μm, less than about 47 μm, less than about 48 μm, less than about 49 μm, less than about 50 μm, less than about 51 μm, less than about 52 μm, less than about 53 μm, less than about 54 μm, less than about 55 μm, less than about 56 μm, less than about 57 μm, less than about 58 μm, less than about 59 μm, less than about 60 μm, less than about 61 μm, less than about 62 μm, less than about 63 μm, less than about 64 μm, less than about 65 μm, less than about 66 μm, less than about 67 μm, less than about 68 μm, less than about 69 μm, less than about 70 μm, less than about 71 μm, less than about 72 μm, less than about 73 μm, less than about 74 μm, less than about 75 μm, less than about 76 μm, less than about 77 μm, less than about 78 μm, less than about 79 μm, less than about 80 μm, less than about 81 μm, less than about 82 μm, less than about 83 μm, less than about 84 μm, less than about 85 μm, less than about 86 μm, less than about 87 μm, less than about 88 μm, less than about 89 μm, less than about 90 μm, less than about 91 μm, less than about 92 μm, less than about 93 μm, less than about 94 μm, less than about 95 μm, less than about 96 μm, less than about 97 μm, less than about 98 μm, less than about 99 μm, less than about 100 μm, less than about 101 μm, less than about 102 μm, less than about 103 μm, less than about 104 μm, less than about 105 μm, less than about 106 μm, less than about 107 μm, less than about 108 μm, less than about 109 μm, less than about 110 μm, less than about 111 μm, less than about 112 μm, less than about 113 μm, less than about 114 μm, less than about 115 μm, less than about 116 μm, less than about 117 μm, less than about 118 μm, less than about 119 μm, less than about 120 μm, less than about 121 μm, less than about 122 μm, less than about 123 μm, less than about 124 μm, less than about 125 μm, less than about 126 μm, less than about 127 μm, less than about 128 μm, less than about 129 μm, less than about 130 μm, less than about 131 μm, less than about 132 μm, less than about 133 μm, less than about 134 μm, less than about 135 μm, less than about 136 μm, less than about 137 μm, less than about 138 μm, less than about 139 μm, less than about 140 μm, less than about 141 μm, less than about 142 μm, less than about 143 μm, less than about 144 μm, less than about 145 μm, less than about 146 μm, less than about 147 μm, less than about 148 μm, less than about 149 μm, less than about 150 μm, less than about 151 μm, less than about 152 μm, less than about 153 μm, less than about 154 μm, less than about 155 μm, less than about 156 μm, less than about 157 μm, less than about 158 μm, less than about 159 μm, less than about 160 μm, less than about 161 μm, less than about 162 μm, less than about 163 μm, less than about 164 μm, less than about 165 μm, less than about 166 μm, less than about 167 μm, less than about 168 μm, less than about 169 μm, less than about 170 μm, less than about 171 μm, less than about 172 μm, less than about 173 μm, less than about 174 μm, less than about 175 μm, less than about 176 μm, less than about 177 μm, less than about 178 μm, less than about 179 μm, less than about 180 μm, less than about 181 μm, less than about 182 μm, less than about 183 μm, less than about 184 μm, less than about 185 μm, less than about 186 μm, less than about 187 μm, less than about 188 μm, less than about 189 μm, less than about 190 μm, less than about 191 μm, less than about 192 μm, less than about 193 μm, less than about 194 μm, less than about 195 μm, less than about 196 μm, less than about 197 μm, less than about 198 μm, less than about 199 μm, or less than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 132 μm, less than about 151 μm, less than about 126 μm, less than about 132 μm, and/or less than about 63 μm of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, greater than about 30 μm, greater than about 31 μm, greater than about 32 μm, greater than about 33 μm, greater than about 34 μm, greater than about 35 μm, greater than about 36 μm, greater than about 37 μm, greater than about 38 μm, greater than about 39 μm, greater than about 40 μm, greater than about 41 μm, greater than about 42 μm, greater than about 43 μm, greater than about 44 μm, greater than about 45 μm, greater than about 46 μm, greater than about 47 μm, greater than about 48 μm, greater than about 49 μm, greater than about 50 μm, greater than about 51 μm, greater than about 52 μm, greater than about 53 μm, greater than about 54 μm, greater than about 55 μm, greater than about 56 μm, greater than about 57 μm, greater than about 58 μm, greater than about 59 μm, greater than about 60 μm, greater than about 61 μm, greater than about 62 μm, greater than about 63 μm, greater than about 64 μm, greater than about 65 μm, greater than about 66 μm, greater than about 67 μm, greater than about 68 μm, greater than about 69 μm, greater than about 70 μm, greater than about 71 μm, greater than about 72 μm, greater than about 73 μm, greater than about 74 μm, greater than about 75 μm, greater than about 76 μm, greater than about 77 μm, greater than about 78 μm, greater than about 79 μm, greater than about 80 μm, greater than about 81 μm, greater than about 82 μm, greater than about 83 μm, greater than about 84 μm, greater than about 85 μm, greater than about 86 μm, greater than about 87 μm, greater than about 88 μm, greater than about 89 μm, greater than about 90 μm, greater than about 91 μm, greater than about 92 μm, greater than about 93 μm, greater than about 94 μm, greater than about 95 μm, greater than about 96 μm, greater than about 97 μm, greater than about 98 μm, greater than about 99 μm, greater than about 100 μm, greater than about 101 μm, greater than about 102 μm, greater than about 103 μm, greater than about 104 μm, greater than about 105 μm, greater than about 106 μm, greater than about 107 μm, greater than about 108 μm, greater than about 109 μm, greater than about 110 μm, greater than about 111 μm, greater than about 112 μm, greater than about 113 μm, greater than about 114 μm, greater than about 115 μm, greater than about 116 μm, greater than about 117 μm, greater than about 118 μm, greater than about 119 μm, greater than about 120 μm, greater than about 121 μm, greater than about 122 μm, greater than about 123 μm, greater than about 124 μm, greater than about 125 μm, greater than about 126 μm, greater than about 127 μm, greater than about 128 μm, greater than about 129 μm, greater than about 130 μm, greater than about 131 μm, greater than about 132 μm, greater than about 133 μm, greater than about 134 μm, greater than about 135 μm, greater than about 136 μm, greater than about 137 μm, greater than about 138 μm, greater than about 139 μm, greater than about 140 μm, greater than about 141 μm, greater than about 142 μm, greater than about 143 μm, greater than about 144 μm, greater than about 145 μm, greater than about 146 μm, greater than about 147 μm, greater than about 148 μm, greater than about 149 μm, greater than about 150 μm, greater than about 151 μm, greater than about 152 μm, greater than about 153 μm, greater than about 154 μm, greater than about 155 μm, greater than about 156 μm, greater than about 157 μm, greater than about 158 μm, greater than about 159 μm, greater than about 160 μm, greater than about 161 μm, greater than about 162 μm, greater than about 163 μm, greater than about 164 μm, greater than about 165 μm, greater than about 166 μm, greater than about 167 μm, greater than about 168 μm, greater than about 169 μm, greater than about 170 μm, greater than about 171 μm, greater than about 172 μm, greater than about 173 μm, greater than about 174 μm, greater than about 175 μm, greater than about 176 μm, greater than about 177 μm, greater than about 178 μm, greater than about 179 μm, greater than about 180 μm, greater than about 181 μm, greater than about 182 μm, greater than about 183 μm, greater than about 184 μm, greater than about 185 μm, greater than about 186 μm, greater than about 187 μm, greater than about 188 μm, greater than about 189 μm, greater than about 190 μm, greater than about 191 μm, greater than about 192 μm, greater than about 193 μm, greater than about 194 μm, greater than about 195 μm, greater than about 196 μm, greater than about 197 μm, greater than about 198 μm, greater than about 199 μm, or greater than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 132 μm, greater than about 151 μm, greater than about 126 μm, greater than about 132 μm, and/or greater than about 63 μm of the depth of the recessed portion.

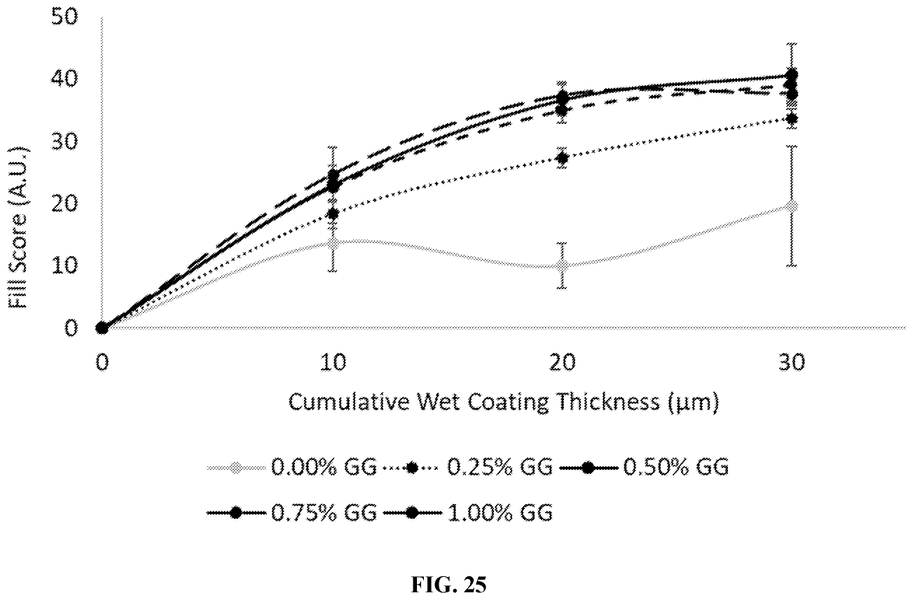

Referring to FIGS. 23A and 23B, the manner in which a portion of the silk fibroin proteins or fragments thereof is coated on a surface of the leather substrate, or the manner in which a portion of the silk fibroin proteins or fragments thereof is in a recessed portion of the leather substrate, can be described by way of a cross-section index, wherein a cross-section index is defined as the ratio between the area above the curve up to a baseline and the length of the cross section across which the area above the curve is determined. The cross-section index is reflected herein as a unitless value. The curve may reflect the leather surface (if uncoated or unfilled) along a cross-section, or a surface of a silk fibroin proteins or fragments thereof coating or filling along a cross-section. The baseline may reflect a horizontal plane approximating the surface of the leather substrate across the segment through which the cross-section index is determined.

As shown in FIG. 23A, a recessed portion is for example between the cross-section x₁=about 210 μm, and x₂=about 600 μm, and the cross-section index of this recessed portion can be calculated as described herein. In some embodiments, a recessed portion of the leather substrate has a cross-section index of about 6.50, about 6.75, about 7, about 7.25, about 7.50, about 7.75, about 8, about 8.25, about 8.50, about 8.75, about 9, about 9.25, about 9.50, about 9.75, or about 10. In some embodiments, a recessed portion of the leather substrate can have another cross-section index, for example about 5, about 5.1, about 5.2, about 5.3, about 5.4, about 5.5, about 5.6, about 5.7, about 5.8, about 5.9, about 6, about 6.1, about 6.2, bout 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, bout 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, or about 10. Also as shown in FIG. 23A, a substantially non-recessed portion of the leather substrate is for example between the cross-section x₁=0 μm, and x₂=about 210 μm, and the cross-section index of this substantially non-recessed portion can be calculated as described herein. In some embodiments, a substantially non-recessed portion of the leather substrate has a cross-section index of about 1.1, about 1.2, about 1.3, about 1.4, about 1.5, about 1.6, about 1.7, about 1.8, about 1.9, or about 2.0. In some embodiments, a substantially non-recessed portion of the leather substrate can have another cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

As shown in FIG. 23B, a recessed portion filled with silk fibroin proteins or fragments thereof is for example between the cross-section x₁=about 210 μm, and x₂=about 395 μm, and the cross-section index of this filled recessed portion can be calculated as described herein. In some embodiments, a filled recessed portion of the leather substrate can have a cross-section index of about 0.25, about 0.50, about 0.75, about 1, about 1.25, about 1.27, about 1.50, about 1.75, or about 2. In some embodiments, a filled recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3. Also as shown in FIG. 23B, a substantially non-recessed portion of the leather substrate coated with silk fibroin proteins or fragments thereof is for example between the cross-section x₁=0 μm, and x₂=about 210 μm, and the cross-section index of this recessed portion can be calculated as described herein. In some embodiments, a coated substantially non-recessed portion of the leather substrate has a cross-section index of about 0.05, about 0.1, about 0.15, about 0.2, about 0.25, about 0.50, about 0.75, about 1, about 1.25, about 1.27, about 1.50, about 1.75, or about 2. In some embodiments, a coated substantially non-recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

In some embodiments, a coated substantially non-recessed portion of the leather substrate may have a cross-section index lower than a substantially non-recessed portion of the leather substrate before coating. In some embodiments, a coated substantially non-recessed portion of the leather substrate has a cross-section index lower than a substantially non-recessed portion of the leather substrate before coating, wherein the cross-section index of the coated substantially non-recessed portion of the leather substrate is higher than 0. In some embodiments, a coated substantially non-recessed portion of the leather substrate has a cross-section index lower than a substantially non-recessed portion of the leather substrate before coating by a factor between 1% and 99%.

In some embodiments, a coated substantially non-recessed portion of the leather substrate may have a cross-section index lower than a substantially recessed portion of the leather substrate before filling. In some embodiments, a coated substantially non-recessed portion of the leather substrate has a cross-section index lower than a substantially recessed portion of the leather substrate before filling, wherein the cross-section index of the coated substantially non-recessed portion of the leather substrate is higher than 0. In some embodiments, a coated substantially non-recessed portion of the leather substrate has a cross-section index lower than a substantially recessed portion of the leather substrate before filling by a factor between 1% and 99%.

In some embodiments, a filled recessed portion of the leather substrate may have a cross-section index lower than a substantially non-recessed portion of the leather substrate before coating. In some embodiments, a filled recessed portion of the leather substrate may have a cross-section index lower than a substantially non-recessed portion of the leather substrate before coating, wherein the cross-section index of the filled recessed portion of the leather substrate is higher than 0. In some embodiments, a filled recessed portion of the leather substrate may have a cross-section index lower than a substantially non-recessed portion of the leather substrate before coating by a factor between 1% and 99%.

In some embodiments, a filled recessed portion of the leather substrate may have a cross-section index lower than a substantially non-recessed portion of the leather substrate before filling. In some embodiments, a filled recessed portion of the leather substrate may have a cross-section index lower than a substantially non-recessed portion of the leather substrate before filling, wherein the cross-section index of the filled recessed portion of the leather substrate is higher than 0. In some embodiments, a filled recessed portion of the leather substrate may have a cross-section index lower than a substantially non-recessed portion of the leather substrate before filling by a factor between 1% and 99%.

The disclosure also provides an article including a leather substrate and silk fibroin proteins or fragments thereof having any average weight average molecular weight and polydispersity described herein, and optionally any other limitations described herein, the article further including one or more polysaccharides selected from starch, cellulose, gum arabic, guar gum, xanthan gum, alginate, pectin, chitin, chitosan, carrageenan, inulin, and gellan gum. In some embodiments, the polysaccharide is gellan gum. In some embodiments, the gellan gum comprises low-acyl content gellan gum. In some embodiments, the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the polysaccharide is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the polysaccharide is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. The ratio between the silk fibroin proteins or fragments thereof and the polysaccharide can be determined by any method known in the art, for example a mass spectrometry method, a spectroscopic method such as IR or NMR, a surface analysis method, or the like.

The disclosure provides an article including a leather substrate and silk fibroin proteins or fragments thereof having an average weight average molecular weight between about 1 kDa and about 5 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 5 kDa and about 10 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 6 kDa and about 17 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 10 kDa and about 15 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 15 kDa and about 20 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 17 kDa and about 39 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 20 kDa and about 25 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 25 kDa and about 30 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 30 kDa and about 35 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 35 kDa and about 40 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 39 kDa and about 80 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 40 kDa and about 45 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 45 kDa and about 50 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 60 kDa and about 100 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 80 kDa and about 144 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure also provides an article including a leather substrate and silk fibroin proteins or fragments thereof having any average weight average molecular weight and polydispersity described herein, and optionally any other limitations described herein, the article further including one or more polyols, and/or one or more polyethers. In some embodiments, the polyols include one or more of glycol, glycerol, sorbitol, glucose, sucrose, and dextrose. In some embodiments, the polyethers include one or more polyethyleneglycols (PEGs). In some embodiments, the w/w ratio between the silk fibroin proteins or fragments thereof and the one or more polyols and/or one or more polyethers is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the one or more polyols and/or one or more polyethers is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99

The disclosure also provides an article including a leather substrate and silk fibroin proteins or fragments thereof having any average weight average molecular weight and polydispersity described herein, and optionally any other limitations described herein, the article further including one or more of a silicone, a dye, a pigment, and a polyurethane as described herein.

In an embodiment, the disclosure provides leather and leather articles processed with a silk composition described herein. In an embodiment, the disclosure provides leather and leather articles coated with a silk composition described herein. In an embodiment, the disclosure provides leather and leather articles repaired with a silk composition described herein, for example by filling, masking, or hiding a defect in the surface or structure of the leather.

In an embodiment, the disclosure provides leather and leather articles processed with any one of herein described silk compositions and a dye to provide colored leather and leather articles exhibiting enhanced color-saturation and excellent color-fixation properties. In some embodiments, the silk composition may be applied currently with the dye. In some embodiments, the silk composition may be applied prior to the dyeing process. In some embodiments, the silk composition may be applied post the dyeing process. In some embodiments, the leather may include nubuck skin in crust, nubuck skin finished in black or blue color, suede skin fined in brown or turquoise color, bottom split suede, or top split wet blue suede.

As used herein, in some embodiments the term “leather” and/or “leather substrate” refers to natural leather and may be derived from bovine skin, sheep skin, lamb skin, horse skin, crocodile skin, alligator skin, avian skin, or another known animal skin as would be appreciated by the art, or processed leather. Unprocessed, processed, coated, and/or repaired leather may include, without limitation, Altered leather, Aniline leather, Bonded leather, Brushed leather, Buffed leather, Bycast leather, Chamois leather, Chrome-tanned leather, Combination tanned leather, Cordovan leather, Corrected grain leather, Crockproof leather, Drummed leather, Embossed leather, Enhanced grain leather, Grained leather, Metallized leather, Naked leather, Natural grain leather, Nubuck leather, Patent leather, Pearlized leather, Plated leather, Printed leather, Protected leather, Pure Aniline leather, Tanned/Retanned leather, Round Hand leather, Saddle leather, Semi-Aniline leather Shrunken grain leather, Side leather, Split leather, Suede leather, and Wet blue. In some embodiments, the term “leather” may refer to synthetic or reconstituted leather, including, but not limited to, leather partially/fully constituted with cellulose, mushroom-based material, synthetic materials such as vinyl, synthetic materials such as polyamide or polyester.

As used herein, the term “hand” refers to the feel of a material, which may be further described as the feeling of softness, crispness, dryness, silkiness, smoothness, and combinations thereof. Material hand is also referred to as “drape.” A material with a hard hand is coarse, rough, and generally less comfortable for the wearer. A material with a soft hand is fluid and smooth and generally more comfortable for the wearer. Material hand can be determined by comparison to collections of material samples, or by use of methods such as the Kawabata Evaluation System (KES) or the Fabric Assurance by Simple Testing (FAST) methods. Behera and Hari, Ind. J. Fibre & Textile Res., 1994, 19, 168-71. In some embodiments, and as described herein, silk can change the hand of leather, as may be evaluated by SynTouch Touch-Scale methodology or another methodology as described herein.

As used herein, a “coating” refers to a material, or combination of materials, that form a substantially continuous layer or film on an exterior surface of a substrate, such as leather or leather article. In some embodiments, a portion of the coating may penetrate at least partially into the substrate. In some embodiments, the coating may penetrate at least partially into the interstices of a substrate. In some embodiments, the coating may be infused into a surface of the substrate such that the application of the coating, or coating process, may include infusing (at the melting temperature of the substrate) at least one coating component at least partially into a surface of the substrate. A coating may be applied to a substrate by one or more of the processes described herein.

In embodiments described where the coating may be infused into a surface of the substrate, the coating may be codissolved in a surface of the substrate such that a component of the coating may be intermixed in the surface of the substrate to a depth of at least about 1 nm, or at least about 2 nm, or at least about 3 nm, or at least about 4 nm, or at least about 5 nm, or at least about 6 nm, or at least about 7 nm, or at least about 8 nm, or at least about 9 nm, or at least about 10 nm, or at least about 20 nm, or at least about 30 nm, or at least about 40 nm, or at least about 50 nm, or at least about 60 nm, or at least about 70 nm, or at least about 80 nm, or at least about 90 nm, or at least about 100 nm. In some embodiments, the coating may be infused into a surface of the substrate where the substrate includes leather or a leather article.

As used herein, the term “bath coating” encompasses coating a material in a bath, immersing a material in a bath, and submerging a material in a bath. Concepts of bath coating are set forth in U.S. Pat. No. 4,521,458, the entirety of which is incorporated by reference.

As used herein, and unless more specifically described, the term “drying” may refer to drying a coated material as described herein at a temperature greater than room temperature (i.e., 20° C.).

The disclosure provides generally to methods and articles related to filling a recessed portion of a leather, such as, without limitation, an opening, a crevice, or a defect in a leather substrate, with silk fibroin proteins and/or fragments thereof. As used herein, the term “defect” or “leather defect,” refers to any imperfection in or on the surface, and/or the underlying structure of the leather. For example, removal of a hair and/or hair follicle may leave a visible void or gap in the surface or structure of the leather or hide. This disclosure is not limited to repairing visible defects, and thus it is contemplated that any defects can be repaired as described herein. This disclosure is likewise not limited to repairing defects of a certain size, and defects of any size can be repaired and/or filled. For example, silk and/or SPFs, and any and all compositions described herein, can be used to fill in or mask the appearance of larger defects occurring over larger areas of a defective skin surface.

As used herein, “repaired” or “repairing” leather refers to filling a defect with a composition including silk and/or SPF, wherein as a result of such repairing the defect is substantially eliminated. For example, a void or gap which is fully or partially filled with a composition as described herein may be a repaired defect.

In an embodiment, the disclosure provides a leather or leather article processed, coated, and/or repaired with silk fibroin-based proteins or fragments thereof. In an embodiment, the disclosure provides a leather or leather article processed, coated, or repaired with silk fibroin-based proteins or fragments thereof, wherein the leather or leather article is a leather or leather article used for human apparel, including apparel. In an embodiment, the disclosure provides a leather or leather article processed, coated, or repaired with silk fibroin-based proteins or fragments thereof, wherein the leather or leather article is used for automobile upholstery. In an embodiment, the disclosure provides a leather or leather article processed, coated, or repaired with silk fibroin-based proteins or fragments thereof, wherein the leather or leather article is used for aircraft upholstery. In an embodiment, the disclosure provides a leather or leather article processed, coated, or repaired with silk fibroin-based proteins or fragments thereof, wherein the leather or leather article is used for upholstery in transportation vehicles for public, commercial, military, or other use, including buses and trains. In an embodiment, the disclosure provides a leather or leather article processed, coated, or repaired with silk fibroin-based proteins or fragments thereof, wherein the leather or leather article is used for upholstery of a product that requires a high degree of resistance to wear as compared to normal upholstery.

In an embodiment, a leather or leather article is treated with a polymer, such as polyglycolide (PGA), polyethylene glycols, copolymers of glycolide, glycolide/L-lactide copolymers (PGA/PLLA), glycolide/trimethylene carbonate copolymers (PGA/TMC), polylactides (PLA), stereocopolymers of PLA, poly-L-lactide (PLLA), poly-DL-lactide (PDLLA), L-lactide/DL-lactide copolymers, co-polymers of PLA, lactide/tetramethylglycolide copolymers, lactide/trimethylene carbonate copolymers, lactide/δ-valerolactone copolymers, lactide/ε-caprolactone copolymers, polydepsipeptides, PLA/polyethylene oxide copolymers, unsymmetrically 3,6-substituted poly-1,4-dioxane-2,5-diones, poly-β-hydroxybutyrate (PHBA), PHBA/β-hydroxyvalerate copolymers (PHBA/HVA), poly-β-hydroxypropionate (PHPA), poly-β-dioxanone (PDS), poly-δ-valerolactone, poly-ε-caprolactone, methylmethacrylate-N-vinyl pyrrolidine copolymers, polyesteramides, polyesters of oxalic acid, polydihydropyrans, polyalkyl-2-cyanoacrylates, polyurethanes (PU), polyvinylalcohols (PVA), polypeptides, poly-β-malic acid (PMLA), poly-β-alkanoic acids, polyvinylalcohol (PVA), polyethyleneoxide (PEO), chitine polymers, polyethylene, polypropylene, polyasetal, polyamides, polyesters, polysulphone, polyether ether ketone, polyethylene terephthalate, polycarbonate, polyaryl ether ketone, and polyether ketone ketone.

In an embodiment, an aqueous solution of pure silk fibroin-based protein fragments of the present disclosure is used to process and/or coat a leather or leather article. In an embodiment, the concentration of silk in the solution ranges from about 0.1% to about 20.0%. In an embodiment, the concentration of silk in the solution ranges from about 0.1% to about 15.0%. In an embodiment, the concentration of silk in the solution ranges from about 0.5% to about 10.0%. In an embodiment, the concentration of silk in the solution ranges from about 1.0% to about 5.0%. In an embodiment, an aqueous solution of pure silk fibroin-based protein fragments of the present disclosure is applied directly to a leather or leather article. Alternatively, silk microsphere and any additives may be used for processing and/or coating a leather or leather article. In an embodiment, additives can be added to an aqueous solution of pure silk fibroin-based protein fragments of the present disclosure before coating (e.g., alcohols) to further enhance material properties. In an embodiment, a silk coating of the present disclosure can have a pattern to optimize properties of the silk on the leather or leather article. In an embodiment, a coating is applied to a leather or leather article under tension and/or lax to vary penetration in to the leather or leather article.

In an embodiment, a composition of pure silk fibroin-based protein fragments of the present disclosure is used to repair a leather or leather article. In some embodiments, the composition is viscous. In some embodiments, the composition is thixotropic. In some embodiments, the composition is a gel, a putty, a wax, a paste, or the like. In some embodiments, the composition is shaped as a repairing bar, for example a repairing crayon. In some embodiments, the composition is delivered from a syringe, a delivery gun, a brush-type applicator, a roller-type applicator, a pen or marker-type applicator, or the like. In some embodiments, the composition is co-delivered from a multiple syringe, for example a double syringe, or a double delivery gun, along a different composition designed to harden, initiate curing of, or otherwise modify the SPF composition. In an embodiment, the concentration of silk in the composition ranges from about 0.1% to about 50.0%. In an embodiment, the concentration of silk in the solution ranges from about 0.1% to about 35.0%. In an embodiment, the concentration of silk in the solution ranges from about 0.5% to about 30.0%. In an embodiment, the concentration of silk in the solution ranges from about 1.0% to about 25.0%. In an embodiment, a composition of pure silk fibroin-based protein fragments of the present disclosure is applied directly to a leather or leather article, for example to a leather defect. Alternatively, silk microsphere and any additives may be used for repairing a leather or leather article. In an embodiment, additives can be added to the composition of pure silk fibroin-based protein fragments of the present disclosure before coating (e.g., alcohols) to further enhance material properties. In an embodiment, a composition is applied to a leather or leather article under tension and/or lax to vary penetration in to the leather, leather article, or leather defect.

Methods of Preparing Leathers Processed or Coated with Silk Compositions Described Herein

In an embodiment, the disclosure provides methods of preparing leather and leather articles coated or repaired with silk compositions described herein.

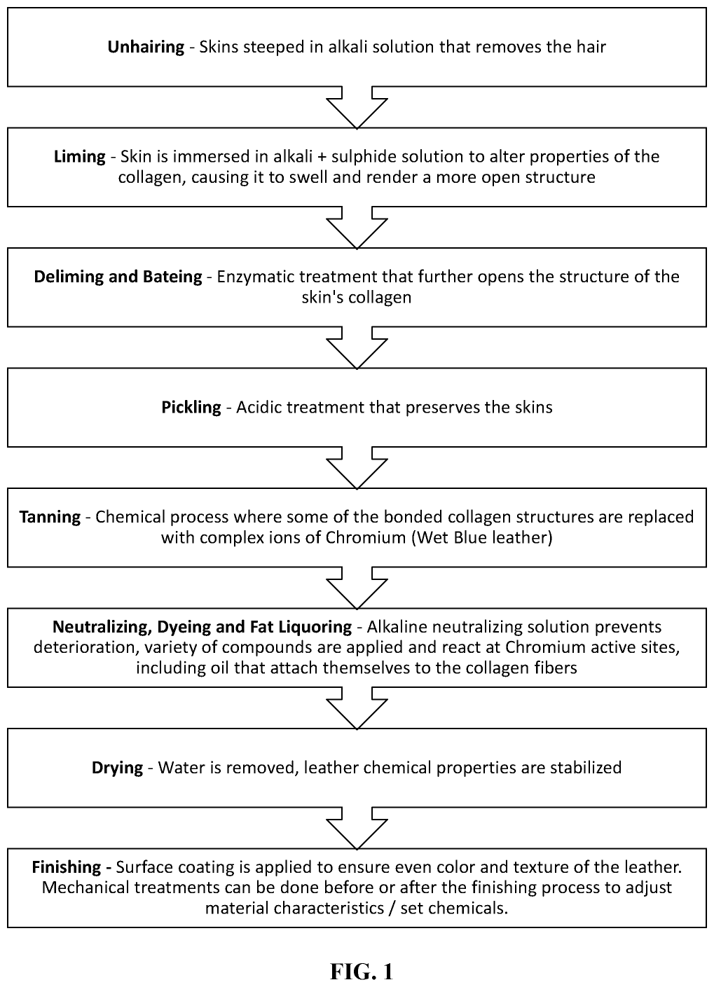

As shown in FIG. 1, the following steps may be used in a leather preparation process:
Unhairing—Skins steeped in alkali solution that removes hair;
Liming—Skin is immersed in alkali/sulphide solution to alter properties of the collagen, causing it to swell and render a more open structure;
Deliming and Bateing—Enzymatic treatment that further opens the structure of the skin's collagen;
Pickling—Acidic treatment that preserves the skins;
Tanning—Chemical process where some of the bonded collagen structures are replaced with complex ions of Chromium (wet blue leather);
Neutralizing, Dyeing and Fat Liquoring—Alkaline neutralizing solution prevents deterioration, variety of compounds are applied and react at Chromium active sites, including oil that attach themselves to the collagen fibers;
Drying—Water is removed, leather chemical properties are stabilized; and
Finishing—Surface coating is applied to ensure even color and texture of the leather. Mechanical treatments can be done before or after the finishing process to adjust material characteristics/set chemicals.

The disclosure provides a method of treating a leather substrate with a silk formulation, the method including applying on a surface of the leather a silk formulation including silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, any other average weight average molecular weights and polydispersities described herein can be used. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, the silk fibroin proteins or fragments thereof have a polydispersity between about 4 and about 4.5. In some embodiments, the silk fibroin proteins or fragments thereof have a polydispersity between about 4.5 and about 5.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further comprises about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further includes about 0.001% (w/v) to about 10% (w/v) sericin. In some embodiments, the silk formulation further includes about 0.001% (w/v) sericin to about 0.01% (w/v) sericin, about 0.01% (w/v) sericin to about 0.1% (w/v) sericin, about 0.1% (w/v) sericin to about 1% (w/v) sericin, or about 1% (w/v) sericin to about 10% (w/v) sericin. In some embodiments, the silk formulation further includes about 1% (w/v) sericin, about 2% (w/v) sericin, about 3% (w/v) sericin, about 4% (w/v) sericin, about 5% (w/v) sericin, about 6% (w/v) sericin, about 7% (w/v) sericin, about 8% (w/v) sericin, about 9% (w/v) sericin, about 10% (w/v) sericin, about 11% (w/v) sericin, about 12% (w/v) sericin, about 12% (w/v) sericin, about 13% (w/v) sericin, about 14% (w/v) sericin, or about 15% (w/v) sericin.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in an aqueous solution for at least 10 days prior to being formulated and applied to the leather substrate. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in the formulation for at least 10 days prior to being applied to the leather substrate. In some embodiments, the silk fibroin proteins or fragments thereof do not spontaneously or gradually gelate and do not visibly change in color or turbidity when in the formulation for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments: 1) a portion of the silk formulation is coated on a surface of the leather substrate; or 2) a portion of the silk formulation is infused into a layer of the leather substrate; or 3) a portion of the silk formulation enters a recessed portion of the leather substrate selected from an opening, a crevice, and a defect in the leather substrate; or 4) any combination of the above. The silk formulation can be coated in any desired thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, coating thickness refers to wet coating. In some embodiments, coating thickness refers to after drying coating thickness. The silk formulation can be infused in a layer of the substrate having any thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, infusion layer thickness refers to wet infusion. In some embodiments, infusion layer thickness refers to after drying infusion.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a rheology modifier. In some embodiments, the rheology modifier includes one or more polysaccharides, including one or more of starch, cellulose, gum arabic, guar gum, xanthan gum, alginate, pectin, chitin, chitosan, carrageenan gum, inulin, and/or gellan gum. In some embodiments, the polysaccharides include gellan gum, including, but not limited to, low-acyl content gellan gum. In some embodiments, the w/w ratio between the silk fibroin proteins or fragments thereof and the rheology modifier in the silk formulation is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the rheology modifier in the silk formulation is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the rheology modifier in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the rheology modifier in the silk formulation is between about 0.01% and about 5%. In some embodiments, the w/v concentration of the rheology modifier in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the rheology modifier in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a plasticizer. In some embodiments, the plasticizer includes one or more polyols, and/or one or more polyethers. In some embodiments, the polyols are selected from one or more of glycol, glycerol, sorbitol, glucose, sucrose, and dextrose. In some embodiments, the polyethers are one or more polyethyleneglycols (PEGs). In some embodiments, the w/w ratio between the silk fibroin proteins or fragments thereof and the plasticizer in the silk formulation is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the plasticizer in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the plasticizer in the silk formulation is between about 0.01% and about 10%. In some embodiments, the w/v concentration of the plasticizer in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the plasticizer in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a defoaming agent at a concentration between about 0.001% and about 1%, between about 0.01% and about 2.5%, between about 0.1% and about 3%, between about 0.5% and about 5%, or between about 0.75% and about 7.5%. In some embodiments, the defoaming agent comprises a silicone. The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a deaeration agent at a concentration between about 0.001% and about 1%, between about 0.01% and about 2.5%, between about 0.1% and about 3%, between about 0.5% and about 5%, or between about 0.75% and about 7.5%. In some embodiments, the deaeration agent comprises a silicone.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation is a liquid, a gel, a paste, a wax, or a cream.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the concentration of silk fibroin proteins or fragments thereof in the silk formulation is between about 0.1% w/v and about 15% w/v. In some embodiments, the concentration of silk fibroin proteins or fragments thereof in the silk formulation is between about 0.5% w/v and about 12% w/v. In some embodiments, the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v. In some embodiments, the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 9.25% w/v, about 9.5% w/v, about 9.75% w/v, or about 10% w/v. In some embodiments, the concentration of silk fibroin proteins or fragments thereof in the silk formulation is between about 5 mg/mL and about 125 mg/mL. In some embodiments, the concentration of silk fibroin proteins or fragments thereof in the silk formulation is about 10 mg/mL, about 11 mg/mL, about 12 mg/mL, about 13 mg/mL, about 14 mg/mL, about 15 mg/mL, about 16 mg/mL, about 17 mg/mL, about 18 mg/mL, about 19 mg/mL, about 20 mg/mL, about 21 mg/mL, about 22 mg/mL, about 23 mg/mL, about 24 mg/mL, about 25 mg/mL, about 26 mg/mL, about 27 mg/mL, about 28 mg/mL, about 29 mg/mL, about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, about 90 mg/mL, about 91 mg/mL, about 92 mg/mL, about 93 mg/mL, about 94 mg/mL, about 95 mg/mL, about 96 mg/mL, about 97 mg/mL, about 98 mg/mL, about 99 mg/mL, about 100 mg/mL, about 101 mg/mL, about 102 mg/mL, about 103 mg/mL, about 104 mg/mL, about 105 mg/mL, about 106 mg/mL, about 107 mg/mL, about 108 mg/mL, about 109 mg/mL, or about 110 mg/mL.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further comprises a pH adjusting agent. In some embodiments, the pH adjusting agent includes one more of an acid and/or a base, including but not limited to, a weak acid and/or a weak base. In some embodiments, the pH adjusting agent includes one or more of ammonium hydroxide and citric acid. Any hydroxide, or weak carboxylic acid can be used interchangeably with any of the above. In some embodiments, the silk formulation has a pH of about 2, about 3, about 4, about 5, about 6, about 7, about 8, about 9, about 10, about 11, or about 12.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments treating the leather substrate with the silk formulation improves one or more of gloss, and/or color saturation, and/or smoothness.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the method further includes one or more additional steps such as dyeing the leather, drying the leather, mechanically stretching the leather, trimming the leather, performing one or more polishing steps of the leather, applying a pigment to the leather, applying a colorant to the leather, applying an acrylic formulation to the leather, chemically fixing the leather, stamping the leather, applying a silicone finish to the leather, providing a Uniflex treatment to the leather, and/or providing a Finiflex treatment to the leather, wherein the step of applying the silk formulation on a surface of the leather is performed before, during, or after the one or more additional steps.

As described herein, a silk and/or SPF composition described herein can be used before, during, or after any of these steps. In some embodiments, the leather preparation process may include the treating of the leather with a silk composition described herein. In some embodiments, the leather preparation process may include the repairing of the leather with a silk composition described herein. In some embodiments, the silk composition may include one or more chemical agents as described hereinbelow (e.g., silicone, polyurethane, etc.).

In some embodiments, a silk composition described herein may be applied to leather or a leather article by any of the methods described herein, but also by hand-spraying, spraying using a mechanical spray setup, applying by brush, rubbing, wet-mixing, washing, drumming, soaking, injecting, plastering, smearing, or the like.

In some embodiments, a silk composition described herein may be applied alone, mixed with one or several chemicals (e.g., chemical agents), as one coat, multiple coats, or defect filling composition, at multiple times using varied application methods, to leathers that have or have not been: dyed, chrome-treated, sprayed with: pigment, acrylic, fixation agents, finishing agents, and/or colorants. In some embodiments, a silk composition described herein may be applied to a finished leather or leather article, a mechanically treated leather or leather article, or a drummed leather or leather article.

In some embodiments, a silk composition described herein (with or without one or more chemical agents) may be used to treat or repair leather before or after the liming step. In some embodiments, a silk composition described herein (with or without one or more chemical agents) may be used to treat or repair leather before or after the deliming and/or bateing steps. In some embodiments, a silk composition described herein (with or without one or more chemical agents) may be used to treat or repair leather before or after the pickling step. In some embodiments, a silk composition described herein (with or without one or more chemical agents) may be used to treat or repair leather before or after the tanning step. In some embodiments, a silk composition described herein (with or without one or more chemical agents) may be used to treat or repair leather before or after the neutralizing, dyeing, and/or fat liquoring steps. In some embodiments, a silk composition described herein (with or without one or more chemical agents) may be used to treat or repair leather before or after the drying step. In some embodiments, a silk composition described herein (with or without one or more chemical agents) may be used to treat or repair leather before or after any finishing step. In some embodiments, a silk composition described herein (with or without one or more chemical agents) may be used during the finishing step or as part of the finishing step.

In some embodiments, a silk composition described herein (with or without one or more chemical agents) may be used to treat or repair leather during the liming step. In some embodiments, a silk composition described herein (with or without one or more chemical agents) may be used to treat or repair leather during the deliming and/or bateing steps. In some embodiments, a silk composition described herein (with or without one or more chemical agents) may be used to treat or repair leather during the pickling step. In some embodiments, a silk composition described herein (with or without one or more chemical agents) may be used to treat or repair leather during the tanning step. In some embodiments, a silk composition described herein (with or without one or more chemical agents) may be used to treat or repair leather during the neutralizing, dyeing, and/or fat liquoring steps. In some embodiments, a silk composition described herein (with or without one or more chemical agents) may be used to treat or repair leather during the drying step. In some embodiments, a silk composition described herein (with or without one or more chemical agents) may be used to treat or repair leather during the finishing step. In some embodiments, a silk composition described herein (with or without one or more chemical agents) may be used during the finishing step or as part of the finishing step. In some embodiments, a silk composition described herein (with or without one or more chemical agents) may be used as a stand-alone step, for example a stand-alone coating and/or repairing step.

In some embodiments, the leather preparation process may include treating or repairing the leather with a chemical agent described herein below. In some embodiments, a chemical agent described herein below may be used to treat or repair leather before or after the drying step. In some embodiments, a chemical agent described herein below may be used to treat or repair leather before or after the finishing step. In some embodiments, a chemical agent described herein below may be used during the finishing step or as part of the finishing step.

In some embodiments, specific leather types may include a variety of other steps. In some embodiments, the disclosure provides methods of making high-quality finished leather, for example high quality black leather, and plonge leather. With regard to the manufacturing of high-quality finished leather, for example high quality black leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process. In some embodiments, a silk composition described herein (with or without one or more chemical agents) may be used to treat or repair leather before or after the polishing process, or as part of the polishing process. In some embodiments, a silk composition described herein (with or without one or more chemical agents) may be used to treat or repair leather before or after the pigment spray process, or as part of the pigment spray process. In some embodiments, a silk composition described herein (with or without one or more chemical agents) may be used to treat or repair leather before or after the chemical fixation process, or as part of the chemical fixation process. In some embodiments, a silk composition described herein (with or without one or more chemical agents) may be used to treat or repair leather before or after the stamping process, or as part of the stamping process. In some embodiments, a silk composition described herein (with or without one or more chemical agents) may be used to treat or repair leather before or after the silicone-coating step of the finishing process, or as part of the silicone finishing process. In some embodiments, a silk composition described herein (with or without one or more chemical agents) may be used to treat or repair leather before or after the Uniflex process, or as part of the Uniflex process.

With regard to the manufacturing of plonge leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process. In some embodiments, a silk composition described herein (with or without one or more chemical agents) may be used to treat or repair leather before or after the first polishing process, or as part of the first polishing process. In some embodiments, a silk composition described herein (with or without one or more chemical agents) may be used to treat or repair leather before or after the color spray process, or as part of the color spray process. In some embodiments, a silk composition described herein (with or without one or more chemical agents) may be used to treat or repair leather before or after the second polish process, or as part of the second polish process. In some embodiments, a silk composition described herein (with or without one or more chemical agents) may be used to treat or repair leather before or after the Finiflex process, or as part of the Finiflex process.

In some embodiments, the silk compositions that may be used for coating or repairing leather and/or leather articles according to the processes described herein may include one or more silk compositions recited in Table 1.

In an embodiment, the disclosure provides a method of treating or repairing leather with a silk composition described herein, wherein the method may include the steps of: dyeing the leather; mechanically stretching the leather; trimming the leather; polishing the leather; applying (optionally by spray application) a pigment, and/or an acrylic; chemically fixing the leather, stamping the leather, applying a silicone finish to the leather; and/or providing a Uniflex treatment to the leather; wherein one or more of the foregoing steps includes applying the silk composition to the leather before, during, or after the recited steps.

In an embodiment, the disclosure provides a method of treating or repairing leather with a silk composition described herein, wherein the method may include the steps of: dyeing the leather, drying the leather; mechanically stretching the leather; trimming the leather; performing a first polish of the leather; applying (optionally by spray application) a colorant, and/or an acrylic; performing a second polish of the leather, and/or providing a Finiflex treatment to the leather; wherein one or more of the foregoing steps includes applying the silk composition to the leather before, during, or after the recited steps.

In some embodiments of the methods described herein, silk compositions described herein may be integrated into the leather treatment processes (e.g. during, before or after: pigment+acrylic, pigment+acrylic spray, colorant spray, dyeing, fixation spray, finishing spray). In some embodiments, silk compositions described herein may be applied at any part of the larger leathering process described in FIG. 1.

In some embodiments of the foregoing methods, drying may be of hand or autosprayed leather materials. In some embodiments, a drying step may be provided after each and/or before each spraying of the leather material. In some embodiments, the leather materials may be dried in an oven. In some embodiments, the drying processes may be at a temperature of less than about 70, 71, 72, 73, 74, or 75° C.; or greater than about 70, 71, 72, 73, 74, or 75° C.; or about 70, 71, 72, 73, 74, or 75° C. In some embodiments, each drying step of the leather materials may be for a period of less than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds; or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds; or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds.

In some embodiments of the foregoing methods, stamping may be used during a native production process by pressing the leather material between a top plate and a bottom plate. In some embodiments, the top plate may be at an operating temperature of less than about 50, 51, 52, 53, 54, 55, 56, 57, 58, 59, 60, 61, 62, 63, 64, or 65° C.; or greater than about 50, 51, 52, 53, 54, 55, 56, 57, 58, 59, 60, 61, 62, 63, 64, or 65° C.; or about 50, 51, 52, 53, 54, 55, 56, 57, 58, 59, 60, 61, 62, 63, 64, or 65° C. In some embodiments, the stamping step may include pressing the leather material between the first and the second plates at the top plate temperature for a period of less than about 1, 2, 3, 4, or 5 seconds; or greater than about 1, 2, 3, 4, or 5 seconds; or about 1, 2, 3, 4, or 5 seconds. In some embodiments, the stamping step may include pressing the leather material between the first and the second plates at the top plate temperature at a pressure of about 75 to about 125 kg/cm², or about 90 to about 110 kg/cm², or about 100 kg/cm².

In some embodiments of the foregoing methods, the Finiflex treatment may include compressing the leather material between two heated rotating metallic wheels at a temperature of about 75 to about 125° C., or about 93° C., at a pressure of about 5 to about 30 kg/m², or about 20 kg/m², and for a period of about 1 to about 10 seconds, or about 4 seconds.

In some embodiments of the foregoing methods, the Uniflex treatment includes pressing the leather material through two pressing cylinders, where the top cylinder is heated to a temperature of about 50 to about 100° C., or about 60° C., while the bottom cylinder may be unheated, and the two cylinders compress the leather material at about 10 to about 50 bar, or about 30 bar, for a period of about 1 to about 10 seconds, or about 3 to about 5 seconds.

In some embodiments, coated leather materials prepared by the foregoing methods may undergo mechanical quality testing according to one or more of a Veslic Process, a Martindale Process, a Water Drop Process, a Hydration Test, and a UV Test.

Veslic Process—Dry (n=50) and wet (n=10) cycles performed at f=1.0 Hz, 1 cm² abrasion cube applied at 1 kg/cm². Visually scored 0-5 (leather and abrasion cube) based on how much color rubs off the leather and onto cube. In some embodiments, dry cycles may from 0-100; wet cycles may be from 0-30; frequency may be from 0.1-2 Hz; and pressure may be from 0-5 kg/cm².

Martindale Process—11 cm² circular cuts of leather samples are rubbed against an abrasive in a lissajous figure pattern (Bowditch curve shape) for n=1500 cycles at a frequency of 0.66-1.0 Hz at 9 kPa. Visually scored 0-5 based on how much color rubs off the leather and onto cube. In some embodiments, the cycles may be from 0-5000; frequency may b from 0.1-2 Hz; and pressure may be from 0-50 kPa.

Water Drop Process— 2-4 droplets are allowed to run the length of a vertically-oriented leather sample; after 1 minute the sample is judged negatively if water streaks remain on the surface. Visually scored 0-5 based on appearance of water streaks on the leather.

Hydration Test—Two circular replicants of the same leather sample are pressed surface-to-surface by a 300 g weight in a humidity chamber (90% Residual Humidity; 50° C.) for 72 hr. Scored based on how easily samples separate from one another after testing and if any color rubs off. In some embodiments, the weight may be from 0-1 kg; the residual humidity may be from 70-95%; the temperature may be from 40-80° C.; and time may be from 24-100 hr.

UV Test—Samples are placed under UV light for 25 hr and observed for color loss. Xe lamp: 42 W/m², 50° C., 2—incident=300-400 nm. Visually scored 0-5 based on how much color fades out of the leather over the testing period. In some embodiments, the time may be from 20-40 hr; lamp intensity may be from 20-60 W/m²; temperature may be from 40-80° C.; and the 2—incident may be about 250-450 nm.

In some embodiments, applying silk at the finishing stage (high-quality finished process) may allow for the creation of a new leather article with a shiny look and a natural touch by mixing silk with casein (e.g., casein phosphoprotein). Silk may be used to replace one of several finishing chemicals normally blended with casein at this stage.

In some embodiments, silk may be used to finish or repair a leather variant requiring lighter coloring treatment. The lighter volumes of colorant and pigment used may render silk more effective at locking in color.

In some embodiments, silk may be used at the wet stages of high-quality finished leather processing (e.g., in the small volume mixing drum) to replace another chemical during the colorant mixing stage.

In some embodiments, a silk wax may be used (or other silk composition described herein) to remove defects/holes in the raw leather (stemming from a follicle or a feed-stock related defect) through application of the silk material onto the skin along any point in the treatment process. If done early in the process, it may be used to change the quality classification of the pre-treated leather to be selected to make a high-quality end product. This effectively provides increased yield (amount of usable leather for a given quality of end product).

Chemical Agents for Use with Leather and Leather Articles Coated with Silk Fibroin-Based Protein Fragments

In certain embodiments, chemical agents may be used to pretreat, treat, and/or post-treat a leather or leather article described herein. In some embodiments, the silk and/or SPF solutions (e.g., SFS), or compositions, described herein, may include one or more of the chemical agents described herein. In some embodiments, the silk and/or SPF solutions or compositions described herein, may replace one or more of the chemical agents described herein. In some embodiments, the chemical agents may be selected from the group consisting of silicone, casein, an acidic agent, a dyeing agent, a pigment dye, a traditional finishing agent, and a technical finishing agent. In some embodiments, chemical agents may include one or more agents recited in Table 2. In some embodiments, the chemical agent may be selected from the group consisting of aqueous lacquers, waxes, oils, binders (protein or other), fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, acidic dyes, basic dyes, dyes (chromium-based or other), colorants, and combinations thereof.

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a wetting agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a wetting agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a wetting agent. In an embodiment, the wetting agent improves one or more coating properties. Suitable wetting agents are known to those of skill in the art. Exemplary, non-limiting examples of wetting agents from a representative supplier, Lamberti SPA, are given in the following table.

| | |
|---|---|
| Imbitex NDT | Non silicone low foaming with high wetting in both |
| | hot or cold conditions, with good detergency and |
| | good stability to alkalis. |
| Imbitex TBL | Wetting and de-aerating agent. |
| Imbitex MRC | Wetting and penetrating agent for mercerizing of |
| | cotton. |
| Tensolam Na | Low foam, special wetting and dispersing agent for |
| liq. | non-woven wet treatments. |
| Imbitex | Wetting agent for water-and oil repellent finishing. |
| NRW3 | |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a detergent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a detergent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a detergent. In an embodiment, the detergent improves one or more coating properties. Suitable detergents are known to those of skill in the art. Exemplary, non-limiting examples of detergents from a representative supplier, Lamberti SPA, are given in the following table.

| | |
|---|---|
| Biorol | Wetting and detergent agent with alkaline stability in NaOH |
| CPNN | up to 10° C. Recommended for continuous scouring, |
| | bleaching, and Jigger applications. |
| Biorol JK | Wetting and detergent agent with extremely low foam |
| new | properties, recommended for high bath turbulence machine |
| | (e.g, jet, overflow, etc.). |
| Biorol | General-purpose wetting and detergent agent suitable for |
| OW 60 | desizing, scouring, and bleaching processes. |
| Biorol | Detergent/wetting agent, low foaming, high concentration, |
| OWK | recommended for over-flow. Useful for removal of silicone |
| | oil on Lycra blends. |
| Cesapon | Specific scouring, de-gumming agent for silk. |
| Silk liq. | |
| Cesapon | High detergent power product containing solvent. |
| Extra | |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a sequestering or dispersing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a sequestering or dispersing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a sequestering or dispersing agent. Suitable sequestering or dispersing agents are known to those of skill in the art. Exemplary, non-limiting examples of sequestering or dispersing agents from a representative supplier, Lamberti SPA, are given in the following table.

| | |
|---|---|
| Lamegal | Dispersing and anti-redepositing agent useful for preparation |
| DSP | dyeing and after soaping of dyed and printed materials with |
| | reactive and vat dyes. This product is also useful as an anti- |
| | oligomer agent in reduction clearing of polyester, dyed or |
| | printed with disperse dyes. |
| Chelam | Multi-purpose sequestering and dispersing agent for a wide |
| TLW/T | variety of textile processes. No shade variation on dyestuff |
| | containing metals. |
| Lamegal | Multi-purpose sequestring and dispersing agent for a wide |
| TL5 | variety of textile processes. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an enzyme. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an enzyme. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an enzyme. Suitable enzymes are known to those of skill in the art. Exemplary, non-limiting examples of enzymes from a representative supplier, Lamberti SPA, are given in the following table.

| | |
|---|---|
| Lazim HT | Thermo-stable amylase for rapid high temperature desizing. |
| Lazim PE | Specific enzyme for bioscouring; provides optimal |
| | wettability, it improves dyeing and color fastness without |
| | causing depolymerization and fabric strength loss. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a bleaching agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a bleaching agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a bleaching agent. Suitable bleaching agents are known to those of skill in the art. Exemplary, non-limiting examples of bleaching agents from a representative supplier, Lamberti SPA, are given in the following table.

| | |
|---|---|
| Stabilox | Highly concentrated stabilizer for alkaline bleaching with |
| OTN conc. | hydrogen peroxide. Suitable for a wide variety of processes. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an antifoaming agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an antifoaming agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an antifoaming agent. Suitable antifoaming agents are known to those of skill in the art. Exemplary, non-limiting examples of antifoaming agents from a representative supplier, Lamberti SPA, are given in the following table.

| | |
|---|---|
| Antifoam SE | General purpose defoaming agent. |
| 47 | |
| Defomex JET | Silicone defoamer effective up to 130° C.. Recommended |
| | for HT and JET dyeing systems. |
| Defomex 2033 | Non-silicone defoamer. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an anti-creasing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an anti-creasing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an anti-creasing agent. Suitable anti-creasing agents are known to those of skill in the art. Exemplary, non-limiting examples of anti-creasing agents from a representative supplier, Lamberti SPA, are given in the following table.

| | |
|---|---|
| Lubisol | Lubricating and anti-creasing agent for rope wet operation on |
| AM | all kind of fibers and machines. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye dispersing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye dispersing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye dispersing agent. Suitable dye dispersing agents are known to those of skill in the art. Exemplary, non-limiting examples of dye dispersing agents from a representative supplier, Lamberti SPA, are given in the following table.

| | |
|---|---|
| Lamegal BO | Liquid dispersing agent (non-ionic), suitable for |
| | direct, reactive, disperse dyeing and PES |
| | stripping. |
| Lamegal DSP | Dispersing and anti back-staining agent in |
| | preparation, dyeing and soaping of dyed and |
| | printed materials. Antioligomer agent. |
| Lamegal 619 | Effective low foam dispersing leveling agent for |
| | dyeing of PES. |
| Lamegal TL5 | Multi-purpose sequestering and dispersing agent |
| | for a variety of textile processes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye leveling agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye leveling agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye leveling agent. Suitable dye leveling agents are known to those of skill in the art. Exemplary, non-limiting examples of dye leveling agents from a representative supplier, Lamberti SPA, are given in the following table.

| | |
|---|---|
| Lamegal A 12 | Leveling agent for dyeing on wool, polyamide |
| | and its blends with acid or metal complex dyes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye fixing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye fixing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye fixing agent. Suitable dye fixing agents are known to those of skill in the art. Exemplary, non-limiting examples of dye fixing agents from a representative supplier, Lamberti SPA, are given in the following table.

| | |
|---|---|
| Lamfix L | Fixing agent for direct and reactive dyestuffs, |
| | containing formaldehyde. |
| Lamfix LU conc. | Formaldehyde free cationic fixing agent for |
| | direct and reactive dyes. It does not affect the |
| | shade and light fastness. |
| Lamfix PA/TR | Fixing agent to improve the wet fastness of acid |
| | dyes on polyamide fabrics, dyed or printed and |
| | polyamide yams. Retarding agent in dyeing of |
| | Polyamide/cellulosic blends with direct dyes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye special resin agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye special resin agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye special resin agent. Suitable dye special resin agents are known to those of skill in the art. Exemplary, non-limiting examples of dye special resin agents from a representative supplier, Lamberti SPA, are given in the following table.

| | |
|---|---|
| Denifast TC | Special resin for cationization of cellulose fibers |
| | to obtain special effects (“DENIFAST system” |
| | and “DENISOL system”). |
| Cobral DD/50 | Special resin for cationization of cellulose fibers |
| | to obtain special effect (“DENIFAST system” |
| | and “DENISOL system”). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye anti-reducing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye anti-reducing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye anti-reducing agent. Suitable dye anti-reducing agents are known to those of skill in the art. Exemplary, non-limiting examples of dye anti-reducing agents from a representative supplier, Lamberti SPA, are given in the following table.

| | |
|---|---|
| Lamberti Redox L2S gra | Anti-reducing agent in grain form. 100% |
| | active content. |
| Lamberti Redox L2S liq. | Anti-reducing agent in liquid form for |
| | automatic dosage. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system anti-migrating agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system anti-migrating agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system anti-migrating agent. Suitable pigment dye system anti-migrating agents are known to those of skill in the art. Exemplary, non-limiting examples of pigment dye system anti-migrating agents from a representative supplier, Lamberti SPA, are given in the following table.

| | |
|---|---|
| Neopat Compound | Compound, developed as migration inhibitor for |
| 96/m conc. | continuous dyeing process with pigments (pad- |
| | dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system binder. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system binder. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system binder. Suitable pigment dye system binders are known to those of skill in the art. Exemplary, non-limiting examples of pigment dye system binders from a representative supplier, Lamberti SPA, are given in the following table.

| | |
|---|---|
| Neopat Binder | Concentrated version of a specific binder used to |
| PM/S conc. | prepare pad-liquor for dyeing with pigments |
| | (pad-dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system binder and anti-migrating agent combination. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system binder and anti-migrating agent combination. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with pigment dye system binder and anti-migrating agent combination. Suitable pigment dye system binder and anti-migrating agent combinations are known to those of skill in the art. Exemplary, non-limiting examples of pigment dye system binder and anti-migrating agent combinations from a representative supplier, Lamberti SPA, are given in the following table.

| | |
|---|---|
| Neopat Compound | Highly concentrated all-in-one product |
| PK1 | specifically developed as migration inhibitor |
| | with specific binder for continuous dyeing |
| | process with pigments (pad-dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a delave agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a delave agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a delave agent. Suitable delave agents are known to those of skill in the art. Exemplary, non-limiting examples of delave agents from a representative supplier, Lamberti SPA, are given in the following table.

| | |
|---|---|
| Neopat compound | Highly concentrated compound of surfactants |
| FTN | and polymers specifically developed for pigment |
| | dyeing and pigment-reactive dyeing process; |
| | especially for medium/dark shades for wash off |
| | effect. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a wrinkle free treatment. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a wrinkle free treatment. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a wrinkle free treatment. Suitable wrinkle free treatments are known to those of skill in the art. Exemplary, non-limiting examples of wrinkle free treatments from a representative supplier, Lamberti SPA, are given in the following table.

| | |
|---|---|
| Cellofix ULF | Anti-crease modified glyoxalic resin for finishing |
| conc. | of cottons, cellulosics and blends with synthetics |
| | fibers. |
| Poliflex PO 40 | Polyethilenic resin for waxy, full and slippy handle |
| | by foulard applications. |
| Rolflex WF | Aliphatic waterborne Nano-PU dispersion used as |
| | extender for wrinkle free treatments. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a softener. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a softener. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a softener. Suitable softeners are known to those of skill in the art. Exemplary, non-limiting examples of softeners from a representative supplier, Lamberti SPA, are given in the following table.

| | |
|---|---|
| Texamina C/FPN | Cationic softening agent with a very soft handle particularly |
| | recommended for application by exhaustion for all kind of |
| | fabrics. Suitable also for cone application. |
| Texamina C SAL | 100% cationic softening agent in flakes form for all type of |
| flakes | fabrics. Dispersible at room temperature. |
| Texamina CL LIQ. | Anphoteric softening agent for all types of fabrics. Not |
| | yellowing. |
| Texamina HVO | Anphoteric softening agent for woven and knitted fabrics of |
| | cotton, other cellulosics and blends. Provides a soft, smooth |
| | and dry handle. Applied by padding. |
| Texamina SIL | Nonionic silicon dispersion in water. Excellent softening, |
| | lubricating and anti-static properties for all fibre types by |
| | padding. |
| Texamina SILK | Special cationic softener with silk protein inside. Provides a |
| | “swollen touch” particularly suitable for cellulosic, wool, silk. |
| Lamfinish LW | All-in compound based on special polymeric hydrophilic |
| | softeners; by coating, foulard, and exhaustion. |
| Elastolam E50 | General purpose mono-component silicone elastomeric |
| | softener for textile finishing. |
| Elastolam EC 100 | Modified polysiloxane micro-emulsion which gives a |
| | permanent finishing, with extremely soft and silky handle. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a handle modifier. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a handle modifier. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a handle modifier. Suitable handle modifiers are known to those of skill in the art. Exemplary, non-limiting examples of handle modifiers from a representative supplier, Lamberti SPA, are given in the following table.

| | |
|---|---|
| Poliflex CSW | Cationic anti-slipping agent. |
| Poliflex R 75 | Parafine finishing agent to give waxy handle. |
| Poliflex s | Compound specifically developed for special |
| | writing effects. |
| Poliflex m | Compound for special dry-waxy handle. |
| Lamsoft SW 24 | Compound for special slippy handle specifically |
| | developed for coating application. |
| Lamfinish SLIPPY | All-in-one compound to get a slippy touch; by |
| | coating. |
| Lamfinish GUMMY | All-in-one compound to get a gummy touch; by |
| | coating. |
| Lamfinish OLDRY | All-in-one compound to get dry-sandy touch |
| | especially suitable for vintage effects; by coating. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a waterborne polyurethane (PU) dispersion. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a waterborne polyurethane (PU) dispersion. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a waterborne polyurethane (PU) dispersion. Suitable waterborne polyurethane dispersions for traditional finishing are known to those of skill in the art. Exemplary, non-limiting examples of waterborne polyurethane dispersions for traditional finishing from a representative supplier, Lamberti SPA, are given in the following table.

| | |
|---|---|
| Rolflex LB 2 | Aliphatic waterborne PU dispersion particularly suggested for |
| | the formulation of textile coatings where bright and rigid top |
| | finish is required. It is particularly suitable as a finishing |
| | agent for organza touch on silk fabrics. Transparent and |
| | shiny. |
| RolflexHP 51 | Aliphatic waterborne PU dispersion particularly suggested for |
| | the formulation of textile coatings for outwear, luggage, |
| | technical articles especially where hard and flexible touch is |
| | required. Transparent and shiny. |
| Rolflex PU 879 | Aliphatic waterborne PU dispersion particularly suggested for |
| | the formulation of textile coatings for outwear, luggage, |
| | technical articles where a medium-hard and flexible touch is |
| | required. |
| Rolflex ALM | Aliphatic waterborne PU dispersion particularly suggested for |
| | the formulation of textile coatings for outwear, luggage, |
| | technical articles where a soft and flexible touch is required. |
| | Can be also suitable for printing application. |
| Rolflex AP | Aliphatic waterborne PU dispersion particularly suggested for |
| | the formulation of textile coatings for outwear, fashion where |
| | a soft and gummy touch is required. |
| Rolflex W4 | Aliphatic waterborne PU dispersion particularly suggested for |
| | the formulation of textile coatings for clothing, outwear where |
| | a full, soft and non sticky touch is required. |
| Rolflex ZB7 | Aliphatic waterborne PU dispersion particularly suggested for |
| | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex BZ 78 | Aliphatic waterborne PU dispersion particularly suggested for |
| | the formulation of textile coatings for clothing, outwear, |
| | sportswear, fashion and technical articles for industrial |
| | applications. The product has an excellent hydrolysis |
| | resistance, a very high charge digestion and electrolytes |
| | stability and an excellent mechanical and tear resistance. Can |
| | be also suitable for foam coating and printing application. |
| Rolflex K 110 | Gives to the coated fabric a full, soft, and slightly sticky |
| | handle with excellent fastness on all types of fabrics. |
| Rolflex OP 80 | Aliphatic waterborne PU dispersion particularly suggested for |
| | the formulation of textile coatings for outwear, luggage and |
| | fashion finishes where an opaque non writing effect is |
| | desired. |
| Rolflex NBC | Aliphatic waterborne PU dispersion generally used by |
| | padding application as a filling and zero formaldehyde sizing |
| | agent. Can be used for outwear and fashion finishing where a |
| | full, elastic and non-sticky touch is required. |
| Rolflex PAD | Aliphatic waterborne PU dispersion specifically designed for |
| | padding application for outwear, sportswear and fashion |
| | applications where a full, elastic and non sticky touch is |
| | required. Excellent washing and dry cleaning fastness as well |
| | as good bath stability. |
| Rolflex PN | Aliphatic waterborne PU dispersion generally applied by |
| | padding application for outerwear and fashion high quality |
| | applications where strong, elastic non sticky finishes are |
| | required. |
| Elafix PV 4 | Aliphatic blocked isocyanate nano-dispersion used in order to |
| | give anti-felting and anti-pilling properties to pure wool |
| | fabrics and his blend. |
| Rolflex SW3 | Aliphatic waterborne PU dispersion particularly suggested to |
| | be used by padding application for the finishing of outwear, |
| | sportswear and fashion where a slippery and elastic touch is |
| | required. It is also a good anti-pilling agent. Excellent in wool |
| | application. |
| Rolflex C 86 | Aliphatic cationic waterborne PU dispersion particularly |
| | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex CN 29 | Aliphatic cationic waterborne PU dispersion particularly |
| | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a finishing resin. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a finishing resin. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a finishing resin. Suitable finishing resins are known to those of skill in the art. Exemplary, non-limiting examples of finishing resins from a representative supplier, Lamberti SPA, are given in the following table.

| | |
|---|---|
| Textol 110 | Handle modifier with very soft handle for coating |
| | finishes |
| Textol RGD | Water emulsion of acrylic copolymer for textile |
| | coating, with very rigid handle. |
| Textol SB 21 | Butadienic resin for finishing and binder for textile |
| | printing |
| Appretto PV/CC | Vinylacetate water dispersion for rigid stiffening |
| Amisolo B | CMS water dispersion for textile finishing as |
| | stiffening agent |
| Lamovil RP | PVOH stabilized solution as stiffening agent |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a waterborne polyurethane dispersion. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a waterborne polyurethane dispersion. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a waterborne polyurethane dispersion. Suitable waterborne polyurethane dispersions for technical finishing are known to those of skill in the art. Exemplary, non-limiting examples of waterborne polyurethane dispersions for technical finishing from a representative supplier, Lamberti SPA, are given in the following table.

| | |
|---|---|
| Rolflex AFP | Aliphatic poly ether polyurethane dispersion in water. The |
| | product has high hydrolysis resistance, good breaking load |
| | resistance and excellent tear resistance. |
| Rolflex ACF | Aliphatic polycarbonate polyurethane dispersion in water. The |
| | product shows good PU and PVC bonding properties, |
| | excellent abrasion resistance as well as chemical resistance, |
| | included alcohol. |
| Rolflex V 13 | Aliphatic poly ether/acry lie copolymer polyurethane dispersion |
| | in water. The product has good thermoadhesive properties and |
| | good adhesion properties on PVC. |
| Rolflex K 80 | Aliphatic poly ether/acry lie copolymer polyurethane dispersion |
| | in water. ROLFLEX K 80 is specifically designed as a high |
| | performing adhesive for textile lamination. The product has |
| | excellent perchloroethylene and water fastness. |
| Rolflex ABC | Aliphatic poly ether polyurethane dispersion in water. |
| | Particularly, the product presents very high water column, |
| | excellent electrolyte resistance, high LOI index, high |
| | resistance to multiple bending. |
| Rolflex ADH | Aliphatic poly ether polyurethane dispersion in water. The |
| | product has a very high water column resistance. |
| Rolflex W4 | Aliphatic waterborne PU dispersion particularly suggested for |
| | the formulation of textile coatings for clothing, outwear where |
| | a full, soft and non-sticky touch is required. |
| Rolflex ZB7 | Aliphatic waterborne PU dispersion particularly suggested for |
| | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex BZ 78 | Aliphatic waterbomed PU dispersion particularly suggested |
| | for the formulation of textile coatings for clothing, outwear, |
| | sportswear, fashion and technical articles for industrial |
| | applications. The product has an excellent hydrolysis |
| | resistance, a very high charge digestion and electrolytes |
| | stability and an excellent mechanical and tear resistance. Can |
| | be also suitable for foam coating and printing application. |
| Rolflex PU 147 | Aliphatic poly ether polyurethane dispersion in water. This |
| | product shows good film forming properties at room |
| | temperature. It has high fastness to light and ultraviolet |
| | radiation and good resistance to water, solvent and chemical |
| | agents, as well as mechanical resistance. |
| Rolflex SG | Aliphatic poly ether polyurethane dispersion in water. Due to |
| | its thermoplastic properties it is suggested to formulate heat |
| | activated adhesives at low temperatures. |
| Elafix PV 4 | Aliphatic blocked isocyanate nano-dispersion used in order to |
| | give antifelting and antipilling properties to pure wool fabrics |
| | and his blend. |
| Rolflex C 86 | Aliphatic cationic waterborne PU dispersion particularly |
| | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex CN 29 | Aliphatic cationic waterborne PU dispersion particularly |
| | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with an oil or water repellant. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with an oil or water repellant. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with an oil or water repellant. Suitable oil or water repellants for technical finishing are known to those of skill in the art. Exemplary, non-limiting examples of oil or water repellants for technical finishing from a representative supplier, Lamberti SPA, are given in the following table.

| | |
|---|---|
| Lamgard FT 60 | General purpose fluorocarbon resin for water and oil |
| | repellency; by padding application. |
| Lamgard 48 | High performance fluorocarbon resin for water and oil |
| | repellency; by padding application. High rubbing |
| | fastness. |
| Imbitex NRW3 | Wetting agent for water-and oil repellent finishing. |
| Lamgard EXT | Crosslinker for fluorocarbon resins to improve |
| | washing fastness. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a flame retardant. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a flame retardant. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a flame retardant. Suitable flame retardants for technical finishing are known to those of skill in the art. Exemplary, non-limiting examples of flame retardants for technical finishing from a representative supplier, Lamberti SPA, are given in the following table.

| | |
|---|---|
| Piroflam 712 | Non-permanent flame retardant compound for padding |
| | and spray application. |
| Piroflam ECO | Alogen free flame retardant compound for back coating |
| | application for all kind of fibers. |
| Piroflam UBC | Flame retardant compound for back coating application |
| | for all kind of fibers. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a crosslinker. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a crosslinker. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a crosslinker. Suitable crosslinkers for technical finishing are known to those of skill in the art. Exemplary, non-limiting examples of crosslinkers for technical finishing from a representative supplier, Lamberti SPA, are given in the following table.

| | |
|---|---|
| Rolflex BK8 | Aromatic blocked polyisocyanate in water dispersion. |
| | It is suggested as a cross-linking agent in coating pastes |
| | based of polyurethane resins to improve washing |
| | fastness. |
| Fissativo 05 | Water dispersible aliphatic polyisocyanate suitable as |
| | crosslinking agent for acrylic and polyurethane |
| | dispersions to improve adhesion and wet and dry scrub |
| | resistance. |
| Resina MEL | Melammine-formaldheyde resin. |
| Cellofix VLF | Low formaldheyde malammine resin. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a thickener for technical finishing. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a thickener for technical finishing. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a thickener for technical finishing. Suitable thickeners for technical finishing are known to those of skill in the art. Exemplary, non-limiting examples of thickeners for technical finishing from a representative supplier, Lamberti SPA, are given in the following table.

| | |
|---|---|
| Lambicol CL 60 | Fully neutralized synthetic thickener for pigment |
| | printing in oil/water emulsion; medium viscosity |
| | type |
| Viscolam PU conc. | Nonionic polyurethane based thickener with |
| | pseudoplastic behavior. |
| Viscolam 115 new | Acrylic thickener; not neutralized. |
| Viscolam PS 202 | Nonionic polyurethane based thickener with |
| | newtonian behavior. |
| Viscolam 1022 | Nonionic polyurethane based thickener with |
| | moderate pseudoplastic behavior. |

In an embodiment, the disclosure provides a leather or leather article processed with a composition comprising silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the disclosure provides a leather or leather article having a coating, wherein the coating comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). Other suitable Union Specialties products such as finishes, additive, and/or oils and waxes are known to those of skill in the art. Exemplary, non-limiting examples of Union Specialties products are given in the following table:

| | |
|---|---|
| Silky Top | NMP-free water-based spray wax top; can be used on any |
| 7425 NF | leather, e.g., sheepskin for garment and nappa; can be sprayed |
| | and then iron on a Finiflex to give desired gloss and feel; can |
| | be sprayed undiluted (for maximum effect) or diluted with |
| | water 1:1 or 1:2. |
| Uniseal | Slightly cationic pre-bottom for corrected grain leathers to |
| 9049 | give uniformity and filling properties; pigment can be added |
| | to UNISEAL 9049 up to 10% for added coverage; can be |
| | sprayed and then plate the leather prior to finishing; can be |
| | diluted and applied by spray method as follows; can be mixed |
| | for 30 minutes under medium shear before using. |
| Unithane | Medium/soft, lightfast, NMP-free waterborne polyurethane, |
| 351 NF | designed for use as a resin binder for basecoats where it has |
| | superior elasticity and recovery adhesion, water resistance |
| | and abrasion resistance; has good filling properties on porous |
| | substrates and very good compatibility with waterborne |
| | pigments and other additives that are commonly used in |
| | waterborne applications. |
| Unithane | NMP-free diamond clear, bright medium-hard topcoat that |
| 2132 NF | gives a feel similar to a nitrocellulose lacquer; when a light |
| | coat is sprayed at a ratio of 1:1 with water onto full grain |
| | leather, the UNITHANE 2132 NF has abrasion resistance and |
| | creates a clear film on leather. |

In any of the foregoing leather or leather article embodiments, the processing composition comprises silk based proteins or fragments thereof having an average weight average molecular weight range of about 5 kDa to about 144 kDa. In any of the foregoing leather or leather article embodiments, the processing composition comprises silk based proteins or fragments thereof having an average weight average molecular weight range of about 6 kDa to about 17 kDa. In any of the foregoing leather or leather article embodiments, the processing composition comprises silk based proteins or fragments thereof having an average weight average molecular weight range of about 17 kDa to about 39 kDa. In any of the foregoing leather or leather article embodiments, the processing composition comprises silk based proteins or fragments thereof having an average weight average molecular weight range of about 39 kDa to about 80 kDa.

In any of the foregoing leather or leather article embodiments, the coating comprises silk based proteins or fragments thereof having an average weight average molecular weight range of about 5 kDa to about 144 kDa. In any of the foregoing leather or leather article embodiments, the coating comprises silk based proteins or fragments thereof having an average weight average molecular weight range of about 6 kDa to about 17 kDa. In any of the foregoing leather or leather article embodiments, the coating comprises silk based proteins or fragments thereof having an average weight average molecular weight range of about 17 kDa to about 39 kDa. In any of the foregoing leather or leather article embodiments, the coating comprises silk based proteins or fragments thereof having an average weight average molecular weight range of about 39 kDa to about 80 kDa.

In any of the foregoing leather or leather article embodiments, the defect repairing filling comprises silk based proteins or fragments thereof having an average weight average molecular weight range of about 5 kDa to about 144 kDa. In any of the foregoing leather or leather article embodiments, the defect repairing filling comprises silk based proteins or fragments thereof having an average weight average molecular weight range of about 6 kDa to about 17 kDa. In any of the foregoing leather or leather article embodiments, the defect repairing filling comprises silk based proteins or fragments thereof having an average weight average molecular weight range of about 17 kDa to about 39 kDa. In any of the foregoing leather or leather article embodiments, the defect repairing filling comprises silk based proteins or fragments thereof having an average weight average molecular weight range of about 39 kDa to about 80 kDa.

In any of the foregoing leather or leather article embodiments, the processing composition comprises silk based proteins or fragments thereof a low molecular weight silk. In any of the foregoing leather or leather article embodiments, the processing composition comprises a medium molecular weight silk. In any of the foregoing leather or leather article embodiments, the processing composition comprises a heavy molecular weight silk. In any of the foregoing leather or leather article embodiments, the processing composition comprises silk based proteins or fragments thereof that comprise one or more of low, medium, and high molecular weight silk.

In any of the foregoing leather or leather article embodiments, the coating comprises silk based proteins or fragments thereof a low molecular weight silk. In any of the foregoing leather or leather article embodiments, the coating comprises a medium molecular weight silk. In any of the foregoing leather or leather article embodiments, the coating comprises a heavy molecular weight silk. In any of the foregoing leather or leather article embodiments, the coating comprises silk based proteins or fragments thereof that comprise one or more of low, medium, and high molecular weight silk.

In any of the foregoing leather or leather article embodiments, the defect repairing filling comprises silk based proteins or fragments thereof a low molecular weight silk. In any of the foregoing leather or leather article embodiments, the defect repairing filling comprises a medium molecular weight silk. In any of the foregoing leather or leather article embodiments, the defect repairing filling comprises a heavy molecular weight silk. In any of the foregoing leather or leather article embodiments, the defect repairing filling comprises silk based proteins or fragments thereof that comprise one or more of low, medium, and high molecular weight silk.

In any of the foregoing leather or leather article embodiments, the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and optionally wherein the proteins or protein fragments, prior to processing, coating, and/or repairing the leather or leather article, do not spontaneously or gradually gelate and do not visibly change in color or turbidity when in a solution for at least 10 days.

### Processes for Production of Silk Fibroin-Based Protein Fragments and Solutions Thereof

As used herein, the term “fibroin” includes silkworm fibroin and insect or spider silk protein. In an embodiment, fibroin is obtained from Bombyx mori. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk).

The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, 9,545,369, and 10,166,177, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein. Methods of using silk fibroin or silk fibroin fragments in coating applications are known and are described for example in U.S. Pat. Nos. 10,287,728 and 10,301,768.

Following are non-limiting examples of suitable ranges for various parameters in and for preparation of the silk solutions and/or compositions of the present disclosure. The silk solutions of the present disclosure may include one or more, but not necessarily all, of these parameters and may be prepared using various combinations of ranges of such parameters.

In an embodiment, the percent silk in the solution or composition is less than 50%. In an embodiment, the percent silk in the solution or composition is less than 45%. In an embodiment, the percent silk in the solution or composition is less than 40%. In an embodiment, the percent silk in the solution or composition is less than 35%. In an embodiment, the percent silk in the solution or composition is less than 30%. In an embodiment, the percent silk in the solution or composition is less than 25%. In an embodiment, the percent silk in the solution or composition is less than 20%. In an embodiment, the percent silk in the solution or composition is less than 19%. In an embodiment, the percent silk in the solution or composition is less than 18%. In an embodiment, the percent silk in the solution or composition is less than 17%. In an embodiment, the percent silk in the solution or composition is less than 16%. In an embodiment, the percent silk in the solution or composition is less than 15%. In an embodiment, the percent silk in the solution or composition is less than 14%. In an embodiment, the percent silk in the solution or composition is less than 13%. In an embodiment, the percent silk in the solution or composition is less than 12%. In an embodiment, the percent silk in the solution or composition is less than 11%. In an embodiment, the percent silk in the solution or composition is less than 10%. In an embodiment, the percent silk in the solution or composition is less than 9%. In an embodiment, the percent silk in the solution or composition is less than 8%. In an embodiment, the percent silk in the solution or composition is less than 7%. In an embodiment, the percent silk in the solution or composition is less than 6%. In an embodiment, the percent silk in the solution or composition is less than 5%. In an embodiment, the percent silk in the solution or composition is less than 4%. In an embodiment, the percent silk in the solution or composition is less than 3%. In an embodiment, the percent silk in the solution or composition is less than 2%. In an embodiment, the percent silk in the solution or composition is less than 1%. In an embodiment, the percent silk in the solution or composition is less than 0.9%. In an embodiment, the percent silk in the solution or composition is less than 0.8%. In an embodiment, the percent silk in the solution or composition is less than 0.7%. In an embodiment, the percent silk in the solution or composition is less than 0.6%. In an embodiment, the percent silk in the solution or composition is less than 0.5%. In an embodiment, the percent silk in the solution or composition is less than 0.4%. In an embodiment, the percent silk in the solution or composition is less than 0.3%. In an embodiment, the percent silk in the solution or composition is less than 0.2%. In an embodiment, the percent silk in the solution or composition is less than 0.1%. In an embodiment, the percent silk in the solution or composition is less than 0.01%. In an embodiment, the percent silk in the solution or composition is less than 0.001%.

In an embodiment, the percent silk in the solution or composition is greater than 0.001%. In an embodiment, the percent silk in the solution or composition is greater than 0.01%. In an embodiment, the percent silk in the solution or composition is greater than 0.1%. In an embodiment, the percent silk in the solution or composition is greater than 0.2%. In an embodiment, the percent silk in the solution or composition is greater than 0.3%. In an embodiment, the percent silk in the solution or composition is greater than 0.4%. In an embodiment, the percent silk in the solution or composition is greater than 0.5%. In an embodiment, the percent silk in the solution or composition is greater than 0.6%. In an embodiment, the percent silk in the solution or composition is greater than 0.7%. In an embodiment, the percent silk in the solution or composition is greater than 0.8%. In an embodiment, the percent silk in the solution or composition is greater than 0.9%. In an embodiment, the percent silk in the solution or composition is greater than 1%. In an embodiment, the percent silk in the solution or composition is greater than 2%. In an embodiment, the percent silk in the solution or composition is greater than 3%. In an embodiment, the percent silk in the solution or composition is greater than 4%. In an embodiment, the percent silk in the solution or composition is greater than 5%. In an embodiment, the percent silk in the solution or composition is greater than 6%. In an embodiment, the percent silk in the solution or composition is greater than 7%. In an embodiment, the percent silk in the solution or composition is greater than 8%. In an embodiment, the percent silk in the solution or composition is greater than 9%. In an embodiment, the percent silk in the solution or composition is greater than 10%. In an embodiment, the percent silk in the solution or composition is greater than 11%. In an embodiment, the percent silk in the solution or composition is greater than 12%. In an embodiment, the percent silk in the solution or composition is greater than 13%. In an embodiment, the percent silk in the solution or composition is greater than 14%. In an embodiment, the percent silk in the solution or composition is greater than 15%. In an embodiment, the percent silk in the solution or composition is greater than 16%. In an embodiment, the percent silk in the solution or composition is greater than 17%. In an embodiment, the percent silk in the solution or composition is greater than 18%. In an embodiment, the percent silk in the solution or composition is greater than 19%. In an embodiment, the percent silk in the solution or composition is greater than 20%. In an embodiment, the percent silk in the solution or composition is greater than 25%. In an embodiment, the percent silk in the solution or composition is greater than 30%. In an embodiment, the percent silk in the solution or composition is greater than 35%. In an embodiment, the percent silk in the solution or composition is greater than 40%. In an embodiment, the percent silk in the solution or composition is greater than 45%. In an embodiment, the percent silk in the solution or composition is greater than 50%.

In an embodiment, the percent silk in the solution or composition is between 0.1% and 50%. In an embodiment, the percent silk in the solution or composition is between 0.1% and 45%. In an embodiment, the percent silk in the solution or composition is between 0.1% and 40%. In an embodiment, the percent silk in the solution or composition is between 0.1% and 35%. In an embodiment, the percent silk in the solution or composition is between 0.1% and 30%. In an embodiment, the percent silk in the solution or composition is between 0.1% and 25%. In an embodiment, the percent silk in the solution or composition is between 0.1% and 20%. In an embodiment, the percent silk in the solution or composition is between 0.1% and 15%. In an embodiment, the percent silk in the solution or composition is between 0.1% and 10%. In an embodiment, the percent silk in the solution or composition is between 0.1% and 9%. In an embodiment, the percent silk in the solution or composition is between 0.1% and 8%. In an embodiment, the percent silk in the solution or composition is between 0.1% and 7%. In an embodiment, the percent silk in the solution or composition is between 0.1% and 6.5%. In an embodiment, the percent silk in the solution or composition is between 0.1% and 6%. In an embodiment, the percent silk in the solution or composition is between 0.1% and 5.5%. In an embodiment, the percent silk in the solution or composition is between 0.1% and 5%. In an embodiment, the percent silk in the solution or composition is between 0.1% and 4.5%. In an embodiment, the percent silk in the solution or composition is between 0.1% and 4%. In an embodiment, the percent silk in the solution or composition is between 0.1% and 3.5%. In an embodiment, the percent silk in the solution or composition is between 0.1% and 3%. In an embodiment, the percent silk in the solution or composition is between 0.1% and 2.5%. In an embodiment, the percent silk in the solution or composition is between 0.1% and 2.0%. In an embodiment, the percent silk in the solution or composition is between 0.1% and 2.4%. In an embodiment, the percent silk in the solution or composition is between 0.5% and 5%. In an embodiment, the percent silk in the solution or composition is between 0.5% and 4.5%. In an embodiment, the percent silk in the solution or composition is between 0.5% and 4%. In an embodiment, the percent silk in the solution or composition is between 0.5% and 3.5%. In an embodiment, the percent silk in the solution or composition is between 0.5% and 3%. In an embodiment, the percent silk in the solution or composition is between 0.5% and 2.5%. In an embodiment, the percent silk in the solution or composition is between 1 and 4%. In an embodiment, the percent silk in the solution or composition is between 1 and 3.5%. In an embodiment, the percent silk in the solution or composition is between 1 and 3%. In an embodiment, the percent silk in the solution or composition is between 1 and 2.5%. In an embodiment, the percent silk in the solution or composition is between 1 and 2.4%. In an embodiment, the percent silk in the solution or composition is between 1 and 2%. In an embodiment, the percent silk in the solution or composition is between 20% and 30%. In an embodiment, the percent silk in the solution or composition is between 0.1% and 6%. In an embodiment, the percent silk in the solution or composition is between 6% and 10%. In an embodiment, the percent silk in the solution or composition is between 6% and 8%. In an embodiment, the percent silk in the solution or composition is between 6% and 9%. In an embodiment, the percent silk in the solution or composition is between 10% and 20%. In an embodiment, the percent silk in the solution or composition is between 11% and 19%. In an embodiment, the percent silk in the solution or composition is between 12% and 18%. In an embodiment, the percent silk in the solution or composition is between 13% and 17%. In an embodiment, the percent silk in the solution or composition is between 14% and 16%. In an embodiment, the percent silk in the solution or composition is 2.4%. In an embodiment, the percent silk in the solution or composition is 2.0%.

In an embodiment, the percent sericin in the solution or composition is non-detectable to 30%. In an embodiment, the percent sericin in the solution or composition is non-detectable to 5%. In an embodiment, the percent sericin in the solution or composition is 1%. In an embodiment, the percent sericin in the solution or composition is 2%. In an embodiment, the percent sericin in the solution or composition is 3%. In an embodiment, the percent sericin in the solution or composition is 4%. In an embodiment, the percent sericin in the solution or composition is 5%. In an embodiment, the percent sericin in the solution or composition is 10%. In an embodiment, the percent sericin in the solution or composition is 30%.

In an embodiment, a solution or composition of the present disclosure includes pure silk fibroin-based protein fragments having an average weight average molecular weight ranging from 6 kDa to 17 kDa. In an embodiment, a solution or composition of the present disclosure includes pure silk fibroin-based protein fragments having an average weight average molecular weight ranging from 17 kDa to 39 kDa. In an embodiment, a solution or composition of the present disclosure includes pure silk fibroin-based protein fragments having an average weight average molecular weight ranging from 39 kDa to 80 kDa.

In an embodiment, a composition of the present disclosure includes pure silk fibroin-based protein fragments having an average weight average molecular weight ranging from 1 to 5 kDa. In an embodiment, a composition of the present disclosure includes pure silk fibroin-based protein fragments having an average weight average molecular weight ranging from 5 to 10 kDa. In an embodiment, a composition of the present disclosure includes pure silk fibroin-based protein fragments having an average weight average molecular weight ranging from 10 to 15 kDa. In an embodiment, a composition of the present disclosure includes pure silk fibroin-based protein fragments having an average weight average molecular weight ranging from 15 to 20 kDa. In an embodiment, a composition of the present disclosure includes pure silk fibroin-based protein fragments having an average weight average molecular weight ranging from 20 to 25 kDa. In an embodiment, a composition of the present disclosure includes pure silk fibroin-based protein fragments having an average weight average molecular weight ranging from 25 to 30 kDa. In an embodiment, a composition of the present disclosure includes pure silk fibroin-based protein fragments having an average weight average molecular weight ranging from 30 to 35 kDa. In an embodiment, a composition of the present disclosure includes pure silk fibroin-based protein fragments having an average weight average molecular weight ranging from 35 to 40 kDa. In an embodiment, a composition of the present disclosure includes pure silk fibroin-based protein fragments having an average weight average molecular weight ranging from 40 to 45 kDa. In an embodiment, a composition of the present disclosure includes pure silk fibroin-based protein fragments having an average weight average molecular weight ranging from 45 to 50 kDa. In an embodiment, a composition of the present disclosure includes pure silk fibroin-based protein fragments having an average weight average molecular weight ranging from 50 to 55 kDa. In an embodiment, a composition of the present disclosure includes pure silk fibroin-based protein fragments having an average weight average molecular weight ranging from 55 to 60 kDa. In an embodiment, a composition of the present disclosure includes pure silk fibroin-based protein fragments having an average weight average molecular weight ranging from 60 to 65 kDa. In an embodiment, a composition of the present disclosure includes pure silk fibroin-based protein fragments having an average weight average molecular weight ranging from 65 to 70 kDa. In an embodiment, a composition of the present disclosure includes pure silk fibroin-based protein fragments having an average weight average molecular weight ranging from 70 to 75 kDa. In an embodiment, a composition of the present disclosure includes pure silk fibroin-based protein fragments having an average weight average molecular weight ranging from 75 to 80 kDa. In an embodiment, a composition of the present disclosure includes pure silk fibroin-based protein fragments having an average weight average molecular weight ranging from 80 to 85 kDa. In an embodiment, a composition of the present disclosure includes pure silk fibroin-based protein fragments having an average weight average molecular weight ranging from 85 to 90 kDa. In an embodiment, a composition of the present disclosure includes pure silk fibroin-based protein fragments having an average weight average molecular weight ranging from 90 to 95 kDa. In an embodiment, a composition of the present disclosure includes pure silk fibroin-based protein fragments having an average weight average molecular weight ranging from 95 to 100 kDa. In an embodiment, a composition of the present disclosure includes pure silk fibroin-based protein fragments having an average weight average molecular weight ranging from 100 to 105 kDa. In an embodiment, a composition of the present disclosure includes pure silk fibroin-based protein fragments having an average weight average molecular weight ranging from 105 to 110 kDa. In an embodiment, a composition of the present disclosure includes pure silk fibroin-based protein fragments having an average weight average molecular weight ranging from 110 to 115 kDa. In an embodiment, a composition of the present disclosure includes pure silk fibroin-based protein fragments having an average weight average molecular weight ranging from 115 to 120 kDa. In an embodiment, a composition of the present disclosure includes pure silk fibroin-based protein fragments having an average weight average molecular weight ranging from 120 to 125 kDa. In an embodiment, a composition of the present disclosure includes pure silk fibroin-based protein fragments having an average weight average molecular weight ranging from 125 to 130 kDa. In an embodiment, a composition of the present disclosure includes pure silk fibroin-based protein fragments having an average weight average molecular weight ranging from 130 to 135 kDa. In an embodiment, a composition of the present disclosure includes pure silk fibroin-based protein fragments having an average weight average molecular weight ranging from 135 to 140 kDa. In an embodiment, a composition of the present disclosure includes pure silk fibroin-based protein fragments having an average weight average molecular weight ranging from 140 to 145 kDa. In an embodiment, a composition of the present disclosure includes pure silk fibroin-based protein fragments having an average weight average molecular weight ranging from 145 to 150 kDa. In an embodiment, a composition of the present disclosure includes pure silk fibroin-based protein fragments having an average weight average molecular weight ranging from 150 to 155 kDa. In an embodiment, a composition of the present disclosure includes pure silk fibroin-based protein fragments having an average weight average molecular weight ranging from 155 to 160 kDa. In an embodiment, a composition of the present disclosure includes pure silk fibroin-based protein fragments having an average weight average molecular weight ranging from 160 to 165 kDa. In an embodiment, a composition of the present disclosure includes pure silk fibroin-based protein fragments having an average weight average molecular weight ranging from 165 to 170 kDa. In an embodiment, a composition of the present disclosure includes pure silk fibroin-based protein fragments having an average weight average molecular weight ranging from 170 to 175 kDa. In an embodiment, a composition of the present disclosure includes pure silk fibroin-based protein fragments having an average weight average molecular weight ranging from 175 to 180 kDa. In an embodiment, a composition of the present disclosure includes pure silk fibroin-based protein fragments having an average weight average molecular weight ranging from 180 to 185 kDa. In an embodiment, a composition of the present disclosure includes pure silk fibroin-based protein fragments having an average weight average molecular weight ranging from 185 to 190 kDa. In an embodiment, a composition of the present disclosure includes pure silk fibroin-based protein fragments having an average weight average molecular weight ranging from 190 to 195 kDa. In an embodiment, a composition of the present disclosure includes pure silk fibroin-based protein fragments having an average weight average molecular weight ranging from 195 to 200 kDa. In an embodiment, a composition of the present disclosure includes pure silk fibroin-based protein fragments having an average weight average molecular weight ranging from 200 to 205 kDa. In an embodiment, a composition of the present disclosure includes pure silk fibroin-based protein fragments having an average weight average molecular weight ranging from 205 to 210 kDa. In an embodiment, a composition of the present disclosure includes pure silk fibroin-based protein fragments having an average weight average molecular weight ranging from 210 to 215 kDa. In an embodiment, a composition of the present disclosure includes pure silk fibroin-based protein fragments having an average weight average molecular weight ranging from 215 to 220 kDa. In an embodiment, a composition of the present disclosure includes pure silk fibroin-based protein fragments having an average weight average molecular weight ranging from 220 to 225 kDa. In an embodiment, a composition of the present disclosure includes pure silk fibroin-based protein fragments having an average weight average molecular weight ranging from 225 to 230 kDa. In an embodiment, a composition of the present disclosure includes pure silk fibroin-based protein fragments having an average weight average molecular weight ranging from 230 to 235 kDa. In an embodiment, a composition of the present disclosure includes pure silk fibroin-based protein fragments having an average weight average molecular weight ranging from 235 to 240 kDa. In an embodiment, a composition of the present disclosure includes pure silk fibroin-based protein fragments having an average weight average molecular weight ranging from 240 to 245 kDa. In an embodiment, a composition of the present disclosure includes pure silk fibroin-based protein fragments having an average weight average molecular weight ranging from 245 to 250 kDa. In an embodiment, a composition of the present disclosure includes pure silk fibroin-based protein fragments having an average weight average molecular weight ranging from 250 to 255 kDa. In an embodiment, a composition of the present disclosure includes pure silk fibroin-based protein fragments having an average weight average molecular weight ranging from 255 to 260 kDa. In an embodiment, a composition of the present disclosure includes pure silk fibroin-based protein fragments having an average weight average molecular weight ranging from 260 to 265 kDa. In an embodiment, a composition of the present disclosure includes pure silk fibroin-based protein fragments having an average weight average molecular weight ranging from 265 to 270 kDa. In an embodiment, a composition of the present disclosure includes pure silk fibroin-based protein fragments having an average weight average molecular weight ranging from 270 to 275 kDa. In an embodiment, a composition of the present disclosure includes pure silk fibroin-based protein fragments having an average weight average molecular weight ranging from 275 to 280 kDa. In an embodiment, a composition of the present disclosure includes pure silk fibroin-based protein fragments having an average weight average molecular weight ranging from 280 to 285 kDa. In an embodiment, a composition of the present disclosure includes pure silk fibroin-based protein fragments having an average weight average molecular weight ranging from 285 to 290 kDa. In an embodiment, a composition of the present disclosure includes pure silk fibroin-based protein fragments having an average weight average molecular weight ranging from 290 to 295 kDa. In an embodiment, a composition of the present disclosure includes pure silk fibroin-based protein fragments having an average weight average molecular weight ranging from 295 to 300 kDa. In an embodiment, a composition of the present disclosure includes pure silk fibroin-based protein fragments having an average weight average molecular weight ranging from 300 to 305 kDa. In an embodiment, a composition of the present disclosure includes pure silk fibroin-based protein fragments having an average weight average molecular weight ranging from 305 to 310 kDa. In an embodiment, a composition of the present disclosure includes pure silk fibroin-based protein fragments having an average weight average molecular weight ranging from 310 to 315 kDa. In an embodiment, a composition of the present disclosure includes pure silk fibroin-based protein fragments having an average weight average molecular weight ranging from 315 to 320 kDa. In an embodiment, a composition of the present disclosure includes pure silk fibroin-based protein fragments having an average weight average molecular weight ranging from 320 to 325 kDa. In an embodiment, a composition of the present disclosure includes pure silk fibroin-based protein fragments having an average weight average molecular weight ranging from 325 to 330 kDa. In an embodiment, a composition of the present disclosure includes pure silk fibroin-based protein fragments having an average weight average molecular weight ranging from 330 to 335 kDa. In an embodiment, a composition of the present disclosure includes pure silk fibroin-based protein fragments having an average weight average molecular weight ranging from 35 to 340 kDa. In an embodiment, a composition of the present disclosure includes pure silk fibroin-based protein fragments having an average weight average molecular weight ranging from 340 to 345 kDa. In an embodiment, a composition of the present disclosure includes pure silk fibroin-based protein fragments having an average weight average molecular weight ranging from 345 to 350 kDa.

In an embodiment, a composition of the present disclosure includes silk protein fragments having an average weight average molecular weight ranging from 6 kDa to 17 kDa. In an embodiment, a composition of the present disclosure includes silk protein fragments having an average weight average molecular weight ranging from 17 kDa to 39 kDa. In an embodiment, a composition of the present disclosure includes silk protein fragments having an average weight average molecular weight ranging from 39 kDa to 80 kDa.

In an embodiment, a composition of the present disclosure includes silk protein fragments having an average weight average molecular weight of about 1 kDa to about 350 kDa, or about 1 kDa to about 300 kDa, or about 1 kDa to about 250 kDa, or about 1 kDa to about 200 kDa, or about 1 kDa to about 150 kDa, or about 1 kDa to about 100 kDa, or about 1 kDa to about 50 kDa, or about 1 kDa to about 25 kDa.

In an embodiment, silk fibroin-based protein fragments incorporated into the silk compositions described herein have having an average weight average molecular weight ranging from 1 kDa to 6 kDa. In an embodiment, silk fibroin-based protein fragments incorporated into the silk compositions described herein have an average weight average molecular weight ranging from 6 kDa to 16 kDa. In an embodiment, silk fibroin-based protein fragments incorporated into the silk compositions described herein have an average weight average molecular weight ranging from 16 kDa to 38 kDa. In an embodiment, silk fibroin-based protein fragments incorporated into the silk compositions described herein have an average weight average molecular weight ranging from 38 kDa to 80 kDa. In an embodiment, silk fibroin-based protein fragments incorporated into the silk compositions described herein have an average weight average molecular weight ranging from 80 kDa to 150 kDa.

In an embodiment, silk fibroin-based protein fragments incorporated into the silk compositions described herein have an average weight average molecular weight ranging from 1 kDa to 250 kDa. In an embodiment, silk fibroin-based protein fragments incorporated into the silk compositions described herein have an average weight average molecular weight ranging from 1 kDa to 240 kDa. In an embodiment, silk fibroin-based protein fragments incorporated into the silk compositions described herein have an average weight average molecular weight ranging from 1 kDa to 230 kDa. In an embodiment, silk fibroin-based protein fragments incorporated into the silk compositions described herein have an average weight average molecular weight ranging from 1 kDa to 220 kDa. In an embodiment, silk fibroin-based protein fragments incorporated into the silk compositions described herein have an average weight average molecular weight ranging from 1 kDa to 210 kDa. In an embodiment, silk fibroin-based protein fragments incorporated into the silk compositions described herein have an average weight average molecular weight ranging from 1 kDa to 200 kDa. In an embodiment, silk fibroin-based protein fragments incorporated into the silk compositions described herein have an average weight average molecular weight ranging from 1 kDa to 190 kDa. In an embodiment, silk fibroin-based protein fragments incorporated into the silk compositions described herein have an average weight average molecular weight ranging from 1 kDa to 180 kDa. In an embodiment, silk fibroin-based protein fragments incorporated into the silk compositions described herein have an average weight average molecular weight ranging from 1 kDa to 170 kDa. In an embodiment, silk fibroin-based protein fragments incorporated into the silk compositions described herein have an average weight average molecular weight ranging from 1 kDa to 160 kDa. In an embodiment, silk fibroin-based protein fragments incorporated into the silk compositions described herein have an average weight average molecular weight ranging from 1 kDa to 150 kDa. In an embodiment, silk fibroin-based protein fragments incorporated into the silk compositions described herein have an average weight average molecular weight ranging from 1 kDa to 140 kDa. In an embodiment, silk fibroin-based protein fragments incorporated into the silk compositions described herein have an average weight average molecular weight ranging from 1 kDa to 130 kDa. In an embodiment, silk fibroin-based protein fragments incorporated into the silk compositions described herein have an average weight average molecular weight ranging from 1 kDa to 120 kDa. In an embodiment, silk fibroin-based protein fragments incorporated into the silk compositions described herein have an average weight average molecular weight ranging from 1 kDa to 110 kDa. In an embodiment, silk fibroin-based protein fragments incorporated into the silk compositions described herein have an average weight average molecular weight ranging from 1 kDa to 100 kDa. In an embodiment, silk fibroin-based protein fragments incorporated into the silk compositions described herein have an average weight average molecular weight ranging from 1 kDa to 90 kDa. In an embodiment, silk fibroin-based protein fragments incorporated into the silk compositions described herein have an average weight average molecular weight ranging from 1 kDa to 80 kDa. In an embodiment, silk fibroin-based protein fragments incorporated into the silk compositions described herein have an average weight average molecular weight ranging from 1 kDa to 70 kDa. In an embodiment, silk fibroin-based protein fragments incorporated into the silk compositions described herein have an average weight average molecular weight ranging from 1 kDa to 60 kDa. In an embodiment, silk fibroin-based protein fragments incorporated into the silk compositions described herein have an average weight average molecular weight ranging from 1 kDa to 50 kDa. In an embodiment, silk fibroin-based protein fragments incorporated into the silk compositions described herein have an average weight average molecular weight ranging from 1 kDa to 40 kDa. In an embodiment, silk fibroin-based protein fragments incorporated into the silk compositions described herein have an average weight average molecular weight ranging from 1 kDa to 30 kDa. In an embodiment, silk fibroin-based protein fragments incorporated into the silk compositions described herein have an average weight average molecular weight ranging from 1 kDa to 20 kDa. In an embodiment, silk fibroin-based protein fragments incorporated into the silk compositions described herein have an average weight average molecular weight ranging from 1 kDa to 10 kDa.

In an embodiment, a composition of the present disclosure includes silk protein fragments having an average weight average molecular weight ranging from 1 to 5 kDa. In an embodiment, a composition of the present disclosure includes silk protein fragments having an average weight average molecular weight ranging from 5 to 10 kDa. In an embodiment, a composition of the present disclosure includes silk protein fragments having an average weight average molecular weight ranging from 10 to 15 kDa. In an embodiment, a composition of the present disclosure includes silk protein fragments having an average weight average molecular weight ranging from 15 to 20 kDa. In an embodiment, a composition of the present disclosure includes silk protein fragments having an average weight average molecular weight ranging from 20 to 25 kDa. In an embodiment, a composition of the present disclosure includes silk protein fragments having an average weight average molecular weight ranging from 25 to 30 kDa. In an embodiment, a composition of the present disclosure includes silk protein fragments having an average weight average molecular weight ranging from 30 to 35 kDa. In an embodiment, a composition of the present disclosure includes silk protein fragments having an average weight average molecular weight ranging from 35 to 40 kDa. In an embodiment, a composition of the present disclosure includes silk protein fragments having an average weight average molecular weight ranging from 40 to 45 kDa. In an embodiment, a composition of the present disclosure includes silk protein fragments having an average weight average molecular weight ranging from 45 to 50 kDa. In an embodiment, a composition of the present disclosure includes silk protein fragments having an average weight average molecular weight ranging from 50 to 55 kDa. In an embodiment, a composition of the present disclosure includes silk protein fragments having an average weight average molecular weight ranging from 55 to 60 kDa. In an embodiment, a composition of the present disclosure includes silk protein fragments having an average weight average molecular weight ranging from 60 to 65 kDa. In an embodiment, a composition of the present disclosure includes silk protein fragments having an average weight average molecular weight ranging from 65 to 70 kDa. In an embodiment, a composition of the present disclosure includes silk protein fragments having an average weight average molecular weight ranging from 70 to 75 kDa. In an embodiment, a composition of the present disclosure includes silk protein fragments having an average weight average molecular weight ranging from 75 to 80 kDa. In an embodiment, a composition of the present disclosure includes silk protein fragments having an average weight average molecular weight ranging from 80 to 85 kDa. In an embodiment, a composition of the present disclosure includes silk protein fragments having an average weight average molecular weight ranging from 85 to 90 kDa. In an embodiment, a composition of the present disclosure includes silk protein fragments having an average weight average molecular weight ranging from 90 to 95 kDa. In an embodiment, a composition of the present disclosure includes silk protein fragments having an average weight average molecular weight ranging from 95 to 100 kDa. In an embodiment, a composition of the present disclosure includes silk protein fragments having an average weight average molecular weight ranging from 100 to 105 kDa. In an embodiment, a composition of the present disclosure includes silk protein fragments having an average weight average molecular weight ranging from 105 to 110 kDa. In an embodiment, a composition of the present disclosure includes silk protein fragments having an average weight average molecular weight ranging from 110 to 115 kDa. In an embodiment, a composition of the present disclosure includes silk protein fragments having an average weight average molecular weight ranging from 115 to 120 kDa. In an embodiment, a composition of the present disclosure includes silk protein fragments having an average weight average molecular weight ranging from 120 to 125 kDa. In an embodiment, a composition of the present disclosure includes silk protein fragments having an average weight average molecular weight ranging from 125 to 130 kDa. In an embodiment, a composition of the present disclosure includes silk protein fragments having an average weight average molecular weight ranging from 130 to 135 kDa. In an embodiment, a composition of the present disclosure includes silk protein fragments having an average weight average molecular weight ranging from 135 to 140 kDa. In an embodiment, a composition of the present disclosure includes silk protein fragments having an average weight average molecular weight ranging from 140 to 145 kDa. In an embodiment, a composition of the present disclosure includes silk protein fragments having an average weight average molecular weight ranging from 145 to 150 kDa. In an embodiment, a composition of the present disclosure includes silk protein fragments having an average weight average molecular weight ranging from 150 to 155 kDa. In an embodiment, a composition of the present disclosure includes silk protein fragments having an average weight average molecular weight ranging from 155 to 160 kDa. In an embodiment, a composition of the present disclosure includes silk protein fragments having an average weight average molecular weight ranging from 160 to 165 kDa. In an embodiment, a composition of the present disclosure includes silk protein fragments having an average weight average molecular weight ranging from 165 to 170 kDa. In an embodiment, a composition of the present disclosure includes silk protein fragments having an average weight average molecular weight ranging from 170 to 175 kDa. In an embodiment, a composition of the present disclosure includes silk protein fragments having an average weight average molecular weight ranging from 175 to 180 kDa. In an embodiment, a composition of the present disclosure includes silk protein fragments having an average weight average molecular weight ranging from 180 to 185 kDa. In an embodiment, a composition of the present disclosure includes silk protein fragments having an average weight average molecular weight ranging from 185 to 190 kDa. In an embodiment, a composition of the present disclosure includes silk protein fragments having an average weight average molecular weight ranging from 190 to 195 kDa. In an embodiment, a composition of the present disclosure includes silk protein fragments having an average weight average molecular weight ranging from 195 to 200 kDa. In an embodiment, a composition of the present disclosure includes silk protein fragments having an average weight average molecular weight ranging from 200 to 205 kDa. In an embodiment, a composition of the present disclosure includes silk protein fragments having an average weight average molecular weight ranging from 205 to 210 kDa. In an embodiment, a composition of the present disclosure includes silk protein fragments having an average weight average molecular weight ranging from 210 to 215 kDa. In an embodiment, a composition of the present disclosure includes silk protein fragments having an average weight average molecular weight ranging from 215 to 220 kDa. In an embodiment, a composition of the present disclosure includes silk protein fragments having an average weight average molecular weight ranging from 220 to 225 kDa. In an embodiment, a composition of the present disclosure includes silk protein fragments having an average weight average molecular weight ranging from 225 to 230 kDa. In an embodiment, a composition of the present disclosure includes silk protein fragments having an average weight average molecular weight ranging from 230 to 235 kDa. In an embodiment, a composition of the present disclosure includes silk protein fragments having an average weight average molecular weight ranging from 235 to 240 kDa. In an embodiment, a composition of the present disclosure includes silk protein fragments having an average weight average molecular weight ranging from 240 to 245 kDa. In an embodiment, a composition of the present disclosure includes silk protein fragments having an average weight average molecular weight ranging from 245 to 250 kDa. In an embodiment, a composition of the present disclosure includes silk protein fragments having an average weight average molecular weight ranging from 250 to 255 kDa. In an embodiment, a composition of the present disclosure includes silk protein fragments having an average weight average molecular weight ranging from 255 to 260 kDa. In an embodiment, a composition of the present disclosure includes silk protein fragments having an average weight average molecular weight ranging from 260 to 265 kDa. In an embodiment, a composition of the present disclosure includes silk protein fragments having an average weight average molecular weight ranging from 265 to 270 kDa. In an embodiment, a composition of the present disclosure includes silk protein fragments having an average weight average molecular weight ranging from 270 to 275 kDa. In an embodiment, a composition of the present disclosure includes silk protein fragments having an average weight average molecular weight ranging from 275 to 280 kDa. In an embodiment, a composition of the present disclosure includes silk protein fragments having an average weight average molecular weight ranging from 280 to 285 kDa. In an embodiment, a composition of the present disclosure includes silk protein fragments having an average weight average molecular weight ranging from 285 to 290 kDa. In an embodiment, a composition of the present disclosure includes silk protein fragments having an average weight average molecular weight ranging from 290 to 295 kDa. In an embodiment, a composition of the present disclosure includes silk protein fragments having an average weight average molecular weight ranging from 295 to 300 kDa. In an embodiment, a composition of the present disclosure includes silk protein fragments having an average weight average molecular weight ranging from 300 to 305 kDa. In an embodiment, a composition of the present disclosure includes silk protein fragments having an average weight average molecular weight ranging from 305 to 310 kDa. In an embodiment, a composition of the present disclosure includes silk protein fragments having an average weight average molecular weight ranging from 310 to 315 kDa. In an embodiment, a composition of the present disclosure includes silk protein fragments having an average weight average molecular weight ranging from 315 to 320 kDa. In an embodiment, a composition of the present disclosure includes silk protein fragments having an average weight average molecular weight ranging from 320 to 325 kDa. In an embodiment, a composition of the present disclosure includes silk protein fragments having an average weight average molecular weight ranging from 325 to 330 kDa. In an embodiment, a composition of the present disclosure includes silk protein fragments having an average weight average molecular weight ranging from 330 to 335 kDa. In an embodiment, a composition of the present disclosure includes silk protein fragments having an average weight average molecular weight ranging from 35 to 340 kDa. In an embodiment, a composition of the present disclosure includes silk protein fragments having an average weight average molecular weight ranging from 340 to 345 kDa. In an embodiment, a composition of the present disclosure includes silk protein fragments having an average weight average molecular weight ranging from 345 to 350 kDa.

In an embodiment, a composition of the present disclosure includes silk protein fragments having an average weight average molecular weight of about 5 kDa. In an embodiment, a composition of the present disclosure includes silk protein fragments having an average weight average molecular weight of about 6 kDa. In an embodiment, a composition of the present disclosure includes silk protein fragments having an average weight average molecular weight of about 7 kDa. In an embodiment, a composition of the present disclosure includes silk protein fragments having an average weight average molecular weight of about 8 kDa. In an embodiment, a composition of the present disclosure includes silk protein fragments having an average weight average molecular weight of about 9 kDa. In an embodiment, a composition of the present disclosure includes silk protein fragments having an average weight average molecular weight of about 10 kDa.

In an embodiment, a composition of the present disclosure includes silk protein fragments having an average weight average molecular weight of about 11 kDa. In an embodiment, a composition of the present disclosure includes silk protein fragments having an average weight average molecular weight of about 12 kDa. In an embodiment, a composition of the present disclosure includes silk protein fragments having an average weight average molecular weight of about 13 kDa. In an embodiment, a composition of the present disclosure includes silk protein fragments having an average weight average molecular weight of about 14 kDa. In an embodiment, a composition of the present disclosure includes silk protein fragments having an average weight average molecular weight of about 15 kDa. In an embodiment, a composition of the present disclosure includes silk protein fragments having an average weight average molecular weight of about 16 kDa. In an embodiment, a composition of the present disclosure includes silk protein fragments having an average weight average molecular weight of about 17 kDa. In an embodiment, a composition of the present disclosure includes silk protein fragments having an average weight average molecular weight of about 18 kDa. In an embodiment, a composition of the present disclosure includes silk protein fragments having an average weight average molecular weight of about 19 kDa. In an embodiment, a composition of the present disclosure includes silk protein fragments having an average weight average molecular weight of about 20 kDa.

In an embodiment, a composition of the present disclosure includes silk protein fragments having an average weight average molecular weight of about 21 kDa. In an embodiment, a composition of the present disclosure includes silk protein fragments having an average weight average molecular weight of about 22 kDa. In an embodiment, a composition of the present disclosure includes silk protein fragments having an average weight average molecular weight of about 23 kDa. In an embodiment, a composition of the present disclosure includes silk protein fragments having an average weight average molecular weight of about 24 kDa. In an embodiment, a composition of the present disclosure includes silk protein fragments having an average weight average molecular weight of about 25 kDa. In an embodiment, a composition of the present disclosure includes silk protein fragments having an average weight average molecular weight of about 26 kDa. In an embodiment, a composition of the present disclosure includes silk protein fragments having an average weight average molecular weight of about 27 kDa. In an embodiment, a composition of the present disclosure includes silk protein fragments having an average weight average molecular weight of about 28 kDa. In an embodiment, a composition of the present disclosure includes silk protein fragments having an average weight average molecular weight of about 29 kDa. In an embodiment, a composition of the present disclosure includes silk protein fragments having an average weight average molecular weight of about 30 kDa.

In an embodiment, a composition of the present disclosure includes silk protein fragments having an average weight average molecular weight of about 31 kDa. In an embodiment, a composition of the present disclosure includes silk protein fragments having an average weight average molecular weight of about 32 kDa. In an embodiment, a composition of the present disclosure includes silk protein fragments having an average weight average molecular weight of about 33 kDa. In an embodiment, a composition of the present disclosure includes silk protein fragments having an average weight average molecular weight of about 34 kDa. In an embodiment, a composition of the present disclosure includes silk protein fragments having an average weight average molecular weight of about 35 kDa. In an embodiment, a composition of the present disclosure includes silk protein fragments having an average weight average molecular weight of about 36 kDa. In an embodiment, a composition of the present disclosure includes silk protein fragments having an average weight average molecular weight of about 37 kDa. In an embodiment, a composition of the present disclosure includes silk protein fragments having an average weight average molecular weight of about 38 kDa. In an embodiment, a composition of the present disclosure includes silk protein fragments having an average weight average molecular weight of about 39 kDa. In an embodiment, a composition of the present disclosure includes silk protein fragments having an average weight average molecular weight of about 40 kDa.

In an embodiment, a composition of the present disclosure includes silk protein fragments having an average weight average molecular weight of about 41 kDa. In an embodiment, a composition of the present disclosure includes silk protein fragments having an average weight average molecular weight of about 42 kDa. In an embodiment, a composition of the present disclosure includes silk protein fragments having an average weight average molecular weight of about 43 kDa. In an embodiment, a composition of the present disclosure includes silk protein fragments having an average weight average molecular weight of about 44 kDa. In an embodiment, a composition of the present disclosure includes silk protein fragments having an average weight average molecular weight of about 45 kDa. In an embodiment, a composition of the present disclosure includes silk protein fragments having an average weight average molecular weight of about 46 kDa. In an embodiment, a composition of the present disclosure includes silk protein fragments having an average weight average molecular weight of about 47 kDa. In an embodiment, a composition of the present disclosure includes silk protein fragments having an average weight average molecular weight of about 48 kDa. In an embodiment, a composition of the present disclosure includes silk protein fragments having an average weight average molecular weight of about 49 kDa. In an embodiment, a composition of the present disclosure includes silk protein fragments having an average weight average molecular weight of about 50 kDa.

In an embodiment, a composition of the present disclosure includes silk protein fragments having an average weight average molecular weight of about 51 kDa. In an embodiment, a composition of the present disclosure includes silk protein fragments having an average weight average molecular weight of about 52 kDa. In an embodiment, a composition of the present disclosure includes silk protein fragments having an average weight average molecular weight of about 53 kDa. In an embodiment, a composition of the present disclosure includes silk protein fragments having an average weight average molecular weight of about 54 kDa. In an embodiment, a composition of the present disclosure includes silk protein fragments having an average weight average molecular weight of about 55 kDa. In an embodiment, a composition of the present disclosure includes silk protein fragments having an average weight average molecular weight of about 56 kDa. In an embodiment, a composition of the present disclosure includes silk protein fragments having an average weight average molecular weight of about 57 kDa. In an embodiment, a composition of the present disclosure includes silk protein fragments having an average weight average molecular weight of about 58 kDa. In an embodiment, a composition of the present disclosure includes silk protein fragments having an average weight average molecular weight of about 59 kDa. In an embodiment, a composition of the present disclosure includes silk protein fragments having an average weight average molecular weight of about 60 kDa.

In an embodiment, a composition of the present disclosure includes silk protein fragments having an average weight average molecular weight of about 61 kDa. In an embodiment, a composition of the present disclosure includes silk protein fragments having an average weight average molecular weight of about 62 kDa. In an embodiment, a composition of the present disclosure includes silk protein fragments having an average weight average molecular weight of about 63 kDa. In an embodiment, a composition of the present disclosure includes silk protein fragments having an average weight average molecular weight of about 64 kDa. In an embodiment, a composition of the present disclosure includes silk protein fragments having an average weight average molecular weight of about 65 kDa. In an embodiment, a composition of the present disclosure includes silk protein fragments having an average weight average molecular weight of about 66 kDa. In an embodiment, a composition of the present disclosure includes silk protein fragments having an average weight average molecular weight of about 67 kDa. In an embodiment, a composition of the present disclosure includes silk protein fragments having an average weight average molecular weight of about 68 kDa. In an embodiment, a composition of the present disclosure includes silk protein fragments having an average weight average molecular weight of about 69 kDa. In an embodiment, a composition of the present disclosure includes silk protein fragments having an average weight average molecular weight of about 70 kDa.

In an embodiment, a composition of the present disclosure includes silk protein fragments having an average weight average molecular weight of about 71 kDa. In an embodiment, a composition of the present disclosure includes silk protein fragments having an average weight average molecular weight of about 72 kDa. In an embodiment, a composition of the present disclosure includes silk protein fragments having an average weight average molecular weight of about 73 kDa. In an embodiment, a composition of the present disclosure includes silk protein fragments having an average weight average molecular weight of about 74 kDa. In an embodiment, a composition of the present disclosure includes silk protein fragments having an average weight average molecular weight of about 75 kDa. In an embodiment, a composition of the present disclosure includes silk protein fragments having an average weight average molecular weight of about 76 kDa. In an embodiment, a composition of the present disclosure includes silk protein fragments having an average weight average molecular weight of about 77 kDa. In an embodiment, a composition of the present disclosure includes silk protein fragments having an average weight average molecular weight of about 78 kDa. In an embodiment, a composition of the present disclosure includes silk protein fragments having an average weight average molecular weight of about 79 kDa. In an embodiment, a composition of the present disclosure includes silk protein fragments having an average weight average molecular weight of about 80 kDa.

In an embodiment, a composition of the present disclosure includes silk protein fragments having an average weight average molecular weight of about 81 kDa. In an embodiment, a composition of the present disclosure includes silk protein fragments having an average weight average molecular weight of about 82 kDa. In an embodiment, a composition of the present disclosure includes silk protein fragments having an average weight average molecular weight of about 83 kDa. In an embodiment, a composition of the present disclosure includes silk protein fragments having an average weight average molecular weight of about 84 kDa. In an embodiment, a composition of the present disclosure includes silk protein fragments having an average weight average molecular weight of about 85 kDa. In an embodiment, a composition of the present disclosure includes silk protein fragments having an average weight average molecular weight of about 86 kDa. In an embodiment, a composition of the present disclosure includes silk protein fragments having an average weight average molecular weight of about 87 kDa. In an embodiment, a composition of the present disclosure includes silk protein fragments having an average weight average molecular weight of about 88 kDa. In an embodiment, a composition of the present disclosure includes silk protein fragments having an average weight average molecular weight of about 89 kDa. In an embodiment, a composition of the present disclosure includes silk protein fragments having an average weight average molecular weight of about 90 kDa.

In an embodiment, a composition of the present disclosure includes silk protein fragments having an average weight average molecular weight of about 91 kDa. In an embodiment, a composition of the present disclosure includes silk protein fragments having an average weight average molecular weight of about 92 kDa. In an embodiment, a composition of the present disclosure includes silk protein fragments having an average weight average molecular weight of about 93 kDa. In an embodiment, a composition of the present disclosure includes silk protein fragments having an average weight average molecular weight of about 94 kDa. In an embodiment, a composition of the present disclosure includes silk protein fragments having an average weight average molecular weight of about 95 kDa. In an embodiment, a composition of the present disclosure includes silk protein fragments having an average weight average molecular weight of about 96 kDa. In an embodiment, a composition of the present disclosure includes silk protein fragments having an average weight average molecular weight of about 97 kDa. In an embodiment, a composition of the present disclosure includes silk protein fragments having an average weight average molecular weight of about 98 kDa. In an embodiment, a composition of the present disclosure includes silk protein fragments having an average weight average molecular weight of about 99 kDa. In an embodiment, a composition of the present disclosure includes silk protein fragments having an average weight average molecular weight of about 100 kDa.

In an embodiment, a composition of the present disclosure includes silk protein fragments having an average weight average molecular weight of about 101 kDa. In an embodiment, a composition of the present disclosure includes silk protein fragments having an average weight average molecular weight of about 102 kDa. In an embodiment, a composition of the present disclosure includes silk protein fragments having an average weight average molecular weight of about 103 kDa. In an embodiment, a composition of the present disclosure includes silk protein fragments having an average weight average molecular weight of about 104 kDa. In an embodiment, a composition of the present disclosure includes silk protein fragments having an average weight average molecular weight of about 105 kDa. In an embodiment, a composition of the present disclosure includes silk protein fragments having an average weight average molecular weight of about 106 kDa. In an embodiment, a composition of the present disclosure includes silk protein fragments having an average weight average molecular weight of about 107 kDa. In an embodiment, a composition of the present disclosure includes silk protein fragments having an average weight average molecular weight of about 108 kDa. In an embodiment, a composition of the present disclosure includes silk protein fragments having an average weight average molecular weight of about 109 kDa. In an embodiment, a composition of the present disclosure includes silk protein fragments having an average weight average molecular weight of about 110 kDa.

In an embodiment, a composition of the present disclosure includes silk protein fragments having an average weight average molecular weight of about 111 kDa. In an embodiment, a composition of the present disclosure includes silk protein fragments having an average weight average molecular weight of about 112 kDa. In an embodiment, a composition of the present disclosure includes silk protein fragments having an average weight average molecular weight of about 113 kDa. In an embodiment, a composition of the present disclosure includes silk protein fragments having an average weight average molecular weight of about 114 kDa. In an embodiment, a composition of the present disclosure includes silk protein fragments having an average weight average molecular weight of about 115 kDa. In an embodiment, a composition of the present disclosure includes silk protein fragments having an average weight average molecular weight of about 116 kDa. In an embodiment, a composition of the present disclosure includes silk protein fragments having an average weight average molecular weight of about 117 kDa. In an embodiment, a composition of the present disclosure includes silk protein fragments having an average weight average molecular weight of about 118 kDa. In an embodiment, a composition of the present disclosure includes silk protein fragments having an average weight average molecular weight of about 119 kDa. In an embodiment, a composition of the present disclosure includes silk protein fragments having an average weight average molecular weight of about 120 kDa.

In an embodiment, a composition of the present disclosure includes silk protein fragments having an average weight average molecular weight of about 121 kDa. In an embodiment, a composition of the present disclosure includes silk protein fragments having an average weight average molecular weight of about 122 kDa. In an embodiment, a composition of the present disclosure includes silk protein fragments having an average weight average molecular weight of about 123 kDa. In an embodiment, a composition of the present disclosure includes silk protein fragments having an average weight average molecular weight of about 124 kDa. In an embodiment, a composition of the present disclosure includes silk protein fragments having an average weight average molecular weight of about 125 kDa. In an embodiment, a composition of the present disclosure includes silk protein fragments having an average weight average molecular weight of about 126 kDa. In an embodiment, a composition of the present disclosure includes silk protein fragments having an average weight average molecular weight of about 127 kDa. In an embodiment, a composition of the present disclosure includes silk protein fragments having an average weight average molecular weight of about 128 kDa. In an embodiment, a composition of the present disclosure includes silk protein fragments having an average weight average molecular weight of about 129 kDa. In an embodiment, a composition of the present disclosure includes silk protein fragments having an average weight average molecular weight of about 130 kDa.

In an embodiment, a composition of the present disclosure includes silk protein fragments having an average weight average molecular weight of about 131 kDa. In an embodiment, a composition of the present disclosure includes silk protein fragments having an average weight average molecular weight of about 132 kDa. In an embodiment, a composition of the present disclosure includes silk protein fragments having an average weight average molecular weight of about 133 kDa. In an embodiment, a composition of the present disclosure includes silk protein fragments having an average weight average molecular weight of about 134 kDa. In an embodiment, a composition of the present disclosure includes silk protein fragments having an average weight average molecular weight of about 135 kDa. In an embodiment, a composition of the present disclosure includes silk protein fragments having an average weight average molecular weight of about 136 kDa. In an embodiment, a composition of the present disclosure includes silk protein fragments having an average weight average molecular weight of about 137 kDa. In an embodiment, a composition of the present disclosure includes silk protein fragments having an average weight average molecular weight of about 138 kDa. In an embodiment, a composition of the present disclosure includes silk protein fragments having an average weight average molecular weight of about 139 kDa. In an embodiment, a composition of the present disclosure includes silk protein fragments having an average weight average molecular weight of about 140 kDa.

In an embodiment, a composition of the present disclosure includes silk protein fragments having an average weight average molecular weight of about 141 kDa. In an embodiment, a composition of the present disclosure includes silk protein fragments having an average weight average molecular weight of about 142 kDa. In an embodiment, a composition of the present disclosure includes silk protein fragments having an average weight average molecular weight of about 143 kDa. In an embodiment, a composition of the present disclosure includes silk protein fragments having an average weight average molecular weight of about 144 kDa.

In an embodiment, a composition of the present disclosure includes silk fibroin-based protein fragments having one or more of low molecular weight, medium molecular weight, and high molecular weight. In an embodiment, a composition of the present disclosure includes silk fibroin-based protein fragments having low molecular weight and silk fibroin-based protein fragments having medium molecular weight. In an embodiment, a composition of the present disclosure includes silk fibroin-based protein fragments having low molecular weight and silk fibroin-based protein fragments having high molecular weight. In an embodiment, a composition of the present disclosure includes silk fibroin-based protein fragments having medium molecular weight and silk fibroin-based protein fragments having high molecular weight. In an embodiment, a composition of the present disclosure includes silk fibroin-based protein fragments having low molecular weight, silk fibroin-based protein fragments having medium molecular weight, and silk fibroin-based protein fragments having high molecular weight.

In an embodiment, a composition of the present disclosure includes silk fibroin-based protein fragments having low molecular weight and silk fibroin-based protein fragments having medium molecular weight. In some embodiments, the w/w ratio between low molecular weight silk fibroin-based protein fragments and medium molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and medium molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and medium molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight and silk fibroin-based protein fragments having high molecular weight. In some embodiments, the w/w ratio between low molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having medium molecular weight and silk fibroin-based protein fragments having high molecular weight. In some embodiments, the w/w ratio between medium molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight, silk fibroin-based protein fragments having medium molecular weight, and silk fibroin-based protein fragments having high molecular weight. In an embodiment, the w/w ratio between low molecular weight silk fibroin-based protein fragments, medium molecular weight silk fibroin-based protein fragments, and high molecular weight silk fibroin-based protein fragments is about 1:1:8, about 1:2:7, about 1:3:6, about 1:4:5, about 1:5:4, about 1:6:3, about 1:7:2, about 1:8:1, about 2:1:7, about 2:2:6, about 2:3:5, about 2:4:4, about 2:5:3, about 2:6:2, about 2:7:1, about 3:1:6, about 3:2:5, about 3:3:4, about 3:4:3, about 3:5:2, about 3:6:1, about 4:1:5, about 4:2:4, about 4:3:3, about 4:4:2, about 4:5:1, about 5:1:4, about 5:2:3, about 5:3:2, about 5:4:1, about 6:1:3, about 6:2:2, about 6:3:1, about 7:1:2, about 7:2:1, or about 8:1:1.

In some embodiments, the silk compositions provided herein may be applied as mixtures to an article to be processed or in stepwise processes to the article. For example, a silk composition that includes low molecular weight silk and medium molecular weight silk may be applied to an article to be processed. Alternatively, a low molecular weight silk composition may be applied to an article to be processed, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be coated or in stepwise processes to form coating layers on the article. For example, a silk composition that includes low molecular weight silk and medium molecular weight silk may be applied to an article to be coated. Alternatively, a low molecular weight silk composition may be applied to an article to be coated, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be repaired or in stepwise processes to form fillings in or on the article. For example, a silk composition that includes low molecular weight silk and medium molecular weight silk may be applied to an article to be repaired. Alternatively, a low molecular weight silk composition may be applied to an article to be repaired, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, where multiple layers of silk compositions are applied to an article to be coated, they may have at least one layer, or 1 layer to 1 million layers, or 1 layer to 100,000 layers, or 1 layer to 10,000 layers, or 1 layer to 1,000 layers of such silk compositions, wherein the layers may have the same or different thicknesses. For example, in some embodiments, the layers may have a thickness of from about 1 nm to about 1 mm, or about 1 nm to about 1 μm, or about 1 nm to about 500 nm, or about 1 nm to about 400 nm, or about 1 nm to about 300 nm, or about 1 nm to about 200 nm, or about 1 nm to about 100 nm, or about 1 nm to about 75 nm, or about 1 nm to about 50 nm, or about 1 nm to about 25 nm, or about 1 nm to about 20 nm, or about 1 nm to about 15 nm, or about 1 nm to about 10 nm, or about 1 nm to about 5 nm.

In an embodiment, a composition of the present disclosure having pure silk fibroin-based protein fragments has a polydispersity ranging from about 1 to about 5.0. In an embodiment, a composition of the present disclosure having pure silk fibroin-based protein fragments has a polydispersity ranging from about 1.5 to about 3.0. In an embodiment, a composition of the present disclosure having pure silk fibroin-based protein fragments has a polydispersity ranging from about 1 to about 1.5. In an embodiment, a composition of the present disclosure having pure silk fibroin-based protein fragments has a polydispersity ranging from about 1.5 to about 2.0. In an embodiment, a composition of the present disclosure having pure silk fibroin-based protein fragments has a polydispersity ranging from about 2.0 to about 2.5. In an embodiment, a composition of the present disclosure having pure silk fibroin-based protein fragments, has a polydispersity ranging from about is 2.0 to about 3.0. In an embodiment, a composition of the present disclosure having pure silk fibroin-based protein fragments, has a polydispersity ranging from about is 2.5 to about 3.0.

In an embodiment, a composition of the present disclosure having silk protein fragments has a polydispersity ranging from about 1 to about 5.0. In an embodiment, a composition of the present disclosure having silk protein fragments has a polydispersity ranging from about 1.5 to about 3.0. In an embodiment, a composition of the present disclosure having silk protein fragments has a polydispersity ranging from about 1 to about 1.5. In an embodiment, a composition of the present disclosure having silk protein fragments has a polydispersity ranging from about 1.5 to about 2.0. In an embodiment, a composition of the present disclosure having silk protein fragments has a polydispersity ranging from about 2.0 to about 2.5. In an embodiment, a composition of the present disclosure having silk protein fragments, has a polydispersity ranging from about is 2.0 to about 3.0. In an embodiment, a composition of the present disclosure having silk protein fragments, has a polydispersity ranging from about is 2.5 to about 3.0.

In some embodiments the polydispersity of low molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of medium molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of high molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments, in compositions described herein having combinations of low, medium, and/or high molecular weight silk protein fragments, such low, medium, and/or high molecular weight silk proteins may have the same or different polydispersities.

### Compositions and Processes Including Silk Fibroin-Based Processing Compositions, Coatings, or Fillings

In an embodiment, the disclosure may include leather or leather articles that may be processed, coated, or repaired with an SPF mixture solution (i.e., silk fibroin solution (SFS)), and/or composition, as described herein to produce a processed, coated, or repaired article. In an embodiment, the processed, coated, or repaired articles described herein may be treated with additional chemical agents that may enhance the properties of the coated article. In an embodiment, the SFS may enhance the properties of the coated or repaired article, or the SFS may include one or more chemical agents that may enhance the properties of the coated or repaired article.

In some embodiments, chemical finishes may be applied to leather or leather articles before or after such leather or leather articles are processed, coated, or repaired with SFS. In an embodiment, chemical finishing may be intended as the application of chemical agents and/or SFS to leather or leather articles to modify the original leather's or leather articles' properties and achieve properties in the leather or leather articles that would be otherwise absent. With chemical finishes, leather or leather articles treated with such chemical finishes may act as surface treatments and/or the treatments may modify the elemental analysis of treated leather or leather article base polymers.

In an embodiment, a type of chemical finishing may include the application of certain silk-fibroin based solutions to leather or leather articles. For example, SFS may be applied to a leather or leather article after it is dyed, but there are also scenarios that may require the application of SFS during processing, during dyeing, or after a garment is assembled from a selected leather or leather article. In some embodiments, after its application, SFS may be dried with the use of heat. In some embodiments, SFS may then be fixed to the surface of the leather or leather article in a processing step called curing.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 1%, or greater than about 0.1%, or greater than about 0.01%, or greater than about 0.001%, or greater than about 0.0001%, or greater than about 0.00001%.

In some embodiments, the solution concentration and the wet pick of the material determines the amount of silk fibroin solution (SFS), which may include silk-based proteins or fragments thereof, that may be fixed or otherwise adhered to the leather or leather article being coated. The wet pick up may be expressed by the following formula:

$$wet pick up ( \% ) = \frac{weight of SFS applied ⨯ 100}{weight of dry textile material} .$$

The total amount of SFS added to the leather or leather article may be expressed by the following formula:

$$SFS added ( \% ) = \frac{weight of dry SFS coated material ⨯ 100}{weight of dry material before coating} .$$

Regarding methods for applying SFS to leather or leather articles more broadly, SFS may be applied to leather or leather articles through a pad or roller application on process, a saturation and removal process, and/or a topical application process. Moreover, the methods of silk application (i.e., SFS application or coating) may include bath coating, kiss rolling, spray coating, and/or two-sided rolling. In some embodiments, the coating processes (e.g., bath coating, kiss rolling, spray coating, two-sided rolling, roller application, saturation and removal application, and/or topical application), drying processes, and curing processes may be varied as described herein to modify one or more selected leather or leather article properties of the resulting coated leather or leather article wherein such properties.

In an embodiment, the drying and/or curing temperature for the processes of the disclosure may be less than about 70° C., or less than about 75° C., or less than about 80° C., or less than about 85° C., or less than about 90° C., or less than about 95° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C., or less than about 230° C.

In an embodiment, the drying and/or curing temperature for the processes of the disclosure may be greater than about 70° C., or greater than about 75° C., or greater than about 80° C., or greater than about 85° C., or greater than about 90° C., or greater than about 95° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C., or greater than about 230° C.

In an embodiment, the drying time for the processes of the disclosure may be less than about 10 seconds, or less than about 20 seconds, or less than about 30 seconds, or less than about 40 seconds, or less than about 50 seconds, or less than about 60 seconds, or less than about 2 minutes, or less than about, 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the drying time for the processes of the disclosure may be greater than about 10 seconds, or greater than about 20 seconds, or greater than about 30 seconds, or greater than about 40 seconds, or greater than about 50 seconds, or greater than about 60 seconds, or greater than about 2 minutes, or greater than about, 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In an embodiment, the curing time for the processes of the disclosure may be less than about 1 second, or less than about 2 seconds, or less than about 3 seconds, or less than about 4 seconds, or less than about 5 seconds, or less than about 6 seconds, or less than about 7 seconds, or less than about 8 seconds, or less than about 9 seconds, or less than about 10 seconds, or less than about 20 seconds, or less than about 30 seconds, or less than about 40 seconds, or less than about 50 seconds, or less than about 60 seconds, or less than about 2 minutes, or less than about 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the curing time for the processes of the disclosure may be greater than about 1 second, or greater than about 2 seconds, or greater than about 3 seconds, or greater than about 4 seconds, or greater than about 5 seconds, or greater than about 6 seconds, or greater than about 7 seconds, or greater than about 8 seconds, or greater than about 9 seconds, or greater than about 10 seconds, or greater than about 20 seconds, or greater than about 30 seconds, or greater than about 40 seconds, or greater than about 50 seconds, or greater than about 60 seconds, or greater than about 2 minutes, or greater than about 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In some embodiments, a silk fibroin processed or coated material may be heat resistant to a selected temperature where the selected temperature is chosen for drying, curing, and/or heat setting a dye that may be applied to the material (e.g., a coated leather or leather article). As used herein, a “heat resistant” may refer to a property of the silk fibroin coating deposited on the material where the silk fibroin coating and/or silk fibroin protein does not exhibit a substantial modification (i.e., “substantially modifying”) in silk fibroin coating performance as compared to a control material having a comparable silk fibroin coating that was not subjected to the selected temperature for drying, curing, wash cycling, and/or heat setting purposes. In some embodiments, the selected temperature is the glass transition temperature (Tg) for the material upon which the silk fibroin coating is applied. In some embodiments, the selected temperature is greater than about 65° C., or greater than about 70° C., or greater than about 80° C., or greater than about 90° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 65° C., or less than about 70° C., or less than about 80° C., or less than about 90° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In some embodiments, the SFS processed, coated, or repaired article may be subjected to heat setting in order to set one or more dyes that may be applied to the SFS coated article in order to permanently set the one or more dyes on the SFS coated or repaired article. In some embodiments, the SFS processed, coated, or repaired article may be heat setting resistant, wherein the SFS coating on the SFS coated article may resist a heat setting temperature of greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In an embodiment, a material processed, coated, or repaired by the silk fibroin coating or filling composition as described herein may partially dissolved or otherwise partially incorporated within a portion of the material after the silk fibroin coated or repaired material is subjected to heating and/or curing as described herein. Without being limited to any one theory, where the silk fibroin processed, coated, or repaired material is heated to greater than about the glass transition temperature (Tg) for the material that is processed, coated, or repaired, the silk fibroin coating may become partially dissolved or otherwise partially incorporated within a portion of the material.

In some embodiments, a material processed, coated, or repaired by the silk fibroin coating as described herein may be sterile or may be sterilized to provide a sterilized silk fibroin coated material. Alternatively, or in addition thereto, the methods described herein may include a sterile SFS prepared from sterile silk fibroin.

In some embodiments, SFS may be used in an SFS processing composition, coating, or repairing composition, where such composition or coating includes one or more chemical agents (e.g., a silicone). SFS may be provided in such an SFS coating at a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.01%, or less than about 0.001%. In some embodiments, SFS may be provided in such an SFS coating at a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 1%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.1%, or greater than about 0.01%, or greater than about 0.001%.

In some embodiments, chemical fabric softeners may include silicones as described herein.

In some embodiments, the chemical agents may include the following, which are supplied by CHT Bezema and are associated with certain selected leather's or leather article's properties, which may be used to strengthen SFS binding on coated or repaired surfaces and/or SFS may be used for enhancing the following chemical agents' properties:
ALPAPRINT CLEAR
   Silicone printing and coating
   Component B is mentioned in the technical leaflet
   Dry handle
   Good rubbing fastness
   Good washfastness
ALPAPRINT ELASTIC ADD
   Silicone printing and coating
   Component B is mentioned in the technical leaflet
   Good rubbing fastness
   Good washfastness
   Suited for yardage printing
ALPAPRINT WHITE
   Silicone printing and coating
   Component B is mentioned in the technical leaflet
   Dry handle
   Good rubbing fastness
   Good washfastness
ALPATEC 30142 A
   Textile finishing
   Coating
   Silicone printing and coating
   Component B is mentioned in the technical leaflet
   Suitable for narrow ribbon coating
   Good rubbing fastness
   Good washfastness
ALPATEC 30143 A
   Silicone printing and coating
   Component B is mentioned in the technical leaflet
   Good rubbing fastness
   Good washfastness
   Suited for yardage printing
ALPATEC 30191 A
   Silicone printing and coating
   Component B is mentioned in the technical leaflet
   Suitable for narrow ribbon coating
   High transparency
   Coating
ALPATEC 30203 A
   Silicone printing and coating
   Component B is mentioned in the technical leaflet
   Suitable for narrow ribbon coating
   High transparency
   Coating
ALPATEC 3040 LSR KOMP. A
   Functional coatings, Silicone printing and coating
   Component B is mentioned in the technical leaflet
   High abrasion resistance
   High transparency
   Coating
ALPATEC 3060 LSR KOMP. A
   Functional coatings, Silicone printing and coating
   Component B is mentioned in the technical leaflet
   High abrasion resistance
   High transparency
   Coating
ALPATEC 530
   Silicone printing and coating
   Suitable for narrow ribbon coating
   High transparency
   Coating
   One component system
ALPATEC 540
   Silicone printing and coating
   Suitable for narrow ribbon coating
   High transparency
   Coating
   One component system
ALPATEC 545
   Silicone printing and coating
   Suitable for narrow ribbon coating
   High transparency
   Coating
   One component system
ALPATEC 550
   Silicone printing and coating
   Suitable for narrow ribbon coating
   High transparency
   Coating
   One component system
ALPATEC 730
   Silicone printing and coating
   Suitable for narrow ribbon coating
   Good washfastness
   High abrasion resistance
   High transparency
ALPATEC 740
   Silicone printing and coating
   Suitable for narrow ribbon coating
   Good washfastness
   High abrasion resistance
   High transparency
ALPATEC 745
   Silicone printing and coating
   Suitable for narrow ribbon coating
   Good washfastness
   High abrasion resistance
   High transparency
ALPATEC 750
   Silicone printing and coating
   Suitable for narrow ribbon coating
   Good washfastness
   High abrasion resistance
   High transparency
ALPATEC BANDAGE A
   Silicone printing and coating
   Component B is mentioned in the technical leaflet
   Suitable for narrow ribbon coating
   Coating
   Two component system
APYROL BASE2 E
   Flame retardants
   Liquid
   Soft handle
   For BS 5852/1+2
   Suited for paste coating
APYROL FCR-2
   Water repellency/oil repellency
   Cationic
   High effectiveness
   Water-based
   Liquid
APYROL FFD E
   Flame retardants
   Liquid
   Suited for polyester
   Suited for polyamide
   Flame inhibiting filler
APYROL FR CONC E
   Flame retardants, Functional coatings
   Liquid
   Suited for polyester
   Suited for polyamide
   Flame inhibiting filler
APYROL GBO-E
   Flame retardants, Functional coatings
   Suited for polyester
   Black-out coating
   For DIN 4102/B1
   Containing halogen
APYROL LV 21
   Flame retardants, Functional coatings
   For DIN 4102/B1
   Suited for paste coating
   Suited for backcoating of black-out vertical blinds and roller blinds
   Containing halogen
APYROL PP 31
   Flame retardants
   Liquid
   Free from antimony
   Flame inhibiting filler
   For BS 5852/1+2
APYROL PP 46
   Flame retardants
   Powder
   Free from antimony
   Flame inhibiting filler
   Suited for paste coating
APYROL PREM E
   Flame retardants
   Soft handle
   For BS 5852/1+2
   Containing halogen
   Semi-permanent
APYROL PREM2 E
   Flame retardants
   Soft handle
   For BS 5852/1+2
   Containing halogen
   Semi-permanent
COLORDUR 005 WHITE
   Flock adhesives, Functional coatings, Silicone printing and coating
   Based on silicone
   Dyestuff pigment suspension
COLORDUR 105 LEMON
   Flock adhesives, Functional coatings, Silicone printing and coating
   Based on silicone
   Dyestuff pigment suspension
COLORDUR 115 GOLDEN YELLOW
   Flock adhesives, Functional coatings, Silicone printing and coating
   Based on silicone
   Dyestuff pigment suspension
COLORDUR 185 ORANGE
   Flock adhesives, Functional coatings, Silicone printing and coating
   Based on silicone
   Dyestuff pigment suspension
COLORDUR 215 RED
   Flock adhesives, Functional coatings, Silicone printing and coating
   Based on silicone
   Dyestuff pigment suspension
COLORDUR 225 DARK RED
   Flock adhesives, Functional coatings, Silicone printing and coating
   Based on silicone
   Dyestuff pigment suspension
COLORDUR 285 VIOLET
   Flock adhesives, Functional coatings, Silicone printing and coating
   Based on silicone
   Dyestuff pigment suspension
COLORDUR 305 BLUE
   Flock adhesives, Functional coatings, Silicone printing and coating
   Based on silicone
   Dyestuff pigment suspension
COLORDUR 355 MARINE
   Flock adhesives, Functional coatings, Silicone printing and coating
   Based on silicone
   Dyestuff pigment suspension
COLORDUR 405 GREEN
   Flock adhesives, Functional coatings, Silicone printing and coating
   Based on silicone
   Dyestuff pigment suspension
COLORDUR 465 OLIVE GREEN
   Flock adhesives, Functional coatings, Silicone printing and coating
   Based on silicone
   Dyestuff pigment suspension
COLORDUR 705 BLACK
   Flock adhesives, Functional coatings, Silicone printing and coating
   Based on silicone
   Dyestuff pigment suspension
COLORDUR AM ADDITIVE
   Flock adhesives, Silicone printing and coating
   Based on silicone
   Migration prevention
   Dyestuff pigment suspension
COLORDUR FL 1015 YELLOW
   Flock adhesives, Functional coatings, Silicone printing and coating
   Based on silicone
   Dyestuff pigment suspension
COLORDUR FL 1815 ORANGE
   Flock adhesives, Functional coatings, Silicone printing and coating
   Based on silicone
   Dyestuff pigment suspension
COLORDUR FL 2415 PINK
   Flock adhesives, Functional coatings, Silicone printing and coating
   Based on silicone
   Dyestuff pigment suspension
COLORDUR FL 4015 GREEN
   Flock adhesives, Functional coatings, Silicone printing and coating
   Based on silicone
   Dyestuff pigment suspension
ECOPERL 1
   Water repellency/oil repellency
   Washfast
   Sprayable
   Based on special functionalised polymers/waxes
   Cationic
ECOPERL ACTIVE
   Water repellency/oil repellency
   Washfast
   Based on special functionalised polymers/waxes
   Cationic
   High effectiveness
LAMETHAN 1 ET 25 BR 160
   Functional coatings, Lamination
   Washfast
   Transparent
   25 μm strong
   Film based on polyester urethane
LAMETHAN ADH-1
   Functional coatings, Lamination
   Breathable
   Suited for dry laminating
   Good stability to washing at 40° C.
   Stable foam adhesive
LAMETHAN ADH-L
   Functional coatings, Lamination
   Washfast
   Transparent
   Suited for paste coating
   Suited for wet laminating
LAMETHAN ALF-K
   Functional coatings, Lamination
   Adhesive additive for bondings
   Suited for dry laminating
   Stable foam adhesive
   Suited for stable foam coating
LAMETHAN LB 15-T BR 152DK
   Functional coatings, Lamination
   Transparent
   15 μm strong
   Breathable
   Suited for dry laminating
LAMETHAN LB 25 BR 155
   Functional coatings, Lamination
   Transparent
   25 μm strong
   Suited for dry laminating
   Good stability to washing at 40° C.
LAMETHAN LB 25 W BR 152
   Lamination
   25 μm strong
   Breathable
   Suited for dry laminating
   Good stability to washing at 40° C.
LAMETHAN TAPE DE 80
   Functional coatings, Lamination
   Polymer base: polyurethane
   Transparent
   Good stability to washing at 40° C.
   Tape for seam sealing
LAMETHAN TAPE ME 160
   Functional coatings, Lamination
   Polymer base: polyurethane
   Transparent
   Good stability to washing at 40° C.
   Tape for seam sealing
LAMETHAN VL-H920 O BR150
   Functional coatings, Lamination
   Two coats with membrane and PES charmeuse
   Breathable
   Suited for dry laminating
   Good stability to washing at 40° C.
LAMETHAN VL-H920 S BR 150
   Functional coatings, Lamination
   Two coats with membrane and PES charmeuse
   Breathable
   Suited for dry laminating
   Good stability to washing at 40° C.
LAMETHAN VL-H920 W BR150
   Functional coatings, Lamination
   Two coats with membrane and PES charmeuse
   Breathable
   Suited for dry laminating
   Good stability to washing at 40° C.
TUBICOAT A 12 E
   Binders, Functional coatings
   Anionic
   Liquid
   Formaldehyde-free
   Polymer base: polyacrylate
TUBICOAT A 17
   Binders, Functional coatings
   Suitable for tablecloth coating
   Anionic
   Liquid
   Self-crosslinking
TUBICOAT A 19
   Binders, Functional coatings
   Washfast
   Anionic
   Formaldehyde-free
   Good stability to washing
TUBICOAT A 22
   Binders, Functional coatings
   Washfast
   Medium-hard film
   Anionic
   Liquid
TUBICOAT A 23
   Binders
   Medium-hard film
   Anionic
   Liquid
   Application for varying the handle
TUBICOAT A 28
   Binders, Functional coatings
   Anionic
   Liquid
   Formaldehyde-free
   Good stability to washing
TUBICOAT A 36
   Binders, Functional coatings
   Washfast
   Anionic
   Liquid
   Low formaldehyde
TUBICOAT A 37
   Binders, Functional coatings
   Washfast
   Suitable for tablecloth coating
   Anionic
   Liquid
TUBICOAT A 41
   Binders, Functional coatings
   Anionic
   Liquid
   Self-crosslinking
   Good fastnesses
TUBICOAT A 61
   Binders, Functional coatings
   Suitable for tablecloth coating
   Liquid
   Non-ionic
   Self-crosslinking
TUBICOAT A 94
   Binders, Functional coatings
   Anionic
   Liquid
   Self-crosslinking
   Good fastnesses
TUBICOAT AIB 20
   Fashion coatings
   Transparent
   Suited for foam coating
   Pearl Gloss Finish
TUBICOAT AOS
   Foaming auxiliaries
   Non-ionic
   Foaming
   Suited for the fluorocarbon finishing
TUBICOAT ASK
   Functional coatings, Lamination
   Adhesive additive for bondings
   Transparent
   Suited for paste coating
   Suited for dry laminating
TUBICOAT B-H
   Binders, Functional coatings
   Polymer base: Styrene butadiene
   Anionic
   Liquid
   Formaldehyde-free
TUBICOAT B 45
   Binders, Functional coatings
   Washfast
   Polymer base: Styrene butadiene
   Anionic
   Liquid
TUBICOAT BO-NB
   Functional coatings
   Medium hard
   Suited for black-out coating
   Good flexibility at low temperatures
   Suited for stable foam coating
TUBICOAT BO-W
   Functional coatings
   Suited for black-out coating
   Impermeable for light
   Suited for stable foam coating
   Water vapour permeable
TUBICOAT BOS
   Foaming auxiliaries
   Anionic
   Foaming
   Foam stabilizer
TUBICOAT DW-FI
   Functional coatings, Special products
   Anionic
   Suited for coating pastes
   Suited for stable foam
   Foamable
TUBICOAT E 4
   Binders
   Anionic
   Self-crosslinking
   Low formaldehyde
   Polymer base: polyethylene vinyl acetate
TUBICOAT ELC
   Functional coatings
   Suited for paste coating
   Black
   Electrically conductive
   Soft
TUBICOAT EMULGATOR HF
   Functional coatings, Special products
   Anionic
   Dispersing
   Suited for coating pastes
   Suited for stable foam
TUBICOAT ENTSCHAUMER N
   Defoamers and deaerators
   Liquid
   Non-ionic
   Silicone-free
   Suited for coating pastes
TUBICOAT FIX FC
   Fixing agents
   Cationic
   Water-based
   Liquid
   Formaldehyde-free
TUBICOAT FIX ICB CONC.
   Fixing agents
   Liquid
   Non-ionic
   Formaldehyde-free
   Suited for crosslinking
TUBICOAT FIXIERER AZ
   Fixing agents
   Liquid
   Suited for crosslinking
   Based on polyaziridin
   Unblocked
TUBICOAT FIXIERER FA
Fixing agents
   Anionic
   Water-based
   Liquid
   Low formaldehyde
TUBICOAT FIXIERER H 24
   Fixing agents
   Anionic
   Water-based
   Liquid
   Formaldehyde-free
TUBICOAT FIXIERER HT
   Fixing agents
   Water-based
   Liquid
   Non-ionic
   Suited for crosslinking
TUBICOAT FOAMER NY
   Foaming auxiliaries
   Non-ionic
   Foaming
   Suited for the fluorocarbon finishing
   Non-yellowing
TUBICOAT GC PU
   Fashion coatings
   Washfast
   Soft handle
   Polymer base: polyurethane
   Transparent
TUBICOAT GRIP
   Functional coatings
   Slip resistant
   Suited for stable foam coating
   Soft
TUBICOAT HEC
   Thickeners
   Powder
   Non-ionic
   Stable to electrolytes
   Stable to shear forces
TUBICOAT HOP-S
   Special products
   Anionic
   Suited for coating pastes
   Coating
   Adhesion promoter
TUBICOAT HS 8
   Binders
   Anionic
   Liquid
   Formaldehyde-free
   Hard film
TUBICOAT HWS-1
   Functional coatings
   Suited for paste coating
   Water-proof
   Suited for giant umbrellas and tents
TUBICOAT KL-TOP F
   Fashion coatings, Functional coatings
   Washfast
   Polymer base: polyurethane
   Transparent
   Suited for paste coating
TUBICOAT KLS-M
   Fashion coatings, Functional coatings
   Washfast
   Soft handle
   Polymer base: polyurethane
   Breathable
TUBICOAT MAF
   Fashion coatings
   Washfast
   Matrix effect
   Improves the rubbing fastnesses
   Soft handle
TUBICOAT MD TC 70
   Fashion coatings
   Vintage wax
   Suited for foam coating
   Suited for topcoats
TUBICOAT MEA
   Functional coatings
   Washfast
   Polymer base: polyurethane
   Suited for paste coating
   Suited for topcoat coatings
TUBICOAT MG-R
   Fashion coatings
   Washfast
   Soft handle
   Suited for paste coating
   Duo Leather Finish
TUBICOAT MOP NEU
   Functional coatings, Special products
   Washfast
   Anionic
   Foamable
   Finish
TUBICOAT MP-D
   Fashion coatings, Functional coatings
   Washfast
   Soft handle
   Medium hard
   Breathable
TUBICOAT MP-W
   Functional coatings
   Washfast
   Polymer base: polyurethane
   Breathable
   Water-proof
TUBICOAT NTC-SG
   Functional coatings
   Washfast
   Transparent
   Suited for paste coating
   Medium hard
TUBICOAT PERL A22-20
   Fashion coatings
   Suited for paste coating
   Suited for foam coating
   Pearl Gloss Finish
TUBICOAT PERL HS-1
   Functional coatings
   Suited for paste coating
   Suited for black-out coating
   Suited for pearlescent coating
   Suited for topcoat coatings
TUBICOAT PERL PU SOFT
   Fashion coatings
   Washfast
   Scarabaeus effect
   Soft handle
   Polymer base: polyurethane
TUBICOAT PERL VC CONC.
   Fashion coatings, Functional coatings
   Soft handle
   Polymer base: polyurethane
   Suited for paste coating
   Suited for black-out coating
TUBICOAT PHV
   Functional coatings
   Medium hard
   Suited for three-dimensional dot coating
TUBICOAT PSA 1731
   Functional coatings, Lamination
   Transparent
   Suited for paste coating
   Suited for dry laminating
   Non-breathable
TUBICOAT PU-UV
   Binders
   Anionic
   Liquid
   Formaldehyde-free
   Good fastnesses
TUBICOAT PU 60
   Binders
   Anionic
   Liquid Application for varying the handle
   Formaldehyde-free
TUBICOAT PU 80
   Binders, Functional coatings
   Washfast
   Anionic
   Liquid
   Can be washed off
TUBICOAT PUH-BI
   Binders
   Anionic
   Liquid
   Formaldehyde-free
   Hard film
TUBICOAT PUL
   Functional coatings
   Polymer base: polyurethane
   Suited for paste coating
   Suited for three-dimensional dot coating
   Slip resistant
TUBICOAT PUS
   Binders, Functional coatings
   Anionic
   Liquid
   Formaldehyde-free
   Polymer base: polyurethane
TUBICOAT PUW-M
   Binders
   Medium-hard film
   Anionic
   Liquid
   Formaldehyde-free
TUBICOAT PUW-S
   Binders
   Anionic
   Liquid
   Formaldehyde-free
   Good stability to washing
TUBICOAT PW 14
   Binders, Functional coatings
   Anionic
   Formaldehyde-free
   Heat-sealable
   Not wetting
TUBICOAT SA-M
   Functional coatings
   Washfast
   Suited for paste coating
   Suited for three-dimensional dot coating
TUBICOAT SCHAUMER HP
   Foaming auxiliaries, Functional coatings
   Non-ionic
   Foaming
   Suited for the fluorocarbon finishing
TUBICOAT SF-BASE
   Fashion coatings
   Washfast
   Soft handle
   Suited for foam coating
   Silk gloss effect
TUBICOAT SHM
   Foaming auxiliaries
   Anionic
   Foam stabilizer
TUBICOAT SI 55
   Special products
   Pseudo-cationic
   Suited for coating pastes
   Foamable
   Coating
TUBICOAT STABILISATOR RP
   Foaming auxiliaries
   Anionic
   Foam stabilizer
TUBICOAT STC 100
   Fashion coatings, Functional coatings
   Transparent
   Breathable
   Suited for stable foam coating
TUBICOAT STC 150
   Fashion coatings, Functional coatings
   Washfast
   Soft handle
   Transparent
   Breathable
TUBICOAT STL
   Functional coatings
   Washfast
   Slip resistant
   Suited for stable foam coating
   Soft
TUBICOAT TCT
   Fashion coatings, Functional coatings
   Washfast
   Polymer base: polyurethane
   Transparent
   Suited for paste coating
TUBICOAT VA 10
   Binders
   Anionic
   Liquid
   Formaldehyde-free
   Hard film
TUBICOAT VCP
   Functional coatings
   Suited for paste coating
   Medium hard
   Suited for black-out coating
TUBICOAT VERDICKER 17
   Thickeners
   Anionic
   High efficiency
   Synthetic
TUBICOAT VERDICKER ASD
   Thickeners
   Anionic
   Quick swelling
   Stable to shear forces
   Pseudoplastic
TUBICOAT VERDICKER LP
   Thickeners
   Anionic
   Stable to shear forces
   Pseudoplastic
   Dispersible
TUBICOAT VERDICKER PRA
   Thickeners
   Anionic
   Liquid
   Stable to electrolytes
   Rheological additive
TUBICOAT WBH 36
   Special products
   Finish
   Application for preventing roller deposits
TUBICOAT WBV
   Special products
   Non-ionic
   Finish
   Application for preventing roller deposits
TUBICOAT WEISS EU
   Functional coatings, Special products
   Suited for coating pastes
   Suited for stable foam
   Suited for topcoat coatings
   Titanium dioxide paste
TUBICOAT WLI-LT KONZ
   Functional coatings
   Washfast
   Suited for paste coating
   Slip resistant
   Soft
TUBICOAT WLI
   Fashion coatings, Functional coatings
   Washfast
   Scarabaeus effect
   Soft handle
   Suited for paste coating
TUBICOAT WOT
   Fashion coatings
   Washfast
   Soft handle
   Suited for paste coating
   Wash-out effect
TUBICOAT WX-TCA 70
   Fashion coatings, Functional coatings
   Vintage wax
   Suited for paste coating
   Suited for topcoat coatings
TUBICOAT WX BASE
   Fashion coatings
   Vintage wax
   Soft handle
   Suited for paste coating
   Application in the prime coat
TUBICOAT ZP NEU
   Water repellency/oil repellency
   Zircon-paraffine base
   Suited for aqueous systems
   Cationic
   Foamable
TUBIGUARD 10-F
   Water repellency/oil repellency
   Washfast
   Sprayable
   Cationic
   Liquid
TUBIGUARD 21
   Water repellency/oil repellency
   Washfast
   Cationic
   High effectiveness
   Water-based
TUBIGUARD 25-F
   Water repellency/oil repellency
   Washfast
   Sprayable
   Cationic
   High effectiveness
TUBIGUARD 270
   Functional coatings, Water repellency/oil repellency
   Washfast
   Cationic
   High effectiveness
   Liquid
TUBIGUARD 30-F
   Water repellency/oil repellency
   Washfast
   Sprayable
   Cationic
   High effectiveness
TUBIGUARD 44 N
   Water repellency/oil repellency
   Washfast
   Sprayable
   Suited for aqueous systems
   Liquid
TUBIGUARD 44N-F
   Water repellency/oil repellency
   Suited for aqueous systems
   Non-ionic
   Suited for polyester
   Foamable
TUBIGUARD 66
   Water repellency/oil repellency
   Washfast
   Sprayable
   High effectiveness
   Liquid
TUBIGUARD 90-F
   Water repellency/oil repellency
   Washfast
   Cationic
   High effectiveness
   Liquid
TUBIGUARD AN-F
   Water repellency/oil repellency
   Washfast
   Sprayable
   Cationic
   High effectiveness
TUBIGUARD FA2-F
   Water repellency/oil repellency
   Sprayable
   Cationic
   Suited for polyester
   Foamable
TUBIGUARD PC3-F
   Functional coatings, Water repellency/oil repellency
   Washfast
   Cationic
   Liquid
   Paste
TUBIGUARD SR 2010-F W
   Water repellency/oil repellency
   Cationic
   High effectiveness
   Foamable
   Based on C6 fluorocarbon

In some embodiments, the chemical agents may include the following, which are supplied by CHT Bezema and are associated with certain selected leather or leather article) properties, which may be used to strengthen SFS binding to inkjet printing dye:
CHT-ALGINAT MVU
   Ink jet printing preparation, Thickeners
   Cationic
   Powder
   Anionic
   High colour brilliance
PRISULON CR-F 50
   Ink jet printing preparation, Thickeners
   Liquid
   Good outlines
   High surface levelness
   Good penetration
TUBIJET DU 01
   Ink jet printing preparation
   Antimigrant
   Anionic
   Liquid
   Formaldehyde-free
TUBIJET NWA
   Ink jet printing preparation
   Liquid
   Non-ionic
   Without impact on the handle
   Formaldehyde-free
TUBIJET PUS
   Ink jet printing preparation
   Film forming
   Anionic
   Liquid
   Formaldehyde-free
TUBIJET VDK
   Ink jet printing preparation
   Liquid
   Formaldehyde-free
   Halogen-free
   Flame protection effect
TUBIJET WET
   Ink jet printing preparation
   Anionic
   Liquid
   Without impact on the handle
   Formaldehyde-free

In some embodiments, the chemical agents of the disclosure may include the following inkjet printing dyes, which are supplied by CHT Bezema and are associated with certain selected leather or leather article properties, which may be used in combination with SFS:
BEZAFLUOR BLUE BB
   Pigments
   High Performance
   BEZAFLUOR (fluorescent pigments)
BEZAFLUOR GREEN BT
   Pigments
   High Performance
   BEZAFLUOR (fluorescent pigments)
BEZAFLUOR ORANGE R
   Pigments
   High Performance
   BEZAFLUOR (fluorescent pigments)
BEZAFLUOR PINK BB
   Pigments
   High Performance
   BEZAFLUOR (fluorescent pigments)
BEZAFLUOR RED R
   Pigments
   High Performance
   BEZAFLUOR (fluorescent pigments)
BEZAFLUOR VIOLET BR
   Pigments
   High Performance
   BEZAFLUOR (fluorescent pigments)
BEZAFLUOR YELLOW BA
   Pigments
   High Performance
   BEZAFLUOR (fluorescent pigments)
BEZAPRINT BLACK BDC
   Pigments
   Advanced
   BEZAPRINT (classic pigments)
BEZAPRINT BLACK DT
   Pigments
   Advanced
   BEZAPRINT (classic pigments)
BEZAPRINT BLACK DW
   Pigments
   Advanced
   BEZAPRINT (classic pigments)
BEZAPRINT BLACK GOT
   Pigments
   High Performance
   BEZAKTIV GOT (GOTS)
BEZAPRINT BLUE BN
   Pigments
   Advanced
   BEZAPRINT (classic pigments)
BEZAPRINT BLUE BT
   Pigments
   Advanced
   BEZAPRINT (classic pigments)
BEZAPRINT BLUE GOT
   Pigments
   High Performance
   BEZAKTIV GOT (GOTS)
BEZAPRINT BLUE RR
   Pigments
   Advanced
   BEZAPRINT (classic pigments)
BEZAPRINT BLUE RT
   Pigments
   Advanced
   BEZAPRINT (classic pigments)
BEZAPRINT BLUE RTM
   Pigments
   Advanced
   BEZAPRINT (classic pigments)
BEZAPRINT BLUE TB
   Pigments
   Advanced
   BEZAPRINT (classic pigments)
BEZAPRINT BORDEAUX K2R
   Pigments
   Advanced
   BEZAPRINT (classic pigments)
BEZAPRINT BROWN RP
   Pigments
   Advanced
   BEZAPRINT (classic pigments)
BEZAPRINT BROWN TM
   Pigments
   Advanced
   BEZAPRINT (classic pigments)
BEZAPRINT CITRON 10G
   Pigments
   Advanced
   BEZAPRINT (classic pigments)
BEZAPRINT CITRON GOT
   Pigments
   High Performance
   BEZAKTIV GOT (GOTS)
BEZAPRINT GREEN 2B
   Pigments
   Advanced
   BEZAPRINT (classic pigments)
BEZAPRINT GREEN BS
   Pigments
   Advanced
   BEZAPRINT (classic pigments)
BEZAPRINT GREEN BT
   Pigments
   Advanced
   BEZAPRINT (classic pigments)
BEZAPRINT GREY BB
   Pigments
   Advanced
   BEZAPRINT (classic pigments)
BEZAPRINT NAVY GOT
   Pigments
   High Performance BEZAKTIV GOT (GOTS)
BEZAPRINT NAVY RRM
   Pigments
   Advanced
   BEZAPRINT (classic pigments)
BEZAPRINT NAVY TR
   Pigments
   Advanced
   BEZAPRINT (classic pigments)
BEZAPRINT OLIVE GREEN BT
   Pigments
   Advanced
   BEZAPRINT (classic pigments)
BEZAPRINT ORANGE 2G
   Pigments
   Advanced
   BEZAPRINT (classic pigments)
BEZAPRINT ORANGE GOT
   Pigments
   High Performance
   BEZAKTIV GOT (GOTS)
BEZAPRINT ORANGE GT
   Pigments
   Advanced
   BEZAPRINT (classic pigments)
BEZAPRINT ORANGE RG
   Pigments
   Advanced
   BEZAPRINT (classic pigments)
BEZAPRINT PINK BW
   Pigments
   Advanced
   BEZAPRINT (classic pigments)
BEZAPRINT RED 2BN
   Pigments
   Advanced
   BEZAPRINT (classic pigments)
BEZAPRINT RED GOT
   Pigments
   High Performance
   BEZAKTIV GOT (GOTS)
BEZAPRINT RED KF
   Pigments
   Advanced
   BEZAPRINT (classic pigments)
BEZAPRINT RED KGC
   Pigments
   Advanced
   BEZAPRINT (classic pigments)
BEZAPRINT SCARLET GRL
   Pigments
   Advanced
   BEZAPRINT (classic pigments)
BEZAPRINT SCARLET RR
   Pigments
   Advanced
   BEZAPRINT (classic pigments)
BEZAPRINT TURQUOISE GT
   Pigments
   Advanced
   BEZAPRINT (classic pigments)
BEZAPRINT VIOLET FB
   Pigments
   Advanced
   BEZAPRINT (classic pigments)
BEZAPRINT VIOLET KB
   Pigments
   Advanced
   BEZAPRINT (classic pigments)
BEZAPRINT VIOLET R
   Pigments
   Advanced
   BEZAPRINT (classic pigments)
BEZAPRINT VIOLET TN
   Pigments
   Advanced
   BEZAPRINT (classic pigments)
BEZAPRINT YELLOW 2GN
   Pigments
   Advanced
   BEZAPRINT (classic pigments)
BEZAPRINT YELLOW 3GT
   Pigments
   Advanced
   BEZAPRINT (classic pigments)
BEZAPRINT YELLOW 4RM
   Pigments
   Advanced
   BEZAPRINT (classic pigments)
BEZAPRINT YELLOW GOT
   Pigments
   High Performance
   BEZAKTIV GOT (GOTS)
BEZAPRINT YELLOW RR
   Pigments
   Advanced
   BEZAPRINT (classic pigments)

In some embodiments, the chemical agents of the disclosure may include the following, which are supplied by Lamberti SPA and are associated with certain selected leather or leather article properties, which may be used to strengthen SFS binding on coated or repaired surfaces or SFS may be used for enhancing such chemical agent properties:

### Pre Treatment:

Waterborne Polyurethanes Dispersions
Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Oil and Water Repellents
Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3
   Wetting agent for water- and oil repellent finishing.
Lamgard EXT.
   Crosslinker for fluorocarbon resins to improve washing fastness.

Flame Retardants
Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers.

Crosslinkers
Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polyisocyanate suitable as crosslinking agent for acrylic and polyurethane dispersions to improve adhesion and wet and dry scrub resistance.
Resina MEL.
   Melamine-formaldehyde resin.
Cellofix VLF.
   Low formaldehyde melamine resin.

Thickeners
Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior
Viscolam 1022.
   Nonionic polyurethane based thickener with moderate pseudoplastic behavior.

Dyeing

Dispersing Agents
Lamegal BO.
   Liquid dispersing agent non ionic, suitable for direct, reactive, disperse dyeing and PES stripping
Lamegal DSP.
   Dispersing/anti back-staining agent in preparation, dyeing and soaping of dyed and printed materials. Antioligomer agent.
Lamegal 619.
   Effective low foam dispersing leveling agent for dyeing of PES
Lamegal TLS.
   Multi-purpose sequestring and dispersing agent for all kind of textile process

Levelling Agents
Lamegal A 12.
   Leveling agent for dyeing on wool, polyamide and its blends with acid or metalcomplex dyes

Fixing Agents
Lamfix L.
   Fixing agent for direct and reactive dyestuffs, containing formaldheyde
Lamfix LU conc.
   Formaldehyde free cationic fixing agent for direct and reactive dyes. It does not affect the shade and light fastness.
Lamfix PA/TR.
   Fixing agent to improve the wet fastness of acid dyes on polyamide fabrics, dyed or printed and polyamide yarns. Retarding agent in dyeing of Polyamide/cellulosic blends with direct dyes.

Special Resins
Denifast TC.
   Special resin for cationization of cellulose fibers to obtain special effects (“DENIFAST system” and “DENISOL system”).
Cobral DD/50.
   Special resin for cationization of cellulose fibers to obtain special effect (“DENIFAST system” and “DENISOL system”).

Antireducing Agents
Lamberti Redox L2S gra.
   Anti-reducing agent in grain form. 100% active content
Lamberti Redox L2S liq.
   Anti-reducing agent in liquid form for automatic dosage.

Anticreasing Agent
Lubisol AM.
   Lubricating and anti creasing agent for rope wet operation on all kind of fibers and machines.

Pigment Dye

Antimigrating Agent
Neopat Compound 96/m conc.
   Compound, developed as migration inhibitor for continuous dyeing process with pigments (pad-dry process).

Binding Agent
Neopat Binder PM/S conc.
   Concentrated version of a specific binder used to prepare pad-liquor for dyeing with pigments (pad-dry process).

All in One Agent
Neopat Compound PK1.
   High concentrated compound specifically developed as migration inhibitor with specific binder for continuous dyeing process with pigments (pad-dry process) all in one

Delavè Agent
Neopat compound FTN.
   High concentrated compound of surfactants and polymers specifically developed for pigment dyeing and pigment-reactive dyeing process; especially for medium/dark shades for wash off effect

Traditional Finishing Agents

Wrinkle Free Treatment
Cellofix ULF conc.
   Anti-crease modified glyoxalic resin for finishing of cottons, cellulosics and blend with synthetics fibers.
Poliflex PO 40.
   Polyethilenic resin for waxy, full and slippy handle by foulard applications.
Rolflex WF.
   Aliphatic waterborned Nano-PU dispersion used as extender for wrinkle free treatments.

Softeners
Texamina C/FPN.
   Cationic softening agent with a very soft handle particularly recommended for application by exhaustion for all kind of fabrics. Suitable also for cone application.
Texamina C SAL flakes.
   100% cationic softening agent in flakes form for all type of fabrics. Dispersible at room temperature.
Texamina CL LIQ.
   Anphoteric softening agent for all types of fabrics. Not yellowing.
Texamina HVO.
   Anphoteric softening agent for woven and knitted fabrics of cotton, other cellulosics and blends. Gives a soft, smooth and dry handle. Applied by padding.
Texamina SIL.
   Nonionic silicon dispersion in water. Excellent softening, lubricating and anti-static properties for all fibre types by padding.
Texamina SILK.
   Special cationic softener with silk protein inside. Gives a “swollen touch” particularly suitable for cellulosic, wool, silk.
Lamfinish LW.
   All-in compound based on special polymeric hydrophilic softeners;
   by coating, foulard, and exhaustion.
Elastolam E50.
   General purpose mono-component silicone elastomeric softener for textile finishing.
Elastolam EC 100.
   Modified polysiloxane micro-emulsion which gives a permanent finishing, with extremely soft and silky handle.

Handle Modifier
Poliflex CSW.
   Cationic anti-slipping agent.
Poliflex R 75.
   Parafine finishing agent to give waxy handle.
Poliflex s.
   Compound specifically developed for special writing effects.
Poliflex m.
   Compound for special dry-waxy handle.
Lamsoft SW 24.
   Compound for special slippy handle specifically developed for coating application.
Lamfinish SLIPPY.
   All-in compound to get a slippy touch; by coating.
Lamfinish GUMMY.
   All-in compound to get a gummy touch; by coating.
Lamfinish OLDRY.
   All-in compound to get dry-sandy touch especially suitable for vintage effects; by coating

Waterborne Polyurethanes Dispersions
Rolflex LB 2.
   Aliphatic waterborned PU dispersion particularly suggested for the formulation of textile coatings where bright and rigid top finish is required. It is particularly suitable as a finishing agent for organza touch on silk fabrics. Transparent and shiny.
Rolflex HP 51.
   Aliphatic waterborned PU dispersion particularly suggested for the formulation of textile coatings for outwear, luggage, technical articles especially where hard and flexible touch is required. Transparent and shiny.
Rolflex PU 879.
   Aliphatic waterborned PU dispersion particularly suggested for the formulation of textile coatings for outwear, luggage, technical articles where a medium-hard and flexible touch is required.
Rolflex ALM.
   Aliphatic waterborned PU dispersion particularly suggested for the formulation of textile coatings for outwear, luggage, technical articles where a soft and flexible touch is required. Can be also suitable for printing application.
Rolflex AP.
   Aliphatic waterborned PU dispersion particularly suggested for the formulation of textile coatings for outwear, fashion where a soft and gummy touch is required.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex K 110.
   Gives to the coated fabric a full, soft, and slightly sticky handle with excellent fastness on all types of fabrics.
Rolflex OP 80.
   Aliphatic waterborned PU dispersion particularly suggested for the formulation of textile coatings for outwear, luggage and fashion finishes where an opaque non writing effect is desired.
Rolflex NBC.
   Aliphatic waterborned PU dispersion generally used by padding application as a filling and zero formaldheyde sizing agent. Can be used for outwear and fashion finishings where a full, elastic and non sticky touch is required.
Rolflex PAD.
   Aliphatic waterborned PU dispersion specifically designed for padding application for outwear, sportswear and fashion applications where a full, elastic and non sticky touch is required. Excellent washing and dry cleaning fastness as well as good bath stability.
Rolflex PN.
   Aliphatic waterborned PU dispersion generally applied by padding application for outerwear and fashion high quality applications where strong, elastic non sticky finishes are required.
Elafix PV 4.
   Aliphatic blocked isocyanate Nano-dispersion used in order to give antifelting and antipilling properties to pure wool fabrics and his blend.
Rolflex SW3.
   Aliphatic waterborned PU dispersion particularly suggested to be used by padding application for the finishing of outwear, sportswear and fashion where a slippery and elastic touch is required. It is also a good antipilling agent. Excellent in wool application.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Other Resins
Textol 110.
   Handle modifier with very soft handle for coating finishes
Textol RGD.
   Water emulsion of acrylic copolymer for textile coating, with very rigid handle.
Textol SB 21.
   Butadienic resin for finishing and binder for textile printing
Appretto PV/CC.
   Vinylacetate water dispersion for rigid stiffening
Amisolo B.
   CMS water dispersion for textile finishing as stiffening agent
Lamovil RP.
   PVOH stabilized solution as stiffening agent

Technical Finishing Agents

Waterborne Polyurethanes Dispersions
Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Oil and Water Repellents
Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3.
   Wetting agent for water- and oil repellent finishing.
Lamgard EXT.
   Crosslinker for fluorocarbon resins to improve washing fastness.

Flame Retardants
Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers

Crosslinkers
Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polyisocyanate suitable as crosslinking agent for acrylic and polyurethane dispersions to improve adhesion and wet and dry scrub resistance.
Resina MEL.
   Melammine-formaldheyde resin.
Cellofix VLF.
   Low formaldheyde malammine resin.

Thickeners
Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior
Viscolam 1022.
   Nonionic polyurethane based thickener with moderate pseudoplastic behavior.

In some embodiments, the chemical agent may include one or more of a silicone, an acidic agent, a dyeing agent, a pigment dye, a traditional finishing agent, and a technical finishing agent. The dyeing agent may include one or more of a dispersing agent, a levelling agent, a fixing agent, a special resin, an antireducing agent, and an anticreasing agent. The pigment dye may include one or more of an antimigrating agent, a binding agent, an all in one agent, and a delave agent. The traditional finishing agent may include one or more of a wrinkle free treatment, a softener, a handle modifier, a waterborne polyurethanes dispersion, and other resins. The technical finishing agent may include one or more of a waterborne polyurethanes dispersion, an oil repellant, a water repellant, a crosslinker, and a thickener.

In some embodiments, certain chemical agents of the disclosure may be provided by one or more of the following chemical suppliers: Adrasa, AcHitex Minerva, Akkim, Archroma, Asutex, Avocet dyes, BCC India, Bozzetto group, CHT, Clariant, Clearity, Dilube, Dystar, Eksoy, Erca group, Genkim, Giovannelli e Figli, Graf Chemie, Huntsman, KDN Bio, Lamberti, LJ Specialties, Marlateks, Montegauno, Protex, Pulcra Chemicals, Ran Chemicals, Fratelli Ricci, Ronkimya, Sarex, Setas, Silitex, Soko Chimica, Tanatex Chemicals, Union Specialties, Zaitex, Zetaesseti, and Z Schimmer.

In some embodiments, the chemical agent may include an acidic agent. Accordingly, in some embodiments, SFS may include an acidic agent. In some embodiments, an acidic agent may be a Bronsted acid. In an embodiment, the acidic agent includes one or more of citric acid and acetic acid. In an embodiment, the acidic agent aids the deposition and coating of SPF mixtures (i.e., SFS coating) on the leather or leather article to be coated as compared to the absence of such acidic agent. In an embodiment, the acidic agent improves crystallization of the SPF mixtures at the textile to be coated.

In an embodiment, the acidic agent is added at a concentration by weight (% w/w or % w/v) or by volume (v/v) of greater than about 0.001%, or greater than about 0.002%, or greater than about 0.003%, or greater than about 0.004%, or greater than about 0.005%, or greater than about 0.006%, or greater than about 0.007%, or greater than about 0.008%, or greater than about 0.009%, or greater than about 0.01%, or greater than about 0.02%, or greater than about 0.03%, or greater than about 0.04%, or greater than about 0.05%, or greater than about 0.06%, or greater than about 0.07%, or greater than about 0.08%, or greater than about 0.09%, or greater than about 0.1%, or greater than about 0.2%, or greater than about 0.3%, or greater than about 0.4%, or greater than about 0.5%, or greater than about 0.6%, or greater than about 0.7%, or greater than about 0.8%, or greater than about 0.9%, or greater than about 1.0% or greater than about 2.0%, or greater than about 3.0%, or greater than about 4.0%, or greater than about 5.0%.

In an embodiment, the acidic agent is added at a concentration by weight (% w/w or % w/v) or by volume (v/v) of less than about 0.001%, or less than about 0.002%, or less than about 0.003%, or less than about 0.004%, or less than about 0.005%, or less than about 0.006%, or less than about 0.007%, or less than about 0.008%, or less than about 0.009%, or less than about 0.01%, or less than about 0.02%, or less than about 0.03%, or less than about 0.04%, or less than about 0.05%, or less than about 0.06%, or less than about 0.07%, or less than about 0.08%, or less than about 0.09%, or less than about 0.1%, or less than about 0.2%, or less than about 0.3%, or less than about 0.4%, or less than about 0.5%, or less than about 0.6%, or less than about 0.7%, or less than about 0.8%, or less than about 0.9%, or less than about 1.0% or less than about 2.0%, or less than about 3.0%, or less than about 4.0%, or less than about 5.0%.

In some embodiments, SFS may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In some embodiments, SFS may include an acidic agent, and may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In an embodiment, the chemical agent may include silicone. In some embodiments, a SFS may include silicone. In some embodiments, the leather or leather article may be pretreated (i.e., prior to SFS application) or post-treated (i.e., after SFS application) with silicone.

In some embodiments, silicone may include a silicone emulsion.

The term “silicone,” may generally refer to a broad family of synthetic polymers, mixtures of polymers, and/or emulsions thereof, that have a repeating silicon-oxygen backbone including, but not limited to, polysiloxanes. In some embodiments, a silicone may include any silicone species disclosed herein.

Describing the compositions and coatings more broadly, silicone may be used, for example to improve hand, but may also increase the water repellency (or reduce water transport properties) of a material coated with silicone.

In some embodiments, SFS may include silicone in a concentration by weight (% w/w or % w/v) or by volume (v/v) of less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.01%, or less than about 0.001%.

In some embodiments, SFS may include silicone in a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 1%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.1%, or greater than about 0.01%, or greater than about 0.001%.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 1%, or greater than about 0.1%, or greater than about 0.01%, or greater than about 0.001%, or greater than about 0.0001%, or greater than about 0.00001%.

In some embodiments, an SFS coating may include SFS, as described herein. In some embodiments, SFS may include a silicone and/or an acidic agent. In some embodiments, SFS may include a silicone and an acidic agent. In some embodiments, the SFS may include a silicone, an acidic agent, and/or an additional chemical agent, wherein the additional chemical agent may be one or more of the chemical agents described herein. In some embodiments, SFS may include a silicone emulsion and an acidic agent, such as acetic acid or citric acid.

In some embodiments, the coating processes of the disclosure may include a finishing step for the resulting coated materials. In some embodiments, the finishing or final finishing of the materials that are coated with SFS under the processes of the disclosure may include sueding, steaming, brushing, polishing, compacting, raising, tigering, shearing, heatsetting, waxing, air jet, calendaring, pressing, shrinking, treatment with polymerizer, coating, lamination, and/or laser etching. In some embodiments, finishing of the SFS coated materials may include treatment of the textiles with an AIRO® 24 dryer that may be used for continuous and open-width tumbling treatments of woven, non-woven, and knitted fabrics.

The following clauses describe certain embodiments.

Clause 1. An article comprising a leather substrate and silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

Clause 2. The article of clause 1, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

Clause 3. The article of clause 1 or 2, further comprising about 0.001% (w/w) to about 10% (w/w) sericin relative to the silk fibroin proteins or fragments thereof.

Clause 4. The article of any one of clauses 1 to 3, wherein the silk fibroin proteins or fragments thereof do not spontaneously or gradually gelate and do not visibly change in color or turbidity when in an aqueous solution for at least 10 days prior to being added to the leather substrate.

Clause 5. The article of any one of clauses 1 to 4, wherein a portion of the silk fibroin proteins or fragments thereof is coated on a surface of the leather substrate.

Clause 6. The article of any one of clauses 1 to 5, wherein a portion of the silk fibroin proteins or fragments thereof is infused into a layer of the leather substrate.

Clause 7. The article of any one of clauses 1 to 6, wherein a portion of the silk fibroin proteins or fragments thereof is in a recessed portion of the leather substrate.

Clause 8. The article of any one of clauses 1 to 7, the article further comprising one or more polysaccharides selected from starch, cellulose, gum arabic, guar gum, xanthan gum, alginate, pectin, chitin, chitosan, carrageenan, inulin, and gellan gum.

Clause 9. The article of clause 8, wherein the gellan gum comprises low-acyl content gellan gum.

Clause 10. The article of clause 8 or 9, wherein the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

Clause 11. The article of clause 8 or 9, wherein the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

Clause 12. The article of any one of clauses 1 to 11, the article further comprising one or more polyols, and/or one or more polyethers.

Clause 13. The article of clause 12, wherein the polyols comprise one or more of glycol, glycerol, sorbitol, D-sorbitol, glucose, sucrose, mannitol, D-mannitol, and dextrose.

Clause 14. The article of clause 12, wherein the polyethers comprise one or more polyethyleneglycols (PEGs).

Clause 15. The article of any one of clauses 12 to 14, wherein the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

Clause 16. The article of any one of clauses 1 to 15, the article further comprising one or more of a silicone, a dye, a pigment, and a polyurethane.

Clause 17. The article of any one of clauses 1 to 16, the article further comprising one or more of a crosslinker, a crosslinker adduct, or a crosslinker reaction derivative.

Clause 18. The article of any one of clauses 1 to 16, the article further comprising one or more of: an isocyanate, isocyanate adduct, and/or isocyanate reaction derivative; a poly diisocyanate, poly diisocyanate adduct, and/or poly diisocyanate reaction derivative; an aziridine, aziridine adduct, and/or aziridine reaction derivative; a carbodiimide, carbodiimide adduct, and/or carbodiimide reaction derivative; an aldehyde, aldehyde adduct, and/or aldehyde reaction derivative; a polyisocyanate, polyisocyanate adduct, and/or polyisocyanate reaction derivative; a polyaziridine, polyaziridine adduct, and/or polyaziridine reaction derivative; a polycarbodiimide, polycarbodiimide adduct, and/or polycarbodiimide reaction derivative; a polyaldehyde, polyaldehyde adduct, and/or polyaldehyde reaction derivative; a polyurethane, polyurethane adduct, and/or polyurethane reaction derivative; a polyacrylate, polyacrylate adduct, and/or polyacrylate reaction derivative; a polyester, polyester adduct, and/or polyester reaction derivative; a wax, wax adduct, and/or wax reaction derivative; a protein, protein adduct, and/or protein reaction derivative; or an alcohol, alcohol adduct, and/or alcohol reaction derivative.

Clause 19. A method of treating a leather substrate with a silk formulation, the method comprising applying on a surface of the leather a silk formulation comprising silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

Clause 20. The method of clause 19, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

Clause 21. The method of clause 19 or 20, wherein the silk formulation further comprises about 0.001% (w/w) to about 10% (w/w) sericin relative to the silk fibroin proteins or fragments thereof.

Clause 22. The method of any one of clauses 19 to 21, wherein the silk formulation further comprises about 0.001% (w/v) to about 10% (w/v) sericin.

Clause 23. The method of any one of clauses 19 to 22, wherein the silk fibroin proteins or fragments thereof do not spontaneously or gradually gelate and do not visibly change in color or turbidity when in an aqueous solution for at least 10 days prior to being formulated and applied to the leather substrate.

Clause 24. The method of any one of clauses 19 to 23, wherein a portion of the silk formulation is coated on a surface of the leather substrate, and/or a portion of the silk formulation is infused into a layer of the leather substrate, and/or a portion of the silk formulation enters a recessed portion of the leather substrate.

Clause 25. The method of any one of clauses 19 to 24, wherein the silk formulation further comprises a rheology modifier.

Clause 26. The method of clause 25, wherein the rheology modifier comprises one or more polysaccharides selected from starch, cellulose, gum arabic, guar gum, xanthan gum, alginate, pectin, chitin, chitosan, carrageenan gum, inulin, and gellan gum.

Clause 27. The method of clause 26, wherein the gellan gum comprises low-acyl content gellan gum.

Clause 28. The method of any one of clauses 25 to 27, wherein the w/w ratio between the silk fibroin proteins or fragments thereof and the rheology modifier in the silk formulation is selected from about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

Clause 29. The method of any one of clauses 25 to 27, wherein the w/w ratio between the silk fibroin proteins or fragments thereof and the rheology modifier in the silk formulation is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

Clause 30. The method of any one of clauses 25 to 27, wherein the w/v concentration of the rheology modifier in the silk formulation is between about 0.01% and about 5%, or between about 0.1% and about 1%.

Clause 31. The method of any one of clauses 19 to 30, wherein the silk formulation further comprises a plasticizer.

Clause 32. The method of clause 31, wherein the plasticizer comprises one or more polyols, and/or one or more polyethers.

Clause 33. The method of clause 32, wherein the polyols are selected from one or more of glycol, glycerol, sorbitol, D-sorbitol, glucose, sucrose, mannitol, mannitol, D-mannitol, and dextrose.

Clause 34. The method of clause 32, wherein the polyethers are one or more polyethyleneglycols (PEGs).

Clause 35. The method of any one of clauses 31 to 34, wherein the w/w ratio between the silk fibroin proteins or fragments thereof and the plasticizer in the silk formulation is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

Clause 36. The method of any one of clauses 31 to 34, wherein the w/v concentration of the plasticizer in the silk formulation is between about 0.01% and about 10%.

Clause 37. The method of any one of clauses 19 to 36, wherein the silk formulation further comprises a defoaming agent at a concentration between about 0.001% and about 1%.

Clause 38. The method of clause 37, wherein the defoaming agent comprises a silicone.

Clause 39. The method of any one of clauses 19 to 38, wherein the silk formulation further comprises one or more of an isocyanate, a poly diisocyanate, an aziridine, a carbodiimide, an aldehyde, a polyisocyanate, a polyaziridine, a polycarbodiimide, a polyaldehyde, a polyurethane, a polyacrylate, a polyester, a wax, a protein, and/or an alcohol.

Clause 40. The method of any one of clauses 19 to 39, wherein the silk formulation is a liquid, a gel, a paste, a wax, or a cream.

Clause 41. The method of any one of clauses 19 to 40, wherein the silk formulation comprises one or more sub-formulations to be applied at the same time or at different times.

Clause 42. The method of any one of clauses 19 to 41, wherein the concentration of silk fibroin proteins or fragments thereof in the silk formulation is between about 0.1% w/v and about 15% w/v.

Clause 43. The method of any one of clauses 19 to 41, wherein the concentration of silk fibroin proteins or fragments thereof in the silk formulation is between about 0.5% w/v and about 12% w/v.

Clause 44. The method of any one of clauses 19 to 41, wherein the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v.

Clause 45. The method of any one of clauses 19 to 41, wherein the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 9.25% w/v, about 9.5% w/v, about 9.75% w/v, or about 10% w/v.

Clause 46. The method of any one of clauses 19 to 41, wherein the concentration of silk fibroin proteins or fragments thereof in the silk formulation is between about 5 mg/mL and about 125 mg/mL.

Clause 47. The method of any one of clauses 19 to 41, wherein the concentration of silk fibroin proteins or fragments thereof in the silk formulation is about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, or about 90 mg/mL.

Clause 48. The method of any one of clauses 19 to 47, the method further comprising one or more additional steps selected from dyeing, drying, water annealing, mechanical stretching, trimming, polishing, applying a pigment, applying a colorant, applying an acrylic formulation, applying an urethane formulation, chemical fixing, stamping, applying a silicone finish, providing a Uniflex treatment, and/or providing a Finiflex treatment, wherein the step of applying the silk formulation on a surface of the leather is performed before, during, or after the one or more additional steps.

Clause 49. The method of any one of clauses 19 to 48, wherein treating the leather substrate with the silk formulation results in one or more of the following: increase in gloss, increase in color saturation, color enhancement, increase in color fixation, reduced dye use, and/or improved colorfastness.

Clause 50. The method of clause 49, wherein the improvement is as to a leather substrate not similarly treated with a silk formulation.

### Examples

The following examples are put forth so as to provide those of ordinary skill in the art with a complete disclosure and description of how to make and use the described embodiments, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1— Silk Solutions Used for Treating Leather

A number of silk solutions are prepared for the treatment of leather, as described in Table 1, and maybe used as described herein.

TABLE 1
Silk formulations for different stages of leather treatment

| Type of | | |
|---|---|---|
| Silk | Titration Agent (TA) | Formulation Process |
| 6% 1:1 | Ammonium Hydroxide | Mix 1 part low MW with 1 part med MW; Titrate |
| (L:M) pH 8 | | stepwise with dilute TA (1:100 stock) |
| 6% 2:1 | Ammonium Hydroxide | Mix 2 parts low MW with 1 part med MW; Titrate |
| (L:M) pH 8 | | stepwise with dilute TA (1:100 stock) |
| 6% 3:1 | Ammonium Hydroxide | Mix 3 parts low MW with 1 part med MW; Titrate |
| (L:M) pH 8 | | stepwise with dilute TA (1:100 stock) |
| 6% 4:1 | Ammonium Hydroxide | Mix 4 parts low MW with 1 part med MW; Titrate |
| (L:M) pH 8 | | stepwise with dilute TA (1:100 stock) |
| 6% 5:1 | Ammonium Hydroxide | Mix 5 parts low MW with 1 part med MW; Titrate |
| (L:M) pH 8 | | stepwise with dilute TA (1:100 stock) |
| 6% 6:1 | Ammonium Hydroxide | Mix 6 parts low MW with 1 part med MW; Titrate |
| (L:M) pH 8 | | stepwise with dilute TA (1:100 stock) |
| 6% 7:1 | Ammonium Hydroxide | Mix 7 parts low MW with 1 part med MW; Titrate |
| (L:M) pH 8 | | stepwise with dilute TA (1:100 stock) |
| 6% 8:1 | Ammonium Hydroxide | Mix 8 parts low MW with 1 part med MW; Titrate |
| (L:M) pH 8 | | stepwise with dilute TA (1:100 stock) |
| 6% 9:1 | Ammonium Hydroxide | Mix 9 parts low MW with 1 part med MW; Titrate |
| (L:M) pH 8 | | stepwise with dilute TA (1:100 stock) |
| 6% 1:2 | Ammonium Hydroxide | Mix 1 part low MW with 2 parts med MW; Titrate |
| (L:M) pH 8 | | stepwise with dilute TA (1:100 stock) |
| 6% 1:3 | Ammonium Hydroxide | Mix 1 part low MW with 3 parts med MW; Titrate |
| (L:M) pH 8 | | stepwise with dilute TA (1:100 stock) |
| 6% 1:4 | Ammonium Hydroxide | Mix 1 part low MW with 4 parts med MW; Titrate |
| (L:M) pH 8 | | stepwise with dilute TA (1:100 stock) |
| 6% 1:5 | Ammonium Hydroxide | Mix 1 part low MW with 5 parts med MW; Titrate |
| (L:M) pH 8 | | stepwise with dilute TA (1:100 stock) |
| 6% 1:6 | Ammonium Hydroxide | Mix 1 part low MW with 6 parts med MW; Titrate |
| (L:M) pH 8 | | stepwise with dilute TA (1:100 stock) |
| 6% 1:7 | Ammonium Hydroxide | Mix 1 part low MW with 7 parts med MW; Titrate |
| (L:M) pH 8 | | stepwise with dilute TA (1:100 stock) |
| 6% 1:8 | Ammonium Hydroxide | Mix 1 part low MW with 8 parts med MW; Titrate |
| (L:M) pH 8 | | stepwise with dilute TA (1:100 stock) |
| 6% 1:9 | Ammonium Hydroxide | Mix 1 part low MW with 9 parts med MW; Titrate |
| (L:M) pH 8 | | stepwise with dilute TA (1:100 stock) |
| 6% 1:1 | Acetic Acid | Mix 1 part low MW with 1 part med MW; Titrate |
| (L:M) pH 4 | | stepwise with stock TA |
| 6% 2:1 | Acetic Acid | Mix 2 parts low MW with 1 part med MW; Titrate |
| (L:M) pH 4 | | stepwise with stock TA |
| 6% 3:1 | Acetic Acid | Mix 3 parts low MW with 1 part med MW; Titrate |
| (L:M) pH 4 | | stepwise with stock TA |
| 6% 4:1 | Acetic Acid | Mix 4 parts low MW with 1 part med MW; Titrate |
| (L:M) pH 4 | | stepwise with stock TA |
| 6% 5:1 | Acetic Acid | Mix 5 parts low MW with 1 part med MW; Titrate |
| (L:M) pH 4 | | stepwise with stock TA |
| 6% 6:1 | Acetic Acid | Mix 6 parts low MW with 1 part med MW; Titrate |
| (L:M) pH 4 | | stepwise with stock TA |
| 6% 7:1 | Acetic Acid | Mix 7 parts low MW with 1 part med MW; Titrate |
| (L:M) pH 4 | | stepwise with stock TA |
| 6% 8:1 | Acetic Acid | Mix 8 parts low MW with 1 part med MW; Titrate |
| (L:M) pH 4 | | stepwise with stock TA |
| 6% 9:1 | Acetic Acid | Mix 9 parts low MW with 1 part med MW; Titrate |
| (L:M) pH 4 | | stepwise with stock TA |
| 6% 1:2 | Acetic Acid | Mix 1 part low MW with 2 parts med MW; Titrate |
| (L:M) pH 4 | | stepwise with stock TA |
| 6% 1:3 | Acetic Acid | Mix 1 part low MW with 3 parts med MW; Titrate |
| (L:M) pH 4 | | stepwise with stock TA |
| 6% 1:4 | Acetic Acid | Mix 1 part low MW with 4 parts med MW; Titrate |
| (L:M) pH 4 | | stepwise with stock TA |
| 6% 1:5 | Acetic Acid | Mix 1 part low MW with 5 parts med MW; Titrate |
| (L:M) pH 4 | | stepwise with stock TA |
| 6% 1:6 | Acetic Acid | Mix 1 part low MW with 6 parts med MW; Titrate |
| (L:M) pH 4 | | stepwise with stock TA |
| 6% 1:7 | Acetic Acid | Mix 1 part low MW with 7 parts med MW; Titrate |
| (L:M) pH 4 | | stepwise with stock TA |
| 6% 1:8 | Acetic Acid | Mix 1 part low MW with 8 parts med MW; Titrate |
| (L:M) pH 4 | | stepwise with stock TA |
| 6% 1:9 | Acetic Acid | Mix 1 part low MW with 9 parts med MW; Titrate |
| (L:M) pH 4 | | stepwise with stock TA |
| 1% 1:1 | Ammonium Hydroxide | Dilute silk stocks to 1% w/v; Mix 1 part low MW with 1 |
| (L:M) pH 8 | | part med MW; Titrate stepwise with dilute TA (1:100 |
| | | stock) |
| 1% 2:1 | Ammonium Hydroxide | Dilute silk stocks to 1% w/v; Mix 2 parts low MW with 1 |
| (L:M) pH 8 | | part med MW; Titrate stepwise with dilute TA (1:100 |
| | | stock) |
| 1% 3:1 | Ammonium Hydroxide | Dilute silk stocks to 1% w/v; Mix 3 parts low MW with 1 |
| (L:M) pH 8 | | part med MW; Titrate stepwise with dilute TA (1:100 |
| | | stock) |
| 1% 4:1 | Ammonium Hydroxide | Dilute silk stocks to 1% w/v; Mix 4 parts low MW with 1 |
| (L:M) pH 8 | | part med MW; Titrate stepwise with dilute TA (1:100 |
| | | stock) |
| 1% 5:1 | Ammonium Hydroxide | Dilute silk stocks to 1% w/v; Mix 5 parts low MW with 1 |
| (L:M) pH 8 | | part med MW; Titrate stepwise with dilute TA (1:100 |
| | | stock) |
| 1% 6:1 | Ammonium Hydroxide | Dilute silk stocks to 1% w/v; Mix 6 parts low MW with 1 |
| (L:M) pH 8 | | part med MW; Titrate stepwise with dilute TA (1:100 |
| | | stock) |
| 1% 7:1 | Ammonium Hydroxide | Dilute silk stocks to 1% w/v; Mix 7 parts low MW with 1 |
| (L:M) pH 8 | | part med MW; Titrate stepwise with dilute TA (1:100 |
| | | stock) |
| 1% 8:1 | Ammonium Hydroxide | Dilute silk stocks to 1% w/v; Mix 8 parts low MW with 1 |
| (L:M) pH 8 | | part med MW; Titrate stepwise with dilute TA (1:100 |
| | | stock) |
| 1% 9:1 | Ammonium Hydroxide | Dilute silk stocks to 1% w/v; Mix 9 parts low MW with 1 |
| (L:M) pH 8 | | part med MW; Titrate stepwise with dilute TA (1:100 |
| | | stock) |
| 1% 1:2 | Ammonium Hydroxide | Dilute silk stocks to 1% w/v; Mix 1 part low MW with 2 |
| (L:M) pH 8 | | parts med MW; Titrate stepwise with dilute TA (1:100 |
| | | stock) |
| 1% 1:3 | Ammonium Hydroxide | Dilute silk stocks to 1% w/v; Mix 1 part low MW with 3 |
| (L:M) pH 8 | | parts med MW; Titrate stepwise with dilute TA (1:100 |
| | | stock) |
| 1% 1:4 | Ammonium Hydroxide | Dilute silk stocks to 1% w/v; Mix 1 part low MW with 4 |
| (L:M) pH 8 | | parts med MW; Titrate stepwise with dilute TA (1:100 |
| | | stock) |
| 1% 1:5 | Ammonium Hydroxide | Dilute silk stocks to 1% w/v; Mix 1 part low MW with 5 |
| (L:M) pH 8 | | parts med MW; Titrate stepwise with dilute TA (1:100 |
| | | stock) |
| 1% 1:6 | Ammonium Hydroxide | Dilute silk stocks to 1% w/v; Mix 1 part low MW with 6 |
| (L:M) pH 8 | | parts med MW; Titrate stepwise with dilute TA (1:100 |
| | | stock) |
| 1% 1:7 | Ammonium Hydroxide | Dilute silk stocks to 1% w/v; Mix 1 part low MW with 7 |
| (L:M) pH 8 | | parts med MW; Titrate stepwise with dilute TA (1:100 |
| | | stock) |
| 1% 1:8 | Ammonium Hydroxide | Dilute silk stocks to 1% w/v; Mix 1 part low MW with 8 |
| (L:M) pH 8 | | parts med MW; Titrate stepwise with dilute TA (1:100 |
| | | stock) |
| 1% 1:9 | Ammonium Hydroxide | Dilute silk stocks to 1% w/v; Mix 1 part low MW with 9 |
| (L:M) pH 8 | | parts med MW; Titrate stepwise with dilute TA (1:100 |
| | | stock) |
| 6% med | Ammonium Hydroxide | Titrate 6% Med MW silk stepwise with dilute TA (1:100 |
| pH 13 | | stock) |
| 6% med | Ammonium Hydroxide | Titrate 6% Med MW silk stepwise with dilute TA (1:100 |
| pH 12 | | stock) |
| 6% med | Ammonium Hydroxide | Titrate 6% Med MW silk stepwise with dilute TA (1:100 |
| pH 11 | | stock) |
| 6% med | Ammonium Hydroxide | Titrate 6% Med MW silk stepwise with dilute TA (1:100 |
| pH 10 | | stock) |
| 6% med | Ammonium Hydroxide | Titrate 6% Med MW silk stepwise with dilute TA (1:100 |
| pH 9 | | stock) |
| 6% med | Ammonium Hydroxide | Titrate 6% Med MW silk stepwise with dilute TA (1:100 |
| pH 8 | | stock) |
| 6% med | Ammonium Hydroxide | Titrate 6% Med MW silk stepwise with dilute TA (1:100 |
| pH 7 | and/or Acetic Acid | stock) |
| 6% low | Acetic Acid | Titrate 6% low MW silk stepwise with stock TA |
| pH 6 | | |
| 6% low | Acetic Acid | Titrate 6% low MW silk stepwise with stock TA |
| pH 5 | | |
| 6% low | Acetic Acid | Titrate 6% low MW silk stepwise with stock TA |
| pH 4 | | |
| 6% med | Acetic Acid | Titrate 6% med MW silk stepwise with stock TA |
| pH 3 | | |
| 6% low | Acetic Acid | Titrate 6% low MW silk stepwise with stock TA |
| pH 2 | | |
| 1% low | Acetic Acid | Dilute 6% silk low MW stock to 1% w/v; Titrate stepwise |
| pH 6 | | with stock TA |
| 1% low | Acetic Acid | Dilute 6% silk low MW stock to 1% w/v; Titrate stepwise |
| pH 5 | | with stock TA |
| 1% low | Acetic Acid | Dilute 6% silk low MW stock to 1% w/v; Titrate stepwise |
| pH 4 | | with stock TA |
| 1% low | Acetic Acid | Dilute 6% silk low MW stock to 1% w/v; Titrate stepwise |
| pH 3 | | with stock TA |
| 1% low | Acetic Acid | Dilute 6% silk low MW stock to 1% w/v; Titrate stepwise |
| pH 2 | | with stock TA |
| 1% med | Acetic Acid | Dilute 6% silk med MW stock to 1% w/v; Titrate |
| pH 6 | | stepwise with stock TA |
| 1% med | Acetic Acid | Dilute 6% silk med MW stock to 1% w/v; Titrate |
| pH 5 | | stepwise with stock TA |
| 1% med | Acetic Acid | Dilute 6% silk med MW stock to 1% w/v; Titrate |
| pH 4 | | stepwise with stock TA |
| 1% med | Acetic Acid | Dilute 6% silk med MW stock to 1% w/v; Titrate |
| pH 3 | | stepwise with stock TA |
| 1% med | Acetic Acid | Dilute 6% silk med MW stock to 1% w/v; Titrate |
| pH 2 | | stepwise with stock TA |

Silk formulations as described herein may be used before, during, or after various leather processing steps, including:

Drying—Drying of hand and autosprayed skins may be done in production line ovens used during normal leather processing. The autosprayed skins may be dried one or more times in between one or more spray treatments, e.g., spray>dry>spray>dry. Oven temperature may vary between 70-75° C. and each dry round may last ˜25 seconds.

Stamping—Stamping may be used during the production process of leathers. During the process, a skin is compressed (treated side up) between two metal plates (approx. 5-6 m²), the top plate operating at 57° C. The skin is compressed at this temperature for 2 seconds at 100 kg/cm². Qualitatively speaking, the stamping process may add sheen to the leather sample.

Finiflex— A typical processing step for plonge leathers, this mechanical treatment may be used as a final step for silk-doped leathers. The skin is processed in two halves on this machine—the skin half is lifted into and compressed by a rotating heated metallic wheel (93° C.; 20 kg/m²; dwheel=0.3 m) for 4 seconds. The skin is then pulled out, flipped, and the other half is treated in the same way.

Uniflex—The Uniflex treatment is similar to the Finiflex treatment, used at the final stage of leather processing. During this process, a skin is fed onto a feeder belt into two pressing cylinders (each 0.3 m in diameter). The top cylinder is heated to 60° C., while the bottom cylinder is unheated. Together, the cylinders compress the skin at 30 bar for 3-5 seconds.

Polishing—The polisher shaves off some of the surface treatment(s) done on the leather in prior processing steps (physical abrasion). At earlier stages in leather processing this serves to “open up” the skin for more effective adhesion of fixation/pigmentation agents in a similar way to the mechanical stretching process which occurs right before trimming of the skins.

Autosprayer—Unless otherwise noted, when skins are sprayed using the in-house automatic spray machine they may be sprayed in one or more rounds with intermediate drying treatments. Spraying fluid (silk, silicone treatment, etc.) may be pumped into the nozzle feed lines at 3 bar, and fed into the nozzle inlet (Dnozzle=0.6 mm) at a pressure between 0.8-1.2 bar. The spray volume of the AUTO sprayer may vary between 0.8-1.0 g/ft². The residence volume of the spraying fluid may be approximately 2-2.5 L. Various silk formulations described herein may be able to be fed into such machine and sprayed evenly onto skins.

The hand spray process may involve one or more coats, e.g., two passes each of different orientation, coat 1 vertically oriented spray pattern, and coat 2 horizontally-oriented spray pattern, of silk deposited onto half of one skin, with the other half covered up as a control. Hand-spray coating volumes may be approximately 50 mL per coat.

6% coated skins may have a noticeably darker sheen when placed under viewing light, and may be slightly stiffer to the touch compared to the untreated control half.

### Example 2: Using a Silk and/or SPF Composition to Repair, Mask, or Hide Follicle or Other Defects in Leather

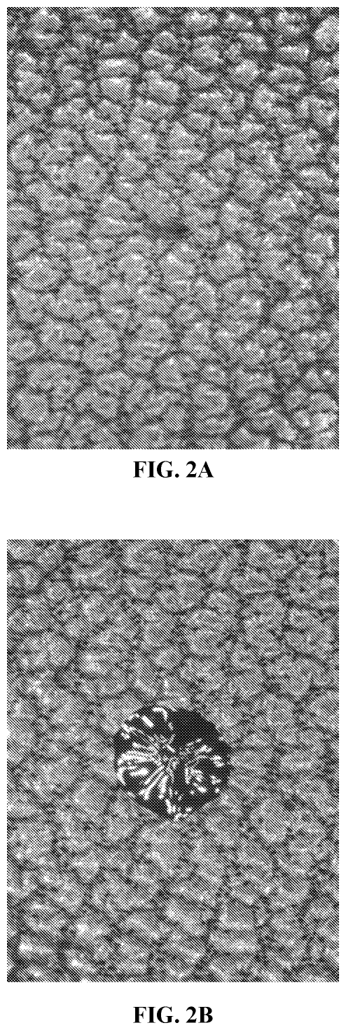

A follicle or other surface or sub-surface defect in leather or hides can be masked, hidden, or repaired using one or more silk or SPF compositions as described herein, for example as shown in FIGS. 2A-7C. A composition including from about 1% to about 6% v/v cam be used as a coating and/or mixing agent, and a composition having higher silk and/or SPF concentration, for example up to, about, or above 30% v/v, can be used as a filling agent for defects. These compositions can include various classes of substances, for example polysaccharides, polysaccharide blends, triglycerides, organic acids, surfactants, etc. The silk and/or SPF compositions can include additional agents to alter viscosity, or used as gelling agents, plasticizers, to adjust color and/or luster. A composition includes 6% v/v low molecular weight silk solution blended with 1% v/v xanthan gum powder (gelation agent), and/or glycerol-silk blends (<1% v/v glycerol to ˜25% v/v glycerol) with glycerol acting as a plasticizer.

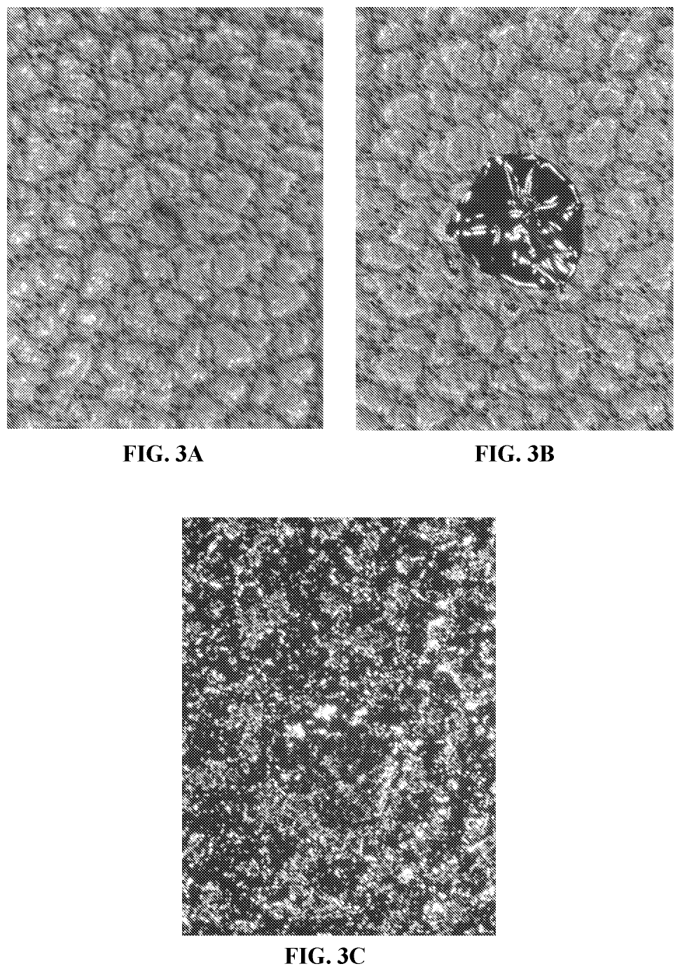

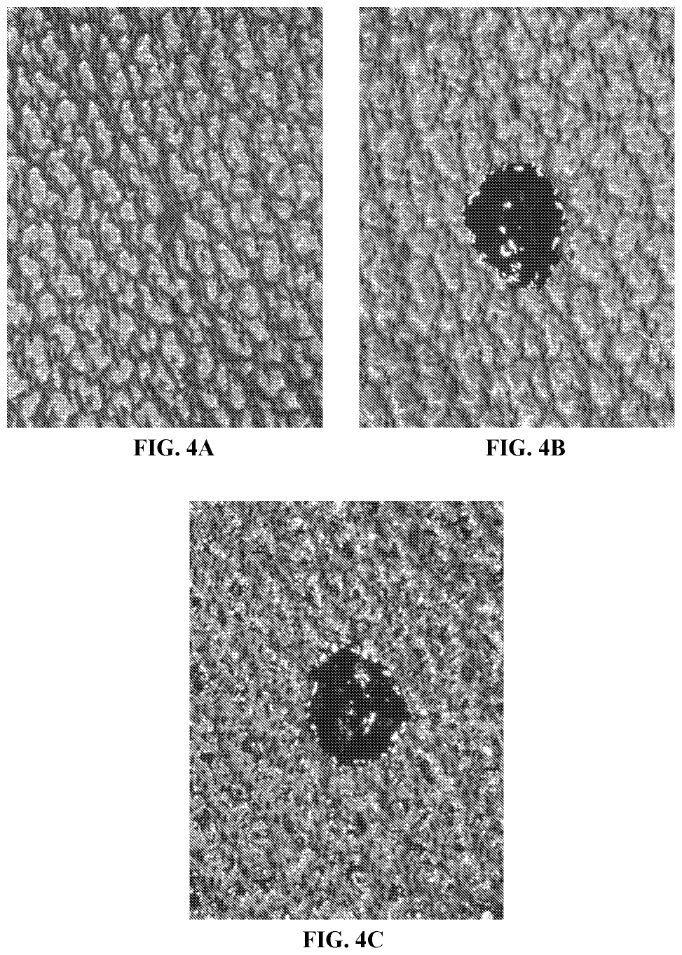

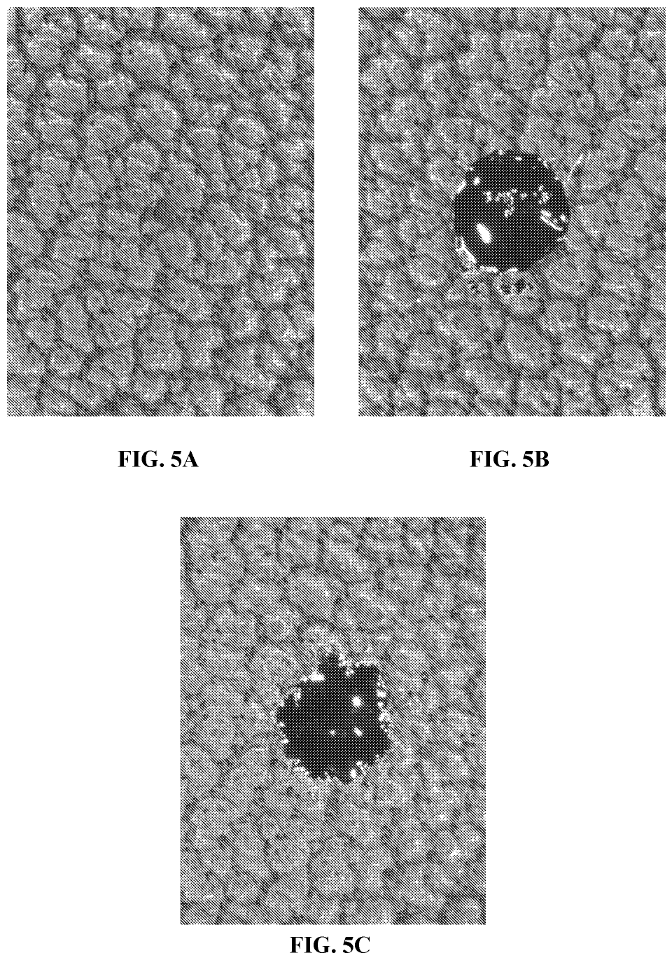

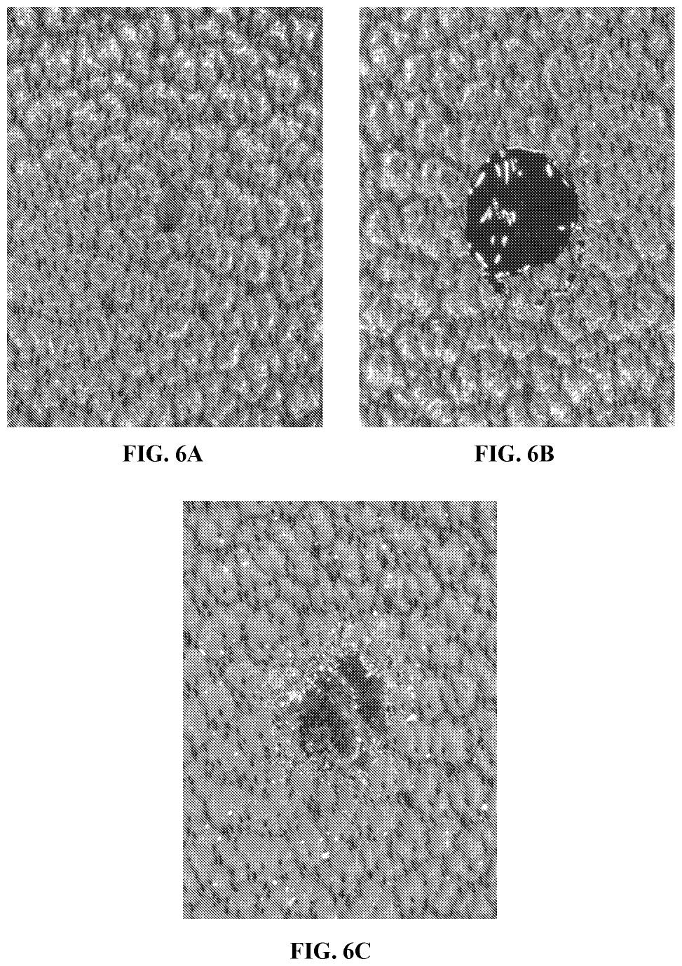

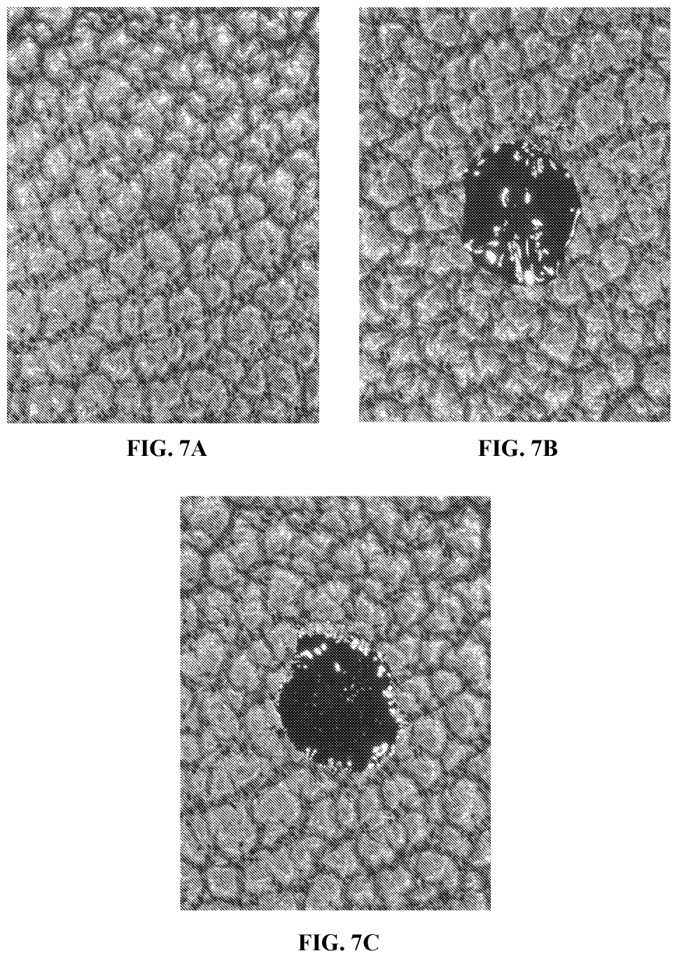

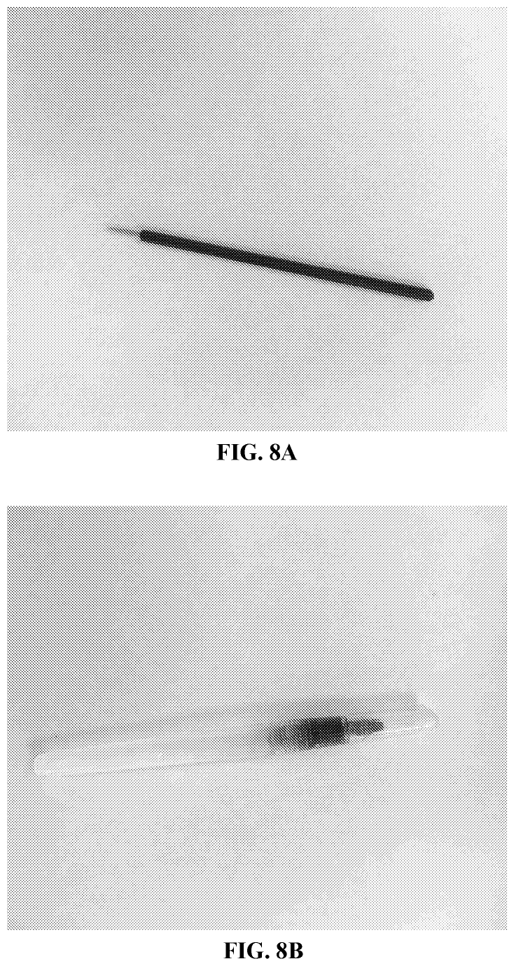

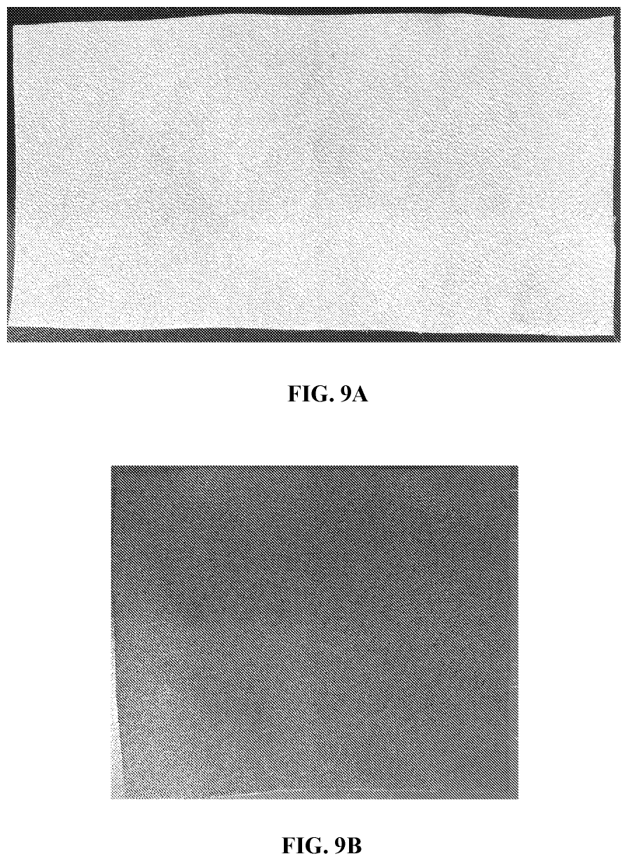

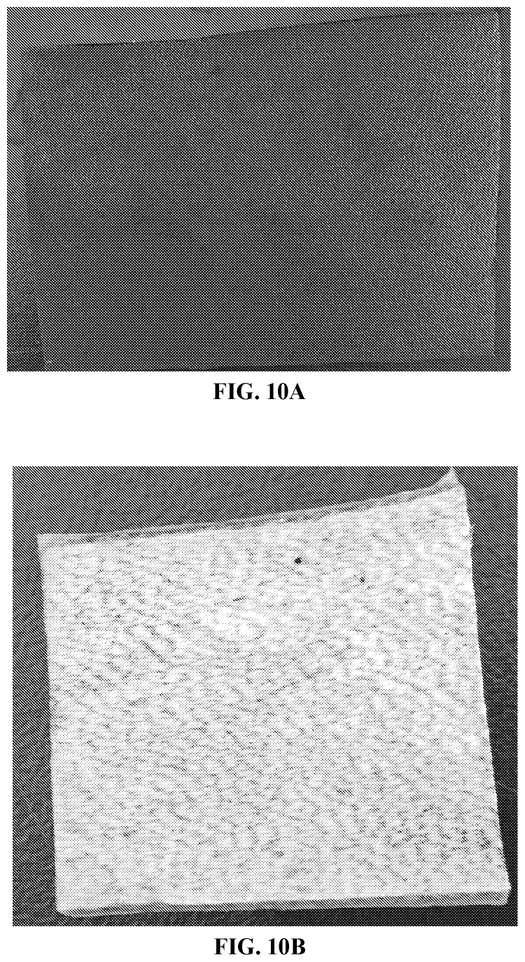

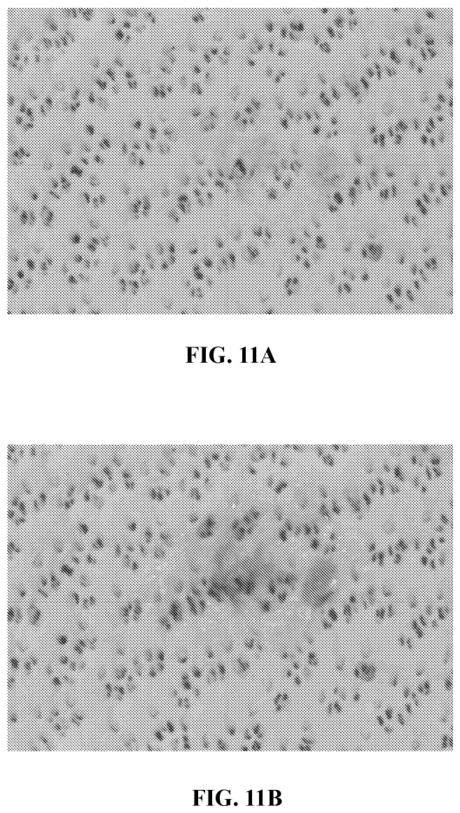

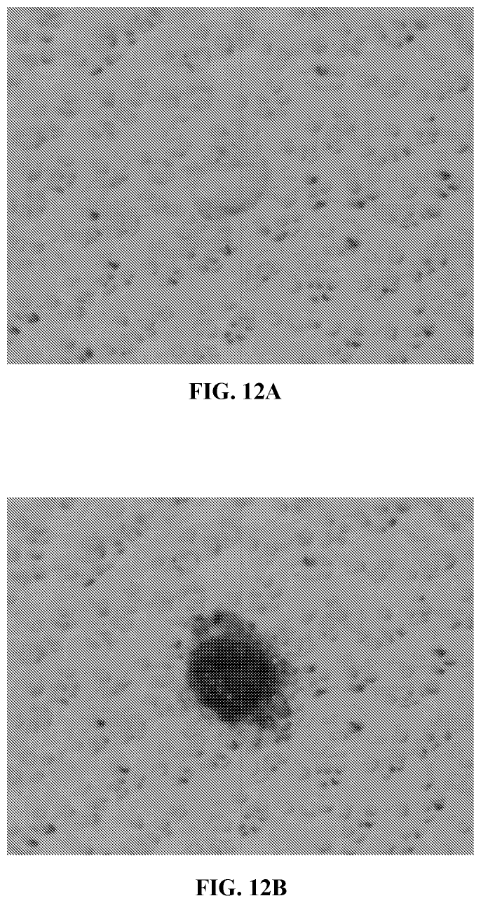

FIG. 2A shows a leather defect prior to repairing, and FIG. 2B shows the repaired defect filled with a composition as described herein. FIG. 3A shows a leather defect prior to repairing, while FIG. 3B shows the repaired defect filled with a composition as described herein, and FIG. 3C shows the repaired defect filled with a composition as described herein and then coated with Unithane 2132 NF. FIG. 4A shows a leather defect prior to repairing, while FIG. 4B shows the repaired defect filled with a composition as described herein, and FIG. 4C shows the repaired defect filled with a composition as described herein and then coated with Unithane 351 NF. FIG. 5A shows a leather defect prior to repairing, while FIG. 5B shows the repaired defect filled with a composition as described herein, and FIG. 5C shows the repaired defect filled with a composition as described herein and then coated with Silky Top 7425 NF. FIG. 6A shows a leather defect prior to repairing, while FIG. 6B shows the repaired defect filled with a composition as described herein, and FIG. 6C shows the repaired defect filled with a composition as described herein and then coated with Uniseal 9049. FIG. 7A shows a leather defect prior to repairing, while FIG. 7B shows the repaired defect filled with a composition as described herein, and FIG. 7C shows the repaired defect filled with a composition as described herein and then coated with a 6% M silk coating. FIGS. 8A and 8B show an eyeliner brush—applicator for a defect filling process (FIG. 8A), and a brush pen/marker filled with silk as applicator for a defect filling process (FIG. 8B). FIGS. 9A and 9B show a sample of undyed lambskin leather (left side—uncoated, right side—coated with 6% low MW silk, 4 seconds autospray; FIG. 9A), and a sample of dyed lambskin leather (left side—uncoated, right side—coated with 6% low MW silk, 4 seconds autospray; FIG. 9B). FIGS. 10A and 10B show a sample of bovine leather coated with 6% low MW silk, 4 seconds autospray (FIG. 10A), and a sample of undyed lambskin leather coated with 6% low MW silk mixed with 1% Clariant Hostaperm Violet RL Spec Pigment. FIGS. 11A and 11B show a sample of undyed lambskin leather defect filled with 21% med MW silk with brush pen, before (FIG. 11A), and after (FIG. 11B). FIGS. 12A and 12B show a sample of undyed lambskin leather defect filled with 21% M silk with 1% Clariant Hostaperm Violet RL Spec Pigment applied with an eyeliner brush applicator, before (FIG. 12A), and after (FIG. 12B).

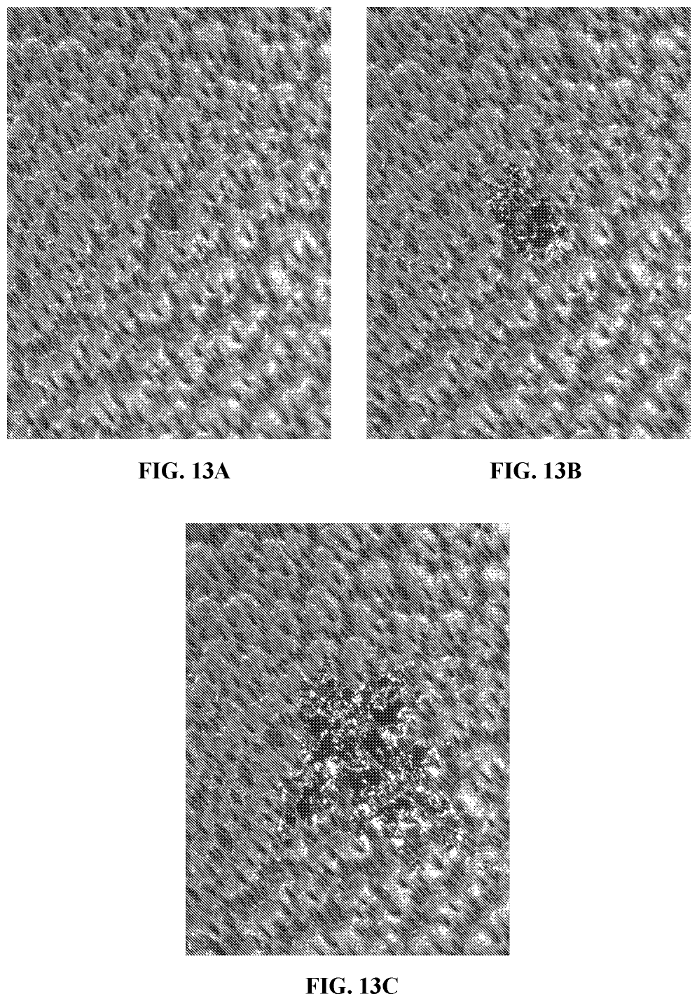

FIGS. 13A to 13C show application of a defect filler composition using an eyeliner-type applicator, resulting in enhanced control of the topography of silk deposition to more accurately match natural patters on leather surface; FIG. 13A: unfilled defect; FIG. 13B: one round of application using an eyeliner brush; and FIG. 13C: second round of application using an eyeliner brush (24% low MW silk).

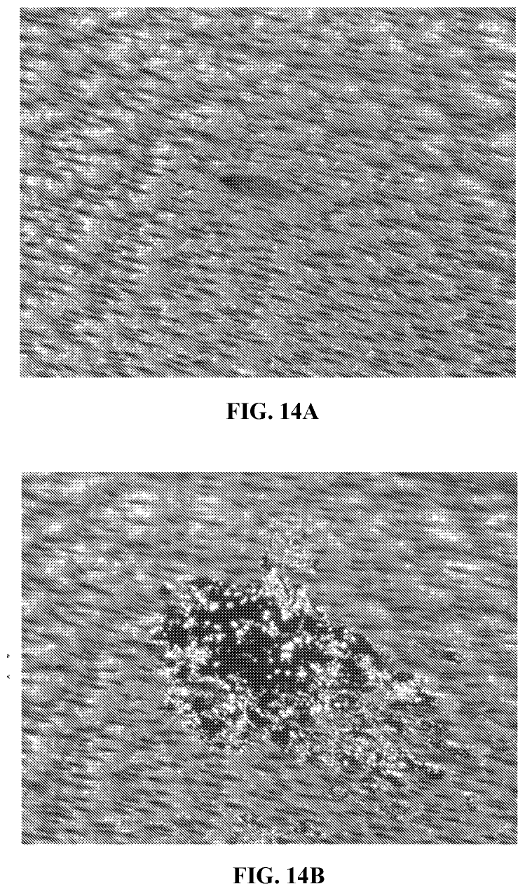

FIGS. 14A and 14B show application of a defect filler composition using a brush pen applicator; FIG. 14A: unfilled defect; and FIG. 14B: filled defect.

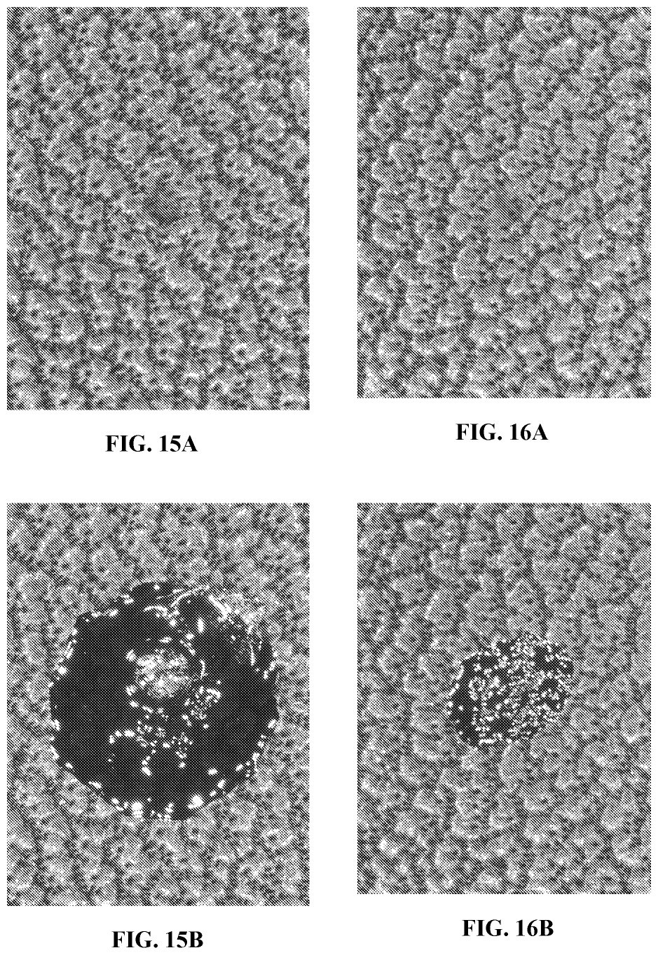

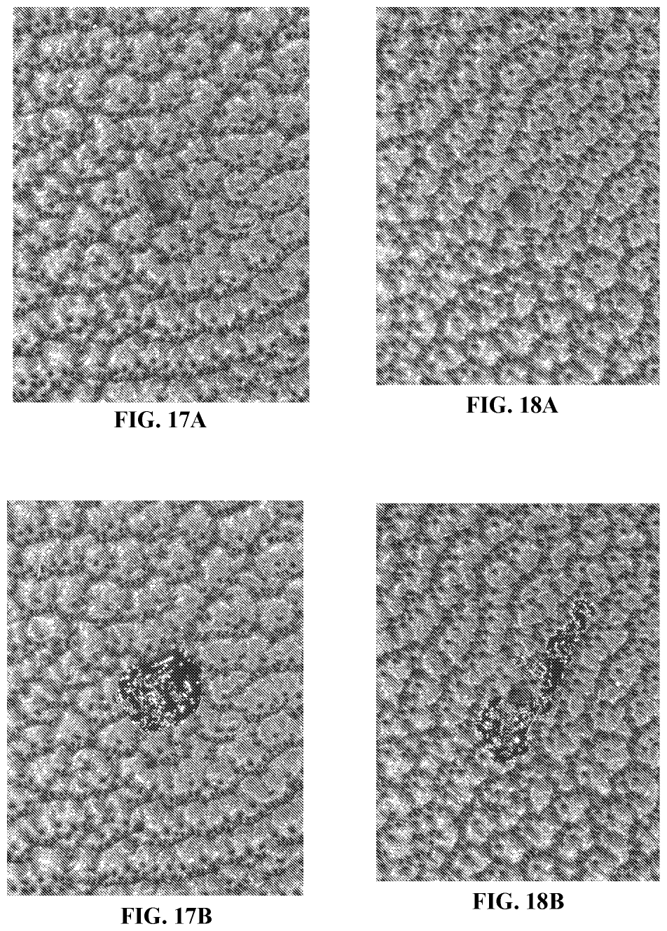

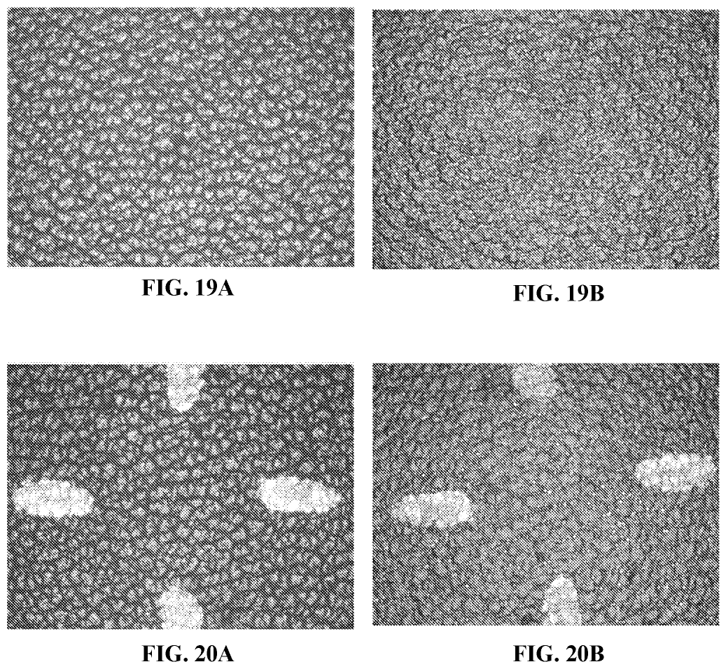

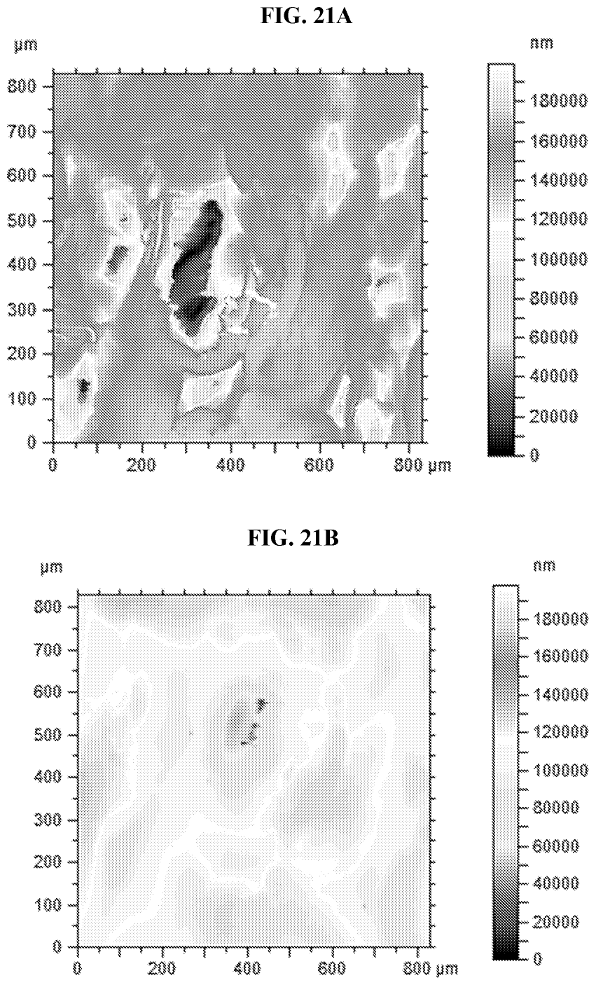

FIGS. 15A and 15B show application of a defect filler composition using a pipette applicator; FIG. 15A: unfilled defect; and FIG. 15B: defect filled with 10 μL high concentration (˜21% w/v) silk composition. FIGS. 16A and 16B show application of a defect filler composition using a pipette applicator; FIG. 16A: unfilled defect; and FIG. 16B: defect filled with 5 μL high concentration (˜21% w/v) silk composition. FIGS. 17A and 17B show application of a defect filler composition using a pipette applicator; FIG. 17A: unfilled defect; and FIG. 17B: defect filled with 1 μL high concentration (˜21% w/v) silk composition. FIGS. 18A and 18B show application of a defect filler composition using a pipette applicator; FIG. 18A: unfilled defect; and FIG. 18B: defect filled with 0.1 μL high concentration (˜21% w/v) silk composition. Volumes ranging between 5 μL and 1 μL appear optimal for filling certain small defects.

On the application of silk/silk blends to leather surface: the silk/silk blend can be applied for the purpose of addressing defects in the following manners—handheld manual tools such as brushes, scrapers, paddles; dipping an entire skin in a silk/silk blend; a compound application tool such as a silk “pen”, or gel applicator (“hot glue gun”-like applicator); direct pouring of silk/silk blend onto skin or skin section; by a gloved hand or finger; by a print jet nozzle or a similar automated application device or system.

### Example 3: Aqueous Formulations of Silk Fibroin for Repairing, Masking, or Hiding Follicle or Other Defects in Leather

Aqueous formulations of silk fibroin and those blended with a variety of additives, including Gellan Gum (GG) and Glycerol (GLY) can be applied as even coatings on the surface of leathers (including lambskin) in order to fill in and disguise “pinhole” defects present on the leather surface. These formulations are compatible with and can sustain the chemical agents and mechanical treatments typically employed in the standard industry finishing process for lambskin leathers. The ability of these formulations to fill in and “mask” specific defect types allows finished leather skins that would normally be graded as Grade II and III skins to be given a Grade I selection, increasing their resale value to textile partners. This allows leather tanneries to augment their manufacturing practices in a way that increases the proportion of Grade I skins on hand using a coating process that is sustainable and compatible with all aspects of leather processing after the Dye Stage.

Table 2 details the range of Silk-based coatings formulated with GG and GLY, their characteristics and relevant process parameters.

TABLE 2
Silk-based coatings formulated with GG and GLY

| | Concentration | | | |
|---|---|---|---|---|
| | (% wt. OR % vol. silk | | Wet Coating | |
| Additive | solution) | pH | Thickness (μm) | Titrants |
| GG | 0.1-1.0% wt. | 5- | 4-60 | NH₄OH (5%) |
| | | 10 | | Citric Acid (10% |
| | | | | w/v) |
| GLY | 0.1-25% vol. | 5- | 4-60 | NH₄OH (5%) |
| | | 10 | | Citric Acid (10% |
| | | | | w/v) |

Both GG- and GLY-silk formulations were made using MID (medium) molecular weight silk at a silk solution concentration of 6% w/v (60 mg/mL), though that concentration can vary from 0.5-10% w/v (5-100 mg/mL). The final prepared formulations were applied to leather skin samples using a wire bar coater (TQC industries).

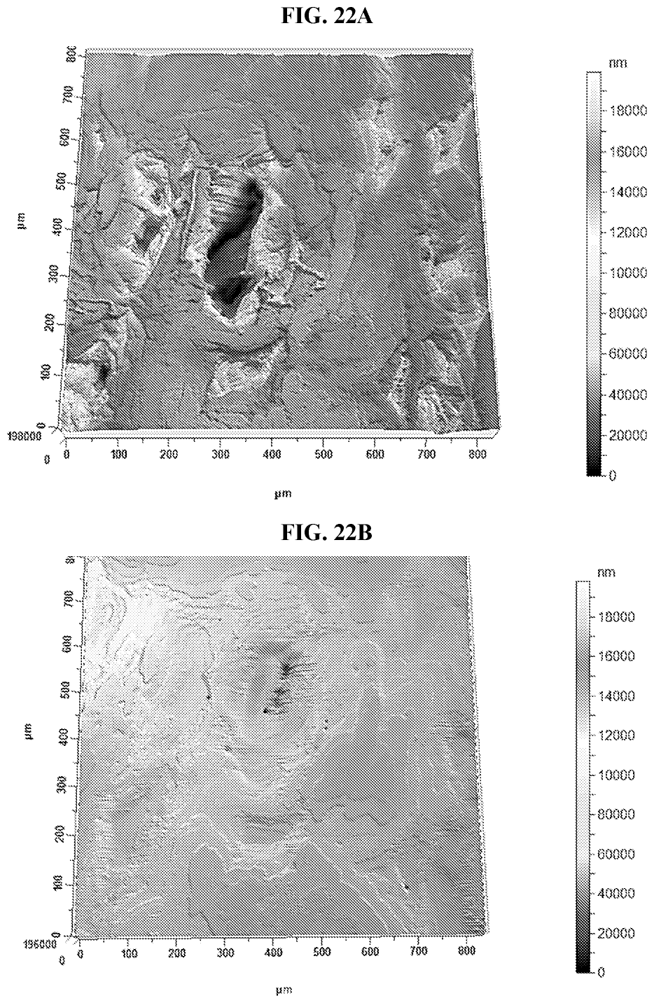

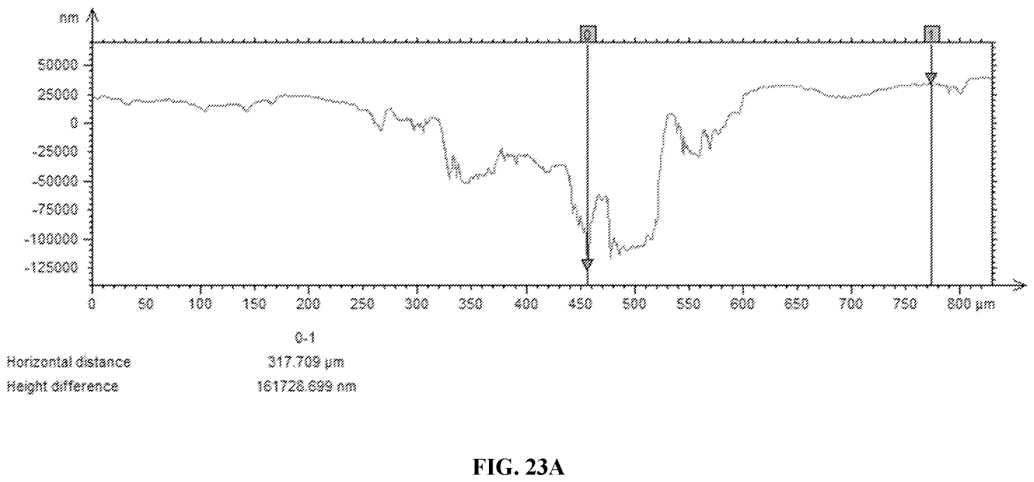

FIGS. 19A and 19B illustrate before and after images of a leather sample coated with a GG-silk formulation variant; leather sample before (FIG. 19A) and after (FIG. 19B) coating with Silk+0.5% wt. GG pH 9.75; coating applied using wire bar coater 20 μm (TQC Industries); defect is in the center of the field of view of all images, magnification is approximately 3×. FIGS. 20A and 20B illustrate before and after images of a leather sample coated with a GLY-silk formulation variant; leather sample before (FIG. 20A) and after (FIG. 20B) coating with Silk+10% vol. GLY pH 8; coating applied using wire bar coater 20 μm (TQC Industries); defect is in the center of the field of view of all images, magnification is approximately 3×.

### Example 4: Optical Profilometry of Point Filling with 5 μL 6% Mid Silk-GG

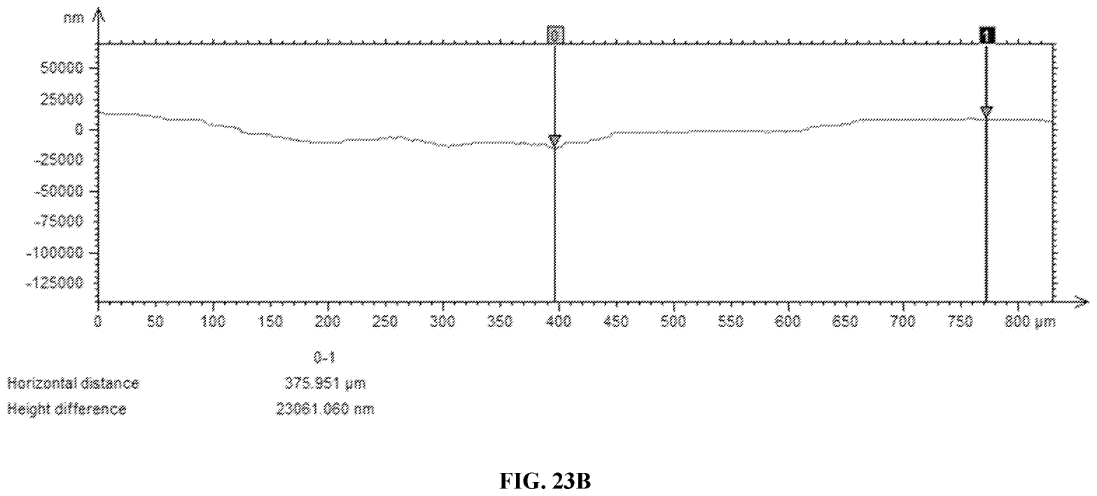

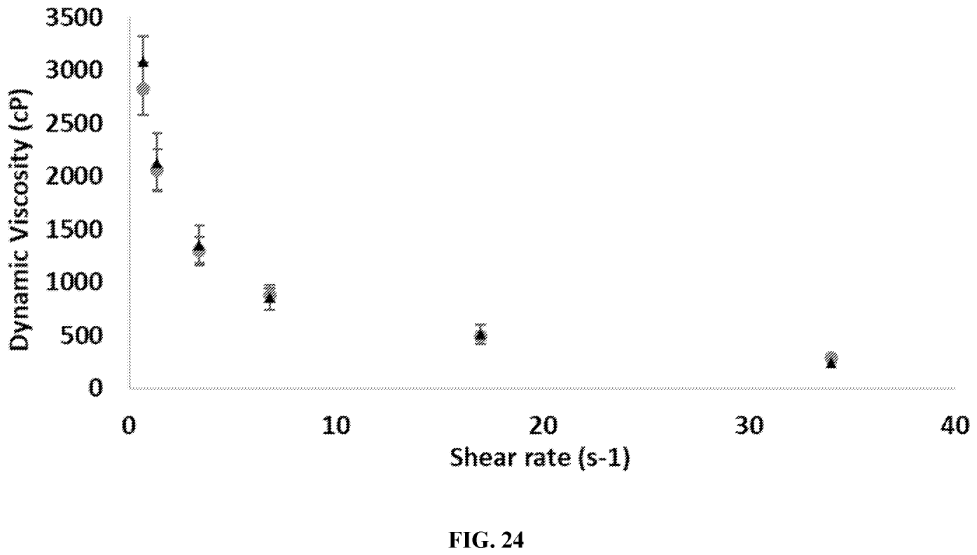

2D and 3D images and one dimensional topography traces of leather samples coated with GG—silk were obtained by optical profilometry. FIGS. 21A and 21B illustrate before and after images (2D) of a leather sample coated with GG—silk before (FIG. 21A) and after (FIG. 21B) coating with Silk+0.5% wt. GG via point filling. Defect is in the center of the field of view of both images. Images were captured using a Taylor Hobson CCI HD optical profilometer. FIGS. 22A and 22B illustrate before and after images (3D) of a leather sample coated with GG—silk before (FIG. 22A) and after (FIG. 22B) coating with Silk+0.5% wt. GG via point filling. Defect is in the center of the field of view of both images. Images were captured using a Taylor Hobson CCI HD optical profilometer. FIGS. 23A and 23B illustrate before and after topography traces of a leather sample coated with GG—silk before (FIG. 23A) and after (FIG. 23B) coating with Silk+0.5% wt. GG via point filling. Traces were captured using a Taylor Hobson CCI HD optical profilometer.

### Example 5: Modulating Viscosity of Silk Fibroin-Based Coatings for Filling Defects on Leather

Various polysaccharides, including Low-acyl content Gellan gum (GG) can be used as rheology modifiers for silk-based formulations so they may be applied as coatings on leather surfaces. Varying the weight content of GG alters the viscosity of the formulation, which in turn allows the silk fibroin component to provide various finishing and filling/masking/impregnation effects.

Silk fibroin solutions that are too fluid tend to penetrate too deeply into certain leather variants such as lambskin, reducing their efficiency and applicability as filling/masking agents for surface defects. Using GG to increase the viscosity of the silk formulation allows the fibroin protein to settle closer to the grain-side surface of the leather, allowing more of the dry weight fraction of the silk to settle into defect cavities, thus providing more efficient filling.

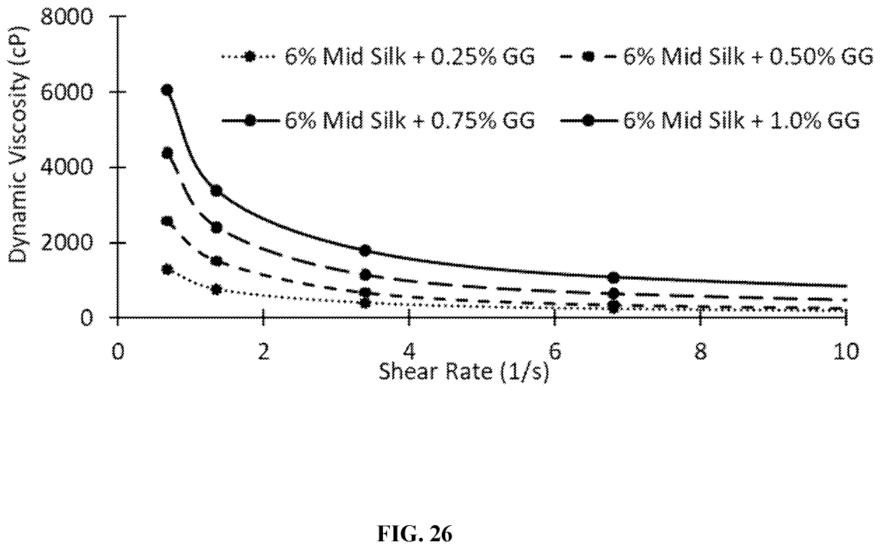

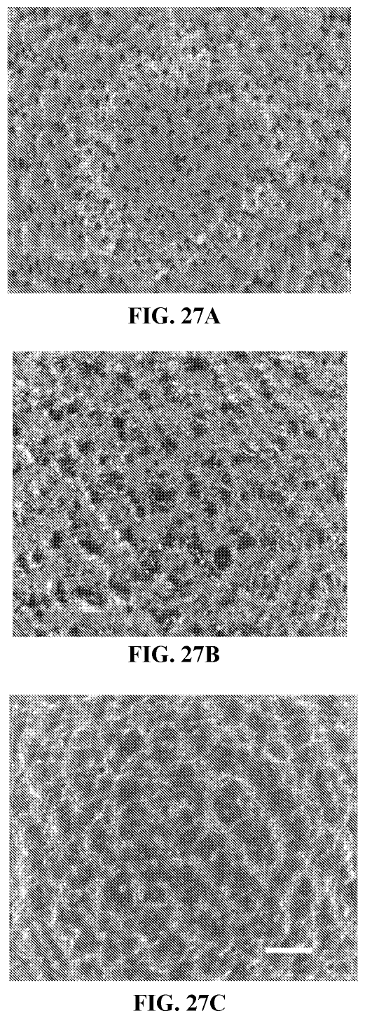

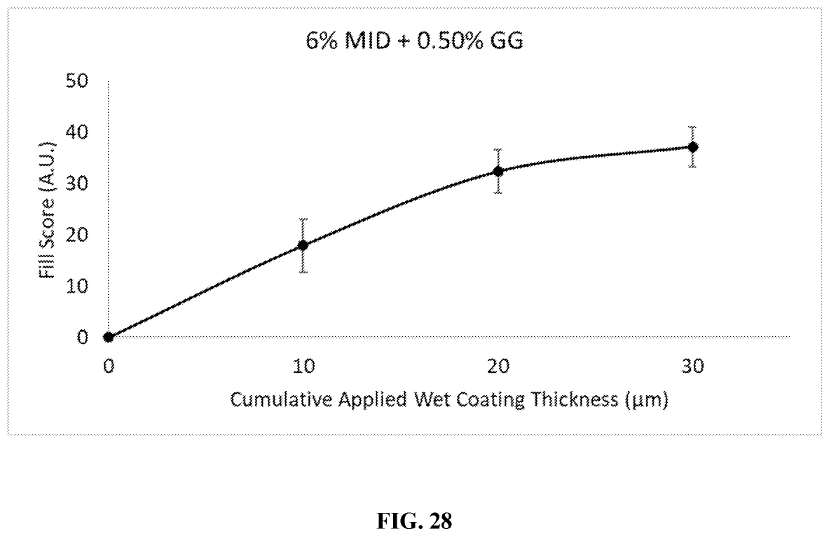

FIG. 24 is a chart illustrating viscosity as a function of shear rate for two independent batches of silk-based coating formulations for leather (6% MID MW silk fibroin+0.5% w/v GG). Batch A (Triangle) and Batch B (Circle) refer to two separate manufacturing batches of purified silk fibroin solution—the curve illustrates the reproducibility of the silk formulations after the addition of Gellan gum in terms of their rheological properties. FIG. 25 is a chart illustrating the fill score as a function of Gellan gum (GG) content. Higher GG concentration (higher viscosity) silk formulations demonstrated improved defect filling compared to lower GG concentration formulations. N=3 replicate coating samples per treatment group. FIG. 26 is a chart illustrating viscosity as a function of shear rate for 6% Mid MW silk fibroin solutions containing different concentrations of GG.

### Example 6: Silk Fibroin-based Defect Filling Agents for Lambskin Leather

Surface defects on leather, for example lambskin leather, decrease the value of the skins and limits the overall available supply. Aqueous formulations of silk fibroin and those blended with a variety of additives, including Low-acyl content Gellan gum (GG) can be applied as even coatings on the surface of leathers (including lambskin) in order to fill in and disguise “pinhole” defects present on the leather surface. These formulations are compatible with and can sustain chemical agents and mechanical treatments typically employed throughout standard finishing processes for lambskin leathers.

Finishing formulations based on natural chemistry platforms such as silk fibroin that can fill in and mask these defects not only address this issue but do so in a sustainable manner. Specifically, the ability of these formulations to fill in and “mask” specific defect types allows finished leather skins that would normally not be selected as ‘top grade’ be given top grade selection, thus increasing their resale value to textile partners. This allows leather tanneries to augment their manufacturing practices in a way that increases the proportion of top grade skins on hand using a coating process that is sustainable and compatible with all aspects of leather finishing.

Summarized in Table 3 are exemplary silk-based coatings formulated with GG and other additives, their characteristics and relevant process parameters. Silk Fibroin-GG (SF-GG) formulations can be made using MID or LOW molecular weight silk at a silk solution concentration of 6% w/v (60 mg/mL), though that concentration can vary from 0.5-12% w/v (5-125 mg/mL).

TABLE 3
Silk-fibroin formulations

| Additive | Concentration | Descriptor |
|---|---|---|
| Gellan Gum | 0.1-1.0% w/v | Rheology Modifier |
| Carrageenan Gum | | |
| Xanthan Gum | | |
| Glycerol | 0.0-100 mg/mL | Plasticizer |
| Sorbitol | | |
| Glucose | | |
| Sucrose | | |
| Dextrose | | |
| PEG 200, 400 | | |
| Kollasol LOK | 0.0-1.0 g/L | De-foaming agent |
| Stahl DF-13-444 | | |

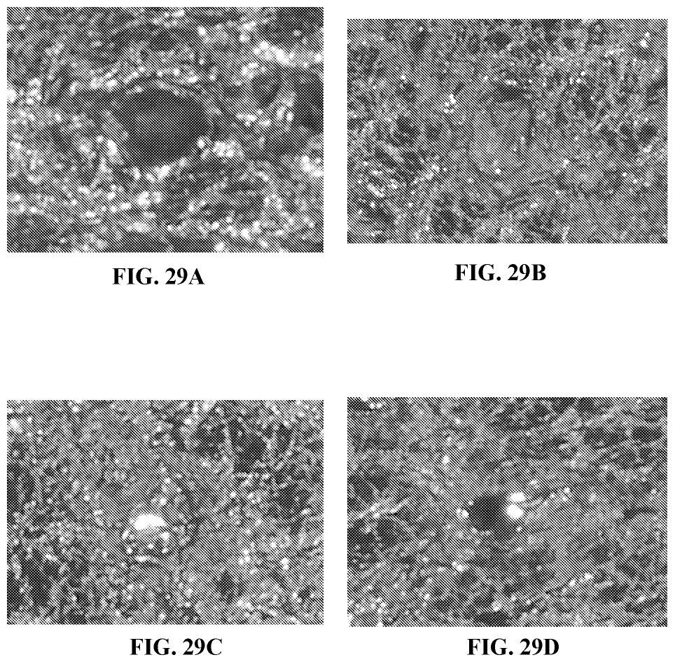

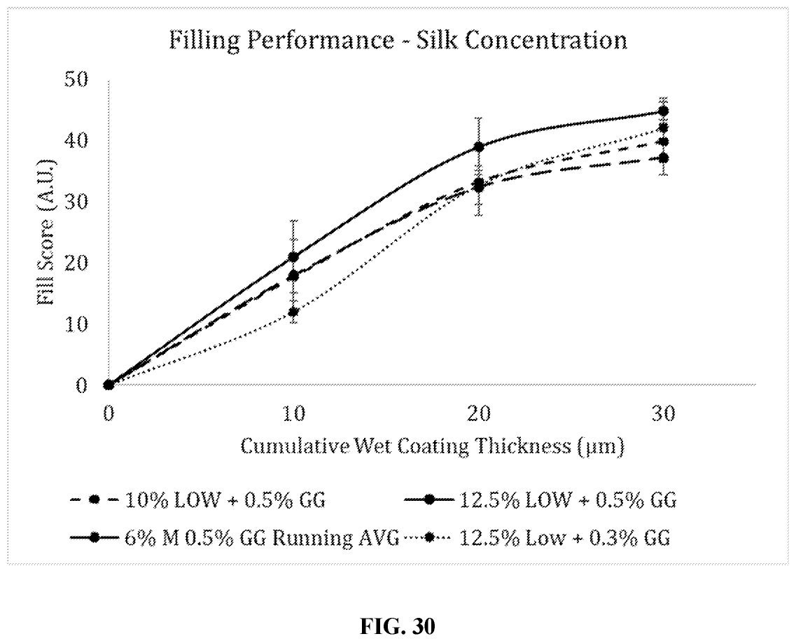

FIGS. 27A-27C are microscope images of lambskin leather sample coated with an SF-GG formulation variant. Leather sample before (FIG. 27A), after (FIG. 27B) coating with 6% MID MW Silk+0.5% w/v GG pH 9.75, and after finishing (FIG. 27C). The coating was applied using a wire bar coater (20 μm— TQC Industries). The defect site is in the center of the field of view all images, magnification is approximately 3×, scale bar approximately 1.0 mm. FIG. 28 illustrates an example defect filling performance for one SF-GG formulation variant (6% MID MW silk fibroin+0.5% w/v GG) applied to lambskin leather containing 10 defect sites. The coating was applied over n=3 layers using a wire bar coater (10 μm TQC Industries). Data points shown are the average of N=20 sample coatings.

Summarized in Table 4 are mechanical data for tensile testing of films cast from various silk-based coating formulations. Data was captured on an Instron system in a tension regime, data reported is mean±standard deviation for n=5 sample films (film thickness 95-200 μm).

TABLE 4
Tensile Strength Data for Cast Films of Silk-fibroin Formulations

| | Ultimate | Elongation | |
|---|---|---|---|
| | Tensile | at Break | Modulus |
| Sample ID | Strength (MPa) | (%) | (MPa) |
| 6% Mid MW | 48.78 ± 5.07 | 3.2 ± 0.9 | 19.44 ± 1.21 |
| 6% Low MW | 37.25 ± 10.20 | 3.0 ± 0.9 | 17.73 ± 2.38 |
| 1:1 Low:Mid MW | 46.08 ± 4.21 | 3.1 ± 1.1 | 19.20 ± 3.10 |
| 6% Mid MW + | 25.10 ± 11.85 | 1.8 ± 0.6 | 19.68 ± 2.30 |
| 0.5% w/v GG | | | |
| 6% Mid MW + 50% | 4.32 ± 1.72 | 52.1 ± 33.2 | 0.78 ± 0.26 |
| w/v GLY | | | |

### Example 7: Quantifying Defect Filling Performance of Silk-Fibroin Based Coatings on Leather

A combined visual and microscopy-based method designed to quantitatively differentiate the ability of various silk-based coatings to fill and/or mask pinhole surface defects on leather substrates is described. When comparing filling performance between a variety of coating formulations, it is often difficult to objectively compare how efficient one coating variant is over another in terms of its ability to fill and mask surface defects for a given applied coating mass. The method procedure is outlined below, with the specifics of the ‘Fill Score’ metric detailed in Table 5.

Sample Preparation: Leather samples are prepared at least in triplicate for each individual coating formulation to be tested. Cut samples in 3″×3″ squares with each containing at least N=10 surface ‘pinhole’ defects. Using the Lightbox (City+Residential lighting combined setting), carefully circle each of the 10 surface defects using a black pen, with a guide line aligned with the defect in the center of the circle so that all microscope images of the defect site are in the same orientation. Defects should be chosen that are at least ˜2-3 cm from the edge of the leather sample. Number the defect sites 1 through 10 using a silver Sharpie marking pen. Prior to coating the samples, image each defect site for each sample using the light microscope and weight the samples. Store sample images in such a way that each replicate maintains its own folder of sample images throughout the coating process.

Coating and Image Collection: After all uncoated samples have been weighed and imaged, clip the first sample onto the glass application table so that there is at least 3 cm between the bottom of the clip and the first defect. Using a 3 mL plastic pipette draw up 1-2 mL of coating formulation and deposit a trace onto the top of the leather sample above the defects. Exerting light downward pressure, place the 10 μm bar above the fluid trace and draw it down past the bottom edge of the leather sample. Take care not to rotate the bar or create uneven ‘pooling’ areas of coating formulation. Allow coated samples to dry under ambient conditions for at least 10-15 minutes after coating. After samples are dry, observe each of them in the lightbox and visually assess each defect site on each sample—record if any sites achieve scores of a 4 or 5 using the ratings scale in Table 5. Remove sample from the Lightbox and image each defect site on each sample using the light microscope. Weigh each sample using the digital balance. Repeat steps as needed (one, two, three more times, etc.) until several total rounds of coating, visual analysis and image collection have been completed. Once all coating, visual scoring and image collection has been completed for all samples, generate Fill Scores for all remaining defect sites that did not receive scores of 4 or 5 via visual analysis in between coating layers. Use the score system described in Table 5 to assign scores to all defect sites. Once all defect sites across all coating groups have received a fill score, generate a SUM score for each replicate by adding up the total scores for all 10 defect sites for each coating layer (layers 0, 1, 2, 3). SUM score metric ranges from 0 (all sites uncoated/completely unaffected by coating) to 50 (all sites filled and not visible to naked eye). Average the SUM score across all replicates for each experimental coating group calculated for each coating layer. Statistically significant differences in filling performance between coating groups are calculated using the Student's t-test for independent means.

Summarized in Table 5 is a scoring system developed to assign fill scores to individual defect sites present on a leather swatch (3″×3″). For each coating variant, N=3 swatches are coated in 10 μm increments (up to three layers per treatment), and each individual defect site (identified by the experimenter) is assigned a score after 0, 1, 2, and 3 layers have been applied. Those scores are summed across the 10 defect sites per swatch and then that sum is averaged across the three coating replicates to give the Fill Score metric for 0, 10 μm, 20 μm, and 30 μm of cumulative applied coating thickness.

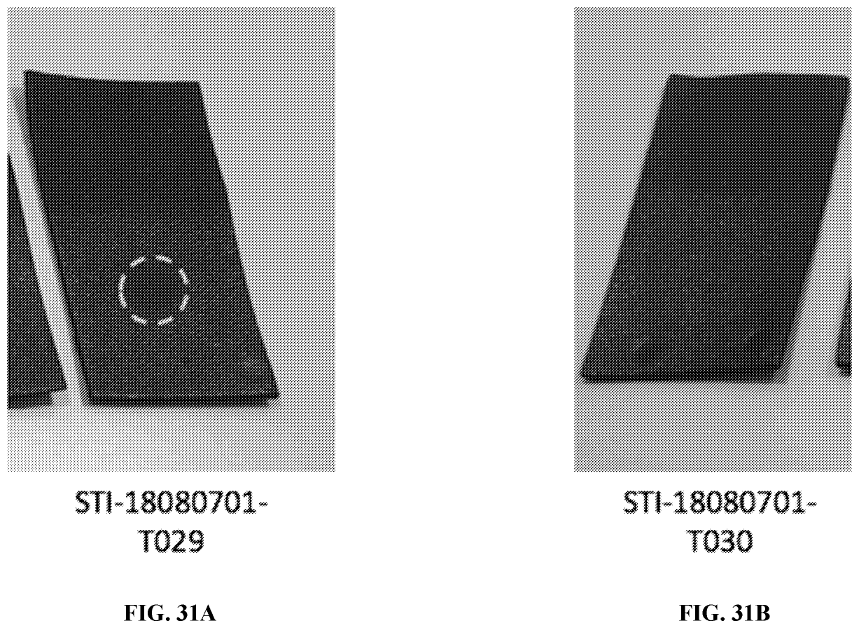

TABLE 5
Scoring System for Defect Fillings

| | | Exemplary |
|---|---|---|
| Score | Description | Image |
| 0 | Uncoated defect site-coating has either not | FIG. 29A |
| | been applied or completely misses the defect | |
| | area (score assigned after assessment of | |
| | microscopy image) | |
| 1 | Minor reduction of defect size around edges of | FIG. 29B |
| | cavity-no filling or aggregation of coating in | |
| | defect cavity (score assigned after assessment | |
| | of microscopy image) | |
| 2 | Partial filling of defect cavity-noticeable | FIG. 29C |
| | build-up or partial build-up of coating material | |
| | (score assigned after assessment of | |
| | microscopy image) | |
| 3 | Defect appears filled, edges of coating | FIG. 29D |
| | formulation appear flush with grain surface | |
| | around defect site | |
| | (score assigned after assessment of | |
| | microscopy image) | |
| 4 | Defect is filled with no meniscus/is flush | N/A |
| | with the grain of the leather but defect site can | |
| | still be seen with the naked eye (score | |
| | assigned after visual assessment) | |
| 5 | Defect is filled with no meniscus/is flush | N/A |
| | with the grain of the leather and the site can no | |
| | longer be identified by the observer after 5 | |
| | seconds within the area identified as | |
| | containing a defect (score assigned after | |
| | visual assessment) | |

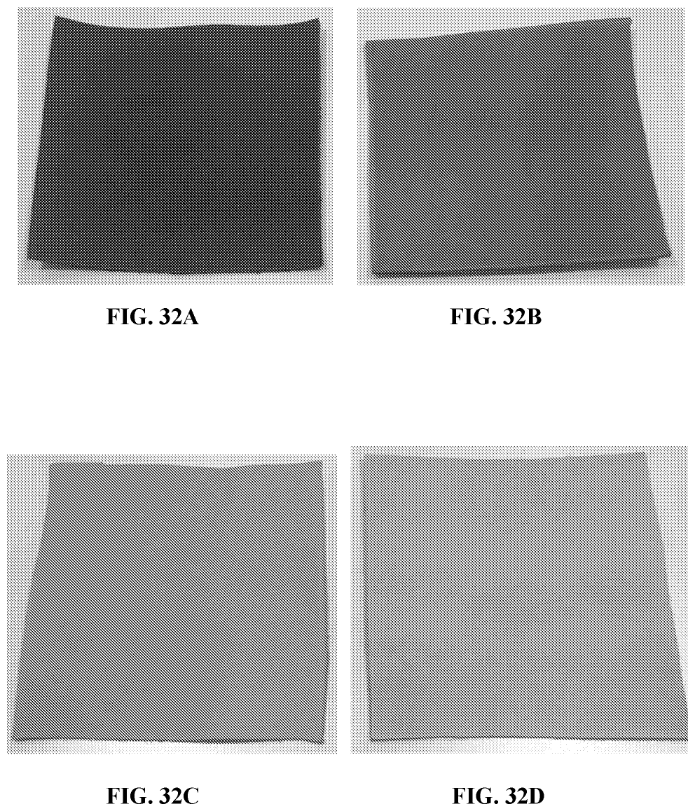

FIG. 30 illustrates an example Fill Score chart—Fill score as a function of applied wet coating thickness for various concentrations of silk fibroin-based formulations (3 applications at 10 μm using a wire bar coater— TQC Industries). Different silk concentrations for low MW (10-12.5% w/v) and mid MW (6% w/v) affect efficiency of filling as additional coating layers are applied. Higher silk concentrations and higher-GG content (12.5% w/v low mw+0.5% GG) formulations tend to demonstrate better filling characteristics than lower silk- and lower GG-content formulations.

### Example 8: Water Annealing of Silk Fibroin on Lambskin Leather for Water Resistant Effect

A process called “water annealing” can be used to make a silk coating on leather more water resistant. For some applications and use cases, it is important for leather to be able to repel water. Most water-repellant coatings are synthetic, and are often fluorinated chemicals. There exists a need for a more natural water-repellant leather coating. By coating leather with silk and performing the water annealing method, a natural water repellant coating can be accessed. Water annealing of silk materials is described in general in Hu et al., Biomacromolecules. 2011 May 9; 12(5): 1686-1696.

Sample Preparation: Each sample is affixed to a cardboard panel with tape and hand sprayed (ca. 10 psi) from a distance of approximately 6″ using the solution(s) indicated in Table 6. The spraying is done twice in succession—first in a quick up-down motion and then in a quick left-right motion. Total exposure time of leather is approximately 1.5-2 seconds; The leather is allowed to dry for at least 30 minutes; The leather is placed in a vacuum chamber (Realflo Stainless Steel Vacuum Chamber) with a petri dish of approx. 2 mL of DI water under static vacuum at approx. −14 psi. The time used to water anneal varies depending on the experiment; After water annealing, the leather is allowed to rest for at least 30 minutes.

Performance Test: A plastic pipette is used to dispense one drop of DI water on the surface of the silk-treated leather. The water drop is allowed to sit on the leather for 30 seconds and then is wiped away; The coated leather is inspected for the presence of a watermark on the leather. If no watermark is present, it is said that the coating is water resistant.

TABLE 6
Treatment parameters for exemplary leather samples

| | | Test |
|---|---|---|
| Sample | Treatment | Result |
| STI- | Handspray with 50% Uniseal 9049 in | Fail |
| 18080701- | water for four seconds. | |
| T029 | Let sit 30 minutes | |
| | Handspray with 6% Mid Silk in water | |
| | according to the procedure above. | |
| | Let sit 30 minutes. | |
| STI- | Handspray with 50% Uniseal 9049 in | Pass |
| 18080701- | water for four seconds. | |
| T030 | Let sit 30 minutes | |
| | Handspray with 6% Mid Silk in water | |
| | according to the procedure above. | |
| | Let sit 30 minutes. | |
| | Water anneal for 4 hours according to | |
| | the procedure above. | |

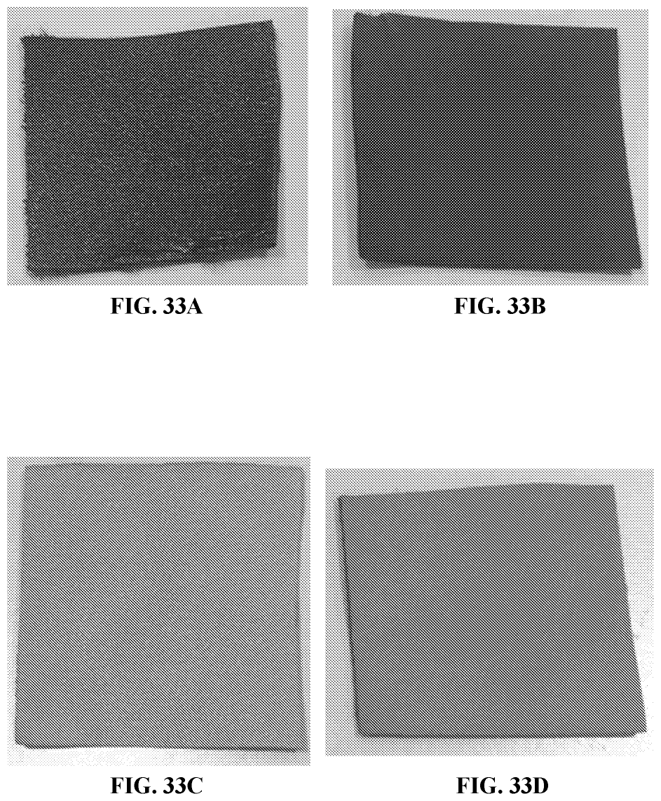

FIGS. 31A and 31B are images of leather samples STI-18080701-T029 (not water annealed; FIG. 31A) and STI-18080701-T030 (water annealed; FIG. 31B). After the water drop has been wiped away, no water drop remains on STI-18080701-T030 (FIG. 31B).

### Example 9: Silk Fibroin-Based Color Saturation Spray Treatments for Lambskin Leathers

Silk formulations applied to leather increases the saturation of leather color, and the amount of color change can be tuned by silk concentration. It is important for leather manufacturers to be able to access a wide variety of leather colors in order to satisfy the market's desire for new, rich leathers. Using a silk spray treatment in conjunction with typical dyeing techniques yields a palette of richer, more saturated colors to be used in leather production. In some embodiments, silk applied after dyeing yields a richer color.

Sample Preparation: Samples are hand sprayed with the silk formulations summarized in Table 7. Each sample is affixed to a cardboard panel with tape and hand sprayed (ca. 10 psi) from a distance of approximately 6″ using the solution indicated in Table 7. The spraying is done twice in succession—first in a quick up-down motion and then in a quick left-right motion. Total exposure time of leather is approximately 1.5-2 seconds.

TABLE 7
Description of Sample Preparation for
Leather Used in Color Saturation Study

| Sample | Substrate | Spray Coating |
|---|---|---|
| RSD-TXTL-287-T001 | Black bovine | None |
| RSD-TXTL-287-T002 | Brown lamb skin | None |
| RSD-TXTL-287-T003 | Magenta lamb skin | None |
| RSD-TXTL-287-T004 | Orange lamb skin | None |
| RSD-TXTL-287-T005 | Black bovine | 6% Mid |
| RSD-TXTL-287-T006 | Brown lamb skin | 6% Mid |
| RSD-TXTL-287-T007 | Magenta lamb skin | 6% Mid |
| RSD-TXTL-287-T008 | Orange lamb skin | 6% Mid |
| RSD-TXTL-287-T009 | Black bovine | 6% Low |
| RSD-TXTL-287-T010 | Brown lamb skin | 6% Low |
| RSD-TXTL-287-T011 | Magenta lamb skin | 6% Low |
| RSD-TXTL-287-T012 | Orange lamb skin | 6% Low |

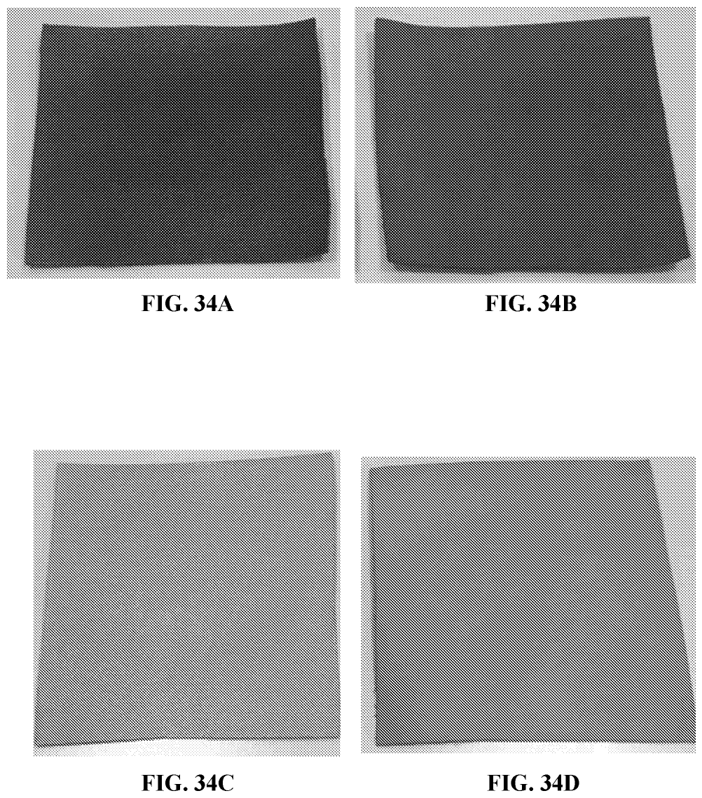

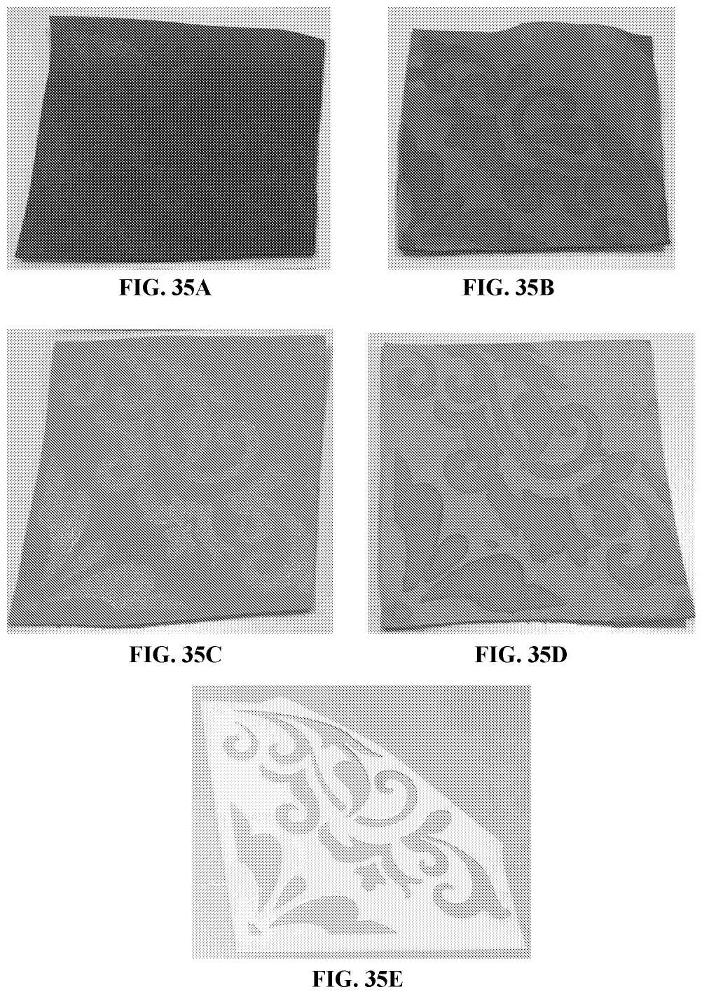

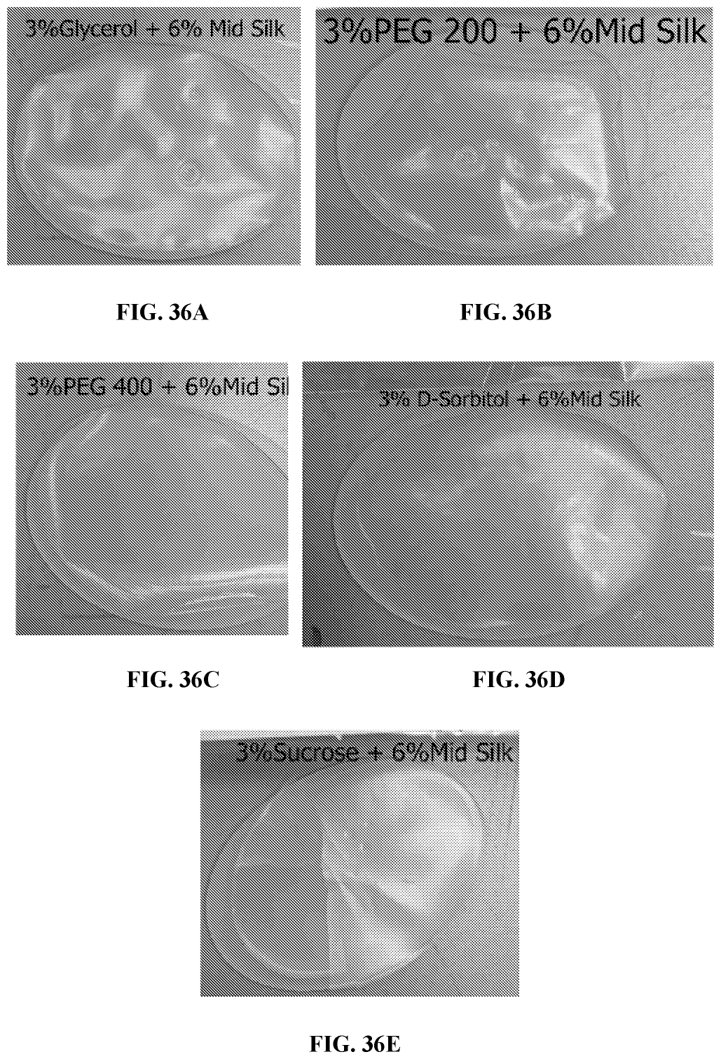

The silk-treated samples have a different color saturation from the untreated samples, as shown in FIGS. 32A-32D, 33A—33D, and 34A—34D, and summarized in Table 8. Colorimetry data was collected using a CM-700d Spectrophotometer (Konica Minolta).

L*, a*, and b* refer to the color parameters defined in the CIELAB color space, where L* is a measure of lightness from black (0) to white (100), a* is a measure of green (−) to red (+), and b* is a measure of blue (−) to yellow (+). The data in Table 8 show that the hue and saturation of leather is different for silk-coated vs non-silk-coated leather samples.

TABLE 8
Colorimetry data for samples T001-012

| | L* Avg | a* Avg | b* Avg |
|---|---|---|---|
| T001 | 23.4 ± 0.3 | 0.1 ± 0.1 | −0.7 ± 0.1 |
| T005 | 26.2 ± 0.4 | 0.0 ± 0.2 | −0.8 ± 0.1 |
| T009 | 26.4 ± 0.2 | 0.0 ± 0.0 | −0.9 ± 0.0 |
| T002 | 32.9 ± 1.4 | 8.9 ± 0 0 | 13.3 ± 0.3 |
| T006 | 27.5 ± 0.9 | 7.8 ± 0.3 | 9.6 ± 0.5 |
| T010 | 29.6 ± 1.3 | 8.7 ± 0.1 | 11.5 ± 0.8 |
| T003 | 36.7 ± 0.2 | 57.0 ± 0.1 | −3.0 ± 0.2 |
| T007 | 41.8 ± 0.2 | 52.5 ± 0.3 | 0.4 ± 0.8 |
| T011 | 42.0 ± 0.3 | 53.3 ± 0.1 | 0.5 ± 1.2 |
| T004 | 48.0 ± 0.4 | 37.7 ± 0.4 | 25.8 ± 0.4 |
| T008 | 39.5 ± 0.5 | 35.8 ± 0.5 | 24.8 ± 0.7 |
| T012 | 43.3 ± 0.1 | 37.8 ± 0.1 | 26.8 ± 0.2 |

### Example 10: Silk Fibroin-Based Gloss Enhancers for Lambskin Leathers

Silk formulations applied to leather increase the glossiness of leather, and the amount of gloss can be tuned with silk concentration. A glossy, lustrous appearance is often desired for finished leather articles. Leather alone does not have this glossy aspect. Usually glossiness is achieved using synthetic resins or additives. As described herein, naturally-derived silk fibroin can be used to produce similar or better levels of gloss.

Sample Preparation: Samples are hand sprayed with the silk formulation indicated in Table 9. Each sample is affixed to a cardboard panel with tape and hand sprayed (ca. 10 psi) from a distance of approximately 6″ using the solution indicated in Table 9. The spraying is done twice in succession—first in a quick up-down motion and then in a quick left-right motion. Total exposure time of leather is approximately 1.5-2 seconds. Samples are left out to dry for 15 minutes between applications.

TABLE 9
Sample Preparation for Blue Leather Used in Gloss Study

| Sample | Substrate | Testing Article | Spray 1 | Spray 2 | Spray 3 |
|---|---|---|---|---|---|
| T001A | Black bovine | Water | Water | Water | Water |
| T001B | leather | Water | Water | Water | Water |
| T001C | | Water | Water | Water | Water |
| T002A | | Low MW Silk | 0.57% | 0.57% | 1.41% |
| T002B | | Low MW Silk | Silk | Silk | Silk |
| T002C | | Low MW Silk | | | |
| T006A | | Mid MW Silk | | | |
| T006B | | Mid MW Silk | | | |
| T006C | | Mid MW Silk | | | |

Samples treated with silk instead of water are significantly glossier, as shown by gloss data (Table 10). 60° gloss values were generated using a WG60 Precision Glossmeter.

TABLE 10
Gloss values for leather samples after coating
with various materials (water or silk)

| | | Gloss Before | Gloss After |
|---|---|---|---|
| Sample | Coating Material | Coating | Coating |
| T001A | Water | 7.6 | 6.7 |
| T001B | Water | 6.1 | 5.9 |
| T001C | Water | 6.7 | 7 |
| T002A | Low MW Silk TFF-001-0204 Mix | 7.2 | 24.6 |
| | (Scale-Up) | | |
| T002B | Low MW Silk TFF-001-0204 Mix | 8.4 | 24.3 |
| | (Scale-Up) | | |
| T002C | Low MW Silk TFF-001-0204 Mix | 8.6 | 25.6 |
| | (Scale-Up) | | |
| T006A | Mid MW Silk TFF-001-0411 | 7.3 | 18.6 |
| | (Scale-Up) | | |
| T006B | Mid MW Silk TFF-001-0411 | 7.7 | 19.5 |
| | (Scale-Up) | | |
| T006C | Mid MW Silk TFF-001-0411 | 10.2 | 24.9 |
| | (Scale-Up) | | |

### Example 11: Stenciling of Silk Fibroin on Lambskin Leather for Two-Toned Effect

Silk patterns can be applied to leather using a stencil. It is important for leather manufacturers to be able to access a wide variety of leather finishes, including colors, sheens, and patterns in order to satisfy the market's desire for new, rich leathers. Using a silk spray treatment in conjunction with a stencil yields leather with intricate patterns on the surface. Compared to patterned leathers made by etching techniques, the silk-stencil process described herein is more straightforward.

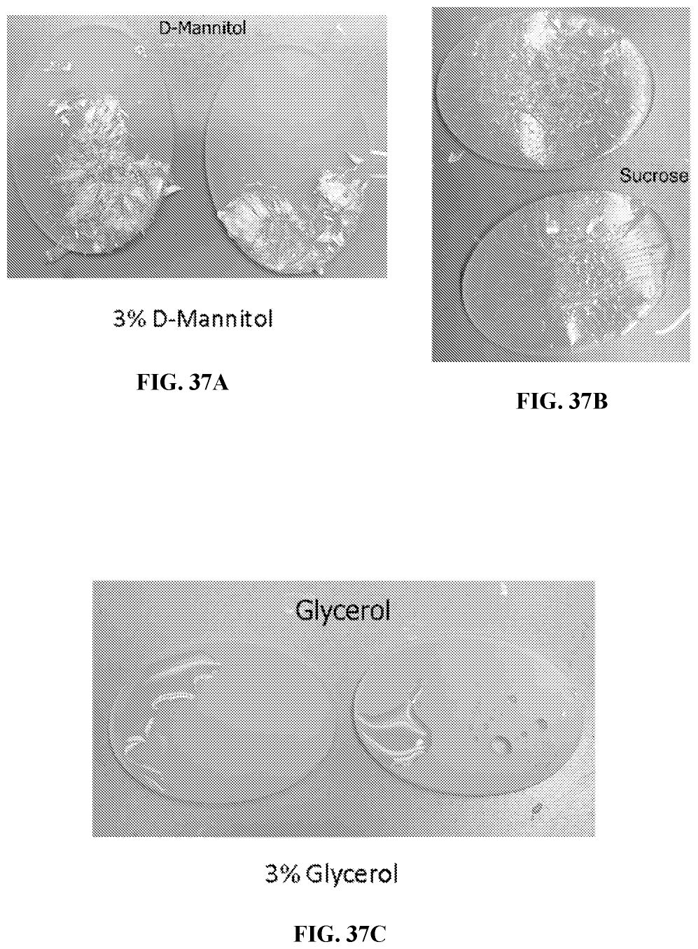

Sample Preparation: Samples are hand sprayed with the silk formulation indicated in Table 11. Each sample is affixed to a cardboard panel with tape with a stencil (FIG. 35E) on top of it and hand sprayed (ca. 10 psi) from a distance of approximately 6″ using the solution indicated in Table 11. The spraying is done twice in succession—first in a quick up-down motion and then in a quick left-right motion. Total exposure time of leather is approximately 1.5-2 seconds.

TABLE 11
Description of Sample Preparation for Leather Used in Stencil Study

| Sample | Substrate | Spray Coating |
|---|---|---|
| RSD-TXTL-287-T013 | Black bovine | 6% Low with stencil |
| RSD-TXTL-287-T014 | Brown lambskin | 6% Low with stencil |
| RSD-TXTL-287-T015 | Magenta lambskin | 6% Low with stencil |
| RSD-TXTL-287-T016 | Orange lambskin | 6% Low with stencil |

Leather samples that are silk coated using a stencil provide an interesting and unique visual aspect (FIGS. 35A-35D; photographs of the leather samples T013-T016 (6% Low with stencil coating), along with the stencil used to make the coatings, FIG. 35E).

### Example 12: Leather Coating with Silk/Plasticizer Formulations

Silk films with enhanced flexibility were made using various plasticizers which show promising results when used with protein. Silk formulations plasticized with these additives are useful for creating flexible polymer coatings on leather.

Break is a phenomenon that occurs on leather that has either been over-finished or finished using rigid film-forming chemistries; a mismatch in elastic modulus between the collagen of the leather and the applied finishing layers creates cracks and even areas of delamination when the leather is handled that persist after the leather has been relaxed. Avoiding break is an essential component of manufacturing high-quality leather. In coating leather with silk that has been plasticized using various additives, homogeneous coating can occur without imparting break onto the leather.

As described herein, silk when plasticized is more flexible. 6% Mid MW Silk was mixed with different plasticizers at 1.5% and 3% concentration (weight/volume). Each of 1.5% Plasticizer with Silk and 3% plasticizer with silk were cast on silicone molds using 1.5 ml of solution. The films were cured for two days at 25° C. and were then evaluated for flexibility. The corresponding plasticizers were then selected and coated on leather swatches and evaluated for break.

TABLE 12
Description of sample preparation for leather using Mid MW Silk and
various plasticizers

| Sample No. | Casting Formulation | Observations |
|---|---|---|
| RSD-TXTL-370-1 | 6% Mid Silk (Control) | Brittle |
| RSD-TXTL-370-2 | 6% Mid Silk + 3% D-Sorbitol | Very flexible |
| RSD-TXTL-370-3 | 6% Mid Silk + 1.5% D-Sorbitol | Very flexible |
| RSD-TXTL-370-4 | 6% Mid Silk + 3% PEG 200 | Very flexible |
| RSD-TXTL-370-5 | 6% Mid Silk + 1.5% PEG 200 | Very flexible |
| RSD-TXTL-370-6 | 6% Mid Silk + 3% PEG 400 | Slightly flexible |
| RSD-TXTL-370-7 | 6% Mid Silk + 1.5% PEG 400 | Slightly flexible |
| RSD-TXTL-370-8 | 6% Mid Silk + 3% Sucrose | Brittle |
| RSD-TXTL-370-9 | 6% Mid Silk + 1.5% Sucrose | Brittle |
| RSD-TXTL-370-10 | 6% Mid Silk + 3% D-Mannitol | Brittle |
| RSD-TXTL-370-11 | 6% Mid Silk + 1.5% D-Mannitol | Brittle |
| RSD-TXTL-370-12 | 6% Mid Silk + 3% Glycerol | Flexible |
| RSD-TXTL-370-13 | 6% Mid Silk + 1.5% Glycerol | Flexible |

TABLE 13
Description of sample preparations for plasticizers only

| Sample No. | Casting Formulation | Observations |
|---|---|---|
| RSD-TXTL-370-14 | 3% D-Mannitol | Does not form film |
| RSD-TXTL-370-15 | 3% D-Sorbitol | Does not form film |
| RSD-TXTL-370-16 | 3% Sucrose | Does not form film |
| RSD-TXTL-370-17 | 3% PEG 200 | Does not form film |
| RSD-TXTL-370-18 | 3% Glycerol | Does not form film |
| RSD-TXTL-370-19 | 3% PEG 400 | Does not form film |

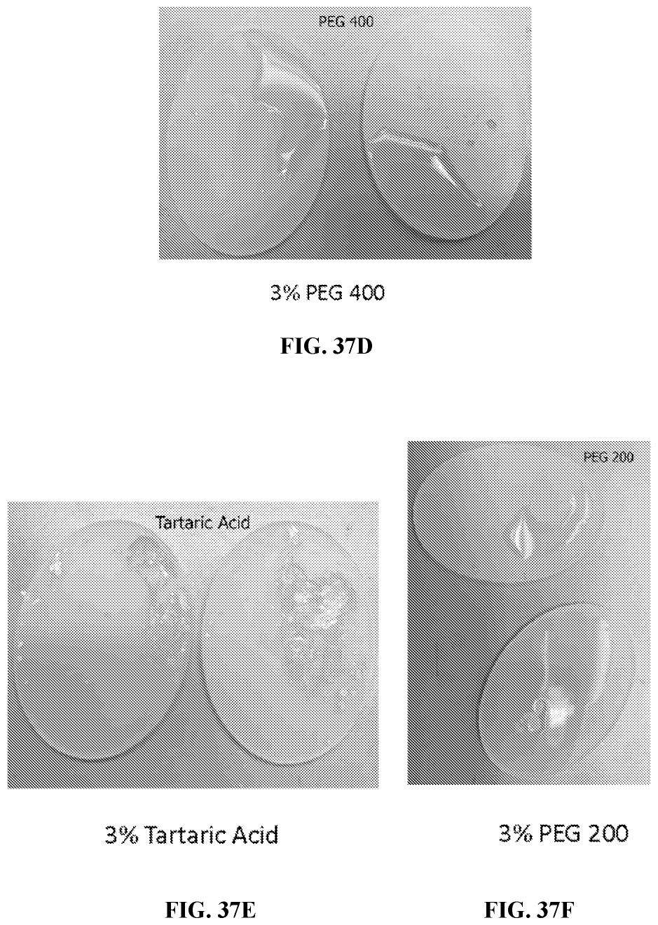

FIGS. 36A to 36E illustrate exemplary embodiments of flexible films made from 6% Mid Silk with 3% plasticizers; the plasticizers used are, respectively, glycerol (FIG. 36A), PEG 200 (FIG. 36B), PEG 400 (FIG. 36C), D-sorbitol (FIG. 36D), and sucrose (FIG. 36E).

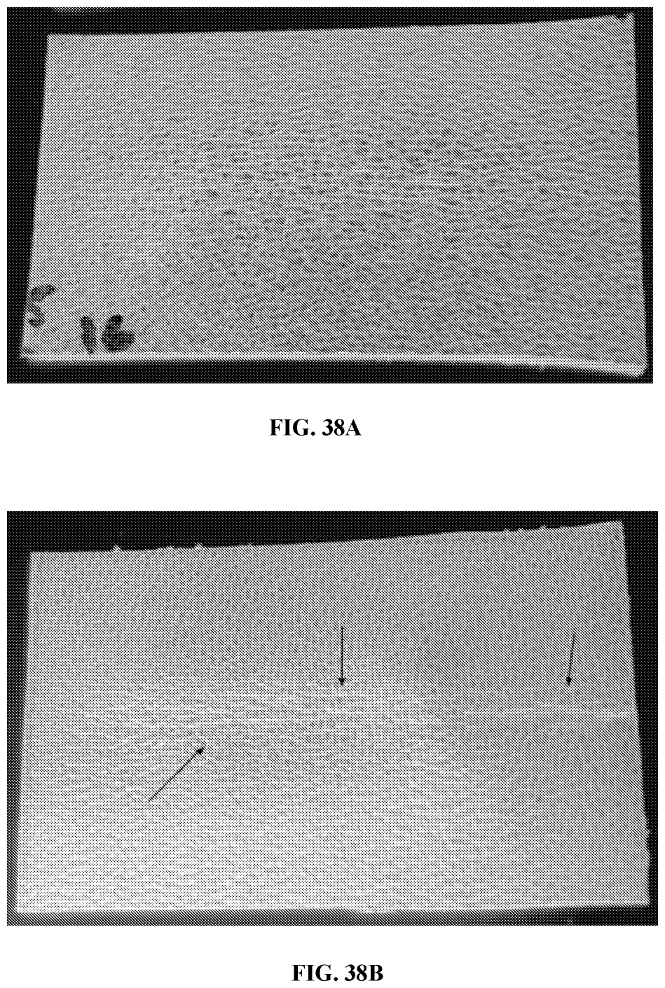

FIGS. 37A to 37F illustrate that plasticizers on their own are unable to form films, and thus that silk is integral to making a flexible film; the plasticizers used are, respectively, D-mannitol (FIG. 37A), sucrose (FIG. 37B), glycerol (FIG. 37C), PEG 400 (FIG. 37D), tartaric acid (FIG. 37E), and PEG 200 (FIG. 37F).

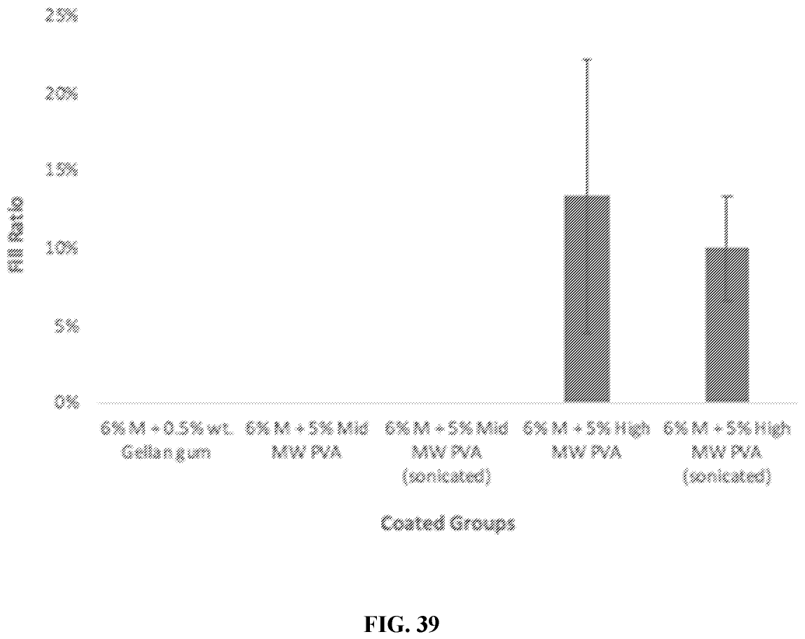

FIGS. 38A and 38B illustrate a visualization of break on leather coated using silk with and without plasticizer; and showing that the formulation of silk and plasticizer results in improved leather break compared to silk alone; FIG. 38A illustrates a leather sample coated with 6% MID MW silk and 0.5% (wt.) Gellan gum and 3% (volume) PEG 200, wherein no break areas visible after handling for 60 seconds; FIG. 38B illustrates a leather sample coated with 6% MID MW silk and 0.5% (wt.) Gellan gum, wherein the graphical arrows denote areas of excessive break remaining on the sample after handling for 60 seconds.

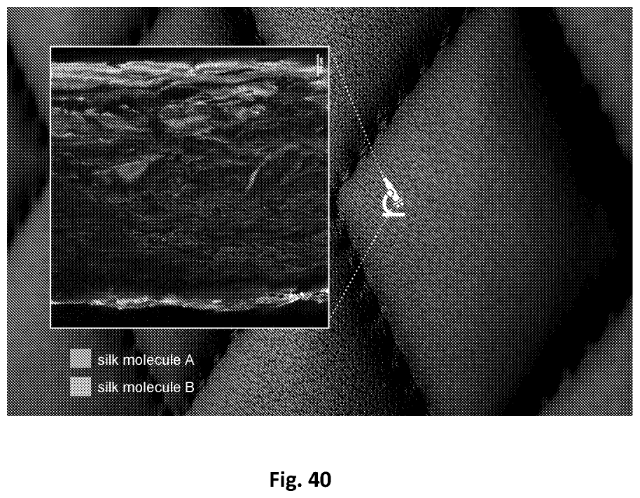

FIG. 39 is a chart illustrating that silk-PVA blends are also plasticized relative to silk alone, and can be used to fill leather defects as well as provide improved break. The fill ratio of various-MW polyvinyl alcohol (PVA)-silk blends is shown compared to silk-gellan gum control (far left) on 25 sq. in. leather samples. Samples are coated at 4.0 g/sq. ft. using an Automatic Film Application Table with a 20 μm wire bar coater (TQC Industries).

### Example 13: Effects of Activated Silk™ Treatment on Color Saturation on Leather

1. Leather substrates
(1) Nubuck skins in crust—Black and Brown
(2) Nubuck skins finished—Black and Blue
(3) Suede skins finished—Brown and Turquoise
(4) Bottom split suede—Not tested
(5) Top Split Wet Blue Suede (wet skin)—Not tested 2. Activated Silk™ Formulation
(1) Silk molecule A
(2) Silk molecule B

3. Method

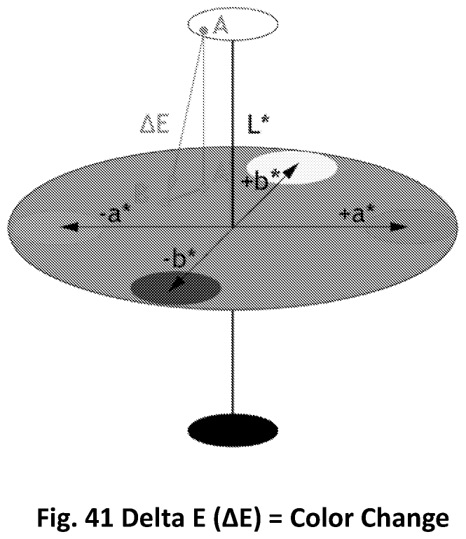

The leather samples were sprayed with Activated Silk™ Formulations containing silk molecule A and silk molecule B. The molecular level interactions between silk molecules A and B and the leather was studied with a microscope. Microscopic cross-section of silk and leather infusion, showing two different silk molecules A and B with varying penetration (See FIG. 40).

The impact on color saturation on the Activated Silk™ treated color leather samples was evaluated visually and quantified using a CM 700d Spectrophotometer from Konica Minolta by measuring color difference (ΔE).

The color difference (ΔE) is quantified using the color space parameters measured for the Activated Silk™ treated leather samples versus the untreated samples. A discernable color enhancement/saturation on a silk treated leather sample is characterized as having ΔE>1. ΔE>1 is considered to be discernible by the human eye.

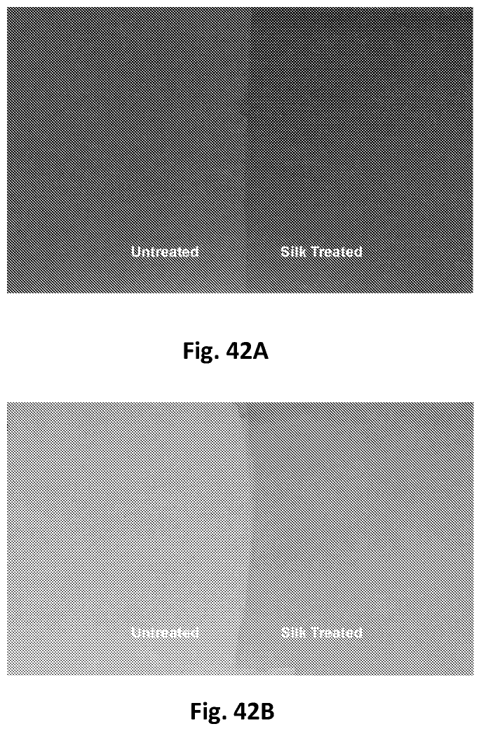

The calculation of ΔE is based on the change in 3 color values as measured by the spectrophotometer (See FIG. 41 and Eq. 1):
L* from dark (−) to light (+)
a* from green (−) to red (+)
b* from blue (−) to yellow (+)

ΔE*_{ab}=\sqrt{(L*₂−L*ⱼ)²+(a*₂−a*₁)²+(b*₂−b*ⱼ)²} Eq. 1

L₂, a₂ and b₂ were assigned to the Activated Silk™ treated samples and L₁, a₁ and b₁ were assigned to the untreated samples.

The color saturation testing results demonstrated that Activated Silk™ formulations had an impact on color enhancement/saturation on most samples (e.g. ΔE>1). Most significant color changes observed on the brown and dark blue Nubuck samples, and the Suede samples.

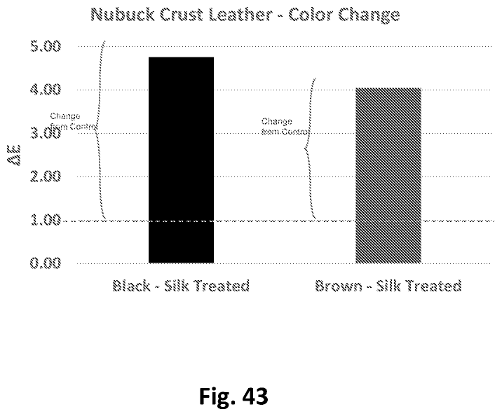

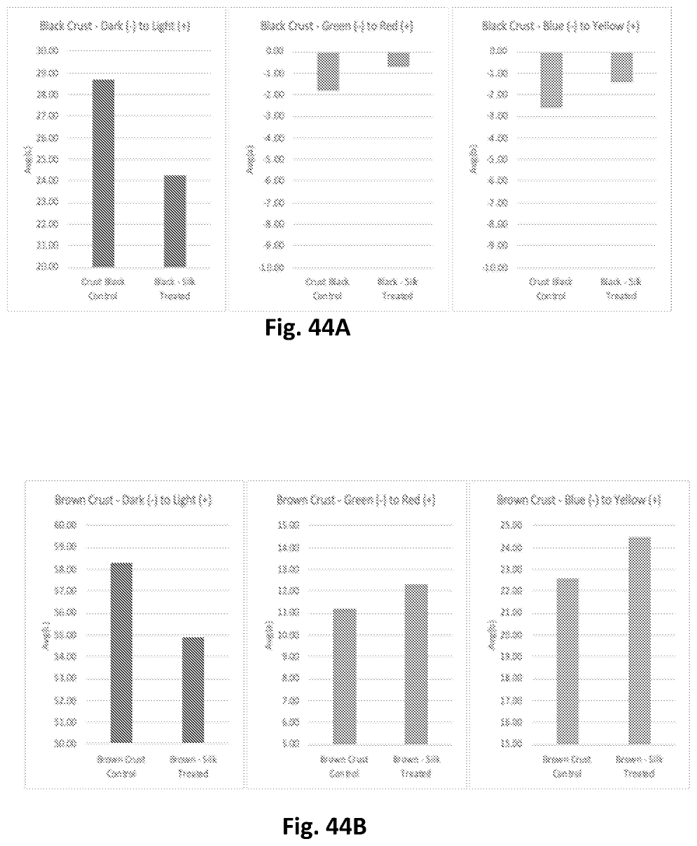

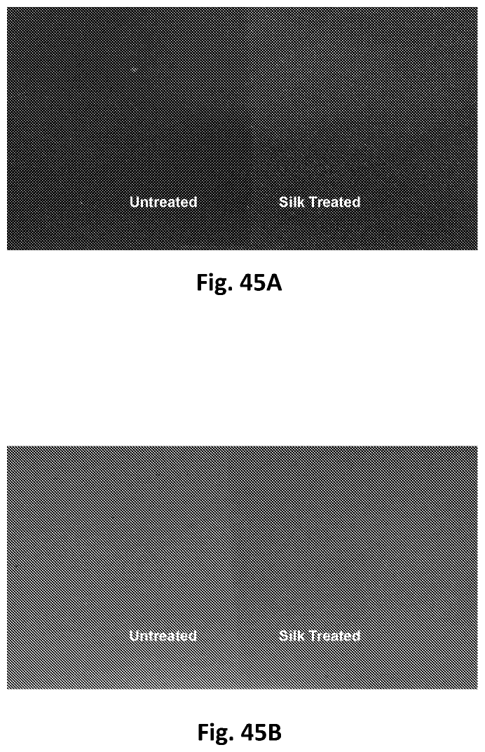

The color changes for silk treated black and brown Nubuck Crust leather samples as compared with untreated Nubuck Crust leather samples are shown in FIGS. 42A and 42B. The measured ΔE values for the silk treated black and brown Nubuck Crust leather samples are summarized in FIG. 43. The color change measurements are summarized in FIGS. 44A-B.

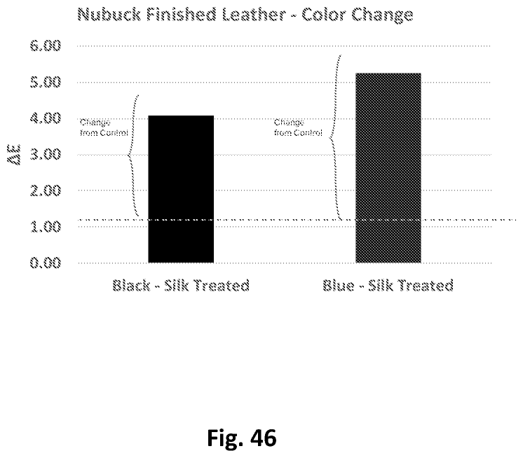

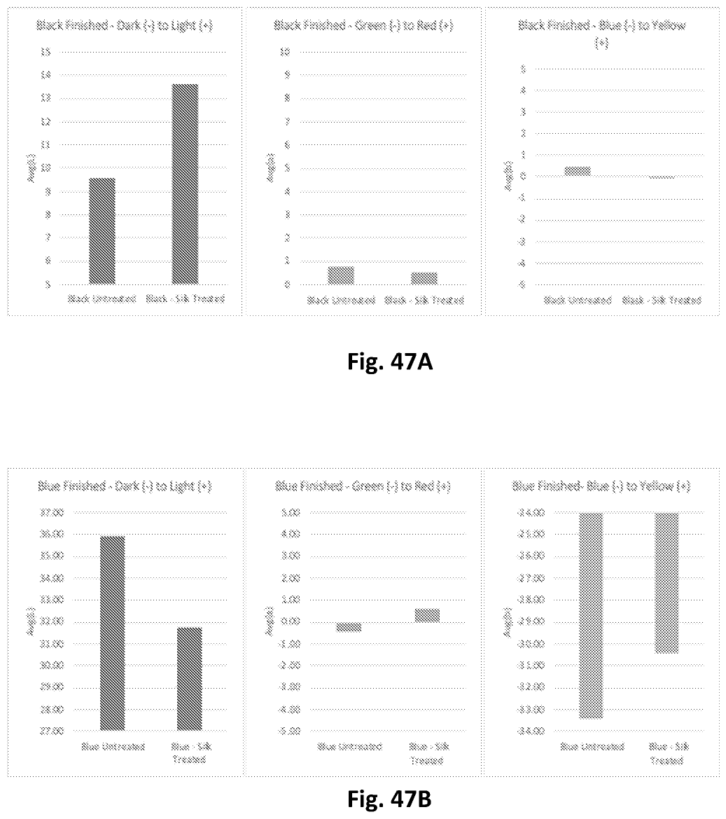

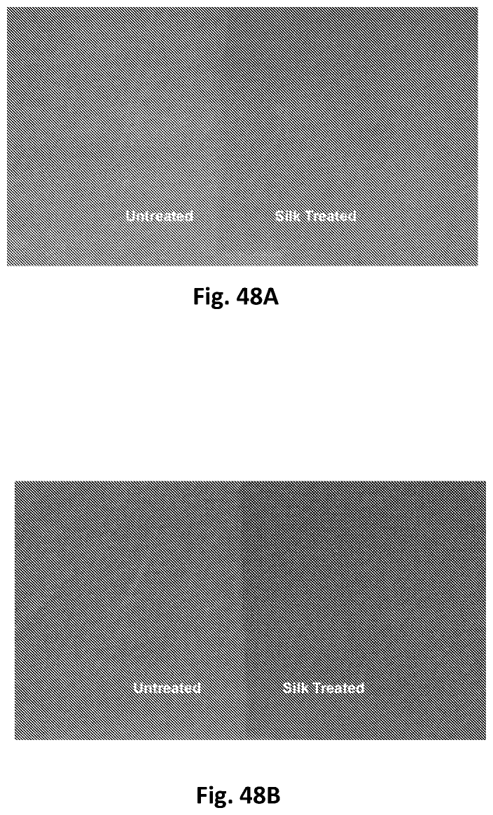

The color changes for silk treated black and blue Nubuck Finished leather samples as compared with untreated black and blue Nubuck Finished leather samples are shown in FIGS. 45A-B. The measured ΔE values for the silk treated black and blue Nubuck Finished leather samples are summarized in FIG. 46. The color change measurements are summarized in FIGS. 47A-B.

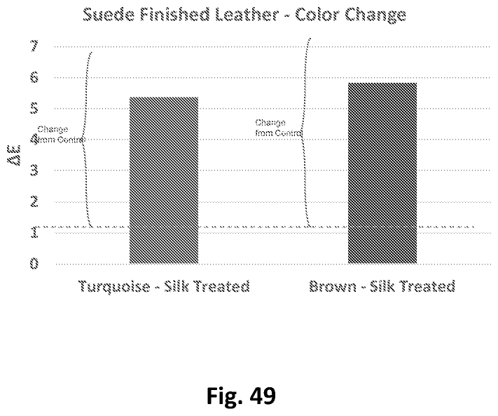

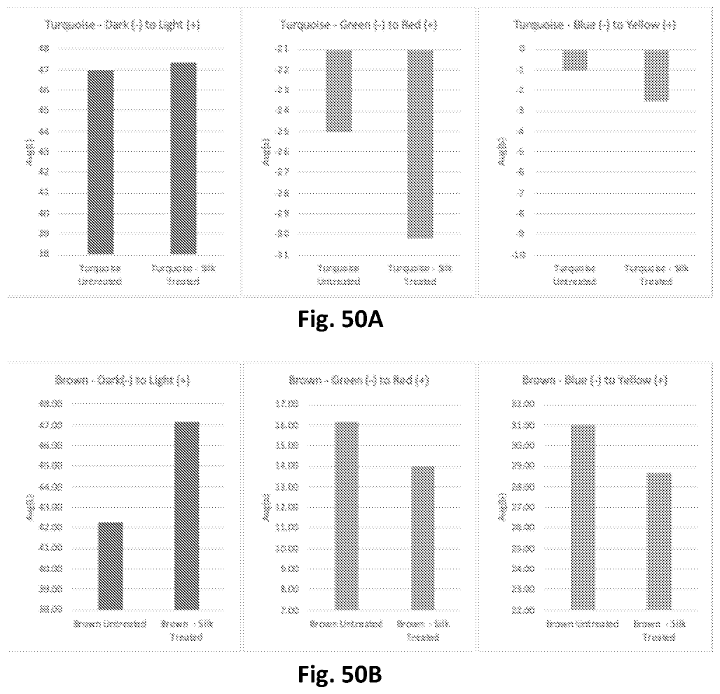

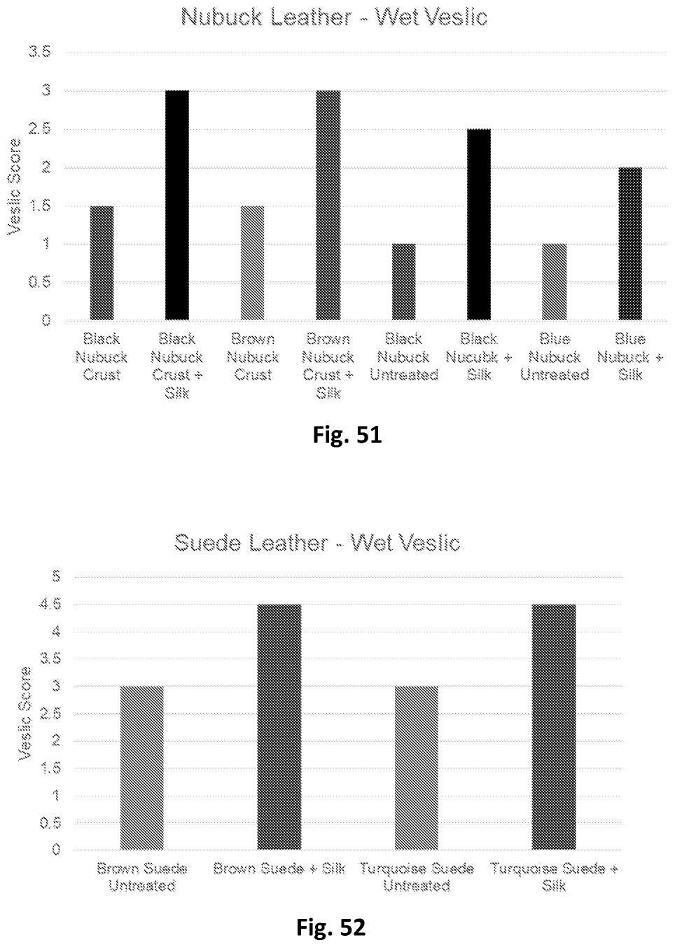

The color changes for silk treated turquoise and brown Nubuck Finished suede leather samples as compared with untreated turquoise and brown Nubuck Finished suede leather samples are shown in FIGS. 48A and 48B. The measured ΔE values for the silk treated turquoise and brown Nubuck Finished suede leather samples are summarized in FIG. 49. The color change measurements are summarized in FIGS. 50A-B.

### Example 14: Effects of Activated Silk™ Treatment on Color Fixation on Leather

1. Material
(1) Nubuck skins in crust—Black and Brown
(2) Nubuck skins finished—Black and Blue
(3) Suede skins finished—Brown and Turquoise
(4) Bottom split suede—Not tested
(5) Top Split Wet Blue Suede (wet skin)—Not tested

2. Activated Silk™ Formulation
(1) Silk molecule A
(2) Silk molecule B

3. Method

The leather samples were sprayed with Activated Silk™ Formulations containing silk molecule A and silk molecule B. The impact on color fixation was evaluated using a Veslic Color fastness Abrasion Tester by measuring Veslic Score (Schap Specialty Machine, Inc.). The molecular level interactions between silk molecules A and B and the leather was studied with a microscope. Microscopic cross-section of silk and leather infusion, showing two different silk molecules A and B with varying penetration (See FIG. 40).

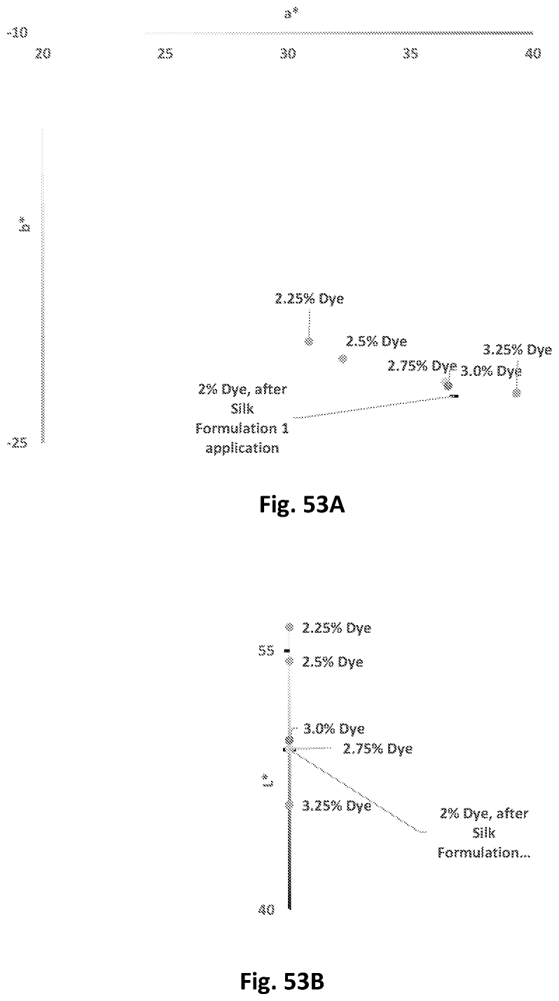

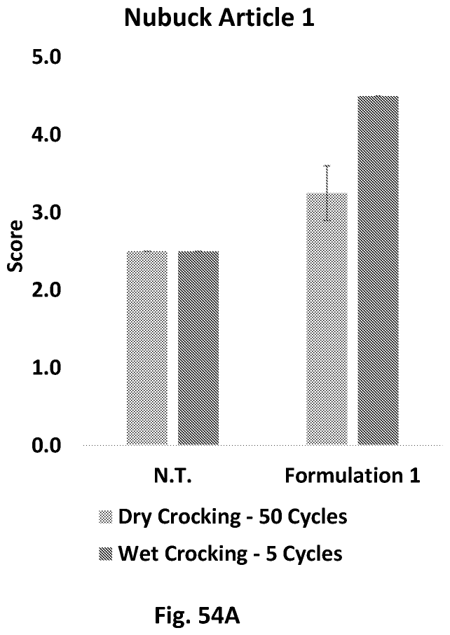

The veslic scores for silk treated Black and Brown Nubuck Crust leather samples, silk treated Black and Blue Nubuck Finished leather samples, silk treated Brown and Turquoise Suede leather samples, untreated Black and Brown Nubuck Crust leather samples, untreated Black and Blue Nubuck Finished leather samples, and treated Brown and Turquoise Suede leather samples were summarized in FIGS. 51-52.

The color fixation testing results demonstrated that improvements on color fixation were obtained for the testing sample by measuring the wet veslic scores. Wet veslic scores increases of 1-1.5 points are observed for most samples.

### Example 15: Protocols for the Use of Activated Silk™ to Enhance Color Saturation and Fixation on Leather

Melio 09-S-11 (poly diisocyanate; formulation including: hexane, 1,6-diisocyanato-, homopolymer, >=50-<=75, CAS 28182-81-2; ethanol, 2-butoxy-, 1-acetate, >=10-<=25, CAS 112-07-2; poly(oxy-1,2-ethanediyl), .alpha.-tridecyl-.omega.-hydroxy-, phosphate, >0-<=3, CAS 9046-01-9; 2-propanamine, N-ethyl-N-(1-methylethyl)-, >0-<=3, CAS 7087-68-5; phosphoric acid, butyl ester, >0-<=3, CAS 12788-93-1; hexane, 1,6-diisocyanato-, >0-<=0.3, CAS 822-06-0).

Roda Link 5777 (carbodiimide, formulated as aqueous crosslinker based on a modified carbodiimide).
Roda Link 3315/F (aliphatic aldehydes; formulated by aliphatic aldehydes in aqueous solution).

1. Application of Activated Silk™ Prior to Dyeing:
a. Prepare Activated Silk™ coating solution
   i. Dilute desired amount of Activated Silk™ concentrate in water.
      1. Formulations to consider
         a. 1.5%-35% of Activated Silk™ C (Low MW)
         b. 1.5%-35% of Activated Silk™ D (Mid MW)
         c. 1.5%-35% of 1:1 Activated Silk™ C+D
      2. Mix for 1-2 minutes by gently stirring, not shaking.
      3. Please try to prevent excessive foaming during this process.
   ii. In some embodiments, crosslinker can be added and mixed by gently stirring for 1-2 minutes.
      1. In some embodiments, crosslinkers are Roda Link 5777 and Melio 09-S-11, in a ratio of 4.25:1 (Activated Silk™ to crosslinker)
   iii. Apply Activated Silk™ formulations via spray gun, allowing skins with Activated Silk™ to cure for at least 3 days
   iv. Stamp skins, as needed
b. Dye skins using conventional dyeing method

2. Application of Activated Silk™ During Dyeing Process
a. Application of Activated Silk™ with dye
   i. Follow conventional dyeing process
   ii. Add Activated Silk™ after fatliquoring step, and agitate for 10 minutes
      1. Suggested Formulations:
         a. 1%-5% Activated Silk™ C (Low MW)
         b. 1%-5% Activated Silk™ D (Mid MW)
         c. 1%-5% Activated Silk™ C+D (1:1 ratio)
      iii. Add fixative
      iv. Complete required skin processing
b. Application of Activated Silk™ in dye drum, post rinse:
   i. Prepare dyeing solution and start dyeing process
   ii. Complete dyeing process and rinse skins
   iii. Add Activated Silk™ and agitate for 10 minutes in drum, suggested formulations below
      1. 1%-5% Activated Silk™ C
      2. 1%-5% Activated Silk™ D
      3. 1%-5% Activated Silk™ C+D (1:1)
   iv. Finish skins as usual

3. Application of Activated Silk™ after Dyeing Process During Finishing Process
a. Dilute the desired amount of Activated Silk™ in water
   i. Apply Activated Silk™ formulation via spray gun, suggested formulations below:
      1. 1.5%-17% Activated Silk™ C
      2. 1.5%-17% Activated Silk™ D
      3. 1.5%-17% Activated Silk™ C+D
   ii. Mix by gently stirring for 1-2 minutes, not shaking.
   iii. Please try to prevent excessive foaming during this process.
b. In some embodiments, crosslinker can be added and mixed by gently stirring for 1-2 minutes. In some embodiments, crosslinkers are Roda Link 5777 and Melio 09-S-11, in a ratio of 4.25:1 (Activated Silk™ to crosslinker)
c. Finish samples as per regular process
d. Allow to cure at least 3 days and up to 5 days, based on crosslinker used

### Example 16: Treatment of Leather with Silk and Crosslinkers

Various leathers have been coated with various combinations of Activated Silk™ and crosslinkers to provide performance benefits, in particular colorfastness. Activated Silk™ alone can provide improved performance properties to leather such as colorfastness and other protective properties. In some cases it is advantageous, however, to use Activated Silk™ in conjunction with a crosslinker. These combinations may further improve the properties listed above or provide other properties.

### Sample Treatments

Samples are generated via spray finish.
Samples are weighed prior to spray application.
Spray application takes place in one contiguous coat, applied onto sample at a distance of 1-1.5 ft at outlet pressure of 30 psi.
Samples are weighed after coating and applied wet mass is calculated Tests
   Wet Veslic (ISO 11640), 10 cycles
   Dry Veslic (ISO 11640), 50 cycles
   Wet Crocking (AATCC TM 8), 5 cycles
   Dry Crocking (AATCC TM 8), 50 cycles

TABLE 14
Changes in Scores from Untreated Samples (Dry and Wet Veslic and
Crocking)

| | | | Low Silk + | Low Silk + | Low Silk + | Low Silk + |
|---|---|---|---|---|---|---|
| Changes | | Low | Isocyanate | Carbodiimide | Aziridine | Aldehyde |
| in Scores | Test | Silk | Crosslinker | Crosslinker | Crosslinker | Crosslinker |
| Full Grain | Crocking- | +2 | +2 | +2 | +0.5 | +2.25 |
| Leather | D50 | | | | | |
| | Veslic- | +0.5 | +1 | +0.5 | +0 | +0.25 |
| | D50 | | | | | |
| | Crocking- | +0.5 | +1 | +0.5 | +0.5 | +0.5 |
| | W5 | | | | | |
| | Veslic- | +0 | +0.5 | +0.5 | +0.5 | +0.75 |
| | D50 | | | | | |
| | Veslic- | +0.75 | +0.5 | +1.25 | +2.75 | +0.75 |
| | W10 | | | | | |
| Nubuck | Crocking- | +0.5 | +0.5 | +0.5 | +0 | +0.5 |
| Leather | D50 | | | | | |
| | Crocking- | +0 | +1.25 | +1 | +0.25 | +0.5 |
| | W5 | | | | | |
| | Veslic- | +0.75 | +2 | +1 | +0.75 | +0 |
| | D50 | | | | | |
| | Veslic- | +1.5 | +2.75 | +0 | +1.5 | +1 |
| | W10 | | | | | |
| Suede | Crocking- | +0 | +0 | +0.5 | +0.25 | +0.25 |
| Leather | D50 | | | | | |

TABLE 15
Further improvements achieved in leather rubfastness using Activated
Silk ™ with crosslinkers

| Leather | | Test and Test | Improve- | |
|---|---|---|---|---|
| Type | Color | Method | ment | Formula |
| Nubuck | Black | Wet Crocking | 1 → 2 | 8.3% Mid Silk + 2% |
| | | (AATCC TM8- | | Aldehyde Crosslinker |
| | | 10 Cycles) | | |
| Nubuck | Black | Wet Crocking | 1 → 2 | 8.3% Mid Silk + 2% |
| | | (AATCC TM8- | | Carbodiimide |
| | | 10 Cycles) | | Crosslinker |
| Nubuck | Blue | Wet Crocking | 1 → 2 | 8.3% Mid Silk + 2% |
| | | (AATCC TM8- | | Aldehyde Crosslinker |
| | | 10 Cycles) | | |
| Split | Black | Wet Crocking | 1 → 2 | 8.3% Mid Silk + 2% |
| Grain | | (AATCC TM8- | | Carbodiimide |
| | | 50 Cycles) | | Crosslinker |
| Split | Olive | Wet Crocking | 1 → 2 | 8.3% Mid Silk + 2% |
| Grain | | (AATCC TM8- | | Isocyanate |
| | | 50 Cycles) | | Crosslinker |
| Split | Olive | Wet Crocking | 1 → 2 | 8.3% Mid Silk + 2% |
| Grain | | (AATCC TM8- | | Aldehyde Crosslinker |
| | | 50 Cycles) | | |
| Split | Olive | Wet Crocking | 1 → 2.5 | 8.3% Mid Silk + 2% |
| Grain | | (AATCC TM8- | | Carbodiimide |
| | | 50 Cycles) | | Crosslinker |
| Full | Red | Wet Crocking | 3 → 4.5 | 8.3% Mid Silk + 2% |
| Grain | | (AATCC TM8- | | Isocyanate |
| | | 10 Cycles) | | Crosslinker |
| Full | Red | Wet Crocking | 3 → 4 | 8.3% Mid Silk + 2% |
| Grain | | (AATCC TM8- | | Aldehyde Crosslinker |
| | | 10 Cycles) | | |
| Full | Red | Wet Crocking | 3 → 4.5 | 8.3% Mid Silk + 2% |
| Grain | | (AATCC TM8- | | Carbodiimide |
| | | 10 Cycles) | | Crosslinker |
| Nubuck | Brown | Wet Crocking | 1 → 3.5 | 8.3% Mid Silk + 2% |
| | | (AATCC TM8- | | Carbodiimide |
| | | 10 Cycles) | | Crosslinker |
| Nubuck | Black | Wet Crocking | 1 → 2.5 | 8.3% Mid Silk + 2% |
| | | (AATCC TM8- | | Carbodiimide |
| | | 10 Cycles) | | Crosslinker |
| Suede | Brown | Wet Crocking | 1.5 → 4 | 8.3% Mid Silk + 2% |
| | | (AATCC TM8- | | Carbodiimide |
| | | 10 Cycles) | | Crosslinker |
| Nubuck | Brown | Wet Veslic (ISO | 1.5 → 3 | 8.3% Mid Silk + 2% |
| | | 11640-10 Cycles) | | Isocyanate Crosslinker |
| Nubuck | Brown | Wet Veslic (ISO | 1.5 → 3 | 17% Mid Silk + 3% |
| | | 11640-10 Cycles) | | Isocyanate Crosslinker |
| Nubuck | Black | Wet Veslic (ISO | 1.5 → 2.5 | 17% Low Silk + 3% |
| | | 11640-10 Cycles) | | Isocyanate Crosslinker |
| Nubuck | Black | Wet Veslic (ISO | 1.5 → 4.5 | 8.3% Mid Silk + 2% |
| | | 11640-10 Cycles) | | Isocyanate Crosslinker |
| Nubuck | Black | Wet Veslic (ISO | 1.5 → 3 | 8.3% Mid Silk + 2% |
| | | 11640-10 Cycles) | | Aldehyde Crosslinker |
| Nubuck | Blue | Wet Veslic (ISO | 1 → 2 | 8.3% Low Silk + 2% |
| | | 11640-10 Cycles) | | Isocyanate Crosslinker |
| Nubuck | Blue | Wet Veslic (ISO | 1 → 2 | 17% Low Silk + 3% |
| | | 11640-10 Cycles) | | Isocyanate Crosslinker |
| Nubuck | Blue | Wet Veslic (ISO | 1 → 2 | 8.3% Mid Silk + 2% |
| | | 11640-10 Cycles) | | Isocyanate Crosslinker |
| Nubuck | Blue | Wet Veslic (ISO | 1 → 2 | 17% Mid Silk + 3% |
| | | 11640-10 Cycles) | | Aldehyde Crosslinker |
| Nubuck | Black | Wet Veslic (ISO | 1 → 4 | 8.3% Mid Silk + 2% |
| | | 11640-10 Cycles) | | Isocyanate Crosslinker |
| Nubuck | Black | Wet Veslic (ISO | 1 → 4.5 | 1% Mid Silk + 3% |
| | | 11640-10 Cycles) | | Isocyanate Crosslinker |
| Suede | Brown | Wet Veslic (ISO | 3 → 4 | 17% Low Silk + 3% |
| | | 11640-10 Cycles) | | Isocyanate Crosslinker |
| Suede | Brown | Wet Veslic (ISO | 3 → 4 | 8.3% Mid Silk + 2% |
| | | 11640-10 Cycles) | | Isocyanate Crosslinker |
| Suede | Brown | Wet Veslic (ISO | 3 → 4 | 8.3% Mid Silk + 2% |
| | | 11640-10 Cycles) | | Aldehyde Crosslinker |
| Suede | Brown | Wet Veslic (ISO | 3 → 4 | 17% Mid Silk + 3% |
| | | 11640-10 Cycles) | | Isocyanate Crosslinker |
| Suede | Brown | Wet Veslic (ISO | 3 → 4.5 | 17% Mid Silk + 3% |
| | | 11640-10 Cycles) | | Aldehyde Crosslinker |
| Suede | Tur- | Wet Veslic (ISO | 3 → 4 | 8.3% Low Silk + 2% |
| | quoise | 11640-10 Cycles) | | Isocyanate Crosslinker |
| Suede | Tur- | Wet Veslic (ISO | 3 → 4 | 17% Low Silk + 3% |
| | quoise | 11640-10 Cycles) | | Isocyanate Crosslinker |
| Suede | Tur- | Wet Veslic (ISO | 3 → 4 | 8.3% Mid Silk + 2% |
| | quoise | 11640-10 Cycles) | | Isocyanate Crosslinker |
| Suede | Tur- | Wet Veslic (ISO | 3 → 4 | 8.3% Mid Silk + 2% |
| | quoise | 11640-10 Cycles) | | Aldehyde Crosslinker |
| Suede | Tur- | Wet Veslic (ISO | 3 → 4 | 17% Mid Silk + 3% |
| | quoise | 11640-10 Cycles) | | Isocyanate Crosslinker |
| Suede | Tur- | Wet Veslic (ISO | 3 → 4.5 | 17% Mid Silk + 3% |
| | quoise | 11640-10 Cycles) | | Aldehyde Crosslinker |
| Nubuck | Brown | Wet Veslic (ISO | 1.5 → 2.5 | 1.7% Mid Silk + 0.5% |
| | | 11640-10 Cycles) | | Aldehyde Crosslinker |
| Nubuck | Blue | Wet Veslic (ISO | 1 → 2 | 1.7% Low Silk + 0.5% |
| | | 11640-10 Cycles) | | Isocyanate Crosslinker |
| Nubuck | Blue | Wet Veslic (ISO | 1 → 2 | 1.7% Mid Silk + 0.5% |
| | | 11640-10 Cycles) | | Isocyanate Crosslinker |
| Suede | Brown | Wet Veslic (ISO | 3 → 4 | 1.7% Low Silk + 0.5% |
| | | 11640-10 Cycles) | | Isocyanate Crosslinker |
| Suede | Brown | Wet Veslic (ISO | 3 → 4 | 1.7% Low Silk + 0.5% |
| | | 11640-10 Cycles) | | Aldehyde Crosslinker |
| Suede | Brown | Wet Veslic (ISO | 3 → 4 | 1.7% Low Silk + 0.5% |
| | | 11640-10 Cycles) | | Isocyanate Crosslinker |
| Suede | Brown | Wet Veslic (ISO | 3 → 4 | 1.7% Low Silk + 0.5% |
| | | 11640-10 Cycles) | | Aldehyde Crosslinker |
| Suede | Tur- | Wet Veslic (ISO | 3 → 4 | 1.7% Low Silk + 0.5% |
| | quoise | 11640-10 Cycles) | | Isocyanate Crosslinker |
| Suede | Tur- | Wet Veslic (ISO | 3 → 4 | 1.7% Low Silk + 0.5% |
| | quoise | 11640-10 Cycles) | | Aldehyde Crosslinker |
| Suede | Tur- | Wet Veslic (ISO | 3 → 4 | 1.7% Low Silk + 0.5% |
| | quoise | 11640-10 Cycles) | | Isocyanate Crosslinker |
| Suede | Tur- | Wet Veslic (ISO | 3 → 4.5 | 1.7% Low Silk + 0.5% |
| | quoise | 11640-10 Cycles) | | Aldehyde Crosslinker |

### Example 17: Reduction of Dye Using Pre-Dye Application of Silk

When silk is sprayed onto leather before dyeing, the amount of dye that is needed to be used in the dye bath decreases. The silk absorbs more dye, thus requiring less dye to be present in the bath. This effect has economic implications because the use of silk can lead to reducing usage of synthetic dyestuffs, without limitation.

Typically, a high concentration of dyestuffs is used in the leather dye bath, with the understanding that much of the dye will not penetrate the leather and will become waste. The dyes used in the leather industry are typically synthetic petrochemicals that can pollute the environment when they leach into wastewater. There is therefore an unmet need for technologies that can increase dye uptake so that fewer dyestuffs are needed, and their production and use can be minimized. There is a particular need for these technologies to increase dye uptake to be sustainable, so that the reduction of synthetic dyes is not accomplished through the use of some other synthetic agent.

Silk fibroin solutions of various molecular weight (e.g., and without particular limitation, about 5—about 100 kDa) and concentration (e.g., and without particular limitation, 10 g/mL) have been applied via a spray coating process at 11 g/sqft onto leather articles prior to dyeing. These articles were then dyed via standard methods using a range of dye concentrations. In certain instances, the silk formulations have been mixed with industry standard crosslinking agents of various compositions to achieve a desired result.

The color of the resulting leathers was determined colorimetrically, using a Konica Minolta 700d colorimeter, and color values were plotted in the L*a*b* color space. This data showed that spraying the leather with the silk formulation prior to dyeing allowed less dye to be used, while still accessing a similar color.

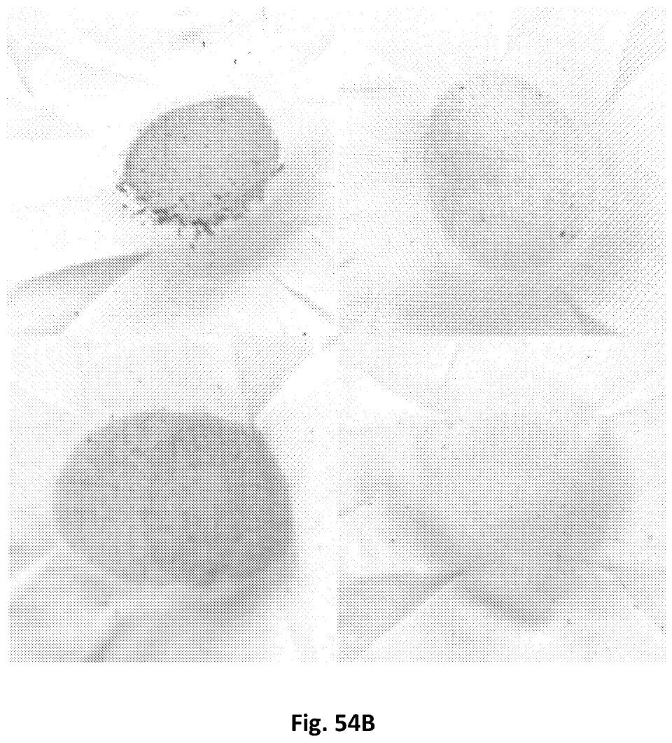

FIGS. 53A and 53B illustrate the color of leather samples determined colorimetrically with color values plotted in the L*a*b* color space; FIG. 53A: a* and b* values for leather dyed with different concentrations of purple dye; FIG. 53B: L* values for leather dyed with different concentrations of purple dye.

The data shows that a similar color can be accessed using either 3% dye, or using 2% dye after application of Silk Formulation 1 via spray. This represents a 33% reduction in dye.

### Example 18: Improving Leather Colorfastness Performance with Silk Fibroin Coatings

Coatings of aqueous silk fibroin suspensions can be utilized to improve colorfastness performance of finished leather articles. Without wishing to be bound by any particular theory, this is accomplished through deposition of a silk-based polymer network that acts as a topcoat ‘film’ finish which physically prevents significant dye migration off of the leather surface.

Finished leather articles of various grain structure and application are expected to meet a diverse format of customer standards for colorfastness performance, two examples of which are colorfastness to migration (such as ISO 15701) and colorfastness to crocking (such as AATCC TM 8) tests. Still, many tanneries struggle with meeting customer standards for all of their articles, and chemistries that are effective in improving these colorfastness regimes are highly desirable. It is also becoming increasingly more important that these solutions are comprised of sustainable materials rather than petrochemicals. The present disclosure addresses critical industry gaps in leather colorfastness performance in a sustainable manner.

Silk fibroin solutions of various molecular weight (e.g., and without limitation, about 5—about 100 kDa) and concentration (1-100 mg/mL) have been applied via a spray coating process at varying wet application masses (1-10 gift²) onto leather articles and improved their colorfastness performance compared to positive and negative control groups. In certain instances, the silk formulations have been mixed with industry standard crosslinking agents of various composition to achieve a desired result.

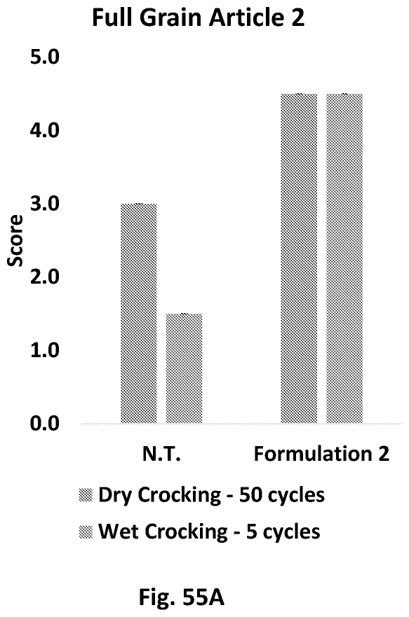

FIGS. 54A and 54B illustrate the colorfastness to crocking performance for a Nubuck leather article; FIG. 54A: scores of control (N.T.) and experimental articles treated with Silk Formulation 1; FIG. 54B: crocking fabric pads for scores given in FIG. 54A (clockwise from top right: N.T. dry 50 cycles; treated dry 50 cycles; treated wet 5 cycles; N.T. wet 5 cycles); N=2 replicates per group.

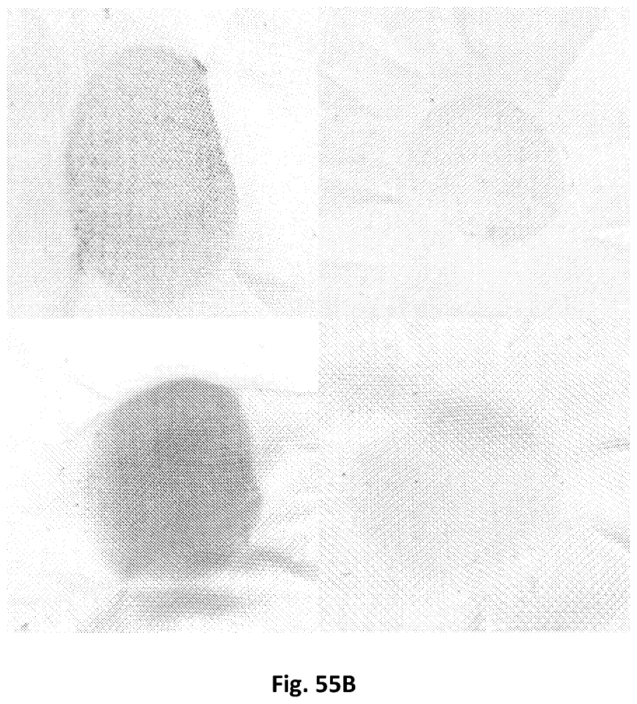

FIGS. 55A and 55B illustrate colorfastness to crocking performance for a Full Grain leather article; FIG. 55A: scores of control (N.T.) and experimental articles treated with Silk Formulation 2; FIG. 55B: crocking fabric pads for scores given in FIG. 55A (clockwise from top right: N.T. dry 50 cycles; treated dry 50 cycles; treated wet 5 cycles; N.T. wet 5 cycles); N=2 replicates per group.

Colorfastness to migration performance for several leather articles. Top Scores of control (N.T.) and experimental articles treated with various silk formulations (3 through 6):

| | | Form- | Form- | Form- | Form- |
|---|---|---|---|---|---|
| Leather | N.T. | ulation | ulation | ulation | ulation |
| Description | Score | 3 | 4 | 5 | 6 |
| Blue Nubuck | 2.75 | 4 | 4.5 | 4.5 | 4 |
| | | +1.25 | +1.75 | +1.75 | +1.25 |
| Brown | 3.25 | 4.5 | 4.5 | 4.5 | — |
| Nubuck | | +1.25 | +1.25 | +1.25 | |
| Brown | 2.5 | 3 | 3 | 3 | — |
| Suede | | +0.5 | +0.5 | +0.5 | |

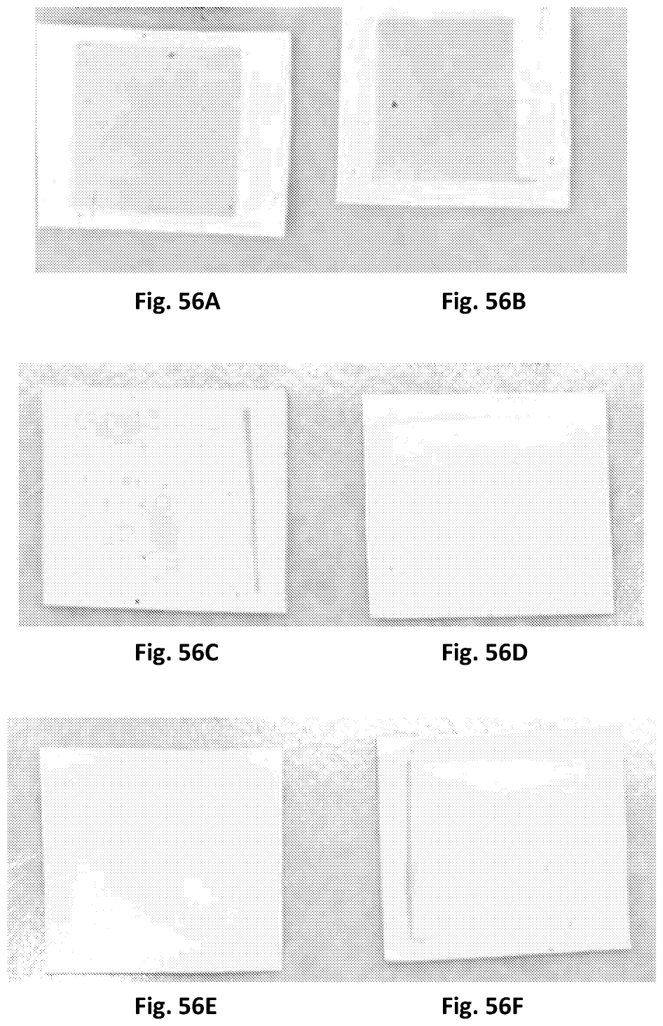

FIGS. 56A-56F: Blue Nubuck colorfastness to migration performance images of N.T. (FIGS. 56A and 56B) and treated (FIG. 56C: Formulation 3; FIG. 56D: Formulation 4; FIG. 56E: Formulation 5; FIG. 56F: Formulation 6) samples.

### Example 19: Combination Formulations

| | Chemical | Particular | |
|---|---|---|---|
| Type | Classes | Products | Formulations |
| Cross- | Poly- | Melio 09S11 | 15% AS 104-LS + 0.5% Melio 09S11 |
| linkers | isocyanates | (Stahl) | 15% AS 104-LS + 1% Melio 09S11 |
| | | | 15% AS 104-LS + 1.5% Melio 09S11 |
| | | | 15% AS 104-LS + 2% Melio 09S11 |
| | | | 15% AS 104-LS + 2.5% Melio 09S11 |
| | | | 15% AS 104-LS + 3% Melio 09S11 |
| | | | 15% AS 104-LS + 3.5% Melio 09S11 |
| | | | 15% AS 104-LS + 4% Melio 09S11 |
| | | | 15% AS 104-LS + 4.5% Melio 09S11 |
| | | | 15% AS 104-LS + 5% Melio 09S11 |
| | | | 15% AS 104-LS + 5.5% Melio 09S11 |
| | | | 15% AS 104-LS + 6% Melio 09S11 |
| | | | 15% AS 104-LS + 6.5% Melio 09S11 |
| | | | 15% AS 104-LS + 7% Melio 09S11 |
| | | | 15% AS 104-LS + 7.5% Melio 09S11 |
| | | | 15% AS 104-LS + 8% Melio 09S11 |
| | | | 15% AS 104-LS + 8.5% Melio 09S11 |
| | | | 15% AS 104-LS + 9% Melio 09S11 |
| | | | 15% AS 104-LS + 9.5% Melio 09S11 |
| | | | 15% AS 104-LS + 10% Melio 09S11 |
| | | | 16% AS 104-LS + 0.5% Melio 09S11 |
| | | | 16% AS 104-LS + 1% Melio 09S11 |
| | | | 16% AS 104-LS + 1.5% Melio 09S11 |
| | | | 16% AS 104-LS + 2% Melio 09S11 |
| | | | 16% AS 104-LS + 2.5% Melio 09S11 |
| | | | 16% AS 104-LS + 3% Melio 09S11 |
| | | | 16% AS 104-LS + 3.5% Melio 09S11 |
| | | | 16% AS 104-LS + 4% Melio 09S11 |
| | | | 16% AS 104-LS + 4.5% Melio 09S11 |
| | | | 16% AS 104-LS + 5% Melio 09S11 |
| | | | 16% AS 104-LS + 5.5% Melio 09S11 |
| | | | 16% AS 104-LS + 6% Melio 09S11 |
| | | | 16% AS 104-LS + 6.5% Melio 09S11 |
| | | | 16% AS 104-LS + 7% Melio 09S11 |
| | | | 16% AS 104-LS + 7.5% Melio 09S11 |
| | | | 16% AS 104-LS + 8% Melio 09S11 |
| | | | 16% AS 104-LS + 8.5% Melio 09S11 |
| | | | 16% AS 104-LS + 9% Melio 09S11 |
| | | | 16% AS 104-LS + 9.5% Melio 09S11 |
| | | | 16% AS 104-LS + 10% Melio 09S11 |
| | | | 17% AS 104-LS (=1% SF solids) + 0.5% Melio 09S11 |
| | | | 17% AS 104-LS (=1% SF solids) + 1% Melio 09S11 |
| | | | 17% AS 104-LS (=1% SF solids) + 1.5% Melio 09S11 |
| | | | 17% AS 104-LS (=1% SF solids) + 2% Melio 09S11 |
| | | | 17% AS 104-LS (=1% SF solids) + 2.5% Melio 09S11 |
| | | | 17% AS 104-LS (=1% SF solids) + 3% Melio 09S11 |
| | | | 17% AS 104-LS (=1% SF solids) + 3.5% Melio 09S11 |
| | | | 17% AS 104-LS (=1% SF solids) + 4% Melio 09S11 |
| | | | 17% AS 104-LS (=1% SF solids) + 4.5% Melio 09S11 |
| | | | 17% AS 104-LS (=1% SF solids) + 5% Melio 09S11 |
| | | | 17% AS 104-LS (=1% SF solids) + 5.5% Melio 09S11 |
| | | | 17% AS 104-LS (=1% SF solids) + 6% Melio 09S11 |
| | | | 17% AS 104-LS (=1% SF solids) + 6.5% Melio 09S11 |
| | | | 17% AS 104-LS (=1% SF solids) + 7% Melio 09S11 |
| | | | 17% AS 104-LS (=1% SF solids) + 7.5% Melio 09S11 |
| | | | 17% AS 104-LS (=1% SF solids) + 8% Melio 09S11 |
| | | | 17% AS 104-LS (=1% SF solids) + 8.5% Melio 09S11 |
| | | | 17% AS 104-LS (=1% SF solids) + 9% Melio 09S11 |
| | | | 17% AS 104-LS (=1% SF solids) + 9.5% Melio 09S11 |
| | | | 17% AS 104-LS (=1% SF solids) + 10% Melio 09S11 |
| | | | 18% AS 104-LS + 0.5% Melio 09S11 |
| | | | 18% AS 104-LS + 1% Melio 09S11 |
| | | | 18% AS 104-LS + 1.5% Melio 09S11 |
| | | | 18% AS 104-LS + 2% Melio 09S11 |
| | | | 18% AS 104-LS + 2.5% Melio 09S11 |
| | | | 18% AS 104-LS + 3% Melio 09S11 |
| | | | 18% AS 104-LS + 3.5% Melio 09S11 |
| | | | 18% AS 104-LS + 4% Melio 09S11 |
| | | | 18% AS 104-LS + 4.5% Melio 09S11 |
| | | | 18% AS 104-LS + 5% Melio 09S11 |
| | | | 18% AS 104-LS + 5.5% Melio 09S11 |
| | | | 18% AS 104-LS + 6% Melio 09S11 |
| | | | 18% AS 104-LS + 6.5% Melio 09S11 |
| | | | 18% AS 104-LS + 7% Melio 09S11 |
| | | | 18% AS 104-LS + 7.5% Melio 09S11 |
| | | | 18% AS 104-LS + 8% Melio 09S11 |
| | | | 18% AS 104-LS + 8.5% Melio 09S11 |
| | | | 18% AS 104-LS + 9% Melio 09S11 |
| | | | 18% AS 104-LS + 9.5% Melio 09S11 |
| | | | 18% AS 104-LS + 10% Melio 09S11 |
| | | | 19% AS 104-LS + 0.5% Melio 09S11 |
| | | | 19% AS 104-LS + 1% Melio 09S11 |
| | | | 19% AS 104-LS + 1.5% Melio 09S11 |
| | | | 19% AS 104-LS + 2% Melio 09S11 |
| | | | 19% AS 104-LS + 2.5% Melio 09S11 |
| | | | 19% AS 104-LS + 3% Melio 09S11 |
| | | | 19% AS 104-LS + 3.5% Melio 09S11 |
| | | | 19% AS 104-LS + 4% Melio 09S11 |
| | | | 19% AS 104-LS + 4.5% Melio 09S11 |
| | | | 19% AS 104-LS + 5% Melio 09S11 |
| | | | 19% AS 104-LS + 5.5% Melio 09S11 |
| | | | 19% AS 104-LS + 6% Melio 09S11 |
| | | | 19% AS 104-LS + 6.5% Melio 09S11 |
| | | | 19% AS 104-LS + 7% Melio 09S11 |
| | | | 19% AS 104-LS + 7.5% Melio 09S11 |
| | | | 19% AS 104-LS + 8% Melio 09S11 |
| | | | 19% AS 104-LS + 8.5% Melio 09S11 |
| | | | 19% AS 104-LS + 9% Melio 09S11 |
| | | | 19% AS 104-LS + 9.5% Melio 09S11 |
| | | | 19% AS 104-LS + 10% Melio 09S11 |
| | | | 20% AS 104-LS + 0.5% Melio 09S11 |
| | | | 20% AS 104-LS + 1% Melio 09S11 |
| | | | 20% AS 104-LS + 1.5% Melio 09S11 |
| | | | 20% AS 104-LS + 2% Melio 09S11 |
| | | | 20% AS 104-LS + 2.5% Melio 09S11 |
| | | | 20% AS 104-LS + 3% Melio 09S11 |
| | | | 20% AS 104-LS + 3.5% Melio 09S11 |
| | | | 20% AS 104-LS + 4% Melio 09S11 |
| | | | 20% AS 104-LS + 4.5% Melio 09S11 |
| | | | 20% AS 104-LS + 5% Melio 09S11 |
| | | | 20% AS 104-LS + 5.5% Melio 09S11 |
| | | | 20% AS 104-LS + 6% Melio 09S11 |
| | | | 20% AS 104-LS + 6.5% Melio 09S11 |
| | | | 20% AS 104-LS + 7% Melio 09S11 |
| | | | 20% AS 104-LS + 7.5% Melio 09S11 |
| | | | 20% AS 104-LS + 8% Melio 09S11 |
| | | | 20% AS 104-LS + 8.5% Melio 09S11 |
| | | | 20% AS 104-LS + 9% Melio 09S11 |
| | | | 20% AS 104-LS + 9.5% Melio 09S11 |
| | | | 20% AS 104-LS + 10% Melio 09S11 |
| | | Roda Link | 15% AS 104-LS + 0.5% Roda Link C70 |
| | | C 70 (TFL) | 15% AS 104-LS + 1% Roda Link C70 |
| | | | 15% AS 104-LS + 1.5% Roda Link C70 |
| | | | 15% AS 104-LS + 2% Roda Link C70 |
| | | | 15% AS 104-LS + 2.5% Roda Link C70 |
| | | | 15% AS 104-LS + 3% Roda Link C70 |
| | | | 15% AS 104-LS + 3.5% Roda Link C70 |
| | | | 15% AS 104-LS + 4% Roda Link C70 |
| | | | 15% AS 104-LS + 4.5% Roda Link C70 |
| | | | 15% AS 104-LS + 5% Roda Link C70 |
| | | | 15% AS 104-LS + 5.5% Roda Link C70 |
| | | | 15% AS 104-LS + 6% Roda Link C70 |
| | | | 15% AS 104-LS + 6.5% Roda Link C70 |
| | | | 15% AS 104-LS + 7% Roda Link C70 |
| | | | 15% AS 104-LS + 7.5% Roda Link C70 |
| | | | 15% AS 104-LS + 8% Roda Link C70 |
| | | | 15% AS 104-LS + 8.5% Roda Link C70 |
| | | | 15% AS 104-LS + 9% Roda Link C70 |
| | | | 15% AS 104-LS + 9.5% Roda Link C70 |
| | | | 15% AS 104-LS + 10% Roda Link C70 |
| | | | 16% AS 104-LS + 0.5% Roda Link C70 |
| | | | 16% AS 104-LS + 1% Roda Link C70 |
| | | | 16% AS 104-LS + 1.5% Roda Link C70 |
| | | | 16% AS 104-LS + 2% Roda Link C70 |
| | | | 16% AS 104-LS + 2.5% Roda Link C70 |
| | | | 16% AS 104-LS + 3% Roda Link C70 |
| | | | 16% AS 104-LS + 3.5% Roda Link C70 |
| | | | 16% AS 104-LS + 4% Roda Link C70 |
| | | | 16% AS 104-LS + 4.5% Roda Link C70 |
| | | | 16% AS 104-LS + 5% Roda Link C70 |
| | | | 16% AS 104-LS + 5.5% Roda Link C70 |
| | | | 16% AS 104-LS + 6% Roda Link C70 |
| | | | 16% AS 104-LS + 6.5% Roda Link C70 |
| | | | 16% AS 104-LS + 7% Roda Link C70 |
| | | | 16% AS 104-LS + 7.5% Roda Link C70 |
| | | | 16% AS 104-LS + 8% Roda Link C70 |
| | | | 16% AS 104-LS + 8.5% Roda Link C70 |
| | | | 16% AS 104-LS + 9% Roda Link C70 |
| | | | 16% AS 104-LS + 9.5% Roda Link C70 |
| | | | 16% AS 104-LS + 10% Roda Link C70 |
| | | | 17% AS 104-LS (=1% SF solids) + 0.5% Roda Link C70 |
| | | | 17% AS 104-LS (=1% SF solids) + 1% Roda Link C70 |
| | | | 17% AS 104-LS (=1% SF solids) + 1.5% Roda Link C70 |
| | | | 17% AS 104-LS (=1% SF solids) + 2% Roda Link C70 |
| | | | 17% AS 104-LS (=1% SF solids) + 2.5% Roda Link C70 |
| | | | 17% AS 104-LS (=1% SF solids) + 3% Roda Link C70 |
| | | | 17% AS 104-LS (=1% SF solids) + 3.5% Roda Link C70 |
| | | | 17% AS 104-LS (=1% SF solids) + 4% Roda Link C70 |
| | | | 17% AS 104-LS (=1% SF solids) + 4.5% Roda Link C70 |
| | | | 17% AS 104-LS (=1% SF solids) + 5% Roda Link C70 |
| | | | 17% AS 104-LS (=1% SF solids) + 5.5% Roda Link C70 |
| | | | 17% AS 104-LS (=1% SF solids) + 6% Roda Link C70 |
| | | | 17% AS 104-LS (=1% SF solids) + 6.5% Roda Link C70 |
| | | | 17% AS 104-LS (=1% SF solids) + 7% Roda Link C70 |
| | | | 17% AS 104-LS (=1% SF solids) + 7.5% Roda Link C70 |
| | | | 17% AS 104-LS (=1% SF solids) + 8% Roda Link C70 |
| | | | 17% AS 104-LS (=1% SF solids) + 8.5% Roda Link C70 |
| | | | 17% AS 104-LS (=1% SF solids) + 9% Roda Link C70 |
| | | | 17% AS 104-LS (=1% SF solids) + 9.5% Roda Link C70 |
| | | | 17% AS 104-LS (=1% SF solids) + 10% Roda Link C70 |
| | | | 18% AS 104-LS + 0.5% Roda Link C70 |
| | | | 18% AS 104-LS + 1% Roda Link C70 |
| | | | 18% AS 104-LS + 1.5% Roda Link C70 |
| | | | 18% AS 104-LS + 2% Roda Link C70 |
| | | | 18% AS 104-LS + 2.5% Roda Link C70 |
| | | | 18% AS 104-LS + 3% Roda Link C70 |
| | | | 18% AS 104-LS + 3.5% Roda Link C70 |
| | | | 18% AS 104-LS + 4% Roda Link C70 |
| | | | 18% AS 104-LS + 4.5% Roda Link C70 |
| | | | 18% AS 104-LS + 5% Roda Link C70 |
| | | | 18% AS 104-LS + 5.5% Roda Link C70 |
| | | | 18% AS 104-LS + 6% Roda Link C70 |
| | | | 18% AS 104-LS + 6.5% Roda Link C70 |
| | | | 18% AS 104-LS + 7% Roda Link C70 |
| | | | 18% AS 104-LS + 7.5% Roda Link C70 |
| | | | 18% AS 104-LS + 8% Roda Link C70 |
| | | | 18% AS 104-LS + 8.5% Roda Link C70 |
| | | | 18% AS 104-LS + 9% Roda Link C70 |
| | | | 18% AS 104-LS + 9.5% Roda Link C70 |
| | | | 18% AS 104-LS + 10% Roda Link C70 |
| | | | 19% AS 104-LS + 0.5% Roda Link C70 |
| | | | 19% AS 104-LS + 1% Roda Link C70 |
| | | | 19% AS 104-LS + 1.5% Roda Link C70 |
| | | | 19% AS 104-LS + 2% Roda Link C70 |
| | | | 19% AS 104-LS + 2.5% Roda Link C70 |
| | | | 19% AS 104-LS + 3% Roda Link C70 |
| | | | 19% AS 104-LS + 3.5% Roda Link C70 |
| | | | 19% AS 104-LS + 4% Roda Link C70 |
| | | | 19% AS 104-LS + 4.5% Roda Link C70 |
| | | | 19% AS 104-LS + 5% Roda Link C70 |
| | | | 19% AS 104-LS + 5.5% Roda Link C70 |
| | | | 19% AS 104-LS + 6% Roda Link C70 |
| | | | 19% AS 104-LS + 6.5% Roda Link C70 |
| | | | 19% AS 104-LS + 7% Roda Link C70 |
| | | | 19% AS 104-LS + 7.5% Roda Link C70 |
| | | | 19% AS 104-LS + 8% Roda Link C70 |
| | | | 19% AS 104-LS + 8.5% Roda Link C70 |
| | | | 19% AS 104-LS + 9% Roda Link C70 |
| | | | 19% AS 104-LS + 9.5% Roda Link C70 |
| | | | 19% AS 104-LS + 10% Roda Link C70 |
| | | | 20% AS 104-LS + 0.5% Roda Link C70 |
| | | | 20% AS 104-LS + 1% Roda Link C70 |
| | | | 20% AS 104-LS + 1.5% Roda Link C70 |
| | | | 20% AS 104-LS + 2% Roda Link C70 |
| | | | 20% AS 104-LS + 2.5% Roda Link C70 |
| | | | 20% AS 104-LS + 3% Roda Link C70 |
| | | | 20% AS 104-LS + 3.5% Roda Link C70 |
| | | | 20% AS 104-LS + 4% Roda Link C70 |
| | | | 20% AS 104-LS + 4.5% Roda Link C70 |
| | | | 20% AS 104-LS + 5% Roda Link C70 |
| | | | 20% AS 104-LS + 5.5% Roda Link C70 |
| | | | 20% AS 104-LS + 6% Roda Link C70 |
| | | | 20% AS 104-LS + 6.5% Roda Link C70 |
| | | | 20% AS 104-LS + 7% Roda Link C70 |
| | | | 20% AS 104-LS + 7.5% Roda Link C70 |
| | | | 20% AS 104-LS + 8% Roda Link C70 |
| | | | 20% AS 104-LS + 8.5% Roda Link C70 |
| | | | 20% AS 104-LS + 9% Roda Link C70 |
| | | | 20% AS 104-LS + 9.5% Roda Link C70 |
| | | | 20% AS 104-LS + 10% Roda Link C70 |
| | | XR-5350 | 15% AS 104-LS + 5% XR-5350 |
| | | (Stahl) | 15% AS 104-LS + 5.5% XR-5350 |
| | | | 15% AS 104-LS + 6% XR-5350 |
| | | | 15% AS 104-LS + 6.5% XR-5350 |
| | | | 15% AS 104-LS + 7% XR-5350 |
| | | | 15% AS 104-LS + 7.5% XR-5350 |
| | | | 15% AS 104-LS + 8% XR-5350 |
| | | | 15% AS 104-LS + 8.5% XR-5350 |
| | | | 15% AS 104-LS + 9% XR-5350 |
| | | | 15% AS 104-LS + 9.5% XR-5350 |
| | | | 15% AS 104-LS + 10% XR-5350 |
| | | | 15% AS 104-LS + 10.5% XR-5350 |
| | | | 15% AS 104-LS + 11% XR-5350 |
| | | | 15% AS 104-LS + 11.5% XR-5350 |
| | | | 15% AS 104-LS + 12% XR-5350 |
| | | | 15% AS 104-LS + 12.5% XR-5350 |
| | | | 15% AS 104-LS + 13% XR-5350 |
| | | | 15% AS 104-LS + 13.5% XR-5350 |
| | | | 15% AS 104-LS + 14% XR-5350 |
| | | | 15% AS 104-LS + 14.5% XR-5350 |
| | | | 15% AS 104-LS + 15% XR-5350 |
| | | | 16% AS 104-LS + 5% XR-5350 |
| | | | 16% AS 104-LS + 5.5% XR-5350 |
| | | | 16% AS 104-LS + 6% XR-5350 |
| | | | 16% AS 104-LS + 6.5% XR-5350 |
| | | | 16% AS 104-LS + 7% XR-5350 |
| | | | 16% AS 104-LS + 7.5% XR-5350 |
| | | | 16% AS 104-LS + 8% XR-5350 |
| | | | 16% AS 104-LS + 8.5% XR-5350 |
| | | | 16% AS 104-LS + 9% XR-5350 |
| | | | 16% AS 104-LS + 9.5% XR-5350 |
| | | | 16% AS 104-LS + 10% XR-5350 |
| | | | 16% AS 104-LS + 10.5% XR-5350 |
| | | | 16% AS 104-LS + 11% XR-5350 |
| | | | 16% AS 104-LS + 11.5% XR-5350 |
| | | | 16% AS 104-LS + 12% XR-5350 |
| | | | 16% AS 104-LS + 12.5% XR-5350 |
| | | | 16% AS 104-LS + 13% XR-5350 |
| | | | 16% AS 104-LS + 13.5% XR-5350 |
| | | | 16% AS 104-LS + 14% XR-5350 |
| | | | 16% AS 104-LS + 14.5% XR-5350 |
| | | | 16% AS 104-LS + 15% XR-5350 |
| | | | 17% AS 104-LS (=1% SF solids) + 5% XR-5350 |
| | | | 17% AS 104-LS (=1% SF solids) + 5.5% XR-5350 |
| | | | 17% AS 104-LS (=1% SF solids) + 6% XR-5350 |
| | | | 17% AS 104-LS (=1% SF solids) + 6.5% XR-5350 |
| | | | 17% AS 104-LS (=1% SF solids) + 7% XR-5350 |
| | | | 17% AS 104-LS (=1% SF solids) + 7.5% XR-5350 |
| | | | 17% AS 104-LS (=1% SF solids) + 8% XR-5350 |
| | | | 17% AS 104-LS (=1% SF solids) + 8.5% XR-5350 |
| | | | 17% AS 104-LS (=1% SF solids) + 9% XR-5350 |
| | | | 17% AS 104-LS (=1% SF solids) + 9.5% XR-5350 |
| | | | 17% AS 104-LS (=1% SF solids) + 10% XR-5350 |
| | | | 17% AS 104-LS (=1% SF solids) + 10.5% XR-5350 |
| | | | 17% AS 104-LS (=1% SF solids) + 11% XR-5350 |
| | | | 17% AS 104-LS (=1% SF solids) + 11.5% XR-5350 |
| | | | 17% AS 104-LS (=1% SF solids) + 12% XR-5350 |
| | | | 17% AS 104-LS (=1% SF solids) + 12.5% XR-5350 |
| | | | 17% AS 104-LS (=1% SF solids) + 13% XR-5350 |
| | | | 17% AS 104-LS (=1% SF solids) + 13.5% XR-5350 |
| | | | 17% AS 104-LS (=1% SF solids) + 14% XR-5350 |
| | | | 17% AS 104-LS (=1% SF solids) + 14.5% XR-5350 |
| | | | 17% AS 104-LS (=1% SF solids) + 15% XR-5350 |
| | | | 18% AS 104-LS + 5% XR-5350 |
| | | | 18% AS 104-LS + 5.5% XR-5350 |
| | | | 18% AS 104-LS + 6% XR-5350 |
| | | | 18% AS 104-LS + 6.5% XR-5350 |
| | | | 18% AS 104-LS + 7% XR-5350 |
| | | | 18% AS 104-LS + 7.5% XR-5350 |
| | | | 18% AS 104-LS + 8% XR-5350 |
| | | | 18% AS 104-LS + 8.5% XR-5350 |
| | | | 18% AS 104-LS + 9% XR-5350 |
| | | | 18% AS 104-LS + 9.5% XR-5350 |
| | | | 18% AS 104-LS + 10% XR-5350 |
| | | | 18% AS 104-LS + 10.5% XR-5350 |
| | | | 18% AS 104-LS + 11% XR-5350 |
| | | | 18% AS 104-LS + 11.5% XR-5350 |
| | | | 18% AS 104-LS + 12% XR-5350 |
| | | | 18% AS 104-LS + 12.5% XR-5350 |
| | | | 18% AS 104-LS + 13% XR-5350 |
| | | | 18% AS 104-LS + 13.5% XR-5350 |
| | | | 18% AS 104-LS + 14% XR-5350 |
| | | | 18% AS 104-LS + 14.5% XR-5350 |
| | | | 18% AS 104-LS + 15% XR-5350 |
| | | | 19% AS 104-LS + 5% XR-5350 |
| | | | 19% AS 104-LS + 5.5% XR-5350 |
| | | | 19% AS 104-LS + 6% XR-5350 |
| | | | 19% AS 104-LS + 6.5% XR-5350 |
| | | | 19% AS 104-LS + 7% XR-5350 |
| | | | 19% AS 104-LS + 7.5% XR-5350 |
| | | | 19% AS 104-LS + 8% XR-5350 |
| | | | 19% AS 104-LS + 8.5% XR-5350 |
| | | | 19% AS 104-LS + 9% XR-5350 |
| | | | 19% AS 104-LS + 9.5% XR-5350 |
| | | | 19% AS 104-LS + 10% XR-5350 |
| | | | 19% AS 104-LS + 10.5% XR-5350 |
| | | | 19% AS 104-LS + 11% XR-5350 |
| | | | 19% AS 104-LS + 11.5% XR-5350 |
| | | | 19% AS 104-LS + 12% XR-5350 |
| | | | 19% AS 104-LS + 12.5% XR-5350 |
| | | | 19% AS 104-LS + 13% XR-5350 |
| | | | 19% AS 104-LS + 13.5% XR-5350 |
| | | | 19% AS 104-LS + 14% XR-5350 |
| | | | 19% AS 104-LS + 14.5% XR-5350 |
| | | | 19% AS 104-LS + 15% XR-5350 |
| | | | 20% AS 104-LS + 5% XR-5350 |
| | | | 20% AS 104-LS + 5.5% XR-5350 |
| | | | 20% AS 104-LS + 6% XR-5350 |
| | | | 20% AS 104-LS + 6.5% XR-5350 |
| | | | 20% AS 104-LS + 7% XR-5350 |
| | | | 20% AS 104-LS + 7.5% XR-5350 |
| | | | 20% AS 104-LS + 8% XR-5350 |
| | | | 20% AS 104-LS + 8.5% XR-5350 |
| | | | 20% AS 104-LS + 9% XR-5350 |
| | | | 20% AS 104-LS + 9.5% XR-5350 |
| | | | 20% AS 104-LS + 10% XR-5350 |
| | | | 20% AS 104-LS + 10.5% XR-5350 |
| | | | 20% AS 104-LS + 11% XR-5350 |
| | | | 20% AS 104-LS + 11.5% XR-5350 |
| | | | 20% AS 104-LS + 12% XR-5350 |
| | | | 20% AS 104-LS + 12.5% XR-5350 |
| | | | 20% AS 104-LS + 13% XR-5350 |
| | | | 20% AS 104-LS + 13.5% XR-5350 |
| | | | 20% AS 104-LS + 14% XR-5350 |
| | | | 20% AS 104-LS + 14.5% XR-5350 |
| | | | 20% AS 104-LS + 15% XR-5350 |
| | Polyaziridines | Aqualen AKU | 30% AS 104-LS + 0.05% Aqualen AKU |
| | | (OR equivalent | 30% AS 104-LS + 0.10% Aqualen AKU |
| | | Picassian XL-048 | 30% AS 104-LS + 0.15% Aqualen AKU |
| | | (Stahl) OR | 30% AS 104-LS + 0.20% Aqualen AKU |
| | | equivalent | 30% AS 104-LS + 0.25% Aqualen AKU |
| | | Picassian XL-746 | 30% AS 104-LS + 0.30% Aqualen AKU |
| | | (Stahl)) | 30% AS 104-LS + 0.35% Aqualen AKU |
| | | | 30% AS 104-LS + 0.40% Aqualen AKU |
| | | | 30% AS 104-LS + 0.45% Aqualen AKU |
| | | | 30% AS 104-LS + 0.50% Aqualen AKU |
| | | | 31% AS 104-LS + 0.05% Aqualen AKU |
| | | | 31% AS 104-LS + 0.10% Aqualen AKU |
| | | | 31% AS 104-LS + 0.15% Aqualen AKU |
| | | | 31% AS 104-LS + 0.20% Aqualen AKU |
| | | | 31% AS 104-LS + 0.25% Aqualen AKU |
| | | | 31% AS 104-LS + 0.30% Aqualen AKU |
| | | | 31% AS 104-LS + 0.35% Aqualen AKU |
| | | | 31% AS 104-LS + 0.40% Aqualen AKU |
| | | | 31% AS 104-LS + 0.45% Aqualen AKU |
| | | | 31% AS 104-LS + 0.50% Aqualen AKU |
| | | | 32% AS 104-LS + 0.05% Aqualen AKU |
| | | | 32% AS 104-LS + 0.10% Aqualen AKU |
| | | | 32% AS 104-LS + 0.15% Aqualen AKU |
| | | | 32% AS 104-LS + 0.20% Aqualen AKU |
| | | | 32% AS 104-LS + 0.25% Aqualen AKU |
| | | | 32% AS 104-LS + 0.30% Aqualen AKU |
| | | | 32% AS 104-LS + 0.35% Aqualen AKU |
| | | | 32% AS 104-LS + 0.40% Aqualen AKU |
| | | | 32% AS 104-LS + 0.45% Aqualen AKU |
| | | | 32% AS 104-LS + 0.50% Aqualen AKU |
| | | | 33% AS 104-LS + 0.05% Aqualen AKU |
| | | | 33% AS 104-LS + 0.10% Aqualen AKU |
| | | | 33% AS 104-LS + 0.15% Aqualen AKU |
| | | | 33% AS 104-LS + 0.20% Aqualen AKU |
| | | | 33% AS 104-LS + 0.25% Aqualen AKU |
| | | | 33% AS 104-LS + 0.30% Aqualen AKU |
| | | | 33% AS 104-LS + 0.35% Aqualen AKU |
| | | | 33% AS 104-LS + 0.40% Aqualen AKU |
| | | | 33% AS 104-LS + 0.45% Aqualen AKU |
| | | | 33% AS 104-LS + 0.50% Aqualen AKU |
| | | | 34% AS 104-LS + 0.05% Aqualen AKU |
| | | | 34% AS 104-LS + 0.10% Aqualen AKU |
| | | | 34% AS 104-LS + 0.15% Aqualen AKU |
| | | | 34% AS 104-LS + 0.20% Aqualen AKU |
| | | | 34% AS 104-LS + 0.25% Aqualen AKU |
| | | | 34% AS 104-LS + 0.30% Aqualen AKU |
| | | | 34% AS 104-LS + 0.35% Aqualen AKU |
| | | | 34% AS 104-LS + 0.40% Aqualen AKU |
| | | | 34% AS 104-LS + 0.45% Aqualen AKU |
| | | | 34% AS 104-LS + 0.50% Aqualen AKU |
| | | | 35% AS 104-LS (=1% SF solids) + 0.05% Aqualen AKU |
| | | | 35% AS 104-LS (=1% SF solids) + 0.10% Aqualen AKU |
| | | | 35% AS 104-LS (=1% SF solids) + 0.15% Aqualen AKU |
| | | | 35% AS 104-LS (=1% SF solids) + 0.20% Aqualen AKU |
| | | | 35% AS 104-LS (=1% SF solids) + 0.25% Aqualen AKU |
| | | | 35% AS 104-LS (=1% SF solids) + 0.30% Aqualen AKU |
| | | | 35% AS 104-LS (=1% SF solids) + 0.35% Aqualen AKU |
| | | | 35% AS 104-LS (=1% SF solids) + 0.40% Aqualen AKU |
| | | | 35% AS 104-LS (=1% SF solids) + 0.45% Aqualen AKU |
| | | | 35% AS 104-LS (=1% SF solids) + 0.50% Aqualen AKU |
| | | | 36% AS 104-LS + 0.05% Aqualen AKU |
| | | | 36% AS 104-LS + 0.10% Aqualen AKU |
| | | | 36% AS 104-LS + 0.15% Aqualen AKU |
| | | | 36% AS 104-LS + 0.20% Aqualen AKU |
| | | | 36% AS 104-LS + 0.25% Aqualen AKU |
| | | | 36% AS 104-LS + 0.30% Aqualen AKU |
| | | | 36% AS 104-LS + 0.35% Aqualen AKU |
| | | | 36% AS 104-LS + 0.40% Aqualen AKU |
| | | | 36% AS 104-LS + 0.45% Aqualen AKU |
| | | | 36% AS 104-LS + 0.50% Aqualen AKU |
| | | | 37% AS 104-LS + 0.05% Aqualen AKU |
| | | | 37% AS 104-LS + 0.10% Aqualen AKU |
| | | | 37% AS 104-LS + 0.15% Aqualen AKU |
| | | | 37% AS 104-LS + 0.20% Aqualen AKU |
| | | | 37% AS 104-LS + 0.25% Aqualen AKU |
| | | | 37% AS 104-LS + 0.30% Aqualen AKU |
| | | | 37% AS 104-LS + 0.35% Aqualen AKU |
| | | | 37% AS 104-LS + 0.40% Aqualen AKU |
| | | | 37% AS 104-LS + 0.45% Aqualen AKU |
| | | | 37% AS 104-LS + 0.50% Aqualen AKU |
| | | | 38% AS 104-LS + 0.05% Aqualen AKU |
| | | | 38% AS 104-LS + 0.10% Aqualen AKU |
| | | | 38% AS 104-LS + 0.15% Aqualen AKU |
| | | | 38% AS 104-LS + 0.20% Aqualen AKU |
| | | | 38% AS 104-LS + 0.25% Aqualen AKU |
| | | | 38% AS 104-LS + 0.30% Aqualen AKU |
| | | | 38% AS 104-LS + 0.35% Aqualen AKU |
| | | | 38% AS 104-LS + 0.40% Aqualen AKU |
| | | | 38% AS 104-LS + 0.45% Aqualen AKU |
| | | | 38% AS 104-LS + 0.50% Aqualen AKU |
| | Poly- | Roda Link | 15% AS 104-LS + 1% Roda Link 5777 |
| | carbodiimides | 5777 (TFL) | 15% AS 104-LS + 2% Roda Link 5777 |
| | | (OR equivalent | 15% AS 104-LS + 3% Roda Link 5777 |
| | | Picassian XL-745 | 15% AS 104-LS + 4% Roda Link 5777 |
| | | (Stahl) OR | 15% AS 104-LS + 5% Roda Link 5777 |
| | | equivalent | 15% AS 104-LS + 6% Roda Link 5777 |
| | | Picassian | 15% AS 104-LS + 7% Roda Link 5777 |
| | | XL-732) | 15% AS 104-LS + 8% Roda Link 5777 |
| | | | 15% AS 104-LS + 9% Roda Link 5777 |
| | | | 15% AS 104-LS + 10% Roda Link 5777 |
| | | | 16% AS 104-LS + 1% Roda Link 5777 |
| | | | 16% AS 104-LS + 2% Roda Link 5777 |
| | | | 16% AS 104-LS + 3% Roda Link 5777 |
| | | | 16% AS 104-LS + 4% Roda Link 5777 |
| | | | 16% AS 104-LS + 5% Roda Link 5777 |
| | | | 16% AS 104-LS + 6% Roda Link 5777 |
| | | | 16% AS 104-LS + 7% Roda Link 5777 |
| | | | 16% AS 104-LS + 8% Roda Link 5777 |
| | | | 16% AS 104-LS + 9% Roda Link 5777 |
| | | | 16% AS 104-LS + 10% Roda Link 5777 |
| | | | 17% AS104-LS (=1% SF solids) + 1% Roda Link 5777 |
| | | | 17% AS104-LS (=1% SF solids) + 2% Roda Link 5777 |
| | | | 17% AS104-LS (=1% SF solids) + 3% Roda Link 5777 |
| | | | 17% AS104-LS (=1% SF solids) + 4% Roda Link 5777 |
| | | | 17% AS104-LS (=1% SF solids) + 5% Roda Link 5777 |
| | | | 17% AS104-LS (=1% SF solids) + 6% Roda Link 5777 |
| | | | 17% AS104-LS (=1% SF solids) + 7% Roda Link 5777 |
| | | | 17% AS104-LS (=1% SF solids) + 8% Roda Link 5777 |
| | | | 17% AS104-LS (=1% SF solids) + 9% Roda Link 5777 |
| | | | 17% AS 104-LS (=1% SF solids) + 10% Roda Link 5777 |
| | | | 18% AS 104-LS + 1% Roda Link 5777 |
| | | | 18% AS 104-LS + 2% Roda Link 5777 |
| | | | 18% AS 104-LS + 3% Roda Link 5777 |
| | | | 18% AS 104-LS + 4% Roda Link 5777 |
| | | | 18% AS 104-LS + 5% Roda Link 5777 |
| | | | 18% AS 104-LS + 6% Roda Link 5777 |
| | | | 18% AS 104-LS + 7% Roda Link 5777 |
| | | | 18% AS 104-LS + 8% Roda Link 5777 |
| | | | 18% AS 104-LS + 9% Roda Link 5777 |
| | | | 18% AS 104-LS + 10% Roda Link 5777 |
| | | | 19% AS 104-LS + 1% Roda Link 5777 |
| | | | 19% AS 104-LS + 2% Roda Link 5777 |
| | | | 19% AS 104-LS + 3% Roda Link 5777 |
| | | | 19% AS 104-LS + 4% Roda Link 5777 |
| | | | 19% AS 104-LS + 5% Roda Link 5777 |
| | | | 19% AS 104-LS + 6% Roda Link 5777 |
| | | | 19% AS 104-LS + 7% Roda Link 5777 |
| | | | 19% AS 104-LS + 8% Roda Link 5777 |
| | | | 19% AS 104-LS + 9% Roda Link 5777 |
| | | | 19% AS 104-LS + 10% Roda Link 5777 |
| | | | 20% AS 104-LS + 1% Roda Link 5777 |
| | | | 20% AS 104-LS + 2% Roda Link 5777 |
| | | | 20% AS 104-LS + 3% Roda Link 5777 |
| | | | 20% AS 104-LS + 4% Roda Link 5777 |
| | | | 20% AS 104-LS + 5% Roda Link 5777 |
| | | | 20% AS 104-LS + 6% Roda Link 5777 |
| | | | 20% AS 104-LS + 7% Roda Link 5777 |
| | | | 20% AS 104-LS + 8% Roda Link 5777 |
| | | | 20% AS 104-LS + 9% Roda Link 5777 |
| | | | 20% AS 104-LS + 10% Roda Link 5777 |
| | Polyaldehydes | Roda Link 3315/F | |
| | | Glutaraldehyde | |
| Resins | Polyurethanes | | |
| | Polyacrylates | | |
| | Polyesters | | |
| | Waxes | | |
| | Proteins | | |
| Plasticizers | Alcohols | Glycerol | {5-90% AS 104-LS (=0.3-5.4% SF solids)} + 0.5-5% Glycerol |
| | | Sorbitol | |

All patents, patent applications, and published references cited herein are hereby incorporated by reference in their entirety. While the methods of the present disclosure have been described in connection with the specific embodiments thereof, it will be understood that it is capable of further modification. Further, this application is intended to cover any variations, uses, or adaptations of the methods of the present disclosure, including such departures from the present disclosure as come within known or customary practice in the art to which the methods of the present disclosure pertain.

1. An article comprising a leather substrate and silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

2. The article of claim 1, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

3. The article of claim 1 or 2, further comprising about 0.001% (w/w) to about 10% (w/w) sericin relative to the silk fibroin proteins or fragments thereof.

4. The article of any one of claims 1 to 3, wherein the silk fibroin proteins or fragments thereof do not spontaneously or gradually gelate and do not visibly change in color or turbidity when in an aqueous solution for at least 10 days prior to being added to the leather substrate.

5. The article of any one of claims 1 to 4, wherein a portion of the silk fibroin proteins or fragments thereof is coated on a surface of the leather substrate.

6. The article of any one of claims 1 to 5, wherein a portion of the silk fibroin proteins or fragments thereof is infused into a layer of the leather substrate.

7. The article of any one of claims 1 to 6, wherein a portion of the silk fibroin proteins or fragments thereof is in a recessed portion of the leather substrate.

8. The article of any one of claims 1 to 7, the article further comprising one or more polysaccharides selected from starch, cellulose, gum arabic, guar gum, xanthan gum, alginate, pectin, chitin, chitosan, carrageenan, inulin, and gellan gum.

9. The article of claim 8, wherein the gellan gum comprises low-acyl content gellan gum.

10. The article of claim 8 or 9, wherein the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

11. The article of claim 8 or 9, wherein the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

12. The article of any one of claims 1 to 11, the article further comprising one or more polyols, and/or one or more polyethers.

13. The article of claim 12, wherein the polyols comprise one or more of glycol, glycerol, sorbitol, D-sorbitol, glucose, sucrose, mannitol, D-mannitol, and dextrose.

14. The article of claim 12, wherein the polyethers comprise one or more polyethyleneglycols (PEGs).

15. The article of any one of claims 12 to 14, wherein the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

16. The article of any one of claims 1 to 15, the article further comprising one or more of a silicone, a dye, a pigment, and a polyurethane.

17. The article of any one of claims 1 to 16, the article further comprising one or more of a crosslinker, a crosslinker adduct, or a crosslinker reaction derivative.

18. The article of any one of claims 1 to 16, the article further comprising one or more of: an isocyanate, isocyanate adduct, and/or isocyanate reaction derivative; a poly diisocyanate, poly diisocyanate adduct, and/or poly diisocyanate reaction derivative; an aziridine, aziridine adduct, and/or aziridine reaction derivative; a carbodiimide, carbodiimide adduct, and/or carbodiimide reaction derivative; an aldehyde, aldehyde adduct, and/or aldehyde reaction derivative; a polyisocyanate, polyisocyanate adduct, and/or polyisocyanate reaction derivative; a polyaziridine, polyaziridine adduct, and/or polyaziridine reaction derivative; a polycarbodiimide, polycarbodiimide adduct, and/or polycarbodiimide reaction derivative; a polyaldehyde, polyaldehyde adduct, and/or polyaldehyde reaction derivative; a polyurethane, polyurethane adduct, and/or polyurethane reaction derivative; a polyacrylate, polyacrylate adduct, and/or polyacrylate reaction derivative; a polyester, polyester adduct, and/or polyester reaction derivative; a wax, wax adduct, and/or wax reaction derivative; a protein, protein adduct, and/or protein reaction derivative; or an alcohol, alcohol adduct, and/or alcohol reaction derivative.

19. A method of treating a leather substrate with a silk formulation, the method comprising applying on a surface of the leather a silk formulation comprising silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

20. The method of claim 19, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

21. The method of claim 19 or 20, wherein the silk formulation further comprises about 0.001% (w/w) to about 10% (w/w) sericin relative to the silk fibroin proteins or fragments thereof.

22. The method of any one of claims 19 to 21, wherein the silk formulation further comprises about 0.001% (w/v) to about 10% (w/v) sericin.

23. The method of any one of claims 19 to 22, wherein the silk fibroin proteins or fragments thereof do not spontaneously or gradually gelate and do not visibly change in color or turbidity when in an aqueous solution for at least 10 days prior to being formulated and applied to the leather substrate.

24. The method of any one of claims 19 to 23, wherein a portion of the silk formulation is coated on a surface of the leather substrate, and/or a portion of the silk formulation is infused into a layer of the leather substrate, and/or a portion of the silk formulation enters a recessed portion of the leather substrate.

25. The method of any one of claims 19 to 24, wherein the silk formulation further comprises a rheology modifier.

26. The method of claim 25, wherein the rheology modifier comprises one or more polysaccharides selected from starch, cellulose, gum arabic, guar gum, xanthan gum, alginate, pectin, chitin, chitosan, carrageenan gum, inulin, and gellan gum.

27. The method of claim 26, wherein the gellan gum comprises low-acyl content gellan gum.

28. The method of any one of claims 25 to 27, wherein the w/w ratio between the silk fibroin proteins or fragments thereof and the rheology modifier in the silk formulation is selected from about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

29. The method of any one of claims 25 to 27, wherein the w/w ratio between the silk fibroin proteins or fragments thereof and the rheology modifier in the silk formulation is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

30. The method of any one of claims 25 to 27, wherein the w/v concentration of the rheology modifier in the silk formulation is between about 0.01% and about 5%, or between about 0.1% and about 1%.

31. The method of any one of claims 19 to 30, wherein the silk formulation further comprises a plasticizer.

32. The method of claim 31, wherein the plasticizer comprises one or more polyols, and/or one or more polyethers.

33. The method of claim 32, wherein the polyols are selected from one or more of glycol, glycerol, sorbitol, D-sorbitol, glucose, sucrose, mannitol, mannitol, D-mannitol, and dextrose.

34. The method of claim 32, wherein the polyethers are one or more polyethyleneglycols (PEGs).

35. The method of any one of claims 31 to 34, wherein the w/w ratio between the silk fibroin proteins or fragments thereof and the plasticizer in the silk formulation is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

36. The method of any one of claims 31 to 34, wherein the w/v concentration of the plasticizer in the silk formulation is between about 0.01% and about 10%.

37. The method of any one of claims 19 to 36, wherein the silk formulation further comprises a defoaming agent at a concentration between about 0.001% and about 1%.

38. The method of claim 37, wherein the defoaming agent comprises a silicone.

39. The method of any one of claims 19 to 38, wherein the silk formulation further comprises one or more of an isocyanate, a poly diisocyanate, an aziridine, a carbodiimide, an aldehyde, a polyisocyanate, a polyaziridine, a polycarbodiimide, a polyaldehyde, a polyurethane, a polyacrylate, a polyester, a wax, a protein, and/or an alcohol.

40. The method of any one of claims 19 to 39, wherein the silk formulation is a liquid, a gel, a paste, a wax, or a cream.

41. The method of any one of claims 19 to 40, wherein the silk formulation comprises one or more sub-formulations to be applied at the same time or at different times.

42. The method of any one of claims 19 to 41, wherein the concentration of silk fibroin proteins or fragments thereof in the silk formulation is between about 0.1% w/v and about 15% w/v.

43. The method of any one of claims 19 to 41, wherein the concentration of silk fibroin proteins or fragments thereof in the silk formulation is between about 0.5% w/v and about 12% w/v.

44. The method of any one of claims 19 to 41, wherein the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v.

45. The method of any one of claims 19 to 41, wherein the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 9.25% w/v, about 9.5% w/v, about 9.75% w/v, or about 10% w/v.

46. The method of any one of claims 19 to 41, wherein the concentration of silk fibroin proteins or fragments thereof in the silk formulation is between about 5 mg/mL and about 125 mg/mL.

47. The method of any one of claims 19 to 41, wherein the concentration of silk fibroin proteins or fragments thereof in the silk formulation is about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, or about 90 mg/mL.

48. The method of any one of claims 19 to 47, the method further comprising one or more additional steps selected from dyeing, drying, water annealing, mechanical stretching, trimming, polishing, applying a pigment, applying a colorant, applying an acrylic formulation, applying an urethane formulation, chemical fixing, stamping, applying a silicone finish, providing a Uniflex treatment, and/or providing a Finiflex treatment, wherein the step of applying the silk formulation on a surface of the leather is performed before, during, or after the one or more additional steps.

49. The method of any one of claims 19 to 48, wherein treating the leather substrate with the silk formulation results in one or more of the following: increase in gloss, increase in color saturation, color enhancement, increase in color fixation, reduced dye use, and/or improved colorfastness.

50. The method of claim 49, wherein the improvement is as to a leather substrate not similarly treated with a silk formulation.


SEQUENCE LISTING (53 sequences)

SEQ ID NO: 1 - protein, 6 aa, Artificial Sequence
  Synthetic protein-like multiblock polymer hexapeptide
  MISC_FEATURE (6)..(6): X can be is alanine, tyrosine, valine, or serine
GAGAGX

SEQ ID NO: 2 - protein, 6 aa, Artificial Sequence
  Synthetic protein-like multiblock polymer hexapeptide
GAGAGS

SEQ ID NO: 3 - protein, 5 aa, Artificial Sequence
  Synthetic mammalian elastin
VPGVG

SEQ ID NO: 4 - protein, 5 aa, Artificial Sequence
  Synthetic mammalian elastin
GVGVP

SEQ ID NO: 5 - protein, 6 aa, Artificial Sequence
  Synthetic linker repetitve fragment
GAGAGS

SEQ ID NO: 6 - protein, 44 aa, Artificial Sequence
  Synthetic protein
SGFGPVANGGSGEASSESDFGSSGFGPVANASSGEASSESDFAG

SEQ ID NO: 7 - protein, 5 aa, Artificial Sequence
  Synthetic consensus peptide
  misc_feature (4)..(4): Xaa can be any naturally occurring amino acid
  MISC_FEATURE (5)..(6): X can be alanine, serine, glycine, tyrocine, or proline
GPGXX

SEQ ID NO: 8 - protein, 9 aa, Artificial Sequence
  Synthetic pro-resilin elastomeric protein
GGRPSDTYG

SEQ ID NO: 9 - protein, 9 aa, Artificial Sequence
  Synthetic pro-resilin elastomeric protein
GGRPSSSYG

SEQ ID NO: 10 - protein, 35 aa, Araneus diadematus
GSSAAAAAAAASGPGGYGPENQGPSGPGGYGPGGP

SEQ ID NO: 11 - protein, 5 aa, Artificial Sequence
  Synthetic recombinant silk protein repetitve unit
GPGAS

SEQ ID NO: 12 - protein, 5 aa, Artificial Sequence
  Synthetic recombinant silk protein repetitve unit
GPGSG

SEQ ID NO: 13 - protein, 5 aa, Artificial Sequence
  Synthetic recombinant silk protein repetitve unit
GPGGY

SEQ ID NO: 14 - protein, 5 aa, Artificial Sequence
  Synthetic recombinant silk protein repetitve unit
GPGGP

SEQ ID NO: 15 - protein, 5 aa, Artificial Sequence
  Synthetic recombinant silk protein repetitve unit
GPGGA

SEQ ID NO: 16 - protein, 5 aa, Artificial Sequence
  Synthetic recombinant silk protein repetitve unit
GPGQQ

SEQ ID NO: 17 - protein, 5 aa, Artificial Sequence
  Synthetic recombinant silk protein repetitve unit
GPGGG

SEQ ID NO: 18 - protein, 5 aa, Artificial Sequence
  Synthetic recombinant silk protein repetitve unit
GPGQG

SEQ ID NO: 19 - protein, 5 aa, Artificial Sequence
  Synthetic recombinant silk protein repetitve unit
GPGGS

SEQ ID NO: 20 - protein, 5 aa, Artificial Sequence
  Synthetic recombinant silk protein repetitve unit
AAAAA

SEQ ID NO: 21 - protein, 6 aa, Artificial Sequence
  Synthetic recombinant silk protein repetitve unit
AAAAAA

SEQ ID NO: 22 - protein, 7 aa, Artificial Sequence
  Synthetic recombinant silk protein repetitve unit
AAAAAAA

SEQ ID NO: 23 - protein, 8 aa, Artificial Sequence
  Synthetic recombinant silk protein repetitve unit
AAAAAAAA

SEQ ID NO: 24 - protein, 9 aa, Artificial Sequence
  Synthetic recombinant silk protein repetitve unit
AAAAAAAAA

SEQ ID NO: 25 - protein, 10 aa, Artificial Sequence
  Synthetic recombinant silk protein repetitve unit
AAAAAAAAAA

SEQ ID NO: 26 - protein, 9 aa, Artificial Sequence
  Synthetic recombinant silk protein repetitve unit
GGRPSDTYG

SEQ ID NO: 27 - protein, 9 aa, Artificial Sequence
  Synthetic recombinant silk protein repetitve unit
GGRPSSSYG

SEQ ID NO: 28 - protein, 24 aa, Artificial Sequence
  Synthetic recombinant silk protein repetitve unit
GPYGPGASAAAAAAGGYGPGSGQQ

SEQ ID NO: 29 - protein, 35 aa, Artificial Sequence; identical to SEQ ID NO: 10
  Synthetic recombinant silk protein repetitve unit

SEQ ID NO: 30 - protein, 20 aa, Artificial Sequence
  Synthetic recombinant silk protein repetitve unit
GPGQQGPGQQGPGQQGPGQQ

SEQ ID NO: 31 - protein, 27 aa, Artificial Sequence
  Synthetic recombinant silk protein repetitve unit
GPGGAGGPYGPGGAGGPYGPGGAGGPY

SEQ ID NO: 32 - protein, 28 aa, Artificial Sequence
  Synthetic recombinant silk protein repetitve unit
GGTTIIEDLDITIDGADGPITISEELTI

SEQ ID NO: 33 - protein, 34 aa, Artificial Sequence
  Synthetic recombinant silk protein repetitve unit
PGSSAAAAAAAASGPGQGQGQGQGQGGRPSDTYG

SEQ ID NO: 34 - protein, 39 aa, Artificial Sequence
  Synthetic recombinant silk protein repetitve unit
SAAAAAAAAGPGGGNGGRPSDTYGAPGGGNGGRPSSSYG

SEQ ID NO: 35 - protein, 18 aa, Artificial Sequence
  Synthetic recombinant silk protein repetitve unit
GGAGGAGGAGGSGGAGGS

SEQ ID NO: 36 - protein, 30 aa, Artificial Sequence
  Synthetic recombinant silk protein repetitve unit
GPGGAGPGGYGPGGSGPGGYGPGGSGPGGY

SEQ ID NO: 37 - protein, 24 aa, Artificial Sequence
  Synthetic recombinant silk protein repetitve unit
GPYGPGASAAAAAAGGYGPGCGQQ

SEQ ID NO: 38 - protein, 24 aa, Artificial Sequence
  Synthetic recombinant silk protein repetitve unit
GPYGPGASAAAAAAGGYGPGKGQQ

SEQ ID NO: 39 - protein, 35 aa, Artificial Sequence
  Synthetic recombinant silk protein repetitve unit
GSSAAAAAAAASGPGGYGPENQGPCGPGGYGPGGP

SEQ ID NO: 40 - protein, 35 aa, Artificial Sequence
  Synthetic recombinant silk protein repetitve unit
GSSAAAAAAAASGPGGYGPKNQGPSGPGGYGPGGP

SEQ ID NO: 41 - protein, 35 aa, Artificial Sequence; identical to SEQ ID NO: 40
  Synthetic recombinant silk protein repetitve unit

SEQ ID NO: 42 - protein, 15 aa, Artificial Sequence
  Synthetic silk protein-like multiblock peptide
  MISC_FEATURE (1)..(1): X can be tyrosine or glutamine
  MISC_FEATURE (4)..(4): X can be tyrosine or glutamine
  MISC_FEATURE (8)..(8): X can be tyrosine or glutamine
XGGXGAGXGAGAGAG

SEQ ID NO: 43 - protein, 14 aa, Artificial Sequence
  Synthetic silk protein-like multiblock peptide
  MISC_FEATURE (11)..(12): X can be amino acid sequence GPS or GPG
GPGGYGPGQQXXSA

SEQ ID NO: 44 - protein, 11 aa, Artificial Sequence
  Synthetic silk protein-like multiblock peptide
  MISC_FEATURE (8)..(8): X can be tyrosine, glutamine, or alanine
GRGAAGGXGAA

SEQ ID NO: 45 - protein, 15 aa, Artificial Sequence
  Synthetic silk protein-like multiblock peptide
  MISC_FEATURE (1)..(1): X can be tyrosine or glutamine
  MISC_FEATURE (4)..(4): X can be tyrosine or glutamine
  MISC_FEATURE (8)..(8): X can be tyrosine or glutamine
XGGXGAGXGAGAGAG

SEQ ID NO: 46 - protein, 8 aa, Artificial Sequence
  Synthetic modified amino acid sequence
GCGGGGGG

SEQ ID NO: 47 - protein, 8 aa, Artificial Sequence
  Synthetic modified amino acid sequence
GKGGGGGG

SEQ ID NO: 48 - protein, 14 aa, Artificial Sequence
  Synthetic modified amino acid sequence
GCGGSGGGGSGGGG

SEQ ID NO: 49 - protein, 13 aa, Artificial Sequence
  Synthetic modified amino acid sequence
GKGGGGGGSGGGG

SEQ ID NO: 50 - protein, 13 aa, Artificial Sequence
  Synthetic modified amino acid sequence
GCGGGGGGSGGGG

SEQ ID NO: 51 - protein, 33 aa, Araneus diadematus
GSSAAAAAAAASGPGQGQGQGQGQGGRPSDTYG

SEQ ID NO: 52 - protein, 39 aa, Araneus diadematus; identical to SEQ ID NO: 34

SEQ ID NO: 53 - protein, 30 aa, Artificial Sequence; identical to SEQ ID NO: 36
  Synthetic recombinant silk protein repetitve fragment